(19) United States
(12) Patent Application Publication
(10) Pub. No.: US 2010/0153082 A1
(43) Pub. Date: Jun. 17, 2010

(54) SYSTEMS AND METHODS FOR CELL-CENTRIC SIMULATION OF BIOLOGICAL EVENTS AND CELL BASED-MODELS PRODUCED THEREFROM

(76) Inventors: Richard D. Newman, Meridian, ID (US); Timothy L. Andersen, Boise, ID (US); Ullysses A. Eoff, Nampa, ID (US); Marc G. Footen, Nampa, ID (US); Jeffrey W. Habig, Boise, ID (US); Timothy Otter, Caldwell, ID (US); Cap C. Petschulat, Berkeley, CA (US); Mason E. Vail, Nampa, ID (US); David G. Zuercher, Boise, ID (US)

Correspondence Address: PERKINS COIE LLP, POST OFFICE BOX 1208, SEATTLE, WA, 98111-1208, US

(21) Appl. No.: 12/554,870

(22) Filed: Sep. 4, 2009

Related U.S. Application Data
(63) Continuation-in-part of application No. PCT/US08/75514, filed on Sep. 5, 2008.
(60) Provisional application No. 61/209,972, filed on Mar. 11, 2009.

(51) Int. Cl. G06G 7/60

(52) U.S. Cl. 703/11

(57) ABSTRACT

Systems and methods are provided herein that enable computer-implemented modeling of a biological event. Cell-based models produced from such systems and methods are also disclosed. In some embodiments, systems and methods are provided for cell-centric simulation with accommodating environment feedback. In one embodiment, a computer-implemented method of modeling a biological event can include receiving configurable simulation information and initializing an ontogeny engine to an initial step boundary in accordance with the configurable simulation information. The method can also include advancing the ontogeny engine from a current step boundary to a next step boundary in accordance with the configurable simulation information and the current step boundary. The advancing can include performing a metabolizeCell function. The method can further include continuing the advancing until a halting condition is encountered. In some embodiments, simulation of biological events includes modeling biological processes, such as development of ECM, multicellular tissue and differentiation of pluripotent cells.

### CROSS-REFERENCE TO APPLICATION(S) INCORPORATED BY REFERENCE

This application claims the benefit of U.S. Provisional Application No. 61/209,972, filed Mar. 11, 2009, and is a continuation-in-part of prior International Application No. PCT/US08/75514, filed Sep. 5, 2008, which claims priority to U.S. application Ser. No. 11/899,927, filed Sep. 7, 2007. Further, the present application incorporates the subject matter of (1) U.S. patent application Ser. No. 11/899,927 filed Sep. 7, 2007, entitled “VIRTUAL TISSUE WITH EMERGENT BEHAVIOR AND MODELING METHOD FOR PRODUCING THE TISSUE,” (2) International Application No. PCT/US2008/075514, filed Sep. 5, 2008, entitled “SYSTEMS AND METHODS FOR CELL-CENTRIC SIMULATION AND CELL-BASED MODELS PRODUCED THEREFROM,” (3) U.S. Provisional Patent Application No. 61/118,983 filed Dec. 1, 2008, entitled “CELL-BASED MODELS AND METHODS FOR SIMULATING LYMPHOCYTE DIFFERENTIATION AND OTHER BIOLOGICAL EVENTS,” and (4) U.S. Patent Publication No. 2007/0233441 A1, filed Sep. 23, 2005, entitled “METHOD, SYSTEM, AND APPARATUS FOR VIRTUAL MODELING OF BIOLOGICAL TISSUE WITH ADAPTIVE EMERGENT FUNCTIONALITY,” in their entireties by reference.

### STATEMENT REGARDING FEDERALLY SPONSORED RESEARCH

The U.S. Government has a paid-up license in this invention and the right in limited circumstances to require the patent owner to license others on reasonable terms as provided for by the terms of Contracts DAMD17-02-2-0049 and W81XWH-08-2-0003 as awarded by the US Army Medical Research Acquisition Activity (USAMRAA).

### TECHNICAL FIELD

The present disclosure is generally directed to simulation systems and computer-implemented methods for modeling one or more biological events.

### BACKGROUND

In vivo and in vitro biological research methods are useful for understanding the response of biological systems to various experimental conditions or challenges, such as cell growth conditions, stress, or exposure to drugs. The complexity of biological systems can obstruct interpretation of in vivo experimental results from studies of particular biological pathways or mechanisms. In vitro studies may help in resolving experimental results from these in vivo studies, but only by isolating the experimental system from physiological context.

In silico simulation of biological systems has the potential to keep subject processes and structures within a reasonably complete and detailed context, but still allow a researcher to target data of specific interest and origin. That is, in silico simulation allows virtual dissection without physical separation. When used as a complementary and adjunct tool, in silico simulation can immediately make in vitro and in vivo research far more effective and, in some instances, reduce ethical issues.

However, current state of the art for in silico simulations suffer from limited applicability, rigid top-down designs, and static forms that provide only superficial mimicry of biological form and function, prevent open investigation of perturbations, mutations, and dynamic processes, and require complete knowledge of input pathways, states, or structures.

### BRIEF DESCRIPTION OF THE DRAWINGS

In the drawings, the sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1A is a block diagram illustrating elements of a simulation system in accordance with an embodiment of the disclosure.

FIG. 1B is a schematic block diagram illustrating aspects of the simulation environment for modeling a biological event in accordance with an embodiment of the disclosure.

FIG. 2 is a schematic flow diagram of an ontogeny model illustrating the relationship between gene expression, metabolism, cell signaling, sensory processes and gene regulation in accordance with an embodiment of the disclosure.

FIG. 3A is a flow diagram illustrating a routine for modeling one or more biological events invoked by the simulation system and in accordance with an embodiment of the disclosure.

FIG. 3B is a flow diagram illustrating another routine for modeling a biological event supported by the simulation system and in accordance with an embodiment of the disclosure.

FIG. 4 is a schematic flow diagram illustrating interactions between gene units within a virtual cell in accordance with an embodiment of the disclosure.

FIG. 5 is a schematic flow diagram illustrating interactions between gene units and gene unit products within a virtual cell and in a neighboring virtual cell in accordance with an embodiment of the disclosure.

FIG. 6 is a schematic flow diagram illustrating interactions between gene units and gene unit products capable of establishing cell state in a virtual cell and in a neighboring virtual cell in accordance with an embodiment of the disclosure.

FIGS. 7A-7C are isometric views illustrating a simulation of a cell division event including an initial cell division event and a differentiation event resulting in two cell types (7A), a second cell division event resulting in two cells representing each cell type (7B), and a reversion event (7C) in accordance with embodiments of the disclosure.

FIGS. 8A-8C are schematic flow diagrams illustrating legends for interpreting flow diagrams describing resources and actions in a modeled signaling and gene regulatory network (SGRN) in accordance with an embodiment of the disclosure.

FIG. 9 is a schematic flow diagram illustrating a modeled SGRN for simulating development of a multicellular tissue in accordance with an embodiment of the disclosure.

FIG. 10 is a flow diagram illustrating a routine invoked by a stepPhysics module using an egg-carton model for cell placement in accordance with an embodiment of the disclosure.

FIGS. 11A-11C are schematic block diagrams illustrating an embodiment of a planar egg-carton model for cell placement (11A), and illustrating virtual cell placement configurations after addition of a new virtual cell (11B), and after removal of one virtual cell (11C) in accordance with further embodiments of the disclosure.

FIG. 12 is a flow diagram illustrating a routine invoked by a stepPhysics module using a free-space model for cell placement in accordance with an embodiment of the disclosure.

FIGS. 13A-13C are schematic block diagrams illustrating modeled cell division and cell growth events using a solid sphere free-space model in accordance with an embodiment of the disclosure.

FIGS. 14A-14C are schematic block diagrams illustrating modeled cell growth and cell spatial resolution events for a plurality of virtual cells using a solid sphere free-space model in accordance with an embodiment of the disclosure.

FIG. 15 is a flow diagram illustrating a routine invoked by a stepPhysics module for resolving cell overlap and overshoot events for a plurality of virtual cells using a solid sphere free-space model in accordance with an embodiment of the disclosure.

FIGS. 16A-16D are schematic block diagrams illustrating modeled distribution of forces among solid-spheres upon application of force to one of a group of connected solid-spheres, in the absence (16A and 16B) and presence (16C and 16D) of end-to-end sphere connections in accordance with en embodiment of the disclosure.

FIGS. 17A and 17B are isometric views illustrating simulated cells using a subsphere free-space model with (17A) and without (17B) visible internal subspheres and in accordance with an embodiment of the disclosure.

FIG. 18 is an isometric view illustrating two simulated cells behaving in accordance to simulated forces determined by intercellular adhesion rules and in accordance with an embodiment of the disclosure.

FIG. 19 is a schematic block diagram illustrating one embodiment for calculating the sum vector force of subsphere placement within a virtual cell for determining a modeled cell's resultant spatial orientation in accordance with an embodiment of the disclosure.

FIG. 20 is a graph illustrating a promotion curve for a modeled resource interacting with a modeled regulatory gene wherein the affinity between the resource and gene unit is equal to one in accordance with an embodiment of the disclosure.

FIG. 21 is an isometric view illustrating a modeled cellular sheet including virtual stem cells, in accordance with the simulation of biological events described in Example 2 of section G2 and in accordance with an embodiment of the disclosure.

FIG. 22 is a schematic diagram illustrating the role of transient amplifying cells in the development of epithelial tissue.

FIGS. 23A-23D are isometric views illustrating a modeled epithelial tissue, with the modeled basement membrane highlighted (23A), the modeled tissue's stem cells highlighted (23B), with the modeled cells neighboring the stem cells highlighted (23C), and with a population of modeled lipid-producing cells highlighted (23D) in accordance with an embodiment of the disclosure.

FIGS. 24A-240 are schematic flow diagrams illustrating resources and actions, virtual genes and gene products, and metabolic-interaction rules for modeling a multicellular tissue in accordance with the simulation of biological events described in Example 1 of sections C and G1, and in accordance with an embodiment of the disclosure.

FIGS. 25A-25K are schematic flow diagrams illustrating resources and actions, virtual genes and gene products, and metabolic-interaction rules for modeling a multicellular tissue in accordance with the simulation of biological events described in Example 2 of section G2, and in accordance with an embodiment of the disclosure.

FIG. 26 is a schematic flow diagram illustrating a modeled SGRN for simulating development of a multicellular tissue with stem-cell niches in accordance with the simulation of biological events described in Example 2 of section G2, and in accordance with an embodiment of the disclosure.

FIGS. 27A-27JJ are schematic flow diagrams illustrating resources and actions, gene units and gene unit products, and metabolic-interaction rules for modeling a multicellular epithelial tissue in accordance with the simulation of biological events described in Example 3 of section G3 and in accordance with an embodiment of the disclosure.

FIG. 28 is a block diagram of a basic and suitable computer that may employ aspects of the disclosure;

FIG. 29 is a block diagram illustrating a simple, yet suitable system in which aspects of the disclosure may operate in a networked computer environment;

FIG. 30 is a schematic block diagram illustrating subcomponents of the computing device of FIG. 29 in accordance with an embodiment of the disclosure.

FIGS. 31A-31E illustrate various uses for checkpointing in the system

FIG. 32 illustrates the origins of cell resources. Any of the four resources may be produced through metabolic processes. All but energy may be produced through gene expression. Resources taken from the environment may later be converted to other resources via metabolic or genetic processes.

FIG. 33 illustrates interaction forces between separated particles.

FIGS. 34A-34B illustrates an emitter and collector showing fluid flow in response to a pressure differential (34A) and using an emitter and collector to evaluate tissue permeability (34B).

FIGS. 35A-35C illustrates diffusion of resources through fluids when absorption of resources into a droplet when environmental concentration is greater than in the droplet (35A), when diffusion of resources from a droplet of higher concentration to a droplet of lower concentration (35B) and when releasing resources into the environment when concentration in a droplet is greater than in the environment (35C).

FIGS. 36A-36B illustrates an environment nodes fluid model showing velocity vector field and occlusion of some nodes by cells (36A) and showing pressure rebalancing in response to cell movement (36B).

FIG. 37 illustrates example arrangements possible by limiting the number of attachments between ECM spheres.

FIG. 38 illustrates how to find an action direction and activity direction.

FIGS. 39A-39C illustrate how ECM arrangement is determined by mutually repulsive alignment (39A-39B) and finding the best fit plane (39C)

FIGS. 40A-40B illustrate how ECM units are placed using activity and action direction vectors.

FIG. 41 depicts an ECM placement method to ensure that ECM units are placed on a surface sphere by creating a bounding sphere around the cell and finding the intersection of the action direction vector with the bounding sphere.

FIG. 42A illustrates an example of how polarity placement can work, FIG. 43B illustrates how a discrepancy between LHI values can indicate being on an edge, and FIG. 43C illustrates placement of ECM based on LHI discrepancy.

FIG. 43 illustrates oriented responses to external influences causing ECM to be produced away from an external influence (43A), toward an external influence, or causing division relative to external influence (43C)

FIGS. 44A-44B are graphs illustrating ATP released from cultured cells by 50% hypotonicity (44A) and illustrating that an increase in percentage of water (% hypotonicity) raised the levels of ATP in the cell environment.

FIG. 45 is a schematic diagram of hypothesized ATP Release mechanisms from Reigada and Mitchell, 2005, including a hybrid hypothesis that was validated using the system described herein.

FIG. 46 is a schematic flow diagram illustrating a modeled SGRN for simulating ATP release based on the hybrid hypothesis seen in FIG. 45.

FIG. 47 is a graph of the results from a model run based on the SGRN from FIG. 46 and validating the graphs in FIG. 44A.

FIGS. 48A-48C are schematic flow diagrams illustrating a modeled SGRN for simulating general schemes for modeling viral infection.

FIG. 49 is a schematic flow diagram illustrating a modeled SGRN for simulating CMV infection in CD34+ cells and their progeny.

FIG. 50 is a schematic flow diagram illustrating a modeled SGRN for simulating interactions between bone marrow and osteoclasts.

FIGS. 51A and 51B is a schematic flow diagram illustrating a modeled SGRN for simulating viral spread and replication in a latently infected cell (51A) and an uninfected cell (51B).

FIGS. 52A-52D illustrate the results of the model shown in FIG. 49 in two CD34+ cells that were located 20 units away from each other. Latently infected progenitor cells contain viral genome (52A-52C), and that translates to production of infectious virus (52B-52D).

FIGS. 53A-53C illustrate the results of the model shown in FIG. 49 in two CD34+ cells that were located 20 units away from each other. Latently infected progenitor cells were larger and have less apoptosis accumulation (53A-B)

FIG. 54 is a graph illustrating an increase in the number of cells based on cell lineage and the model that was run on FIG. 53.

FIG. 55A-55C illustrate the results of the model shown in FIG. 49 in two CD34+ cells that were located directly next to each other. Latently infected progenitor cells contain viral genome (55A), and then the uninfected cells also become positive for the viral genome. (55B). Testing positive for the viral genome translates into production of infectious virus, even for the uninfected progenitor cells.

FIG. 56 is a graph illustrating an increase in the number of cells based on cell lineage and the model that was run on FIG. 55.

FIG. 57 illustrates the results of the model shown in FIG. 49 in two CD34+ cells that were located directly next to each other. The amount of CMV Latently infected progenitor cells contain viral genome (55A), then the uninfected cells also become positive for the viral genome. (55B). However, in this experiment, the amount of virus receptors available on the cell is limiting, making the amount of viral genome insufficient to support virus replication. Testing positive for the viral genome does not translate into production of infectious virus in the uninfected progenitor cells.

FIG. 58 is a graph illustrating an increase in population size based on cell lineage and the model that was run in FIG. 57.

FIG. 59 is a schematic flow diagram illustrating a legend, in addition to those of FIGS. 8A-8C, for interpreting flow diagrams describing resources and actions in a modeled signaling and gene regulatory network (SGRN) in accordance with an embodiment of the disclosure.

### DETAILED DESCRIPTION

### A1. Overview

Systems and methods are provided herein that enable computer-implemented modeling of a biological event. In some embodiments, systems and methods are provided for cell-centric simulation. In one embodiment, cell-centric simulation can be defined as computer-implemented simulation of biological events wherein the cell is the starting basic unit, and wherein the cell unit can be defined with varying levels of abstractness to model the biological events with sufficient accuracy, but without having to define unnecessary levels of molecular detail. In other embodiments, cell-centric simulation of biological events, cellular process, tissue formation, etc., can accommodate environment feedback. In one embodiment, cell-centric simulation can be implemented in accordance with configurable simulation information provided to a suitable simulation and/or computing system. In another embodiment, simulation of biological events, as described herein, can automatically implement additional simulation events in accordance with information captured during a previous simulation event and stored in a configuration file. Simulation of a biological event can include simulation of a plurality of biological events that typically occur concurrently and/or in sequential order in living cells or organisms. In some embodiments, simulation of biological events can include modeling biological processes (e.g., development of a multicellular tissue, differentiation of pluripotent cell, etc.), wherein the modeling generates one or more virtual cells having emergent properties.

In one embodiment, a simulation system for modeling a biological event includes a processor and a plurality of modules configured to execute on the processor. For example, the system can include a receive module configured to receive configurable simulation information and an initialize module configured to initialize an ontogeny engine to an initial step boundary in accordance with the configurable simulation information. The system can also include an advance module configured to advance the ontogeny engine from a current step boundary to a next step boundary in accordance with the configurable simulation information and the current step boundary, the advancing comprising performing one or more functions, such as a “stepCells” function. The system can further include a halt detection module configured to continue the execution of the advance module until a halting condition is encountered. In additional embodiments, the advancing step may also include performing one or more of a “stepPhysics” function, a “killCells” function and a “stepECM” function.

Another aspect of the disclosure is directed toward a computer-implemented method of modeling a biological event. The method can include receiving configurable simulation information and initializing an ontogeny engine to an initial step boundary in accordance with the configurable simulation information. In one embodiment, the configurable simulation information can include configured physical and/or chemical parameters, configured environmental information, configured metabolic information and/or other configured information for modeling biological events. The method can also include advancing the ontogeny engine from a current step boundary to a next step boundary in accordance with the configurable simulation information and the current step boundary. The advancing includes performing a stepCells function. In some embodiments, the advancing can include a stepPhysics function and/or other functions. The method can further include continuing the advancing until a halting condition is encountered.

In another embodiment, the disclosure is directed to a method for computer modeling. For example, the method can be used to model development of a virtual multicellular tissue having an emergent property of self-repair, adaptive response to an altered environment, or cellular differentiation. The method can include assigning to a virtual cell, a heritable virtual genome containing a set of gene units, wherein each gene unit has a gene control region that specifies the activity of the gene unit in response to resources in the virtual environment, and a structural region that specifies the resource or resources produced by the gene unit, and wherein the resources produced by the set of gene units include at least one of (a1) an intercellular adhesion resource, (a2) a cell division resource, (a3) a cell growth resource, (a4) an intercellular signaling resource, and (a5) a cell differentiation resource. In some embodiments, the resources produced by the set of gene units can include a combination of two or more resource types selected from the resource types (a1)-(a5). In other embodiments, the resources in the virtual environment can include additional resource types not listed in (a1)-(a5).

The method can also include assigning at least one of (b1) a metabolic-interaction rule to govern the extra-genetic behavior of resources in the virtual environment, (b2) an action rule to promote an adhesion, growth, cell-division or cell death condition of the cell, and (b3) a physical-interaction rule to govern cell movement in response to one or more changes in the virtual environment. The method can further include placing at least one virtual cell in the virtual environment. In some embodiments, the virtual cell can contain at least one resource capable of activating a gene unit assigned to the virtual cell.

The method can further include updating the state of the virtual cell in the virtual environment, by updating the status of resources produced by the gene units in the virtual cell, applying the metabolic-interaction rule to update the status of the resources present in the virtual cell and, optionally, in the virtual environment, applying the action rule to update the adhesion, growth, or division actions taken by the virtual cell, and applying the physical-interaction rule to update the position of the virtual cell with respect to the virtual environment. The method can also include repeating the updating step until a virtual multicellular tissue having one or more desired emergent properties develops. In one embodiment, the updating step continues until the developed virtual multicellular tissue reaches a state of maturity (e.g., analogous to a state of biological homeostasis). For example, a state of maturity can be a state in which (i) the status of the virtual cells is invariant over time, (ii) the condition of at least some of the virtual cells is oscillating around a stable cell condition, or (iii) virtual cells that are dying are being replaced by virtual daughter cells from dividing virtual cells.

The set of gene units in the virtual genome can contain gene units whose gene products, either by themselves or acting through a metabolic-interaction rule, function to trigger an action rule relating to intercellular adhesion, trigger an action rule relating to cellular division, trigger an action rule relating to cell growth, trigger an action rule relating to cell death, trigger an action rule relating to extracellular matrix generation and/or adhesion, produce resources that are exported to the virtual environment, and/or trigger cell differentiation. Passive cell properties, such as rigidity, plasticity and elasticity can be assigned as one or more gene products, or in another embodiment, these passive properties can be associated with non-decaying and/or replenished resources defined in the initial contents of a cell or cellular subsphere.

In some instances, the physical interaction rules can include rules for calculating intercellular forces, based on the degree of overlap between or among the virtual cells, and for resolving cell overlap during a stepPhysics operation. In other embodiments the physical interaction rules can include rules for calculating a separation distance between two or more virtual cells, and for resolving adhesion connections between the two or more separated virtual cells during a stepPhysics operation.

In some embodiments, a virtual cell can be assigned a spherical shape that is preserved through cell growth and cell division. In such embodiments, intercellular forces can be applied between a center point of a first virtual cell and a center point of a second virtual cell.

In other embodiments, a virtual cell can be assigned a plurality of spherical subunits (e.g., subspheres) connected together to simulate a free-form cell that can accommodate a plurality of shapes. In one embodiment, the plurality of spherical subunits can be assigned intracellular adhesion forces such that subspheres have an affinity for adjacent subspheres of the same virtual cell. Intercellular adhesion forces can also be calculated between subspheres of a first virtual cell and subspheres of a second virtual cell. For example, the physical interaction rules can include rules for calculating intracellular and intercellular forces between or among subspheres belonging to the same and/or adjacent virtual cells, respectively. Additionally, the physical interaction rules can include rules for resolving subsphere overlap and/or subsphere separation during a stepPhysics operation

In one embodiment, the method for computer modeling can further include employing a visualization engine for displaying a graphical, a numerical, and/or an alphanumeric representation of progress and/or results from a simulation session (e.g., modeling development of a tissue). In further embodiments, the method for computer modeling can include adjusting one or more parameters of the configurable simulation information. Adjustment of the one or more parameters can include adjusting one or more parameters selected from the group consisting of: (i) a virtual environment resource profile (e.g., the types or distribution of resources); (ii) a chemical-interaction rule; (iii) an action rule; (iv) a physical-interaction rule, and (v) the set of gene units.

In one embodiment, the updating step can continue until the virtual multicellular tissue reaches a state of homeostasis. In this embodiment, the method for computer modeling can further include at least one of: (1) perturbing the shape of the virtual tissue, and applying the updating and repeating steps until the virtual tissue returns to a state of homeostasis; (2) changing a virtual environment resource profile, and applying the updating and repeating steps until the virtual tissue returns to a state of homeostasis; and (3) killing or removing cells from the virtual tissue, and applying the updating and repeating steps until the tissue returns to a state of homeostasis.

Other aspects of the disclosure are directed toward a multi-cellular virtual tissue having an emergent property (e.g., self-repair, adaptive response to an altered environment, tissue differentiation, etc.). In one embodiment, the multi-cellular virtual tissue can contain at least one pluripotent cell capable of division and differentiation toward non-pluripotent cell types, and at least one or more non-pluripotent cell types. Further, the virtual tissue can include a plurality of virtual cell layers, wherein virtual cells in each of the plurality of virtual layers are differentially specialized with respect to each of the other virtual cell layers.

Some aspects of the disclosure are directed to single-cell models, while other aspects of the disclosure are directed toward multicellular cell-based models. Many of the cell-based model features described here (e.g., genome, cell growth, cell division, cell death, signaling sources and detection, adhesion properties, regulation of passive physical properties of cells and other simulated objects) are optional, and use of these features within the context of the disclosure is flexible based on the needs of the specific cell-based model.

The following description provides specific details for a thorough understanding and enabling description of these embodiments of the disclosure. One skilled in the art will understand, however, that the disclosure can be practiced without many of these details. Additionally, some well-known structures or functions may not be shown or described in detail, so as to avoid unnecessarily obscuring the relevant description of the various embodiments.

### A2. Terminology

The terms below have the following definitions herein, unless indicated otherwise:

In biology, a “cell” is the basic unit of living matter in all organisms. A cell is a self-maintaining system employing chemical and physical mechanisms for obtaining energy and/or materials to satisfy nutritional and energy requirements. A cell represents the simplest level of biological organization that manifests all the features of the phenomenon of life with the capacity for autonomous reproduction, for example by cellular division. A “virtual cell”, as used herein, is a computer-simulated analogue of a biological cell (e.g., a modeled cell, a simulated cell, etc.). For example, the virtual cell is separated from its environment (e.g., modeled extracellular matrix, modeled substrate, other virtual cells, etc.) via a cell barrier, e.g., virtual cell “membrane” such that the cell can be considered a discrete unit having an intracellular space separate from the extracellular surroundings.

A virtual cell can also be provided with a virtual genome having a plurality of virtual genes or gene units that can confer on the cell a number of modeled cellular functions. For example, virtual genes can provide a means from which basic cellular functions can be simulated, wherein basic cellular functions can include, but are not limited to, (1) gene expression, (2) cell metabolism, (3) cell division, and/or (4) cell growth. In some embodiments, the virtual cells (“cells”) can be provided with one or more gene units (e.g., virtual genes) to provide virtual gene product(s) or resource(s) that can be influenced during simulation to invoke a cell “death” or virtual cell elimination during simulation. In further embodiments, the cells can be provided with one or more gene units that can be influenced during simulation to invoke biological events, such as differentiation from one cell state or cell type to a second cell state or cell type (e.g., different states of cell differentiation).

The virtual genome can provide a template for enabling simulation of one or more biological events including simulation of cell growth, cell division, cell homeostasis, cell death, cell differentiation, tissue formation, etc. In one embodiment, the virtual genome can be the collection of gene units assigned to or applied to a virtual cell. In another embodiment, the virtual genome can be a sub-collection of gene units assigned to or applied to a virtual cell. For example, in some embodiments, a cell can be provided with more than one virtual genome, wherein each virtual genome includes a set of gene units that can be applied to a particular class of functions (e.g., metabolism genome, cell primitive genome [discussed below], fibroblast development genome, stem cell genome, neuron genome, etc.).

“Virtual genes” (e.g., gene units, gene assemblies) are computer simulation analogues, possibly abstracted, of biological genes. Each gene unit can have a gene control “region” that regulates an activity status or activity level (e.g., low, high, attenuated, etc.) of the gene unit (e.g., in response to absence or presence of resources in the environment and/or cell). For example, in one embodiment, resources can positively and/or negatively regulate gene control regions based on their presence, absence, location within the environment, movement within the environment, and other effects of resources in cellular environments as would occur in vivo. In further embodiments, a quantity of a resource within the macro- and/or micro-environment can strengthen or attenuate the simulated response (e.g., high activity, low activity, etc.). For example, the quantity of a resource can be controlled within a cell-based model and, in some embodiments, the effect of the resource on the modeled cell(s) can be tested at different levels. For example, if the quantity of a resource is doubled, it can be determined whether and to what extent the targeted response is increased, decreased, or is unaffected. In additional embodiments, more than one resource can interact with a gene control region, thereby further strengthening or attenuating a gene unit activity response to the environment during simulation. In addition to control regions, gene units can have a structural “region” (e.g., information configured to specify the resource or resources produced by the gene unit). For example, a growth gene unit may be denoted as [DiffuseNutrient 0.18, NeighborPresent −3] [Growth], specifying that a growth resource is promoted moderately (0.18) by DiffuseNutrient, and strongly inhibited (−3.00) by NeighborPresent. In some embodiments, the structural region can specify more than one resource generated by the gene unit.

A virtual “environment” can include a computer simulation analogue, possibly abstracted, of a biological cellular environment. The term “environment”, as used herein, can reference both extracellular and intracellular environments, and thereby encompasses the entirety of the space or volume occupied by one or more virtual cells in the simulation system as well as the virtual space in which the cells are placed. In one embodiment, the environment can be uniform (e.g., resources present are uniformly distributed and can invoke simulated biological events in one or more cells present in the environment regardless of location (e.g., coordinates). In another embodiment, the environment can be non-uniform or consist of a plurality of dynamic micro-environments. For example, a first micro-environment can include a first set of resources, and a second micro-environment can include a second set of resources. Virtual cells residing in the first and second micro-environments may uptake resources from and/or secrete resources into their respective micro-environments, which can differentially affect the signal and resource landscape of the micro-environments (and thereby show differential modeled behavior).

Intracellular environments can also be uniformly- and/or variably-configured in accordance with an embodiment of the disclosure. For example, a virtual cell can be discreetly or non-discretely subdivided with respect to distribution of resources. As such, increasingly complex levels of detail that mimic the intricacies of natural biological systems can be applied using the simulation system as described herein.

“Resources”, as used herein, are computer simulation analogues, possibly abstracted, of resources found in biological systems. For example, a resource can refer to a virtual compound, molecule or other object resource that can be produced by a virtual gene, or alternatively, is introduced into the environment or converted by a metabolic-interaction rule. Additionally, a resource can refer to a state of an object, an electrical membrane potential, an action capacity, polarizing factors, cytoskeletal properties, localized pools of resources, an influence on physical properties, energy and other conceptual resources. A function or set of functions can be applied to a resource, such that, when present, the resource can affect the state of one or more virtual cells, e.g., through its interaction with other resources and/or gene units in a virtual cell, etc. A resource, whether referred to in a singular or plural form, refers to a collection of a resource type. A resource can be provided a strength value indicating the resource's relative amount or presence in a virtual environment or cell. The strength value (e.g., relative concentration) can be altered during simulation.

“Metabolic equations” or “metabolic-interaction rules” refer to a set of equations that, when invoked, can simulate the extra-genetic (e.g., non-gene) behavior and interactions between or among intracellular and/or extracellular resources, such as products generated by gene unit activity, simulated cell receptors, simulated cell transporters, etc. Metabolic equations can refer to chemical equations, or in other instances, can refer to abstract and/or higher-order metabolic process, such as state changes, intracellular location transitions, differentiation commitments, translating gene unit products, combining resources into higher-order conceptual organizations, etc.

“Action rules” can be provided and invoked in silico to simulate cellular adhesion events, growth events, division events, cell death events and/or stages of the cell cycle, etc. For example, action rules can be a set of operational directives that are invoked when one or more pre-configured conditions are met. For example, action rules can be used, at least in part, to simulate a cell's influence from and/or on adjacent cells. Action rules can also be used, at least in part, to simulate a cell's growth to a larger cell size or to divide a cell into two cells. In some embodiments, action rules can be invoked in response to one or more resources (e.g., triggers) present in the environment, such as those resources produced by a gene unit or metabolic equation relating to intercellular adhesion, cell growth, cell division, and/or other effects of resources in cellular environments as would occur in vivo.

“Physical-interaction rules” can be provided and invoked in silico to simulate how a cell will move in response to its own simulated growth, simulated division, simulated growth and/or division of neighboring cells, and/or how a cell will move in response to physical constraints or perturbations imposed by the environment.

A “resource profile” can be used to define the types of resources distribution of each resource, concentration of each resource, etc., for a particular environment (e.g., macro-environment, micro-environment, etc.) or virtual cell (e.g., intracellular environment). Change in a resource's concentration and/or gradient within an environment or virtual cell can be defined as resource flux. During simulation, a resource profile can change via simulation-induced resource flux.

A gene unit can serve as a template for generating resources that provide cellular function or activity (within the simulation scheme), such as intercellular adhesion, cell division, cell growth, intercellular signaling, etc. As such, resource flux within the simulation scheme can alter the state or states of a virtual cell and/or adjacent cells. As representative of molecular mechanisms recognized in biological systems, a “molecule” and/or other resource can effect a specified role or function within the context of the biological system, such as, by directly or indirectly invoking action and/or physical-interaction rules, interacting with other resources through metabolic-interaction rules, etc. One of ordinary skill in the art will recognize that the resource(s) derived from a gene unit can provide more than one function within the simulation scheme.

“Cell primitives” refer to the simplest operations or behaviors that a virtual cell can perform (e.g., ability to divide, ability to grow larger, ability to move, etc.). All other operations of a cell can be combinations of such cell primitives and/or combinations of cell primitives and other operations or behaviors that a virtual cell can perform.

A “virtual tissue” is a collection of virtual cells collectively having a shape and functional characteristics within the simulation scheme. In biology, a tissue is a mass of cells that are derived from the same origin, but are not necessarily identical, and which work together to perform a particular function or set of functions. For example, tissues (e.g., epithelial, muscle, neural, connective, vascular, etc.) can be recognized as an intermediate form of cellular organization between the individual cell and an organism (e.g., animal, plant). In other embodiments, the virtual tissue can be a simulated representation of artificially grown or genetically engineered tissue.

“Cell signaling” can refer to an event in which resources assigned a signaling function and which are available in the virtual environment (e.g., generated during a simulation step and/or session from a gene unit, provided as an initial cell resource, etc.) can affect the behavior of one or more cells in that environment. For example, simulative generation of a “signaling” resource in one virtual cell can, in a next step, interact with “receptor” resources in or on a second virtual cell. When simulating cell signaling processes, metabolic-interaction rules can further effect a behavior change in the second virtual cell (e.g., activation of one or more gene units within the second cell, etc.).

A “signal” resource can refer to a nutrient or other “molecule”-type resource located external to a virtual cell and/or exported from a virtual cell that can, directly or indirectly, affect the behavior of virtual cells within the context of the simulation scheme. For example, the presence of a signal resource can spawn simulative responses such as transport of the signal resource into a virtual cell, interaction with a control region of a gene unit, interaction with a cell surface receptor resource, etc.

When present, a “receptor” resource can be localized on a virtual cell's surface (e.g., cell barrier, cell membrane, etc.). Interaction, via an invoked metabolic-interaction rule, between an extracellular resource with a signal function and a receptor resource localized on a virtual cell surface, can directly or indirectly affect the behavior of the cell by invoking one or more additional metabolic-interaction rules, action rules, or other rules.

An “adjacent cell,” as applied to a specified virtual cell, refers to other cells that are in contact with and/or are an immediate neighbor of that cell with respect to the simulated environment. In one embodiment, the simplest neighborhood of a cell consists of those cells that are spatially adjacent to (touching) the cell of interest. However, in other embodiments, a cell's neighborhood may be configured as any arbitrary group of cells. For example, a neighborhood (the cells to/from which it will send/receive signals) could include cells that are not adjacent, as occurs in vivo with cells that are able to signal non-local cells via hormones. In further embodiments, a cell's neighborhood can be defined by lineage, adhesions, contact in previous simulation steps, etc.

The “phenotype” of an organism or tissue refers to the observable traits, appearance, properties, function, and behavior of the subject organism or tissue.

“Physical constraints” refer to constraints imposed upon the position and/or growth of a cell due to the presence of adjacent cells or size limits of the tissue.

A “totipotent cell” refers to a cell having the capability to form, by one or more rounds of simulated cell division, other totipotent cells, pluripotent cells, or differentiated cell types. In biology, totipotent cells can give rise to any of the various cell types in an organism.

A “pluripotent cell” refers to a cell that can give rise to daughter cells capable of differentiating into a limited number of different cell types. For instance, dermal stem cells (e.g., a pluripotent cell) can give rise to cells of a variety of dermal cell types, but do not give rise to cells of non-dermal cell types.

A “stem cell” can refer to a totipotent or pluripotent cell. For example, a stem cell can be an undifferentiated or partially undifferentiated cell that can divide indefinitely, the process of which can give rise to a first daughter cell that can undergo a terminal differentiation event resulting in a cell having a specific cell type and/or function. The second daughter cell resulting from each successive division event can be a stem cell that retains its proliferative capacity and an undifferentiated state or partially undifferentiated state.

A “virtual stem cell”, “virtual totipotent cell”, or “virtual pluripotent cell” refer to virtual cells having analogous characteristics to their biological cell counterparts described above.

“Homeostasis” refers to the ability or tendency of an organism or cell to maintain a relatively constant shape, temperature, fluid content, etc., by the regulation of its physiological processes in response to its environment.

“Emergent properties” or “emergent behavior” refers to a process or capability that exists at one level of organization, but not at any lower level and that depends on a specific arrangement, organization, or interaction of the lower level components. Two emergent behaviors of a virtual tissue in accordance with embodiments of the disclosure are (i) self-repair, or induced response whereby cells are replaced when they have been killed, damaged, or removed, and (ii) adaptation, meaning a change in structure, function, or habits as appropriate for different conditions, enabling an organism to survive and reproduce in a certain environment or situation.

An “interval” refers to a time period, typically but not necessarily a discrete time period, at which the state or status of the cells making up a virtual tissue are updated, e.g., while simulating or modeling a biological event.

“Cell differentiation” is the process by which cells acquire a more specialized form or function during development. Cell differentiation can be, in part, described in terms of incremental and/or various stages transitioning the cell toward a terminal stage (e.g., of specialized form or function). For example, stages of differentiation can include a committed and/or specified stage that indicates the cell's strong propensity to differentiate, a determined stage that indicates an inexorable commitment to differentiation, etc. In one example, during early embryonic animal development, a plurality of identical cells eventually become committed to alternative differentiation pathways resulting in development of specialized tissues (e.g., bone, heart, muscle, skin, etc.) in the developing animal. See also pluripotent and totipotent discussed above.

### B. Embodiments of Computing Environments

### B1. Suitable Computing Systems

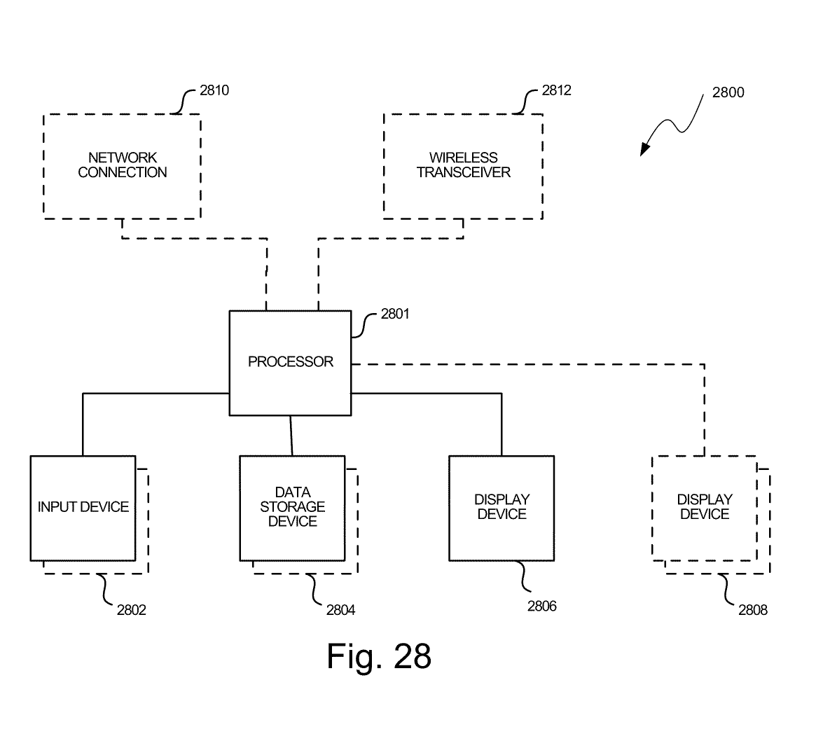

FIG. 28 and the following discussion provide a general description of a suitable computing environment in which aspects of the disclosure can be implemented. Although not required, aspects and embodiments of the disclosure will be described in the general context of computer-executable instructions, such as routines executed by a general-purpose computer, e.g., a server or personal computer. Those skilled in the relevant art will appreciate that the disclosure can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The disclosure can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

The disclosure can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the disclosure described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the disclosure may reside on a server computer, while corresponding portions reside on a client computer. Data structures and transmission of data particular to aspects of the disclosure are also encompassed within the scope of the disclosure.

Referring to FIG. 28, one embodiment of the disclosure employs a computer 2800, such as a personal computer or workstation, having one or more processors 2801 coupled to one or more user input devices 2802 and data storage devices 2804. The computer is also coupled to at least one output device such as a display device 2806 and one or more optional additional output devices 2808 (e.g., printer, plotter, speakers, tactile or olfactory output devices, etc.). The computer may be coupled to external computers, such as via an optional network connection 2810, a wireless transceiver 2812, or both.

The input devices 2802 may include a keyboard and/or a pointing device such as a mouse or haptic device. Other input devices are possible such as a microphone, joystick, pen, touch screen, scanner, digital camera, video camera, and the like. The data storage devices 2804 may include any type of computer-readable media that can store data accessible by the computer 2800, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 28).

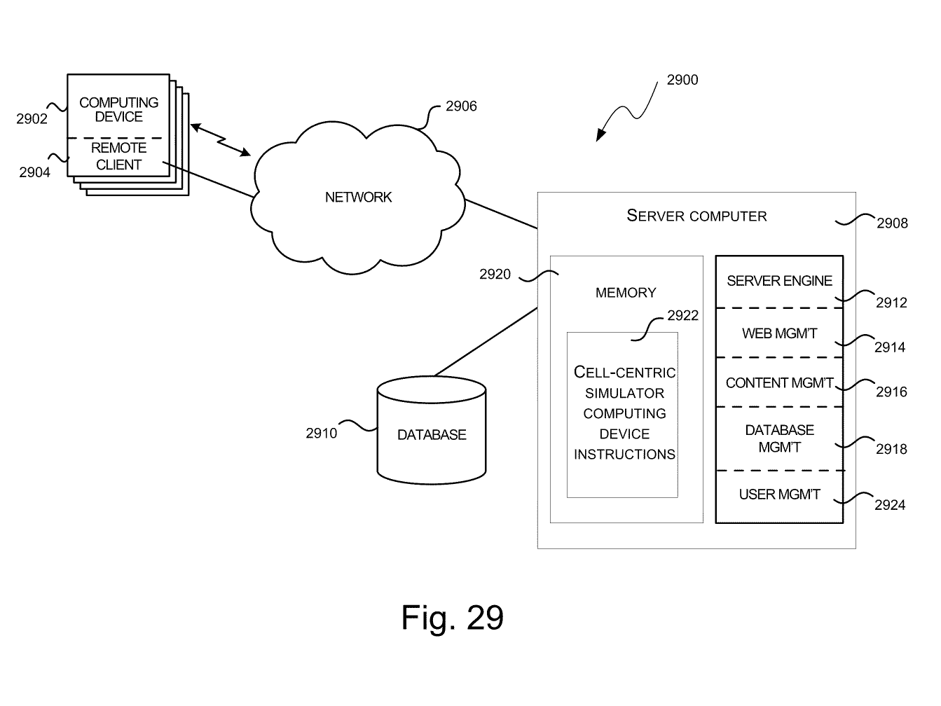

Aspects of the disclosure may be practiced in a variety of other computing environments. For example, referring to FIG. 29, a distributed computing environment with a network interface includes one or more computing devices 2902 (e.g., a client computer) in a system 2900 are shown, each of which includes a remote client module 2904 that permits the computing device to access and exchange data with the network 2906 (e.g., Internet, intranet, etc.), including web sites within the World Wide Web portion of the Internet. The computing devices 2902 may be substantially similar to the computer described above with respect to FIG. 28. Computing devices 2902 may include other program modules such as an operating system, one or more application programs (e.g., word processing or spread sheet applications), and the like. The computing devices 2902 may be general-purpose devices that can be programmed to run various types of applications, or they may be single-purpose devices optimized or limited to a particular function or class of functions. While shown with remote client applications using internet protocols or proprietary communication protocols for communication via network 2906, any application program for providing a graphical user interface to users may be employed (e.g., network browsers), as described in detail below.

At least one server computer 2908, coupled to the network 2906 (e.g., Internet or intranet), performs much or all of the functions for receiving, routing and storing of electronic messages, such as web pages, data streams, audio signals, and electronic images. While the Internet is discussed, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. In some embodiments, a database 2910 or databases, coupled to the server computer(s), can store much of the content exchanged between the computing devices 2902 and the server 2908. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 2908 can also contain an internal memory component 2920. The memory 2920 can be standard memory, secure memory, or a combination of both memory types. The memory 2920 and/or other data storage device 2910 can contain computer readable medium having computing device instructions 2922, such as cell-centric simulator computing device instructions. The encoded computing device instructions 2922 are electronically accessible to at least one of the computing devices 2908 and 2902 for execution. In further embodiments, computing device instructions 2922 can include basic operating instructions, cell-centric simulator instructions (e.g., source code, configurable simulation information), etc.

The server computer 2908 may include a server engine 2912, a web page management component 2914, a content management component 2916, a database management component 2918 and a user management component 2924. The server engine performs basic processing and operating system level tasks. The web page management component 2914 handles creation and display or routing of web pages. Users may access the server computer by means of a URL associated therewith. The content management component 2916 handles most of the functions in the embodiments described herein. The database management component 2918 includes storage and retrieval tasks with respect to the database 2910, queries to the database, read and write functions to the database and storage of data such as video, graphics and audio signals. The user management component 2924 can support authentication of a computing device to the server 2908.

Many of the functional units described herein have been labeled as modules, in order to more particularly emphasize their implementation independence. For example, modules may be implemented in software for execution by various types of processors, such as processor 2801. An identified module of executable code may, for instance, comprise one or more physical or logical blocks of computer instructions which may, for instance, be organized as an object, procedure, function, or algorithm. The identified blocks of computer instructions need not be physically located together, but may comprise disparate instructions stored in different locations which, when joined logically together, comprise the module and achieve the stated purpose for the module.

A module may also be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

A module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

### B2. Embodiments of User Systems and Interfaces

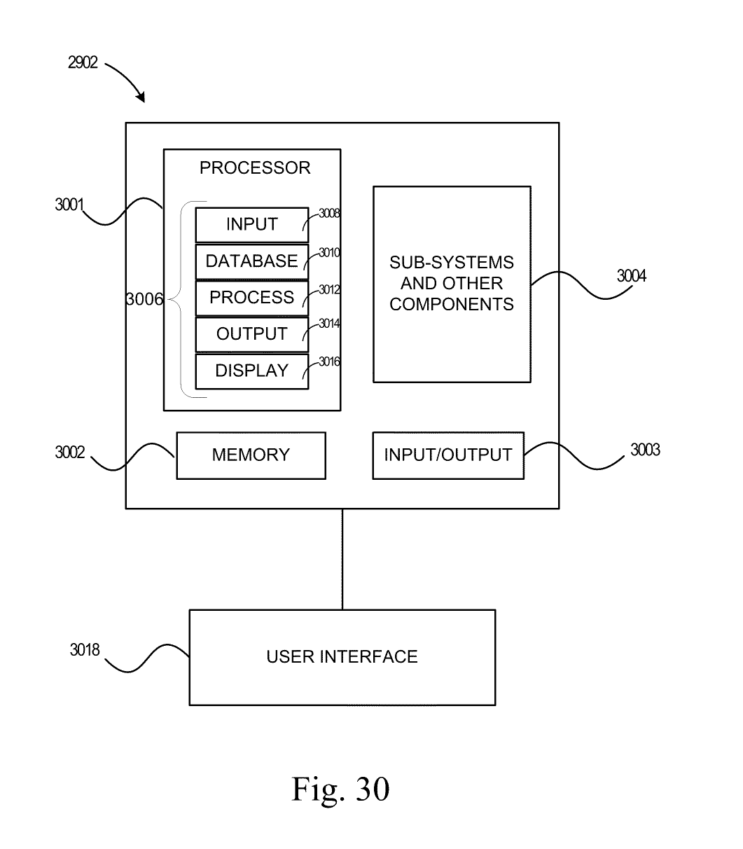

FIG. 30 is a schematic block diagram illustrating subcomponents of the computing device 2902 of FIG. 29 in accordance with an embodiment of the disclosure. The computing device 2902 can include a processor 3001, a memory 3002 (e.g., SRAM, DRAM, flash, or other memory devices), input/output devices 3003, and/or subsystems and other components 3004. The computing device 2902 can perform any of a wide variety of computing processing, storage, sensing, imaging, and/or other functions. Components of the computing device may be housed in a single unit or distributed over multiple, interconnected units (e.g., through a communications network). The components of the computing device 2902 can accordingly include local and/or remote memory storage devices and any of a wide variety of computer-readable media.

As illustrated in FIG. 30, the processor 3001 can include a plurality of functional modules 3006, such as software modules, for execution by the processor 3001. The various implementations of source code (e.g., in a conventional programming language) can be stored on a computer-readable storage medium or can be embodied on a transmission medium in a carrier wave. The modules 3006 of the processor can include an input module 3008, a database module 3010, a process module 3012, an output module 3014, and, optionally, a display module 3016.

In operation, the input module 3008 accepts an operator input via the one or more input devices described above with respect to FIG. 28, and communicates the accepted information or selections to other components for further processing. The database module 3010 organizes records, including simulation records, configurable simulation information, generated models, and other operator activities, and facilitates storing and retrieving of these records to and from a data storage device (e.g., internal memory 3002, external database 2910, etc.). Any type of database organization can be utilized, including a flat file system, hierarchical database, relational database, distributed database, etc.

In the computing environment illustrated in FIG. 30, the process module 3012 can generate simulation control variables based on operator input accepted by the input module 3008, simulation operational parameters, etc., and the output module 3014 can communicate operator input to external computing devices such as server computer 3008. In other embodiments, the input module 3008 can accept data transmitted by a server, such as server 2908 (e.g., over a network 2906). The display module 3016 can be configured to convert and transmit simulation parameters, biological event modeling, input data, etc. through one or more connected display devices, such as a display screen, printer, speaker system, etc.

In various embodiments, the processor 3001 can be a standard central processing unit or a secure processor. Secure processors can be special-purpose processors (e.g., reduced instruction set processor) that can withstand sophisticated attacks that attempt to extract data or programming logic. The secure processors may not have debugging pins that enable an external debugger to monitor the secure processor's execution or registers. In other embodiments, the system may employ a secure field programmable gate array, a smartcard, or other secure devices.

The memory 3002 can be standard memory, secure memory, or a combination of both memory types. By employing a secure processor and/or secure memory, the system can ensure that data and instructions are both highly secure and sensitive operations such as decryption are shielded from observation.

The computing environment 2900 can receive user input in a plurality of formats. In one embodiment, data is received from a user-operated computer interface 3018 (i.e., “user interface”). In various embodiments, the user interface 3018 is associated with the computing device 2902 and can include various input and output devices, such as a keyboard, a mouse, a haptic device, buttons, knobs, styluses, trackballs, microphones, touch screens, liquid crystal displays, light emitting diode displays, lights, speakers, earphones, headsets, and the like.

In other embodiments not shown, the user interface 3018 can be directly associated with the server computer 2908. In further embodiments, there may be more than one user interface 3018 such that multiple users may be simultaneously connected to and interacting with a shared simulation.

Referring back to FIG. 29, the computing device 2902 may connect to network resources, such as other computers 2902 and 2908 and one or more data storage devices 2910. As examples, the computing device 2902 may connect to a server 2908 to upload data logs, configurable simulation information, simulation commands, and so forth. The computing device 2902 may also connect to a server 2908 to download updates to software, cell-centric simulator computing device instructions, and so forth. The computing device 2902 can also connect to the data storage device 2910. As described above, the computing device 2902 may connect to network resources via network 2906, such as the Internet or an intranet.

### B3. Embodiments of Systems and Methods for Simulating a Biological Event

The method, system, and apparatus disclosed herein are directed to a computational approach and platform that incorporates principles of biology, utilizing and building upon primitive features of living systems that are fundamental to their construction and operation and that distinguish them from non-living systems. The goal of such biological incorporation is to identify, extract, and capture in algorithmic form the essential logic by which a living system self-organizes, self-constructs, regulates itself and other cells, and eliminates itself at the end of its cellular life span. Such algorithmic form(s) include a perspective based on the properties of the natural cells and embeds those properties within the simulation system for modeling cellular differentiation, growth, replication, development and other cellular and/or tissue behavior. Accordingly, the cell-based (e.g., cell-centric) approach to modeling biological events and processes produces advantageous modeling features, such as accommodating dynamic environment feedback and hierarchical organization of the cells and tissues, thereby effectuating emergent properties.

In one embodiment, simulation systems and methods as disclosed in International Application No. PCT/US2008/075514, entitled “SYSTEMS AND METHODS FOR CELL-CENTRIC SIMULATION AND CELL-BASED MODELS PRODUCED THEREFROM,” filed Sep. 5, 2008; incorporated by reference in its entirety, can be used to simulate a developmental process starting from a single cell or initial grouping of cells, each with a configured genome (e.g., genotype), to model resultant tissue and/or cellular phenotypes. In other embodiments, the configured genome is not included in the single cell and/or initial grouping of cells. Such embodiments can include other optional configured simulation data for modeling resultant cellular phenotypes and/or multicellular tissues. Phenotypic properties, such as tissue shape and/or cellular spatial orientation, self-repair, specialized cellular differentiation, etc., can arise from the interaction of gene-like elements as the multicellular virtual tissue develops. The simulation system can include an ontogeny engine (described in further detail below) for defining and controlling the parameters of the virtual environment necessary for modeling biological events, such as, tissue development, placement of nutrients, allocation of space for cells to grow, sequencing of simulated events and/or actions, rules that invoke simulation of natural physical laws in the virtual environment, etc. To make the simulation and modeling flexible, the environmental parameters are configurable, and may include rules governing the calculation of molecular affinity, and the placement and concentration of nutrients or other resources.

The present simulation platform provides means for receiving and updating configurable simulation information relating to the simplest operations or behaviors that a virtual cell can perform (e.g., the cellular primitives). For example, configurable simulation information can capture, in algorithmic form, the primitive features of living systems by which the system can self-organize, self-construct, and self repair. The logic behind cell primitive features that can be captured in algorithmic form can include a cell's genome, cellular membrane, extracellular matrix (ECM), ability to divide, ability to grow larger, ability to move or migrate through an environment, ability to maintain and/or change cell shape, ability to polarize, ability to differentiate (functionally specialize), ability to communicate with neighboring cells and the surrounding environment (e.g., send and receive signals), ability to age and/or die, ability to retain or recall or readapt to recent cellular states, ability to connect to adjacent cells and/or the ECM via cellular adhesion, etc. As such, configurable information relating to cell primitives provides the simulation platform with the means to model biological processes such as differentiation of pluripotent and/or progenitor cells, communication and feedback between specialized cells, and metabolism.

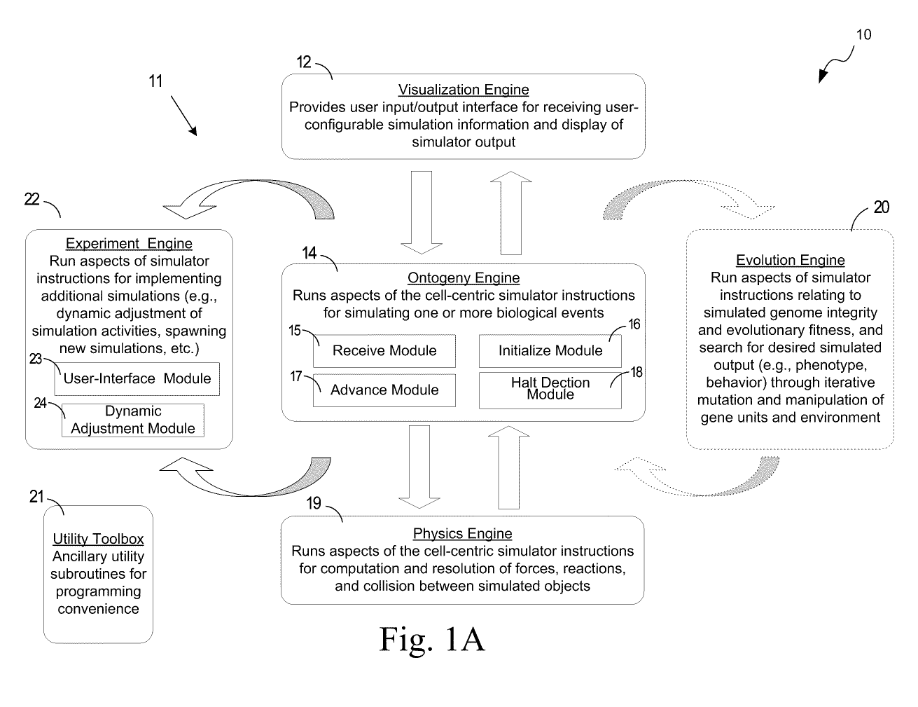

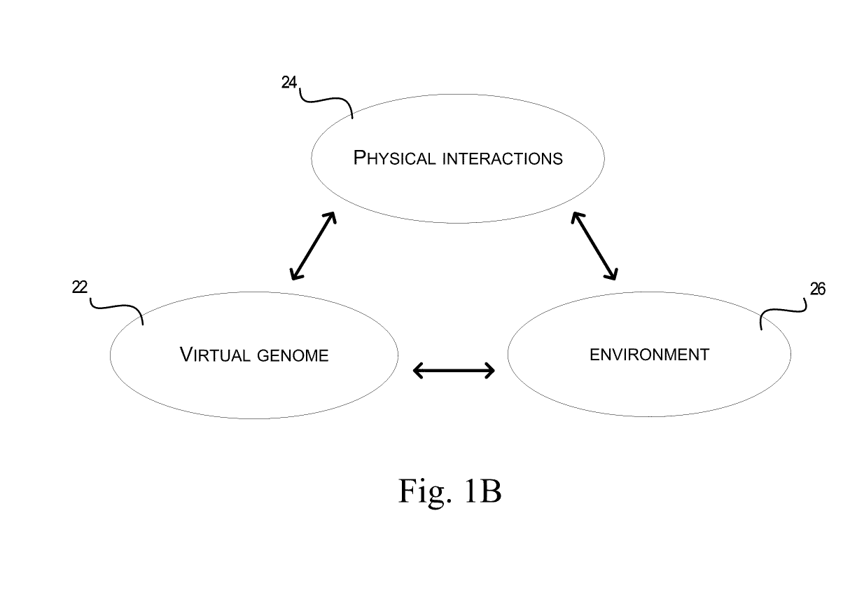

FIG. 1A is block diagram illustrating elements of a simulation system 10 in accordance with an embodiment of the disclosure. As shown in FIG. 1A, the system 10 includes a cell-centric simulator 11 configured to model one or more biological events. In one example, the cell-centric simulator 11 can simulate a developmental process (e.g., tissue and cellular growth and generation, cell differentiation, blastocyte development starting from a single fertilized egg, etc.). In one embodiment, the cell-centric simulator 11 can model tissue phenotype (e.g., appearance, physical traits, properties, etc.). Properties such as tissue shape and self-repair arise from the interaction of modeled gene-like elements (e.g., gene units) as the multicellular virtual tissue and/or cells develop. In some embodiments, the simulator 11 can define and control a plurality of parameters of the virtual environment necessary for modeling cellular and/or tissue development, including placement of nutrients, defining space for cells to grow, sequencing of simulated events and/or actions, rules that invoke simulation of natural physical laws in the virtual environment, etc. In additional embodiments, environmental parameters (e.g., rules governing the calculation of molecular affinity and the placement and concentration of nutrients and/or other resources) are configurable at run-time.

In one embodiment, the cell-centric simulator 11 can include one or more visualization engines 12 for supporting client visualization and manipulation of simulation data generated during a simulation session. In one embodiment, the visualization engine can be supported on a client computing device, such as computing device 2902 (FIGS. 29 and 30) as, for example, a client application. In another embodiment, the visualization engine 12 can be supported by another computing device, such as the server 2908 and/or another computing device. The visualization engine 12 can include a user input and output interface and be configured to interact with the simulator 11 and system 10 (e.g., imputing/receiving user-configurable simulation information, requesting simulation of a biological event, interacting with a simulation in real-time, displaying results and/or data of a completed simulation, etc.). In some embodiments, the visualization engine 12 can be configured to display at least one of (alone or in combination) a graphical, a numerical and an alphanumeric representation of data generated during or following a simulation session. For example, the visualization engine 12 can be configured to generate and display a graphical image representing the current status of the simulation at a user interface, such as user interface 3018 (FIG. 30).

The cell-centric simulator 11 can also include the ontogeny engine 14 for running aspects of the cell-centric simulator instructions (e.g., relating to simulation of biological events, developmental processes, metabolic processes, etc.). For example, the ontogeny engine 14 can include a receive module 15, an initialize module 16, an advance module 17 and a halt detection module 18. In another embodiment, not shown, the ontogeny engine can also include an output module. In general, modules 15, 16, 17 and 18 comprise listings of executable instructions for implementing logical functions which can be embodied in any computer readable medium for use by or in connection with an instruction execution system or device (e.g., computer-based system, processor-containing system, etc.).

In one embodiment, the ontogeny engine 14 can provide the following functions:
from one cell, many cells can develop by cell growth, division, and death;
cells can descend from parent cells and so develop with lineage and sequential order;
cells can be semi-autonomous units, each with its own set of genes;
context-dependent, cell-by-cell control of gene expression via signaling;
construction and monitoring of an extracellular environment; and
higher order, emergent properties (e.g., self-repair).

The cell-centric simulator 11 can further include a physics engine 19 for running additional aspects of the cell-centric simulator instructions (e.g., physical interaction simulation, resolution of spatial and/or size constraints, etc.). In another embodiment, the cell-centric simulator can include an experiment engine 22 for running additional aspects of the cell-centric simulator instructions (e.g., dynamic adjustment of simulation activities, spawning new simulations, etc.) For clarity, the ontogeny engine 14 is shown separate from the physics engine 19 and the experiment engine 22; however, one of ordinary skill in the art will recognize that the ontogeny engine 14 could include the function of the physics engine 19, the experiment engine 22 and/or other functional features relating to the cell-centric simulator 11.

In another embodiment, the simulation system 10 can also include an evolution engine 20 for running further simulation instructions relating to simulated genome integrity, evolutionary fitness, etc. In a further embodiment, the simulation system 10 can include and/or be in communication with adjunct utilities 21 for providing additional programming and/or operation options and support.

FIG. 1B is a schematic block diagram illustrating aspects of the simulation environment for modeling a biological event in accordance with an embodiment of the disclosure. In one embodiment, the ontogeny engine 14 runs aspects of the cell-centric simulator instructions for defining and characterizing the following elements: (i) a virtual genome 22 which specifies the gene units (e.g., control region and structure region) present in a cell; (ii) physical interactions 24, which specifies how the cells move and occupy space during cell growth, division, death, within a tissue, etc.; and (iii) an environment 26 in which the cells will differentiate, develop, replicate, grow and interact.

The simulated and/or configured elements relating to the virtual genome 22, physical interactions 24 and the environment 26 interact within the simulated environment, as illustrated by the arrows in FIG. 1B. For example, status and/or activation of gene units present in a cell depend on both signal resources in both the micro- and macro-environments, and accordingly, gene products simulated by activation of a gene unit contribute to the changing of both the micro- and macro-environments. Biological events, such as cell division and cell growth can occur as a result of the changing resources (e.g., invoked action rules), and such events can alter the physical interactions modeled between cells and their environment (e.g., neighboring cells, substrate, spatial constraints, etc.). In principle, any of these elements 22, 24 and 26 can be adjusted to devise the generation of a given tissue's or cell's response to a perturbation.

In addition, the cell-centric simulator instructions can contain metabolic equations that can be invoked to simulate the extra-genetic activity of resources, including gene products and resources from the environment. The metabolic equations can be configured to model the molecular interactions that occur normally within cells (e.g., how the resources behave independent of the cell genome). For example, metabolic equations can be used to simulate the rate of turnover of the resources, molecular binding and/or reaction effects, etc.

Configurable simulation information for initializing the ontogeny engine 14 can also be accompanied by configurable simulation information relating to criteria for suitability, a basis for evaluating the outcomes of many schemes for development—different gene interactions, physical constraints, environmental conditions, etc. These criteria, analogous to evolutionary processes of selection and descent with modification from ancestral forms, may be provided by the evolution engine 20 for modeling the concept of tissue “fitness”. For example, the evolution engine 20 can include one or more functional modules for generating and/or evaluating a plurality of virtual genomes. In one embodiment, a fitness factor, which can form a basis for selecting preferred and/or “more fit” genomes, can be used to compare the modeled tissue (e.g., during and/or post simulation) with one or more characteristics of a desired target tissue. Evaluation and selection by a fitness criterion can establish a basis for competition among the members of a population of solutions, and a strategy for iterative improvements whereby the most successful solutions of one generation contribute more to the next generation (e.g., simulated cell divisions, cell replacement in a virtual tissue, etc.).

The selection and evaluation process provided by the evolution engine 20 can be useful when simulations of the modeled cells and tissue can be specified with precise coordinates, such as an “egg carton” model wherein each cell is assigned to a specified bin. Alternatively, when using a model where the cells are allowed to adopt positions in free-space, and assume a variety of sizes or shapes, it may be more practical to employ the visualization engine 12 to visually compare the modeled tissue with the target tissue, and make empirical adjustments to the genome, metabolic-interaction rules or environmental conditions, to achieve a closer match between the modeled and target tissues. In another embodiment, analysis of a difference distribution between the modeled and target tissue can be performed. For example, difference distribution can be used to procedurally compare objects by sampling their features to produce comparable profiles. Such differences may include relative location, resource content, adhesion profile (inter- and intracellular), ECM contact and other biological relevant features.

In biology, genes provide a resource for cells by providing a template from which proteins and other molecular resources (e.g., non-translated ribonucleic acids) can be synthesized. As such, the cell-centric simulator 11 provides each virtual cell with a virtual genome, e.g., a set of gene unit templates for simulating protein production and resource synthesis for generating and coordinating a multicellular aggregate during a simulation session. For gene units to simulate natural genes for modeling a biological event, e.g., a developmental process, there can be a means to control how, where and when particular gene units are activated (e.g., generate a resource increase). To represent these features in a computational model, each gene unit within a virtual genome contains both a control (e.g., regulatory) region and a structural (e.g., designating a functional gene product) region. Gene unit activation is controlled by the interaction of resources (e.g., representing transcription factors) in the internal micro-environment of the virtual cell with the control region (e.g., configured simulation parameters specific to that gene unit), in a manner analogous with gene regulatory networks in vivo.

In biology, genes contribute to the biological potential of scale whereby complexity arises from a relatively simple set of genetic encodings. Yet for this potential to be realized, genetic information must be rendered by a process of self-construction, e.g., by development. Self-construction by living systems is driven in a manner that harnesses the power of genetic encodings to ensure heritability of traits, while packaging them in an encoded form that is compact enough to place into a single cell, the smallest living unit.

Integration of gene units into biological simulations (e.g., in the context of development) can rely on understanding characteristics of the gene product encoded by the natural correlate gene sequence, e.g., in the manner that it contributes to cellular function or its coordination in the growing multicellular tissue). For instance, some genes encode sensor resources that allow cells to propagate signals to the ECM and to neighboring cells, while other genes encode receptor resources that allow cells to detect signals from neighboring cells. However, while genes determine the types of sensors a cell can make, genes do not specify the patterns of information that the cell can receive.

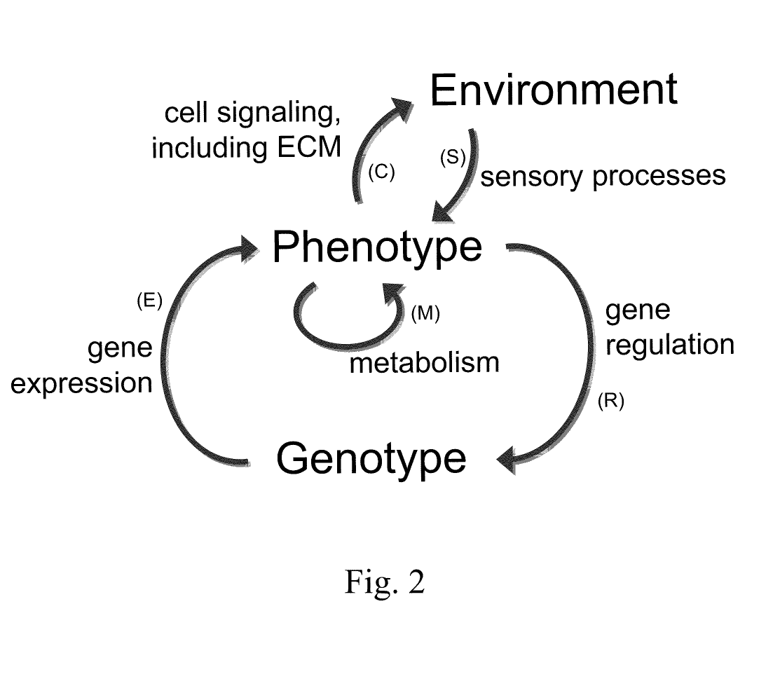

FIG. 2 is a schematic flow diagram of an ontogeny model illustrating the relationship between gene expression, metabolism, cell signaling, sensory processes and gene regulation in accordance with an embodiment of the disclosure. The ontogeny engine 14, which runs aspects of the cell-centric simulator instructions, can be configured to simulate biological processes configured in accordance with the ontogeny model depicted in FIG. 2. For example, the cell-centric simulator instructions can include simulation information related to genetic encoding, a process of self-construction analogous to biological development, as well as environmental influences of the processes by which the organism and/or cell is so constructed. Although FIG. 2 illustrates genotype, phenotype, and environment as separate domains of influence on the process of development (e.g., ontogeny), the arrows indicate that these influences can be interdependent and overlapping.

As seen in the ontology model illustrated in FIG. 2, genotype can influence phenotype through gene expression (E) and internal cellular metabolism (M), while phenotype acts on the genome by regulating overall gene activity (R). The phenotype influences the local environment of adjacent cells by cell signaling (C), for example, by release of cellular products into the environment. In turn, the phenotype is acted upon by the local environment through sensory processing (S), for example, extracellular resources acting on cell receptors, extracellular resource transport into cells, etc. Accordingly, phenotype represents a higher ontological category than genotype, since the phenotype has access to genetically encoded information and information in its environment that is not so encoded.

Patterns of gene expression in cells, or across an entire tissue or organism are derived from functional controls each cell applies according to and/or in response to both the internal and external signals it receives. In contrast, signal resource concentration(s) are locally defined by the position a cell occupies in the developmental field. For example, localized concentration(s) of signal resources can depend on the type and level of resources produced by the cell's neighbors, as well as by signal resources retained in the virtual external environment and/or in the extracellular matrix (ECM). In biology, microenvironments and mechanisms for control of gene expression provide the basis for differentiation.

In addition to their role in development, genes serve a passive role as units of inheritance, the units for transfer of information across generations. For genes to serve as units of inheritance they must have a stable, but not completely unchangeable, structure. For example, changes that occur in the structure (e.g., the coding sequence) of genes are passed on to progeny.

Emergence is a term that conveys many meanings, and accordingly, a broad range of phenomena have been classified as emergent (Steels, 1994; Morowitz, 2002). As used herein, emergence refers to a relationship among cell primitives in a multi-cellular system. In one embodiment, a specific arrangement or interaction among cell primitives produces the emergent behavior, such that the behavior is not a property of any single cell primitive. Typically, emergence refers to behaviors or dynamic states rather than static shapes or structures. In living systems, emergence can convey one or more additional meanings: 1) that the property of interest appears only at some higher level of hierarchical organization than the elements that give rise to it; and 2) that the emergent behavior is adaptive, that it carries survival value, or increases fitness. For instance, homeostasis among vertebrates (e.g., maintenance of blood composition within narrow limits) can satisfy both of these conditions.

As described in more detail below, the cell-centric simulator 11 provides means for simulating one or more biological events such as those that model the naturally occurring events and interrelationships described above. For example, the cell-centric simulator can model development of a tissue, differentiation of specialized cells, wound healing, immune system responses, neurological processes, etc. In operation, the cell-centric simulator 11 provides means for receiving configurable simulation information. Such configurable simulation information can include both macro- and micro-environmental parameters, as well as cell-specific parameters. Cell-specific parameters can include, for example, features characterizing the plurality of gene units that make up the cell's virtual genome, the defined state and/or maturity level of the cell at an initial step boundary (e.g., at the beginning of a simulation session), etc. Further, configurable simulation information can include a plurality of rules and equations that model the interrelationships between the object oriented resources (e.g., gene unit products, nutrients, receiver resources, signaling resources, etc.). Additional configurable simulation information can include physical rules that are invoked to model the physical laws of nature (e.g., contact inhibition, size constraints, gravity, affinity/adhesion parameters between resources and/or cells, etc.). In one embodiment, configurable simulation information can be interpreted by the cell-centric simulator source code for running a simulation.

Additionally, embodiments of the present disclosure have demonstrated utility for simulating emergent properties, such as those described above (e.g., self-repair, cell communication that leads to a desired phenotype, dynamic adaptability to a changed environment, feedback networks that respond to a dynamic environment and model oscillations of cell state that can propagate through a modeled multicellular tissue, etc.). In particular, emergent properties simulated by the cell-centric simulation system 10 can include the following:
differentiation and/or cell specialization from an initial state to a terminal state;
communication by sensory functions and exchange of signals;
homeostasis by regulatory processes and metabolic feedback;
metabolism of fuels, energy, and molecular synthesis;
self-repair through cell turnover, regeneration, and replication; and
adaptation by phenotypic plasticity.

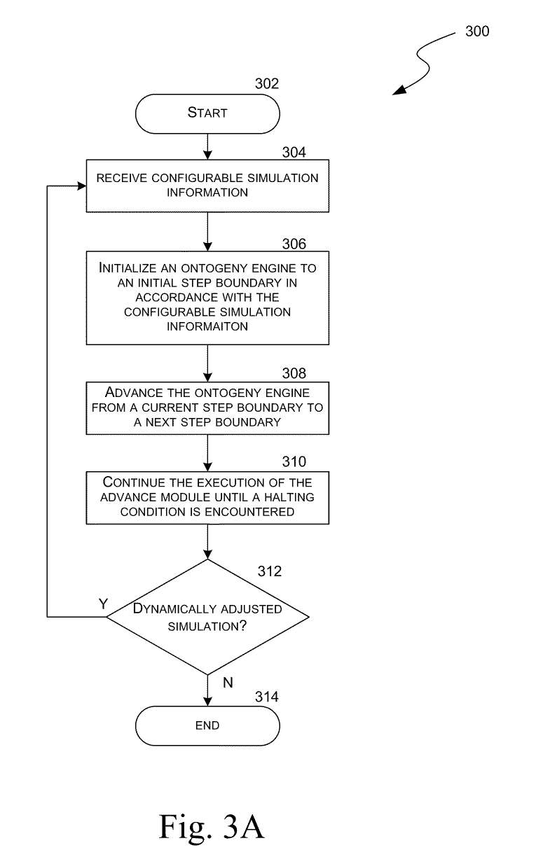

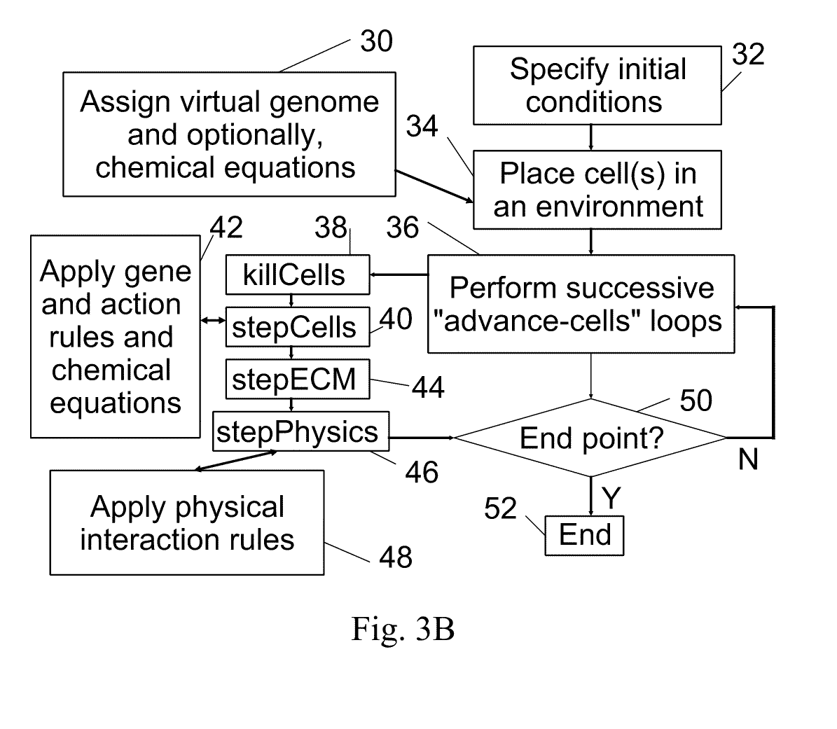

FIG. 3A is a flow diagram illustrating a routine 300 for modeling one or more biological events invoked by the simulation system 10 in some embodiments. The routine 300 can be invoked by a computing device, such as a client computer or a server computer coupled to a computer network. In one embodiment, the computing device includes the cell-centric simulator 11 having the ontogeny engine 14. As an example, the computing device may invoke the routine 300 after an operator engages a user interface in communication with the computing device.

The routine 300 begins at block 302 and the receive module receives configurable simulation information (block 304). In some embodiments, the configurable simulation information can include user-configurable simulation information received from a user interface. In additional embodiments, the configurable simulation information can include information in a configurable file generated from a previous modeling session. The initialize module initializes the ontogeny engine to an initial step boundary in accordance with the configurable simulation information (block 306). In one embodiment, the initial step boundary can define a reference point from which a simulation can commence or continue. For example, the initial step boundary can define the static starting “state” from which subsequent steps may be taken. In the present implementation, the ontogeny engine can be driven one step at a time from the initial step boundary to subsequent step boundaries.

The advance module advances the ontogeny engine from a current step boundary to a next step boundary in accordance with the configurable simulation information and the current step boundary (block 308). In one embodiment, the advancing includes performing a stepCells function (described in detail below). In another embodiment, the advancing can include performing one or more of a killCells function, a stepECM function and stepPhysics function. One of ordinary skill in the art will recognize that the killCells, stepCells, stepECM and stepPhysics functions can be implemented in any combination, in sequential order, in non-sequential order, and/or simultaneously. In such embodiments, the simulation system can be used to model a biological system in a sequential manner or parallel manner. Parallel modeling can be configured to be any number of parallel simulations (e.g., running on processors) ranging from two parallel simulations to an infinite number.

A halt detection module continues the execution of the advance module until a halting condition is encountered (block 310). The routine 300 may then continue at block 312, where it may conditionally continue from block 304 or conditionally end at block 314.

In one embodiment, a halting condition can be a halt command received from an operator (e.g., user) of the system at a user interface, for example. In another embodiment, the halting condition can be a configured halting condition and the halt detection module continues the execution of the advance module until the configured halting condition is detected during simulation. For example, the configured halting condition can be a preset number of advancements by the ontogeny engine from a current step boundary to a next step boundary and the halt detection module can halt the advancement module when the preset number of advancements has been exhausted. In another embodiment, the configured halting condition can be a condition in which a degree of change (of one or more parameters) between a current step boundary and a next step boundary is less than a threshold degree of change. For example, a simulated biological process can be configured to continue through step advancements until a virtual tissue reaches a state of homeostasis. In other embodiments, the configured halting condition can be reaching and/or exceeding a preset number of cells in a virtual environment, cellular occupation of a designated space and/or location of a virtual environment, exhausting a preset time limit, exceeding a preset amount of time in a given step, and/or meeting some other preset fitness goal.

In another embodiment, the cell-centric simulator 11 can be configured to model a biological event in a sequential and/or asynchronous manner. For example, the initialization module can be configured to initialize the ontogeny engine to an initial step boundary such that the initial step boundary includes one or more virtual cells initialized in a virtual environment. The advance module can be configured to advance the ontogeny engine from a current step boundary to a next step boundary, wherein the advancing includes advancing each of the one or more virtual cells in the virtual environment independent of each of the other virtual cells. For example, the advancing can include the killCells function, the stepCells function, the stepECM function, the step Physics function, and/or other functions (e.g., “the functions”) operating on each virtual cell independently from the other virtual cells. In operation, the functions can be invoked in a first virtual cell or, in another embodiment, in a first subpopulation of cells at a different time and/or rate than in a second virtual cell or second subpopulation of cells. Accordingly, a step boundary for one cell can occur independent of a step boundary in an adjacent cell. In this manner, the cell-centric simulator can operate in a continuous manner and/or in a manner in which virtual cells can exhibit differential behavior.

In some embodiments, the visualization engine can generate and display a graphical image representing the current step boundary at a user interface. In one example, the graphical image can be a first graphical image, and the visualization engine can display a second graphical image representing the next step boundary in sequential order following the display of the first graphical image. In another embodiment, the visualization engine can provide progressive display of a plurality of graphical images either in real-time mode (e.g., during simulation), or off-line at one or more times following simulation. For example, the visualization engine can retrieve and render simulation data stored in files for replaying the simulation session (e.g., on a client computer, on a server, etc.). In a further embodiment, the visualization engine can provide a user interactive interface such that an operator can, in real-time, make a change to the simulation (e.g., perturb the environment, change a gene unit in one cell so that cell division and/or growth are not inhibited by neighbor cells, etc.). For example, the routine 300 (at decision block 312) can accommodate adjustment information received (at block 304) from the visualization engine user interactive interface, for initializing the ontogeny engine to an initial step boundary in accordance with the adjustment information.

In some embodiments, not shown, the output module can transmit simulation data to one or more data storage devices. In one embodiment, the output module can generate and transmit a recording file following the end 312 of the routine 300, wherein the recording file can be accessed at a subsequent time to “replay” the simulation, e.g., by the visualization engine. In another embodiment, the visualization engine can retrieve and render the recording data in the recording file such that a visual output of the recording can be manipulated (e.g., cells can be colored, cell connections displayed, visualize subspheres, rotate a point of reference, etc.). The visualization engine can also be configured to replay an entire simulation recording from the recording data, or in another embodiment, replay a sub-portion. Further, the visualization engine can capture “snap shot” images from the recording data in the recording file, e.g., from selected step boundaries.

In one embodiment, configuration files can be generated at any point (e.g., at any step boundary) during a simulation session, including a stop boundary (e.g., when a halting condition is encountered), transmitted (e.g., by the output module) and can be stored for later retrieval. For example, configuration files corresponding to any of the initial step boundary, 1^{st} step boundary, 2^{nd} step boundary, . . . n^{th} step boundary, n^{th}+1 step boundary, . . . stop boundary, etc., can be generated and stored for subsequent retrieval. In one embodiment, configuration files can include simulation information, including all configurable information used during the initiation of the ontogeny engine, as well as simulation information regarding the current step boundary from which the file was generated. In one embodiment, the experiment engine can be configured to access and retrieve a stored configuration file generated during a previous simulation session such that the configuration file can be used to run additional simulations. For example, a selected configuration file can be received by the receive module at block 304 (e.g., from the experiment engine) and the initialize module, at block 306, can initialize the ontogeny engine to an initial step boundary in accordance with the configurable simulation information provided in the selected configuration file. Accordingly, configurable simulation information derived from any step boundary and/or stop boundary can be used to initialize the ontogeny engine and, e.g., define an initial step boundary for initiating further simulation sessions.

In some embodiments, the experiment engine 22 can include a user-interface module 23 (FIG. 1A) for supporting user-selection of the configuration file. For example, the configuration file can be a user-selected file, and be selected from a plurality of stored configuration files. In such embodiments, the operator may be queried by and/or instruct the experiment engine to further alter the configurable simulation information stored in the configuration file. For example, the operator can perturb selected parameters (e.g., gene units, environmental parameters, metabolic equations, action rules, etc.) and/or alter a simulation protocol prior to the initialization of the ontogeny engine at block 306. Accordingly, the simulation system can be used for iterative experiments and queries by an operator by running subsequent simulation sessions having selected parameters altered. An operator can compare results from a plurality of modeled sessions.

In a particular and non-limiting example, an operator may want to determine if and how development of a tissue can be altered when the cells are starved for nutrients at an intermediate point during development. In this example, an operator can choose to run a first simulation session wherein the configurable simulation information codes for a high level of modeled nutrient resources. In a second simulation session, the operator can select a configuration file generated during an intermediate step boundary (e.g., 1^{st} step boundary, 2^{nd} step boundary, . . . n^{th} step boundary, n^{th}+1 step boundary, . . . etc.). Following selection of the desired configuration file, the receive module can receive, at block 304, the configuration file and additional configurable simulation information, wherein the additional information instructs a low level of modeled nutrient resources. The initialize module can initialize the ontogeny engine (block 306) as described above and modeling of tissue development can “continue” from the selected intermediate step boundary while in a virtual environment depleted of nutrient resources. The operator can compare results of the first simulation session to the second simulation using, for example, the visualization engine, or some other data output device.

In other embodiments, the experiment engine 22 can be configured with additional programming logic for automatically selecting configuration files from which additional and/or different simulations can be generated. For example, a simulation session can be automatically implemented using the simulation system without requiring an operator to manually input or otherwise specify the configurable simulation information.

In one embodiment, experiment engine 22 can include a dynamic adjustment module 24 for capturing configuration files and automatically initiating additional simulation sessions for modeling biological events. One of ordinary skill in the art will recognize that the dynamic adjustment module 24 includes configurable hyper-directives (e.g., programmed rules for generating rules). Such hyper-directives allow the spontaneous generation of rules so that the dynamic adjustment module can automatically, and in real-time, run a plurality of directives in accordance with a plurality of simulations.

In one aspect, the dynamic adjustment module can be configured to recognize instances (e.g., at step boundaries, at a stop boundary, etc.) wherein criteria are met for generating a second or multiple simulation sessions. For example, the dynamic adjustment module can be configured to automatically spawn a second simulation following or to run concurrently with a first simulation (decision block 312). In such embodiments, the routine 300 may then continue at block 304, wherein the receive module receives configurable simulation information.

In further embodiments, the dynamic adjustment module 24 can be configured to alter a captured configuration file and/or user-configurable simulation information over multiple simulation sessions, such that the equivalent of multiple experiments can be simulated automatically. For instance, the dynamic adjustment module 24 can systematically and/or randomly alter the control region parameters (e.g., simulating constitutively active expression of a gene, simulating a gene “knock-out” or “knock-down”, etc.) of each of a targeted group of gene units in sequential simulation sessions. An operator can compare the results and/or final modeled output data from any simulation session (e.g., a first simulation session using a “wild-type” or normal gene unit configuration) to any other simulation session results (e.g., a second simulation session using a “knock-out” or absent gene-unit).

FIG. 3B is a flow diagram illustrating another routine for modeling a biological event supported by the simulation system 10 and in accordance with an embodiment of the disclosure. In block 30, a virtual cell (or cells) is assigned a virtual genome, e.g., a set of gene units, each with specified gene control and gene product characteristics (described in more detail below). In some embodiments, one or more metabolic equations that govern the extra-genetic behavior of the resources present in an environment or generated as a result of gene unit activity can be specified (described in more detail below). In block 32, a simulated environment is generated through specification of initial conditions (e.g., spatial parameters, virtual substrate characteristics, resource types [external signals] present, resource density, resource gradient(s) within the environment, available nutrient(s), quantity and distribution of nutrients, etc.). In block 34, one or more virtual cells can be placed in the virtual environment. For example, following blocks 30, 32 and 34, the ontogeny engine can be initialized to an initial step boundary (e.g., an initial static state in accordance with the configuration simulation information received in steps 30, 32 and 34).

Following initialization of the ontogeny engine, simulation of the one or more biological events includes advancing the ontogeny engine from a current step boundary to a next step boundary in accordance with the configurable simulation information and the current step boundary. Accordingly, at block 36, the state of each virtual cell can be advanced in steps. Advancing can include applying at each step, one or more of the functions indicated at blocks 38, 40, 44 and 46. One of ordinary skill in the art will recognize that the ontogeny engine can perform one or more of these functions in any combination and/or order. It will also be recognized that each function employed during the advancing of the ontogeny engine can be performed in a sequential and/or simultaneous manner. In a further embodiment, one or more functions can be performed in an asynchronous manner.

The “killCells” function can be configured to trigger cell death, eliminate dead cells from the virtual environment/tissue, or both. When the killCells function is configured to eliminate virtual cells from the virtual environment/virtual tissue, the cells that are removed are the cells for which a cell death criterion was met (e.g., death gene unit activated, loss of activation of an essential gene unit, etc.) in the previous cell advancement step. Alternatively, the killCells function may be configured such that a protocol message removes cells from the virtual environment/virtual tissue immediately upon reaching a cell death criterion.

The “stepCells” function (block 40) is configured to update and/or refresh cell activity functions that are poised to be affected at that step, including gene activity, gene response, intracellular and intercellular signaling, etc. (described in more detail below). The stepCells function invokes the gene unit control region rules and metabolic equations (block 42) to determine the adjustment in the level of promotion of each gene unit, change state of resources acting within or on each cell, etc. For example, the metabolic equations and correlating changes in activity level of gene units can be applied to produce a “new cell state” for each cell. In response to new and/or step-wise refreshed interactions between resources within a cell and each gene unit, each gene unit within the cell can contribute to the generation of resources (e.g., increasing or decreasing the value of resource strength in the cell, etc.).

In biology, when a gene is transcribed, the transcriptional machinery of the cell synthesizes corresponding ribonucleic resources (RNA) that are defined by the gene's structural region (e.g., open reading frame). Many of these RNAs are, in turn, translated by the cell's translation machinery into proteins having specific functions. Likewise, when gene units are acted upon, the simulation system is updated as though the gene units give rise to the correlative levels of the specific gene product for which the gene units represent. In one embodiment, promotion of a gene unit can occur using a binary method, wherein the concentration of a gene unit promoter resource must exceed a threshold before the gene unit will produce a product, and when that threshold is exceeded the product is produced at a constant rate. In another embodiment, promotion of a gene unit can occur using a sigmoidal function. For example, a small amount of a gene unit product can be produced when the promoter concentration is low, a relatively quick ramp up of product production can occur within a narrow range of promoter concentration, and an effective maximum of product production can occur at some higher concentration value of the promoter. In this embodiment of gene unit promotion, subtle changes to cell state and/or behavior can be achieved.

Newly generated resources may in turn interact with the cell's other gene units in the virtual genome, affecting rates and/or levels of transcription during the next round of applied stepCells function. In some embodiments, the stepCells function can include rules that independently determine rates and/or levels of transcription and translation operations of gene unit templates.

Simulation of biological events is thus governed, at each step advancement, through changes in the virtual external environment, as well as changes to the virtual internal cell environment. Adding further complexity, a virtual cell can also be affected through metabolic equations representing interaction with resources generated by neighboring virtual cells. During simulation, the simplest neighborhood of a cell (the cells to/from which a virtual cell will send/receive signals) consists of those cells that are spatially adjacent to (touching) the cell of interest. However, a cell's neighborhood may be configured as or result in any arbitrary group of cells. For example, a neighborhood could include cells that are not adjacent, as occurs in vivo with cells that are able to signal non-local cells via hormones. In some embodiments, the neighborhood of a cell could have a dynamic range based on the configured strength and diffusion characteristics of a signal resource in a particular surrounding virtual environment. In such embodiments, a user may identify a specified distance for resource diffusion, or may select a lower bound on signal strength which will determine how far a particular signal diffuses in the virtual environment. In other embodiments, a cell's neighborhood can be defined by lineage, adhesions, contact in previous simulation steps, etc. In further embodiments, a neighborhood can be influenced by the presence of fluid in the virtual environment where a signal's diffusion occurs through fluid transfer.

In one embodiment, the “stepECM” function (block 44) can be invoked at each advancing step to update and/or refresh simulated adhesion properties between virtual cells and a virtual ECM, for example. For instance, the stepECM function can be configured to execute rule-based directives for breaking overextended cell adhesions, forming cell adhesions between cells and ECM objects (e.g., ECM components, resources, etc.), weakening cell adhesions with ECM objects over time, etc. (discussed in more detail below). In another embodiment, the stepECM function can be invoked at each advancing step to execute rules for creating and/or decaying virtual ECM objects within the virtual environment. In one embodiment, ECM objects can be spherical subunits that can have adhesion connections with other ECM objects or with cells to provide a structural framework for cells to develop within or upon. ECM subunits can also contain resources which can be used to signal cells, and in some embodiments, can permit cells to deposit signaling resources that can affect other cells which come into contact with the ECM subunit.

In addition to operations that increase or decrease a resource strength value (e.g., analogous to concentration) during simulation, additional optional actions, such as cell growth, cell division and cell death, are applicable to each cell and each of these actions affect the environment's spatial parameters. The virtual genome of a cell can include gene units that serve as a template for growth resources, division resources, death resources, etc., and as these gene units are activated during the simulation session, the concentration of encoded resources in the cell's virtual cytoplasm increases. In some embodiments, growth and/or death can be a function of the concentration of these two types of resources. When a cell accumulates a threshold level of a death resource, it can be removed from the environment in a subsequent advancing step. In another example, if a cell grows, its overall size (e.g., circumference, volume, mass, etc.) is increased. In a further example, if a cell divides, a new cell is placed in a location adjacent and/or proximal to the original parent cell. If all adjacent positions are already occupied and/or there is no physical space to allow additional cells to occupy, operation rules can prevent a cell from dividing. Such operation rules can supersede other factors, such as division and/or growth potential exceeding a predetermined threshold for meeting a division and/or growth action rule requirement.

In one embodiment, the “stepPhysics” function (Block 46) can be invoked at each advancing step to update and/or refresh simulation of physical forces on the virtual cells and/or resources in the environment. For example, the stepPhysics function can move cells according to calculated forces in their environment (e.g., dividing cells, cell growth of neighboring cells, adhesion or attraction forces, etc.) In one embodiment, the stepPhysics function is configured to resolve overlaps between cells that arise from cell growth, division, and/or motion, including motion from prior calculations for resolution of cell overlap. The stepPhysics function invokes physical interaction rules (block 48) for specifying cell adhesion forces, rules for applying natural physical laws and rules for simulating the mechanics of moving cells (e.g., apart from one another during resolution of cell overlap, toward one another to resolve excessive cell motion, etc.) The stepPhysics function, can in one embodiment, be provided by or reside in source code for running by the physics engine.

In one embodiment, the stepPhysics function operates using spatially defined models described further herein. For example, the stepPhysics function can operate using (1) a fixed-coordinate, discrete-coordinate, or egg-carton model in which cells are assigned to predetermined two- or three-dimensional coordinates in space, similar to the bins of an egg carton; (2) a free-space or continuous-coordinate model in which each cell is represented by a solid sphere which is free to assume arbitrary coordinates in two- or three-dimensional space; and (3) a free-space model in which the cells are identified by a plurality of subspheres (e.g., a “bag of marbles”), and therefore, are free to assume arbitrary non-spherical shapes, e.g., flattened shapes. In general, a free-space model gives a much closer approximation to real-cell behavior, and may be required for modeling certain tissue behavior.

In one embodiment, during each “advance-cells” loop (block 36), the stepPhysics function (block 46) runs several cycles, e.g., 20 cycles or greater, to iteratively resolve cell movement and overlap. The resolution of physical interactions requires multiple iterations to ensure that the reaction of objects to other objects in the simulation model is reasonable and yields biologically relevant resolution over time. In one embodiment, a user can configure a fixed number of iterations such that the time allotted to each step is divided into smaller segments of equal time. In this embodiment, a suitable number of iterations should be selected so that the physical resolution is realistic during the simulation, but does not require exorbitant computation. In another embodiment, the simulation system 10 can be configured to determine the number of stepPhysics iterations during the simulation session. In this embodiment, a user can specify the maximum velocity change (acceleration or deceleration) allowed during each physical iteration. The amount of time for an iteration can then be determined based on this velocity requirement resulting in each iteration having a variable amount of time. This embodiment allows the simulation to use fewer iterations per step when there is less physical interaction to resolve, and increases the number of iterations when there are more significant interactions.

As indicated in FIG. 3B, the “advance-cells” loop is repeated until a halting condition is encountered, at 50, terminating the run at 52. This end point/halting condition may be defined, for example, by a pre-selected number of loops, reaching a pre-determined cell number, or reaching a condition in which the tissue reaches a stable or steady state, or reaches another preset fitness goal. In another embodiment, the halting condition can be a user-invoked stop mechanism that requires user interaction in real-time during a simulation session.

### B4. Checkpointing in Systems and Methods for Simulating a Biological Event

In some embodiments, the method, system and apparatus disclosed herein may include a checkpointing system. Checkpointing in software is defined as “storing a snapshot of the current application state, and using it for restarting the execution in case of failure”. Checkpointing captures the ability to save the progress of a program to a file and then reload it at a later time. The system serializes all of the necessary data structures to a checkpoint file and is able to revitalize them at a later time.

### B4.1 Configuration of a Checkpointing System

In accordance with embodiments of the disclosure, the checkpointing system may be configured to produce checkpoint files that will contain everything needed for a simulation to be resumed from that file and produce results identical to the original simulation. Testing the checkpointing system ensures that the checkpoint file or files work properly. The general process for testing such checkpoint files for correctness is as follows. First, advance a simulation for a number of steps, and produce a checkpoint file (File A). Second, continue running the simulation a number of steps further (e.g., 100 steps) and produce another checkpoint file (File B). Third, resume a simulation from File A and advance 100 steps again, saving a third checkpoint file (File C). A variant of this test procedure has been implemented in a unit test and a regression test as well as run manually.

Having all of the spheres in the same position in a well chosen individual that satisfies the above requirements is not assured. The random number generator state should be carefully restored in the resumed simulations to produce the same results that the original simulation would have produced.

The checkpointing system has been implemented so that it supports various checkpointing uses. The features of the checkpointing system are as follows:
The Server is able to produce a checkpoint file that can be used to restore the exact state at a later time. This file is stored on the server computer in a ‘working directory’ associated with that server user and version.
The Server has a ‘checkpoint interval’ that causes a checkpoint file to be produced when the interval time has elapsed. The intercal is configurable through the visualization interface and automatic checkpoints may be assigned names that are clearly associated with the original configuration file.
The client is able to manually cause the Server to checkpoint the simulation. The user is able to enter a custom name for manual checkpoints that are saved in the working directory on the server.
Through the client, users have access to a list of the checkpoint files in their server-side working directory. When one is chosen from the list, the server will reset and load the selected file.
A mechanism is provided in the client software to delete checkpoint files when no longer needed.

### B4.2 Uses for Checkpointing

In one embodiment, checkpointing can be used for fault tolerance. Fault tolerance, generally, is the ability to protect against substantial loss of computing time by periodically saving the simulation state. To use checkpointing for fault tolerance, one will need to be able to specify a checkpoint frequency for the simulation server. This allows progress to be saved automatically on an interval. This could be done per-step or per-time.

In some embodiments, fault tolerance works through setting the checkpoint interval to some non-zero value (the default can be 15 minutes when server is started through a standard session). When a user finds that their simulation has stopped for some unexpected reason, the most recent checkpoint will appear in the server side file drop-down when they reconnect. Selecting this checkpoint file will load their simulation so they can continue. Subsequent auto-checkpoints will replace the prior auto-checkpoints. In some embodiments, the new checkpoint file can replace the last file. In other embodiments, each simulation can produce and store a plurality of checkpoint files.

In another embodiment, checkpointing can be used for experimental branching. Experimental branching allows experimenters to repeatedly load a checkpoint to save development time when running a set of altered configurations that share a common initial phase of development. For experimental branching, a checkpoint is saved at the branch point. This checkpoint is reloaded and altered for each iteration, instance, or run of the experiment. It can be seen as an optimization that saves the experimenter time by reusing as much of the beginning of the simulation as needed. It also guarantees identical starting conditions for the branched runs.

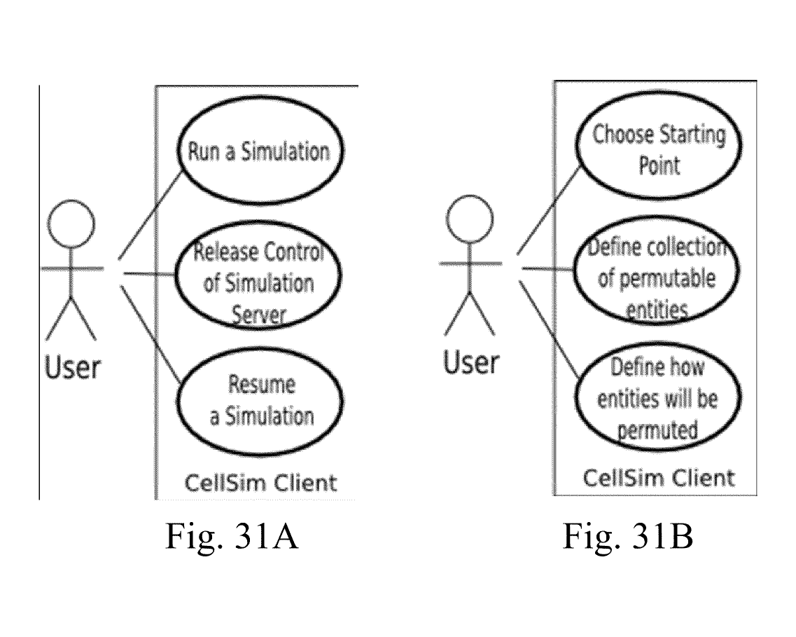

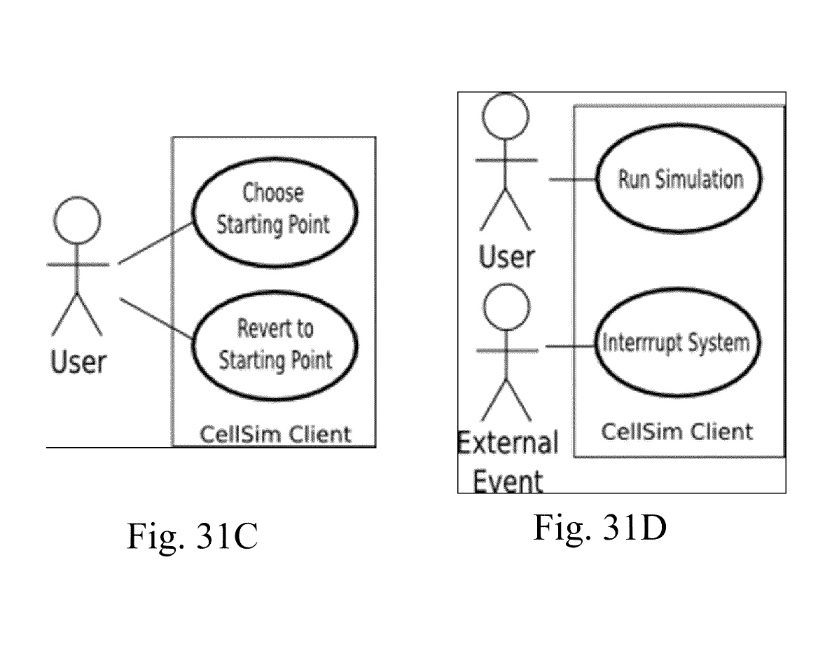

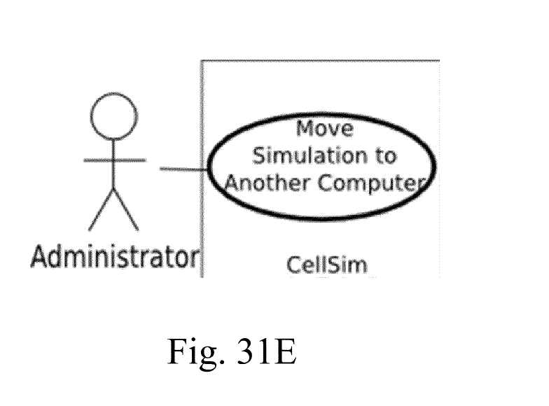

In another example of experimental branching, checkpointing allows a user to permute a collection of entities in a simulation individually, starting from a common starting point. For example, if a user plans to run a gene knockout experiment, the experiment may be structured such that a tissue will be developed to a specified level of maturity and then one of the cells will be chosen for gene knockout. The experiment may then be run for every cell in the tissue. In this way, the implementation of checkpointing allows a user to maintain scientific rigor by running the experiment in every cell of the tissue, but also allows for time savings. As illustrated in FIG. 31B, the User can choose a starting point, define the collection of permutable entities, and finally define how the entities will be permuted.

In yet another example of experimental branching, checkpointing allows a user to run multiple experiments from the same starting point. For example, if a teacher is showing his or her class a virtual tissue that was grown overnight, then a student asks the teacher what would happen if a particular cell was killed in the virtual tissue, the teacher may “mark” the current state of the simulation so he or she can make an ad hoc manipulation to the simulation in order to answer the student's question (i.e., the teacher kills the cell, then lets the tissue develop for a while to see how the tissue reacts), but can then go back to the original simulation at the point that the manipulation was made to continue the original discussion or to answer further questions from that chosen starting point. As illustrated in FIG. 31C, a user (Teacher) can choose a starting point, then after one or more ad hoc manipulations to the simulation, can revert to the starting point.

In some embodiments, checkpointing allows a partially completed simulation to be stopped and later recovered for completion without losing the processing time already invested. For example, if User A and User B share access to a single account on the simulation server, the users may agree to an arrangement wherein User A uses the server for 24 hours, then agrees to relinquish control to User B for the next 24 hours, and so on. If User A begins running a simulation, but after 23 hours, he sees that the simulation will not be complete in the 24 hour time limit, checkpointing allows User A to stop the simulation, relinquish control of the server to User B, and resume his simulation 24 hours later without losing any progress. As illustrated in FIG. 31A, User A can run a simulation, release control of the simulation server after significant time investment, and then later resume the simulation.

In other embodiments, automatic periodic checkpointing allows a user to recover automatically from a temporary failure in a computer platform. Automatic server recovery from the last automatically saved checkpoint reduces loss of user time in the event of server downtime from a power outage or other disruption. For example, a user may start a simulation on Friday, expecting the simulation to run over the weekend. The simulation runs for 36 hours, but the server is interrupted for an unscheduled reason. Automatic server recovery from a checkpoint would prevent a loss in progress due to any unscheduled interruptions. In this embodiment, the user's role is passive. No action is required on the part of the user (FIG. 31D).

In further embodiments, checkpointing allows load balancing in a computer work pool. Too many simulations on one server can cause them all to progress slowly. For example, if a cluster is running 10 simulations and 8 of them are all on one node, an administrator would be able to balance work on the nodes by moving a checkpointed simulation to a more lightly loaded node (FIG. 31E).

### C. Virtual Genes, Metabolic-Interaction Rules and Action Rules

In accordance with embodiments of the disclosure, gene units, metabolic-interaction rules and action rules have equal importance for affecting the fidelity of the resulting cell-based models. While promotion of gene units to produce resource products is clearly useful for creating additional resources in a virtual cell, metabolic-interaction rules provide mechanisms of utilizing resources (either initially provided in a cell simulation session or created during simulation) to affect higher order processing, localization, etc. of the resources. Action rules provide a mechanism of utilizing resources (alone or in combination) to yield physical and/or visible changes to the virtual cells, the virtual environment and other objects or parameters.

### C1. Gene Units

In one embodiment, one or more virtual cells in the system can be assigned a virtual genome containing a plurality of gene units, each of which has a control region that determines what combination of signals (e.g., resources or conditions) will induce gene activity and at what level. Each gene unit also comprises a gene product region that specifies the gene product or action produced by the gene unit. Table 1 includes an exemplary group of gene units that represent a “basic” set of virtual genes that can be used during in a variety of simulation session, e.g., for tissue development applications. One of ordinary skill in the art will recognize additional and/or alternative gene units that can be included in a virtual genome. Moreover, a virtual cell can be provided with a wild-type or natural virtual genome, or in another embodiment, the cell can be provided with a non-wild-type or transgenic virtual genome in which one or more of the gene units are modified. Furthermore, the listings in Table 1 are not meant to be limiting to the structure or context of code shown, and as such, other means and methods of coding and/or conveying gene unit information is considered within the scope of this present disclosure.

TABLE 1
Examples of Gene Units having Control and Gene Product Regions

| Gene | |
|---|---|
| Unit | Gene specification |
| 1 | [DiffuseNutrients .3] [Plasticity, Elasticity, Rigidity], |
| 2 | [DiffuseNutrients 5] [ExistanceSignal, ExistanceSignalReceiver], |
| 3 | [DiffuseNutrients .18, NeighborPresent −3] [Growth], |
| 4 | [DiffuseNutrients .18, NeighborPresent −3] [Division], |
| 5 | [DiffuseNutrients 5, Dominator −10, Dominated 5] |

[DominationSignalReceiver],

| | |
|---|---|
| 6 | [NeighborPresent 3, Dominated −10, Dominator 3] |

[Dominator, DominationSignal]

As shown in Table 1, each gene unit includes a paired control region and a gene product (e.g., structure) region. For example, referring to GENE 3 in Table 1, “[DiffuseNutrients 0.18, NeighborPresent −3] [Growth]” indicates that cell growth is promoted at (+)0.18 by DiffuseNutrients (a configured designation for resources, in this case placed in the environment and transported into the cell) and, given its negative coefficient is inhibited at −3.0 by NeighborPresent. The actions invoked by these six genes units (e.g., cell growth, division, death, adhesion, etc.) are described in greater detail below.

Some characteristics of gene units (or virtual genes) in accordance with embodiments of the disclosure are:
Genes exist at the cell level and are not associated with subunits (described further below). Resources and other resources are associated with subunits. Because of this, transcription is run at the cell level, while metabolism is run at the sphere level. This also creates differences between how genes and resources are passed on to daughter cells.
Genes are inherited, and are therefore “copied” to each daughter cell, In contrast, resources are distributed.
A particular concentration of a transcription factor (TF) can potentially activate any number of promoters. While gene expression is involved in metabolism, transcription does not consume any resources. TFs are not distributed between promoters like we distribute other resources between metabolic equations. This is because we don't think of the promoter/TF reaction as consuming or even tying up large numbers of TFs. Rather, we just look at increasing concentrations of TF as increasing the probability that a TF molecule will be bound to the promoter at any given moment in time, but the process of binding does not reduce the available TF in any real/significant way for other promoters. Justification: there just aren't that many promoters, and typically only one (or a few) TF can bind a promoter at one time.
Genes don't decay.
Genes are mutable. In some aspects, mutation operators may be handled as metabolic equations by extending concept of a metabolic equation to allow the equation to operate at a more generic level (rather than hardcoded to individual molecular types), as well as having the equation operate in a nondeterministic fashion.
The rate of transcription can be variable, but bounded. The transcription rate is controlled by a pluggable function that (typically) is a monotonically increasing sigmoid function bounded between 0 and 1. The reaction rate is attenuated by a multiplier (usually set between 0 and 1).
All resources potentially interact with all promotion regions.
Typical reaction with TF is essentially a “bind” reaction. Within a certain range of concentration, increasing TF will increase promotion/inhibition. Above that range the degree of promotion/inhibition is maximized.

In other embodiments, some or all virtual cells can be configured without a virtual genome.

### C2. Metabolic-Interaction Rules

Resources present in the environment or generated within virtual cells are governed by extragenetic rules, referred to herein as metabolic-interaction rules or “metabolic equations,” which can determine how resources will be transformed or transported as they interact with other resources in the system. Metabolic equations can represent many reactions or processes within a cell. This includes molecular transport, vacuole formation, etc. A virtual cell genome and its metabolic equations may use and produce the same or similar resources. Table 2 shows some differences and similarities between the functions of metabolic equations and genes or gene units.

TABLE 2
Metabolic Equations v. Genes

| Metabolic Equation | Gene |
|---|---|
| can consume inputs | cannot consume inputs |
| uses amounts as inputs | uses concentrations as inputs |
| produces amounts | produces amounts |
| requires at least some of all inputs to | only requires some of at least one |
| produce output | input to produce output |
| is not reduced by the presence of any | can be reduced by the presence of a |
| resources | resource |
| has no upper limit to amount of | upper limit of product produced is |
| product produced | determined by the sum of positive |
| | effects of binding sites |
| production is limited by reactant | production is not limited by any one |
| with least amount | binding site |
| production is linear to limiting factor | production is determined by |
| | promotion curve (which can be linear, |
| | or sigmoidal, or square) |
| input locations are specified | inputs must all be internal |
| product locations are specified | product location is internal |
| reactions happen on subunit basis | reaction happens on cell-wide basis |

In accordance with embodiments of the disclosure, metabolic equations have two components, reactants and products. The amounts of reactants determine the amounts of products. The reactant component may be a list of resources and coefficients, for example:

C,,0,,R,,0,,+C,,1,,R,,1,,+C,,2,,R,,2,,+ . . . +C,,n,,R,,n,,=products

wherein each C,,n,,R,,n,, is a reactant term, C,,n,, is the coefficient of that reactant term and must be greater than 0, and R,,n,, is a resource as defined in a resource catalog (see section E2). The relationship between coefficients (Cs) in reactant terms determines how much of each reactant resource is needed relative to the other reactant resources in order to produce the products. For example if C,,0,, were 1 and C,,1,, were 2, then twice as much of R,,1,, is needed to react with the amount of R,,0,, that is present. If there is not at least twice as much R,,1,, as R,,0,, then we would consider R,,1,, to be a limiting factor, that is, the amount of product is limited by the amount of R,,1,, that is present. If instead there is more than twice as much R,,1,, as R,,0,, then R,,0,, is the limiting factor.

The reactant component may also be a list of resources and coefficients, for example:

C,,0,,R,,0,,+C,,1,,R,,1,,+C,,2,,R,,2,,+C,,n,,R,,n,,=K,,0,,P,,0,,+K,,1,,P,,1,,+K,,2,,P,,2,,+ . . . +K,,n,,P,,n,,

wherein each K,,n,,P,,n,, is considered a product term, K,,n,, is the coefficient of that product term and must be greater than 0, and P,,n,, is a resource as defined in the resource catalog. The relationship between coefficients (Ks) in product terms determines how much product is produced relative to the other products. For example is K,,0,, were 1 and K,,1,, were 2, then twice as much P,,1,, will be produced by this equation as P,,0,,. The relationship between product coefficients (Ks) to reactant coefficients (Cs) in the equation determine how much product is produced relative to the reactants. For example in the equation 2A=1B, there will be 1 B created for every 2 A's that are present.

In some embodiments, a metabolic equation may also have a reaction rate which can limit the reaction. The reaction rate should be greater than 0 and equal to or less than 1, but is not limited to such a range. If the reaction rate is less than 1, then the actual amounts consumed and produced will be the reaction rate times the amount that would have been produced with no limiting.

In other embodiments, a reactant and product may have a location specifier. The location specifier marks a product or reactant as internal, surface, or external. If a reactant is specified as internal, then only resources which are located internal to the cell will match that reactant term. Resource locations can be mixed in metabolic equations such that internal resources can react with surface resources, surface resources can react with external resources, etc. In some embodiments, if any external reactants or products are specified, there must be at least one surface reactant.

In some embodiments, multiple equations may compete for resources. In this case, the amount of a shared resource available to each equation is evaluated so that the equation(s) that can use more get more, and those that can use less get less. In some cases, however, an equation may not get all of a resource that it would have requested if it had been the only equation. No resource is ever over-used, as described below.

According to embodiments of the disclosure, all reactants used in a reaction are consumed by default. In some embodiments, reactants may be marked as not-consumed. This has two consequences. Not-consumed reactants are not consumed in the reaction (similar to an enzymatic reaction), but may still be used in a reaction. For example, when two cells have surfaces which are in contact, resources on the surface of a cell may trigger a reaction in another cell, but because such resources are embedded on the surface of the cell, the other cell cannot consume them.

Table 3 includes a listing of nine exemplary metabolic equations or chemistry-interaction rules that can be invoked when modeling a biological event. One of ordinary skill in the art will recognize additional and/or alternative metabolic equations that can be included in the cell-centric simulation instructions and the system allows for the addition of such equations either in the beginning or during a given simulation session. Furthermore, the listings in Table 3 are not meant to be limiting to the structure or context of code shown, and as such, other means and methods of coding and/or conveying metabolic equation information is considered within the scope of this present disclosure.

TABLE 3
Example Metabolic-Interaction Rules

| EQ # | METABOLIC EQUATION |
|---|---|
| 1 | {DIFFUSENUTRIENTS} + (NUTRIENTTRANSPORT) = |
| | 0.1 DIFFUSENUTRIENTS + (1.11 NUTRIENTTRANSPORT); |
| 2 | (NUTRIENTTRANSPORT) = (1.11 NUTRIENTTRANSPORT); |
| 3 | (GENERICEXPORTER) = (1.11 GENERICEXPORTER); |
| 4 | EXISTANCESIGNAL + (GENERICEXPORTER) = |
| | (1.11 GENERICEXPORTER) + {EXISTANCESIGNAL}; |
| 5 | EXISTANCESIGNALRECEIVER = (EXISTANCESIGNALRECEIVER); |
| 6 | {EXISTANCESIGNAL} + (EXISTANCESIGNALRECEIVER) = |
| | 20 NEIGHBORPRESENT; |
| 7 | DOMINATIONSIGNAL + (GENERICEXPORTER) = |
| | (1.11 GENERICEXPORTER) + {DOMINATIONSIGNAL}; |
| 8 | DOMINATIONSIGNALRECEIVER = (DOMINATIONSIGNALRECEIVER); |
| 9 | {DOMINATIONSIGNAL} + (DOMINATIONSIGNALRECEIVER) = |
| | 20 DOMINATED + 20 GROWABIT; |

The left side of the equal sign in each metabolic equation denotes the reactants and/or substrates, while the right side of the equation denotes the products and/or result of the reactant/substrate interaction. For instance, EQ 4 can be interpreted as follows: when ExistanceSignal is internal to the cell and GenericExporter is on the cell surface, as denoted by parentheses about the resource name, the equation will produce 1+1/9 GenericExporter on its surface for every one surface GenericExporter in the reaction and produce ExistanceSignal resource outside of the cell, as denoted by the braces about the resource name. In this example, the reactants, ExistanceSignal and Generic Exporter, are “consumed” in the execution of the interaction equation EQ 4; therefore, the net effect is to replenish the GenericExporter following consumption and a pending resource decay step, and move ExistanceSignal from inside the cell to outside of the cell. In other embodiments, the reactants can be configured to be non-consumed when the metabolic-interaction equation is executed during simulation.

Metabolic equations can designate how internal or surface substrate resources are converted to other internal or surface resources, how resources are transported across the cell membrane by surface resources, and how resources are relocated between a cell's interior and surface. Metabolic equations can also be used to consume resources, thereby inhibiting their involvement in other and/or additional interactions. In other instances, metabolic equations can be used to maintain concentrations of particular resources that are subject to consumption in one or more equations and/or subject to resource decay.

### C2.1 Resource Distinctions

Metabolic equations can have different “locations” for resource terms. Resources can exist inside the cell, outside of the cell, or they may be embedded in the cell's plasma membrane. Thus, a resource may be designated as an “internal,” “external” or “surface” resource, respectively. The internal and surface resources exist within the cell and persist from step to step, subject to decay and manipulation by the actions of metabolism of the cell in which they exist. External resources are presented in a single solution to the cell every step of the simulation. External resources can come from gradients, other cells external products, other cells surface resources (in the event of a collision between cells), fluid droplets, ECM and any other source a cell may come in contact or be exposed to.

All resources are flagged as internal, surface, or external resources. A cell, then, could have a category for internal resources, a category for external resources, and a category for surface resources. Resources may participate in two or more sets of equations. First, there may be a set of metabolic equations for interactions between resources and for the transport of resources between categories. Second, there may be a set of equations for surface to surface interactions, evaluated only when the cell is contacting another entity in the environment. Upon contact with a cell or another entity, a cell would be presented with the set of embedded/surface resources of the other entity. Products of reactions could include adhesion with strength based on the limiting reactant, and/or addition of a feedback resource to the cell's internal category.

In some embodiments, gene products would be created as internal resources. A metabolic equation may cause an internal product to move to become a surface resource or to transport resources or other resources out of the cell. Transport out of the cell may or may not require a surface resource as a reactant. To accomplish surface signaling, surface resources are added to the list of resources presented to another entity a cell contacts. To the receiving entity, surface signals appear like any other signal and are handled identically. All non-adhesion reactions can be covered in the general set of chemistry equations. Adhesion-producing reactions, however, have a different set of equations because they produce something other than a molecule or other resource. Further, adhesion-producing reactions are only evaluated when two entities collide. Every adhesion rule requires at least one surface resource from each of the colliding entities. The adhesion resulting from application of an adhesion rule would have a strength limited by the least available reagent.

According to one embodiment, the following syntax may be used:
internalResource
{externalResource}
(surfaceResource)
   which allows the desired molecular operations to be handled under the following general guidelines:
   Gene products are always internal resources.
   Internal resources may be moved to the surface or external lists via chemistry equations.
   Any equation involving an external reactant or product should have a surface resource reactant.
   External resources are presented to other cells according to their distribution rules. Surface resources are presented only on contact.
   When a cell contacts another entity, it receives copies of that entity's surface resources along with all other external resources. Thus, the cell is not aware of the source of resources it receives, although in some embodiments, it may have indication of the direction from which it was received.
   A set of AdhesionRules is checked when two entities collide. These rules should contain at least one surface resource from each entity as reactants.

Some non-limiting examples of desired molecular operations accomplished by the above syntax and guidelines are as follows:

### General Chemistry Rules:

Embedding an adhesion resource:

someAdhesionResource=(someAdhesionResource);
Exporting a signal:

mySignal+(helper)={mySignal};
Exporting a signal requiring a complicated set of actors:

needsHelp+internalCatalyst+(helperChannel)+{someExternalHelper}={needsHelp};
Receiving a long-range signal:

(receiver)+{signal}=internalSignal;
Receiving a contact signal:

(receiver)+{signal}=internalSignal;

### AdhesionRules:

Homophilic adhesion without feedback:

(someAdhesion)+{someAdhesion}=Adhesion;
Homophilic adhesion with feedback:

(someAdhesion)+{someAdhesion}=Adhesion+internalSignal;
Heterophilic adhesion with feedback:

(myAdhesion)+{otherAdhesion}=Adhesion+internalSignal;

In further embodiments, external resources may be categorized as “free” or “fixed.” Free resources may be presented or passed to other entities and consumed, and may include, for example, resources in fluid, and signals secreted by cells. Fixed resources may be presented to another entity and may elicit a response from the entity, but may not be moved from their location. In addition, fixed resources may not be consumed, and may include, for example, cell surface markers, ECM markers, or resources from point sources.

In one embodiment, cell subunits have one container for all externally presented resources and one for all externally produced resources. In embodiments wherein resources are categorized as free or fixed, the presented resources supply would be divided into “free presented” and “fixed presented” supplies. Unconsumed “free presented” resources would be relocated into the “external produced” container. In some embodiments, the following terms may represent the reactant side of metabolic equations:
Internal: Resource
Surface: (Resource)
Free External: {Resource}
Fixed External: <Resource>

“Fixed external” resources are not consumed and are not indicative of an actual location relative to the cell, whereas the terms “internal”, “surface”, and “external” are. Thus, there should be no “fixed” resources on the product side of an equation, although surface resources would be recognized by another cell as “fixed.” For equation balancing, free and fixed resources are not interchangeable, even if they are both of the same resource (e.g. fixed resourceA is not equivalent to free resourceA in a given equation for balancing purposes).

In one embodiment, signaling may be accomplished by droplet signaling (see section D.10) during distribution of resources from point sources and resources are presented to the cell subunit as fixed resources. This prevents the cell from radiating point source resources back into fluid. In another embodiment, resources are presented to cell subunits based upon their position in the environment during signaling. For example, resources found on the surface of cells and ECM markers are presented as fixed resources, whereas most others are presented as free.

ECM units may present identity markers as fixed resources as identity markers. In some embodiments, a category for “free” ECM resources may also be provided. Cells may deposit or remove such resources and a threshold for a particular resource that would cause the ECM unit to dissolve may be defined. This would allow cells to remove unwanted ECM.

In some embodiments, metabolic equations may treat reactant terms as consumed or not-consumed. Consumed is the default. Consumed terms can use only presented free resources, whereas non-consumed terms can use both presented free and presented fixed resources. Only resources used in a consumed term are consumed in the reaction.

### C2.2 Consumption of Resources in Metabolic Equations

To handle resource distribution between metabolic equations competing for limited (“overrequested”) resources, some embodiments utilize a two-pass resource distribution method. In the first pass, each equation is evaluated as if all resources are available to that particular equation. The limiting reagent is determined and the amounts of all other reagents that would be used are calculated. These “requested” amounts indicate each equation's relative capacity for consumption. After this pass through the equations, if there are any reagents that are overrequested, all reagents are scaled according to the demand from all equations so that each equation will be presented in the second pass with scaled amounts of each of its reagents appropriate to its relative demand and the available supply of each reagent. In the second pass, then, the transactions can actually occur with reagents being consumed and products produced. The two-pass approach is illustrated by the following, non-limiting examples.

Example A: Two Equations. First, an overrequested resource may be determined in a given set of two equations, for example:

2A+3B=X Equation 1:

2A+1C=Y Equation 2:

wherein resources A, B and C are each present in an amount or concentration of 2.0. Upon the first pass, each equation is evaluated independently as if all reagents are available. If all reagents were available to Equation 1, all 2.0 of B would be used. Therefore, resource B is the limiting resource in the first pass for Equation 1. Consequently, the following amounts of each resource would be used and produced:

(First Pass): 1.33 A+2.00 B=0.67 X. Equation 1:

If all reagents were available to Equation 2, all 2.0 of resource A would be used. Therefore, resource A is the limiting resource in the first pass for Equation 2. Consequently, the following amounts of each resource would be used and produced:

(First Pass): 2.00 A+1.00 C=1.00 Y. Equation 2:

After the first pass, the two equations request a total of 3.33 A, 2.0 B, and 1.0 C. As stated above, there is only 2.0 A, 2.0 B, and 2.0 C available, therefore A is overrequested because there would not be enough of A to supply both equations.

When a resource is overrequested, the system then scales all reagents based on the amounts available. The requested amount of each resource from each metabolic equation is multiplied by a scaling factor, N, such that the total amount requested is equal to the amount available. In the example above, the requested amount of A in each equation has a scaling factor, N_{A}, as represented in Scaling equation A:

$$\begin{matrix}From Equation 1 & From Equation 2 & Available \\ 1.33 {N}_{A} + & 2.00 {N}_{A} = & 2.00\end{matrix}$$

Solving for N_{A}, the scaling factor for resource A is 0.6. Similarly, the requested amount of B in each equation has a scaling factor, N_{B} as represented in Scaling equation B:

$$\begin{matrix}From Equation 1 & From Equation 2 & Available \\ 2.00 {N}_{B} + & 0.00 {N}_{B} = & 2.00\end{matrix}$$

Solving for N_{B}, the scaling factor for resource B is 1.0. Finally, the requested amount of C in each equation has a scaling factor, N_{C} as represented in Scaling equation C:

$$\begin{matrix}From Equation 1 & From Equation 2 & Available \\ 0.00 {N}_{C} + & 1.00 {N}_{C} = & 2.00\end{matrix}$$

Solving for N_{C}, the scaling factor for resource C is 2.0.

In the second pass of the equations, each equation receives its requested amount from the first pass multiplied by its scale factor to reach its scaled amount. Equation 1 has the following amounts of resources available to it:

| | Amount | | Scale | | Scaled |
|---|---|---|---|---|---|
| | Requested | | Factor | | Amount |
| Resource A | 1.33 | × | 0.6 | = | 0.8 |
| Resource B | 2.0 | × | 1.0 | = | 2.0 |
| Resource C | 0.0 | × | 2.0 | = | 0.0 |

Given the scaled amount available, A is now the limiting resource, and Equation 1 would use and produce:

(second pass): 0.8 A+1.2 B=0.4 X Equation 1:

Equation 2 has the following amounts of resources available to it:

| | Amount | | Scale | | Scaled |
|---|---|---|---|---|---|
| | Requested | | Factor | | Amount |
| Resource A | 2.0 | × | 0.6 | = | 1.2 |
| Resource B | 0.0 | × | 1.0 | = | 0.0 |
| Resource C | 1.0 | × | 2.0 | = | 2.0 |

Given the scaled amount available, A is the limiting resource, and Equation 2 would use and produce:

(second pass): 1.2 A+0.6 C=0.6 Y Equation 2:

In the second pass of both Equation 1 and 2, the limiting resource is A. After scaling, the two equations request a total of 2.0 A, 1.2 B and 0.6 C, with 0.0 A, 0.8 B and 1.4 C left over. Thus, the available amounts or concentrations are sufficient to cover the demand.

Example B: Three Equations. Second, an overrequested resource may be determined in a given set of three equations, for example:

2A+3B=X Equation 1:

2A+1C=Y Equation 2:

1B+1C=Z Equation 3:

wherein resources A, B and C are each present in an amount or concentration of 2.0. Like the two equation example, upon the first pass, each equation is evaluated independently as if all reagents are available. If all reagents were available to Equation 1, all 2.0 of B would be used. Therefore, resource B is the limiting resource in the first pass for Equation 1. Consequently, the following amounts of each resource would be used and produced:

(First Pass): 1.33 A+2.00 B=0.67 X. Equation 1:

If all reagents were available to Equation 2, all 2.0 of resource A would be used. Therefore, resource A is the limiting resource in the first pass for Equation 2. Consequently, the following amounts of each resource would be used and produced:

(First Pass): 2.00 A+1.00 C=1.00 Y. Equation 2:

If all reagents were available to Equation 3, all 2.0 of resources B and C would be used. Therefore, both B and C are limited equally in the first pass for Equation 3. Consequently, the following amounts of each resource would be used and produced:

(First Pass): 2.00 B+2.00 C=2.00 Z Equation 3:

After the first pass, the three equations request a total of 3.33 A, 4.00 B, and 3.00 C. As stated above, there is only 2.0 A, 2.0 B, and 2.0 C available, therefore resources A, B and C, are overrequested because there would not be enough to supply the three equations.

When a resource is overrequested, the system then scales all reagents based on the amounts available. The requested amount of each resource from each metabolic equation is multiplied by a scaling factor, N, such that the total amount requested is equal to the amount available. In the example above, the requested amount of A in each equation has a scaling factor, N_{A}, as represented in Scaling equation A:

$$\begin{matrix}From Equation 1 & From Equation 2 & From Equation 3 & Available \\ 1.33 {N}_{A} + & 2.00 {N}_{A} + & 0.00 {N}_{A} = & 2.00\end{matrix}$$

Solving for N_{A}, the scaling factor for resource A is 0.6. Similarly, the requested amount of B in each equation has a scaling factor, N_{B} as represented in Scaling equation B:

$$\begin{matrix}From Equation 1 & From Equation 2 & From Equation 3 & Available \\ 2.00 {N}_{B} + & 0.00 {N}_{B} + & 2.00 {N}_{B} = & 2.00\end{matrix}$$

Solving for N_{B}, the scaling factor for resource B is 0.5. Finally, the requested amount of C in each equation has a scaling factor, N_{C} as represented in Scaling equation C:

$$\begin{matrix}From Equation 1 & From Equation 2 & From Equation 3 & Available \\ 0.00 {N}_{C} + & 1.00 {N}_{C} + & 2.00 {N}_{C} = & 2.00\end{matrix}$$

Solving for N_{C}, the scaling factor for resource C is 0.67.

In the second pass of the equations, each equation receives its requested amount from the first pass multiplied by its scale factor to reach its scaled amount. Equation 1 has the following amounts of resources available to it:

| | Amount | | Scale | | Scaled |
|---|---|---|---|---|---|
| | Requested | | Factor | | Amount |
| Resource A | 1.33 | × | 0.6 | = | 0.8 |
| Resource B | 2.0 | × | 0.5 | = | 1.0 |
| Resource C | 0.0 | × | 0.67 | = | 0.0 |

Given the scaled amount available, B is the limiting resource and Equation 1 would use and produce:

(second pass): 0.67 A+1.0 B=0.33 X Equation 1:

Equation 2 has the following amounts of resources available to it:

| | Amount | | Scale | | Scaled |
|---|---|---|---|---|---|
| | Requested | | Factor | | Amount |
| Resource A | 2.0 | × | 0.6 | = | 1.2 |
| Resource B | 0.0 | × | 0.5 | = | 0.0 |
| Resource C | 1.0 | × | 0.67 | = | 0.67 |

Given the scaled amount available, A is the limiting resource and Equation 2 would use and produce:

(second pass): 1.2 A+0.6 C=0.6 Y Equation 2:

Equation 3 has the following amounts of resources available to it:

| | Amount | | | | |
|---|---|---|---|---|---|
| | Requested | | Scale Factor | | Scaled Amount |
| Resource A | 0.0 | × | 0.6 | = | 0.0 |
| Resource B | 2.0 | × | 0.5 | = | 1.0 |
| Resource C | 2.0 | × | 0.67 | = | 1.33 |

Given the scaled amount available, B is the limiting resource and Equation 3 would use and produce:

(second pass): 1.0 B+1.0 C=1.0 Z Equation 2:

After scaling, the second pass of Equations 1, 2 and 3, request a total of 1.87 A, 2.0 B and 1.6 C, with 0.13 A, 0.0 B and 0.4 C left over. Thus, the available amounts or concentrations are sufficient to cover the demand.

### C2.3 Reaction Multipliers

To reflect the different relative reaction rates of equations that compete for limited resources and to prevent complete consumption of limited resources in each step, a reaction multiplier can be applied to each equation. Reaction multipliers are applied as a scaling factor on the resource requests made by equations during resource distribution. An example process that may benefit from the use of a reaction multiplier is the transport of resources into and out of a cell. The transport mechanism includes a surface resource representing a channel in a cell membrane, which allows certain resources in or out of the cell. In some embodiments, a particular resource may be used in a competing equation to block a channel by competing for the surface channel resource, allowing less of the transported resource through. thout using reaction multipliers, metabolic equations competing for a shared resource such as a transport channel have nearly equal demand, or affinity, for the shared resource, making it difficult to tie up more than half of the shared resource through a blocking equation.

In the absence of reaction multipliers, where the multiplier on each equation is effectively 1.0, 1) all of a reactant will be consumed in one step if it is a limiting factor regardless of how much there is, 2) a limiting factor can block at most (n−1)/n in an equation where n is the number of equations that limiting factor is in as a limiting factor, and 3) all metabolic equations react at the same rate. On the other hand, by adding one or more reaction multipliers, there may be some reactant left over (if the reaction multiplier is less than 1), one equation may “tie up” more than 1/n of a limiting factor (by using ratios of equation multipliers), and equations can be weighted so that some react more rapidly (or use up resources more quickly) than others.

As described above in C2.1, metabolic equations are evaluated according to a two-pass approach that comprises three steps. First, the limiting factors are determined for each equation based on the full amounts of all resources in each equation and request the amounts needed based on the limiting factor. The limiting factor will always have a request from each equation of 100% of the available resource. Second, requests from all equations are gathered, and if any resource is overrequested, then a scaling factor is computed as existing/requested. Third, the scaling factor is applied to previous requests, the limiting factor is recalculated based on the scaled availability, and the consumption and production is calculated based on the new limiting factor.

Applying a reaction multiplier changes only the first of the three steps described above. The maximum first requests from the equation are scaled by the reaction multiplier. If the multiplier is less than 1 then the request for the limiting factor would be less than 100% of the available amount. If the reaction multiplier is greater than 1 then the request will be greater than 100%, but the second scaling step takes care of any excess requests.

There are several effects of reaction multipliers. Using a reaction multiplier (X) less than 1, a single equation will produce X times the amount of product that would have been produced had the multiplier been 1, and will leave (1−X) times the amount of reactants that were available to start with. Using a reaction multiplier greater than 1 has no effect on a single equation unless there are shared resources with other equations (the full amount of consumption and production will occur).

As a non-limiting example, in a system of two given equations, one of the equations can be used to block another under these circumstances in the following manner:

aA+bB=cC, wherein A, B and C are resources, a, b and c are coefficients, and a first ReactionMultiplier=X. Equation 1:

aA+dD=eE, wherein A, D and E are resources, a, d and e are coefficients, and a second ReactionMultiplier=Y. If (X+Y)≦1 then the equations cannot block each other, but if (X+Y)>1 then: Equation 2:
when no D is present and A is the limiting factor in equation 1, output of C is cX(A)/a when X<1 and c(A)/a when X≧1,
when D is present and causes A to be the limiting factor in equation 2, output of C is cX(A)/(a(X+Y)), and
During maximum blockage, C output is reduced to the maximum output*X/(X+Y)

### C3. Metabolism and Energy Use

Cells require a continual input of energy to survive, grow, and maintain their highly ordered state. Energy is used for many purposes in living organisms, including performance of mechanical work in muscle contraction and other cellular movements, active transport of molecules and ions, and synthesis of macromolecules and other biomolecules from simple precursors. These processes maintain an organism in a non-equilibrium state (Berg et al., 2002).

Forms of energy stored or used in a living cell include (1) mechanical energy, for muscle contraction and other movements; (2) electrochemical gradients, in the form of unequal distribution of ions or solutes across a membrane; (3) chemical bond energy, for synthesis of macromolecules from simple precursors; (4) light, either captured (photosynthesis) or produced (bioluminescence); and (5) heat, as a byproduct of conversion of energy.

To produce and store needed energy, a cell breaks down or otherwise utilizes molecular or any other types of resources using the process of metabolism. For example, the conversion of molecules from food into forms of energy and building blocks that animal cells can use is one example of a metabolic process. In most metabolic processes (including gene transcription and translation processes), energy is required to convert resources from on form to another, or to transport resources from one location to another. Energy used by cells for these processes is frequently bound in high-energy molecules, such as adenosine-5′-triphosphate (ATP).

Through digestive processes, macromolecules from food are broken down into simpler compounds that most cells consume as nutrients. Within the cell, nutrients are further broken down through oxidation to yield ATP or other high-energy molecules that can drive energetically unfavorable synthesis of macromolecules (e.g. DNA replication, transcription, protein synthesis, and glycogen biosynthesis). Metabolism may also yield some heat which may keep animals warm in cold conditions, or be lost to the environment.

Like living cells, virtual cells may undergo metabolic processes according to embodiments of the disclosure. Metabolic functions of virtual cells may depend on, or ultimately have an influence on metabolic resources, metabolic equations, gene expression, action capacities or rules, cell properties, production or destruction of ECM, and any other applicable cellular process.

### C3.1 Metabolic Resources

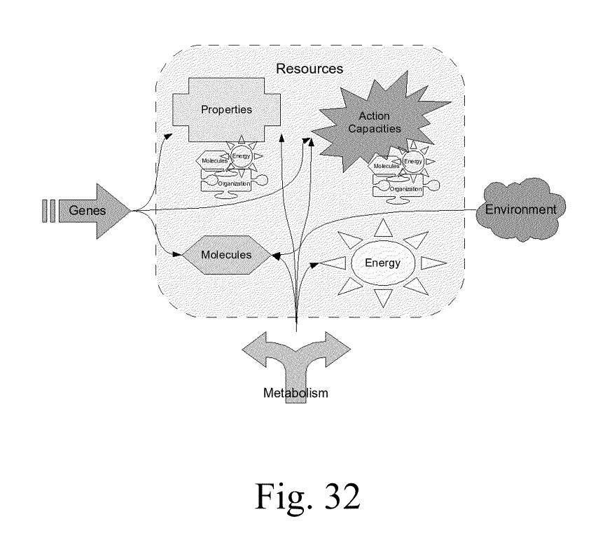

As illustrated in FIG. 32 (Alberts et al., 2002), there are several cellular and environmental resources that may be affected by or utilized by metabolic processes. Therefore, according to embodiments of the disclosure, energy, cellular properties and action capacities may be treated as a resource (i.e., in the same category with molecules) because the abstractions of these resources can be handled according to similar rules, i.e., they are produced and they decay in the same way and we track their amounts and concentrations. To distinguish properties and action capacities from “real” molecules, we have applied special rules to these abstractions. Based on the 1^{st} Law of Thermodynamics and E=mc², it is reasonable to lump matter and energy together and to allow conversion between matter and energy. In addition, genes, by way of transcription, assembling and transporting RNA, and translating and assembling proteins, are also energy and resource intensive processes (Alberts et al., 2002).

In one embodiment, molecular or “regular” resources are of the general-purpose type that may be used as transcription factors, external signals, surface markers, adhesion molecules, metabolic regulators, ECM precursors, triggers for cell actions, etc. Further, promoted genes can produce a “template” resource which is analogous to transcribed RNA. By default, template resources decay completely at the end of the step in which they are produced. However, a template resource explicitly defined in the resource catalog can be assigned a decay rate like regular resources. Each of these resource types includes some notion of energy. All virtual molecules, whether imported from the environment, transcribed from genes, or produced through metabolic reactions, decay over time according to their configured decay rates. In some embodiments, the decay rate can be 0.0 such that a resource does not decay. Ongoing effort (i.e., energy expenditure) is thus required simply to maintain a given concentration. This is consistent with biologically-driven turnover, the natural decay of order (i.e., 2^{nd} Law of Thermodynamics), and the subsequent necessity of utilizing energy to create or maintain order.

In some embodiments, property resources such as rigidity, plasticity and elasticity may be tied to concentrations of specialized resources. In other embodiments, however, property resources could be calculated based on concentrations of monitored resources or other suitable properties that would produce similar or analogous effects. Resources contributing to cell rigidity could be associated with the rigidity property in a list. For example, as the concentration of the monitored resource increases, rigidity would increase at the specified rate. Another resource may be specified to detract from rigidity with increasing concentration by specifying a negative rate.

In one embodiment, an energy cost can be associated with the process of gene expression. Furthermore, while the process of transcription may not consume resources directly, downstream metabolic reactions consume reactants, thereby demanding ongoing transcription. In a specific example, the processes of transcription and translation can be separated. For example, a transcribed gene unit product can be a template resource (described above) analogous to ribonucleic acid (RNA). The RNA resource and energy resource can be reactants in a metabolic equation that produces the specified gene unit product. Unless reactants are explicitly preserved (as in the case of enzymes or transporter molecules), they must be replenished from another source. There is also competition among reactions for limited resources. Taking in resources from the environment requires establishment and maintenance of embedded surface transport molecules, which are subject to decay and recycling. Increased cell size demands increased uptake and production to maintain appropriate concentrations.

Action capacities (e.g., Division, Growth, and Death) are resources that encompass all of the special molecular accumulation, energy conversion, and organizational preparations necessary for the specified actions to take place. When an action occurs, an action capacity resource is consumed. To repeat an action, its capacity must be rebuilt. For example, in vivo cell division involves substantial energy expenditure. Prior to cytokinesis, a cell must replicate its DNA, replicate and segregate critical organelles such as mitochondria, form the mitotic spindle, and segregate chromosomes. By incorporating these many activities into a single resource, genes producing action capacities are effectively complex gene collections that represent the complex networks responsible for these processes in vivo. Consolidation of multiple components as complex gene collections enhances focus on the networks of interest and improves simulation performance.

In accordance with one embodiment of the disclosure, energy in any form can be treated as a resource and function in the same manner as other resources. Energy resources can be consumable reactants in any metabolic equation, thereby creating competition for energy resources among potential cellular process, and limiting metabolism based on energy availability. There is no need to handle energy differently than molecules, because unused energy, for example, can decay according to the same rules as molecules because cellular energy is often stored in molecular form. Modeling energy in this manner is accomplished by the user appropriately distinguishing between different resources in the configuration.

In another embodiment, energy may be introduced as a new resource representing usable energy such that all of the ways cells might store or use energy are reduced to one abstraction. Available energy (Eᵢ) would be produced by converting some molecular resource(s) to Eᵢ in one or more metabolic equations, analogous to conversion of nutrients to energy in a cell. All metabolic equations could include an energy factor with a coefficient as a reactant and as a product (Coefficients are ≧0; the default coefficient=0.). Reactant-side Eᵢ represents activation energy or energy required to drive an energetically unfavorable reaction. Product-side Eᵢ represents usable energy produced or reclaimed by an energetically favorable reaction. This approach distinguishes energy from molecules and lays groundwork for adding distinct energy forms in the future, such as heat or gradients.

Forms of energy, energy-carrying molecules, and their related processes within cells are well studied. Thus, in another aspect, analogues of at least the major forms of cellular energy may be created (e.g., ATP, NADH, NADPH, glucose/glycogen, fatty acids/fats, ionic gradients, heat, etc.) within the platform. Although analogues can also be created using a more flexible approach, advantages of explicitly modeling multiple forms of energy include presenting familiar named abstractions for biologists and the ability to fine-tune each abstraction to match its real-world counterpart for detailed fidelity of simulation.

### C3.2 Metabolic Organization

In accordance with embodiments of the disclosure, a virtual cell may be modeled as a collection of one or more cellular subunits (“subunits”) with both physical and metabolic roles. Subunits may be physically represented as spheres (“subspheres”) defining a cell's volume, mass, shape, and location, with connections between spheres providing a cell's mechanical properties: elasticity, rigidity, and plasticity. For the purpose of the disclosure, the terms subunits and subspheres will be interchangeable unless specified otherwise. Cellular subunits also provide attachment points for intercellular adhesions between cells, adhesions between cells and ECM, or other entities in the environment. In some embodiments, a cellular subunit may be another shape, such as a cube, diamond, heart, club, spade, etc. The physical constraints of a cell, its cellular subunits and associated physical properties are discussed further below in Section D.

### C3.2.1 Cellular Metabolism

A cell's resource contents and metabolic processes may be computed at the cell level or subunit level. Internal, surface, and external resources may be treated as separate pools, and individual subunits may have their own independent pools of resources or be temporarily assigned a subset of the contents of cell pools to enable recognition of locations of high signaling activity and improve signaling fidelity.

In some embodiments, during a metabolic step (discussed further below), a cell may obtain a “map” of the external resources available at each position represented by one of its spheres and the cell then divides its internal and surface resources by the number of spheres to calculate a per sphere amount. For each set of external resources, the cell carries out one iteration of metabolism on behalf of each sphere. Resources consumed or produced during each iteration are removed from or placed in the cell's internal or surface resource pools, wiping out any potential differences in distribution after metabolism. When external resources are produced by metabolism, the cell builds a map of resource amounts and locations to be made available to other cells during a subsequent step.

In other embodiments, cellular metabolism is computed at the cellular subunit level. Thus, metabolism is divided across metabolic subunits, with each metabolic subunit associated with a cellular subunit. Each subunit is responsible for its local resource contents and executes metabolic equations, signaling, and adhesion independently, based on its particular contents and position. Subunit-level metabolism enables localized variations in metabolism to be maintained (i.e. regional distinctions in contents) and utilized across simulation steps for polarization and functional specialization.

Metabolism carried out at the subunit level leads to a more biologically sound model, because cells are not homogeneous entities with uniform contents and organization throughout. Instead, regional differences in contents and organization within a cell enable cell shaping, orientation and polarity, directed movement, targeted signaling, and other specialized cell functions and are, therefore, characteristic of differentiated cells. For instance, the axon of a nerve cell is specialized for propagating impulses while the cell body and dendrites are specialized for receiving signals.

Accordingly, the distribution of resources responsible for metabolic processes should be non-uniform. In living cells such as epithelial cells, non-uniform distribution of resources plays a role in the cell polarity. The plasma membrane of an epithelial cell has distinct apical and basolateral domains separated by a ring of tight junctions (Alberts et al., 2002). The apical domain may include specialized structures such as cilia for movement or microvilli for nutrient uptake while the basal domain is rich in Na, K ATPase “pumps”, and molecules that anchor the cell to the basement membrane. Desmosomal adhesions between epithelial cells provide anchorage internally to cytoskeletal filaments and reinforce the bond between adjacent cells.

Each virtual cell's or sphere's profile of available external molecules allows the cell to make directional decisions for ECM placement and choosing a division plane based on surface activity in the current step (see below). In some embodiments, a cell can have uniform distribution of all resources and thus directional decisions for Division and ECM production can be made relative to a “location of highest activity” map based on the percent of an available surface molecule consumed. In other embodiments where metabolism is carried out on a subunit level, there is an asymmetric distribution of resources. Rather than cells having a “location of highest activity,” subunits with asymmetric distribution make directional decisions based on the “location of highest concentration” for a resource, where concentration combines internal and surface concentrations. Additionally, orientation can be based on recognizing consumption of a surface reactant in a single step, or may also be based on recognizing accumulated results of reactions over many steps.

### C3.2.2 Gene Expression

The cell as a whole is responsible for gene transcription based on total concentrations of internal resources across all subunits. Gene expression should include, but is not limited to, proportional resource consumption and product distribution without requiring global scaling factors and distribution calculations. Transcription and translation in vivo are not part of a single process. Therefore, in some embodiments, gene expression may be separated into transcription and translation phases, providing a more explicit approach and allowing the user to manipulate independently the turnover rates of a protein and its template RNA.

To account for separate transcription and translation processes, promotion and transcription may be based on mean concentrations of internal molecules and gene products may be distributed uniformly throughout the cell. Gene products are not, in this embodiment, encoded proteins, but are template resources analogous to RNA. RNA is not generally destroyed during translation and a strand of RNA may be translated multiple times. However, RNA strands do decay over time and nucleotides are reclaimed and reused to assemble new strands. According to some embodiments, template resources do not appear in any user-defined equation during the normal course of metabolism. Instead, translation may be modeled by allowing decay alone to reduce template resource availability.

In some embodiments, template resource decay rates may be configurable by allowing direct inclusion of fully-specified templates in the resource catalog or by adding a decay rate property to the definition of each template. Disruptions to RNA pathways, however, may be modeled through inclusion of template molecules in user-defined equations. Furthermore, viral infection could be modeled as a template molecule and translation equation injected into a cell.

In some embodiments, energy requirements (or “expression costs”) may include costs for expression in gene assemblies. In addition to regulatory and structural regions, gene assemblies could have an associated list of required resources. Specified quantities of one or more resources (with coefficients) in the list would be required to transcribe each unit of structural products. Promotion of the regulatory region determines the upper bound of transcription and, when promotion is positive, acts as a multiplier on resource coefficients for calculating resource demands. Metabolic equations and genes would then have to compete for all required resources using an algorithm similar to the one described for consumption of reactants in metabolic equations.

In other embodiments, expression costs may include costs associated directly with the resource catalog. Including resource costs in gene assemblies is justified because the cost of producing a protein is indirectly encoded by genes. Each structural gene is transcribed to an RNA strand which is translated into a protein via direct chains of events with associated energy costs. Therefore, the association belongs with the resource definition itself (in the resource catalog) such that a protein encoded by a structural gene always carries the same cost. In other embodiments wherein resources are not produced through the genome, transcription and translation costs are irrelevant.

In some embodiments, a set of translation equations would be required in cellular subunits in addition to user-defined metabolic equations. In some embodiments, these translation equations may be auto-generated for all structural gene products based on resource and cost associations. Translation processes would compete for resources directly with metabolic equations in each cellular subunit.

### C3.3 Resource Mobility

Membrane-bounded organelles (mitochondria, lysosomes, vesicles, etc.) are one way that cells segregate and concentrate their contents, but metabolism may differ from one cytoplasmic domain to another simply by involving different molecules with restricted mobility. In general, passive mobility of intracellular molecules is inversely proportional to their size. Passive (down gradient) movement of molecules is often modeled as diffusion, a process based on random collisions, even though the cytoplasm is very crowded and much of the water is bound rather than in bulk solution (Ellis, 2001). Other factors may contribute to passive mobility of resources. For instance, when a molecule becomes incorporated into a complex, mobility may be reduced, both by incorporation with a larger structure, or by anchorage to a membrane or components of the cytoskeleton. Varied domain composition and internal structure may also result from directed transport of internal molecules (Alberts et al., 2002).

### C3.4 Intracellular Resource Redistribution

Redistribution of resources between intracellular subunits is a responsibility of the virtual cell as a whole. Compartmentalization of metabolism by cellular subunits may sometimes result in complete exhaustion of some resources in active subunits while the same resources may accumulate in inactive subunits. In some embodiments, an algorithm to model redistribution of resources from subunits with high concentrations to subunits with low concentrations may be included. Redistribution of resources between subunits may also be coordinated according to redistribution rates specified for each resource in the resource catalog. Analogous processes in vivo include diffusion, facilitated diffusion, and movement of some intracellular particles, but does not subsume active transport, secretion of vesicles, cytoplasmic streaming, or other active processes.

According to some embodiments, internal resources redistributed at different rates based on size and electrochemical properties. Surface molecules embedded in the plasma membrane are not as readily redistributed, but may also slowly intermix in the plane of the lipid bilayer. Redistribution rates, therefore, may be configurable as a property of particular resources in the resource catalog.

A redistribution rate property may be assigned in some embodiments for each resource defined in the resource catalog. After all subunits have completed their local metabolic processes and ECM has been produced and placed by the cell, each subunit will multiply its amount of each internal resource by its corresponding redistribution rate and remove this amount from the local resource pool for placement in neighboring subunits.

In some embodiments, resource redistribution rates may range from 0.0 to 1.0. By default, resources each have a redistribution rate of 1.0, such that an internal resource is uniformly redistributed across all subunits at the end of a metabolic step. If a lower value is specified, however, a lower percentage of each subunit's amount of that resource is redistributed. At 0.0, the internal resource is not redistributed and the resource does not move between subunits. Surface resources may or may not be redistributed in every embodiment. The cell will accumulate the resources marked for redistribution (M1, M2, M3 in the example below) from all subunits and redistribute them across all subunits. An example of redistribution is as follows:

| Resource | Redistribution Rate |
|---|---|
| M1 | 1.0; |
| M2 | 0.5; |
| M3 | 0.0; |

M1 will be uniformly redistributed after each step. 50% of M2 content from each subunit will be redistributed after each step. M3 doesn't move.

An example of the contents before redistribution in a 3 subunit model:

| Resource | S1 | S2 | S3 |
|---|---|---|---|
| M1 | 1.0 | 0.5 | 0.0 |
| M2 | 1.0 | 0.5 | 0.0 |
| M3 | 1.0 | 0.5 | 0.0 |

Subunit contents after redistribution:

| Resource | S1 | S2 | S3 |
|---|---|---|---|
| M1 | 0.5 | 0.5 | 0.5 |
| M2 | 0.75 | 0.5 | 0.25 |
| M3 | 1.0 | 0.5 | 0.0 |

Example calculations for M2 redistribution. Each subunit calculates M2 to remove from its contents for redistribution:

From S1: 1.0*0.5=0.5

From S2: 0.5*0.5=0.25

From S3: 0.0*0.5=0.0

Cell accumulates M2 for redistribution:

0.5+0.25+0.0=0.75

Cell divides accumulated M2 by number of subunits:

0.75/3=0.25

Cell distributes M2 to all subunits:

S1: 0.5+0.25=0.75

S2: 0.25+0.25=0.5

S3: 0.0+0.25=0.25

Another example redistribution scheme allows some sustainable asymmetry without completely isolating contents of one subunit from others results from distributing half of every subunit's contents uniformly across all other spheres.

An example of the contents after metabolism in a 3 Subunits Example:

| Molecule | S1 | S2 | S3 |
|---|---|---|---|
| A | 1.0 | 0.5 | 0.25 |
| B | 0.0 | 0.0 | 1.0 |
| C | 1.0 | 1.0 | 1.0 |
| D | 1.0 | 1.0 | 0.0 |

An example of the contents after redistributing 50% of each subunit's contents across other subunits:

| Molecule | S1 | S2 | S3 |
|---|---|---|---|
| A | 0.6875 | 0.5625 | 0.5 |
| B | 0.25 | 0.25 | 0.5 |
| C | 1.0 | 1.0 | 1.0 |
| D | 0.75 | 0.75 | 0.5 |

An example of the contents after metabolism in a 5 Subunits Example:

| Molecule | S1 | S2 | S3 | S4 | S5 |
|---|---|---|---|---|---|
| A | 1.0 | 0.75 | 0.5 | 0.25 | 0.0 |
| B | 0.0 | 0.0 | 0.0 | 0.0 | 1.0 |
| C | 1.0 | 1.0 | 1.0 | 1.0 | 1.0 |
| D | 1.0 | 1.0 | 1.0 | 1.0 | 0.0 |

An example of the contents after redistributing 50% of each subunit's contents across other subunits:

| Molecule | S1 | S2 | S3 | S4 | S5 |
|---|---|---|---|---|---|
| A | 0.6875 | 0.59375 | 0.5 | 0.40625 | 0.3125 |
| B | 0.125 | 0.125 | 0.125 | 0.125 | 0.5 |
| C | 1.0 | 1.0 | 1.0 | 1.0 | 1.0 |
| D | 0.875 | 0.875 | 0.875 | 0.875 | 0.5 |

In vivo active mechanisms, such as ATPase pumps, also effect redistribution of particular resources, and such mechanisms may be modeled by using an algorithm based on “affinity for” or “affinity against” relationships to counteract passive, down-gradient movement toward uniformity.

In other embodiments, a fluid model such as those described herein may be employed to allow for realistic resource distribution and consumption in the environment. Fluid models can provide an environment in which resources are limited and cells must regulate resource uptake for the survival of the tissue or organism as a whole. Resource point sources (as described in section E5. below) can be placed in the environment and configured to release resources into contacting fluid. External resources, then, would move through the fluid and be taken in by cells with corresponding receptors in the same way cellular signals are diffused and received.

### C3.5 Consumption of Distributed Action Resources

In one embodiment, resources for cell actions such as growth, division, and ECM production are consumed according to their distribution. A cell can pass information on total resources to be consumed and the total availability to each subunit. Each subunit monitors its local availability and can calculate its contribution to the total. Therefore, each subunit can calculate how much of its local precursor amount to consume.

For a 2-subunit cell (S1, S2) where 1 ECM unit is produced for each 1 ECMPrecursor unit, a consumption example follows:

| Subunit | ECMPrecursor (prior to ECM production) |
|---|---|
| S1 | 1.50 |
| S2 | 0.25 |

Cell accumulates ECMPrecursor.
Total ECMPrecursor == 1.75
Cell can make 1 ECM unit with 0.75 ECMPrecursor left over.
Cell notifies S1 that 1 ECMPrecursor unit is to be consumed and the
total ECMPrecursor was 1.75.
S1 calculates its proportional contribution to the total as
1.5/1.75 = 0.857.
S1 consumes 0.857*1.0 = 0.857 ECMPrecursor.
Cell notifies S1 that 1 ECMPrecursor unit is to be consumed and the
total ECMPrecursor was 1.75.
S2 calculates its proportional contribution to the total as
0.25/1.75 = 0.143.
S2 consumes 0.143*1.0 = 0.143 ECMPrecursor.

| | |
|---|---|
| Subunit | ECMPrecursor (after ECM production) |
| S1 | 0.643 |
| S2 | 0.107 |

In addition to of consumption of ECM, this method may be applied for consumption of growth and division trigger resources.

### C4. Action Rules

In one embodiment, the simulation system can be configured with specific, pre-defined action resources that trigger action rules. For example, resources representing capacity for cell growth, cell division and cell death, as well as resources to control passive physical properties of cells (and other objects), such as rigidity, elasticity and plasticity, can be initially provided, produced from a promoted gene unit, or created by a metabolic equation.

In another embodiment, special action resources may be removed from the model as part of carrying out the action. According to such an embodiment, an action can be associated with one or more trigger and direction reference resources from the user-defined resource catalog (described below with respect to the simulation configuration file). Accordingly, the system can accommodate action rules that require or are configured to be satisfied by any number of resources alone or in combination.

Cellular actions, such as division, growth and death can be high-order outcomes of complex underlying processes, and in biology, there may be multiple alternative pathways or mechanisms involved in achieving the cellular phenotype or behavior. By accommodating multiple trigger resources that may be associated with different independent pathways to satisfy action rules, such biological complexity can be simulated. For example, several different growth factors can be produced through independent pathways depending on the cell's current state. An action rule provided for cell growth can be configured to be satisfied by any one of or a combination of the growth factor resources. Likewise, many factors from natural degradation of the internal cellular “machinery” to signals form the other cells to toxin exposure may result in cell death with varying ancillary effects on the state of the cell. For any action rule, an upper bound on the trigger concentration may be specified and, for death rules, a lower bound representing lack of a critical resource may also be specified.

### C5. Resource Monitors

Living cells with insufficient energy to sustain critical metabolic processes must respond to their condition or they decline and die. Virtual cells need some way to similarly recognize and detect starvation conditions and respond appropriately.

In some embodiments, a named energy resource, such as Eᵢ, and cells could monitor availability of Eᵢ (or any other suitable energy resource) directly and compare it against configured thresholds. Alternatively, independent resource monitor molecules, such as “Health” or “StayAlive”, could be specified and tracked. If no named energy abstraction exists, such a mechanism is required. A benefit of tracking “monitor molecules” is that they may also serve as transcription factors to initiate low-health responses.

For an energy resource monitor molecule to work, each cell must be responsible for maintaining some concentration of the monitor molecule through a process requiring energy resources. Assuming these resources are common to other critical processes, if the cell is incapable of maintaining the monitor molecule, it indicates a general inability to sustain necessary metabolic activities.

According to one embodiment, a fatal minimum threshold may be configurable for an energy resource monitor molecule. When concentration of the monitor molecule drops below the fatal threshold and remains there, the cell will die of starvation. Although in some embodiments, a cell is programmed to die by apoptosis, death by starvation is independent of death by apoptosis. A cell may be allowed several steps to recover, to prevent death from occuring following an exceptional event from which the cell can recover. Alternatively, a slow decay rate on the monitor molecule would reduce sensitivity to temporary dips in resource availability.

In another embodiment, monitored resources may include a fatal threshold for both lower and upper bounded molecules. Some molecules may cause cell death if their concentrations are too low (lower bounded), others may cause death if they are too high (upper bounded), and others must remain within a specific range. Multiple independent death pathways may be created, obviating the need for a specialized “death” action capacity resource. In such embodiments, lists of bounded resources may be used to replace specialized action capacity resources (see section E3.6.12). Growth and division, like death, could be triggered by monitored molecules. Using unspecialized resources rather than specialized action capacity molecules allows for increased user control during the simulation by enabling multiple pathways for each action and by allowing specification of resource properties such as decay.

Dead cells don't just instantly disappear. The way that cells die affects what they leave behind. The term “apoptosis” can refer to any cell death triggered by a threshold resource, most often from gene expression. Since cells that die from apoptosis go through an organized clean-up process before “disappearing”, dead cells can be removed leaving no trace. In another embodiment, a cell can die by necrosis, e.g., death by physical trauma, “messy death”, etc. The result of death should be the natural product of the conditions that led to death.

A “removal delay” resource can be specified. Once a cell has died and the concentration of a configured removal trigger resource has dropped to 0 (or below some threshold) the cell is removed from the simulation and any remaining contents are dumped into the environment. For an apoptotic cell, pathways can be included that ensure that the delay resource is sufficiently high at the time of cell death and cleanup processes are in place such that there are no inflammatory contents left in the cell when it is removed. A cell that is killed involuntarily, on the other hand, would not necessarily have had time to build up the delay resource or organize clean-up conditions prior to death, resulting in more of the cell's internal contents remaining in the environment after its removal.

### C6. Example Signaling and Gene Regulatory Network

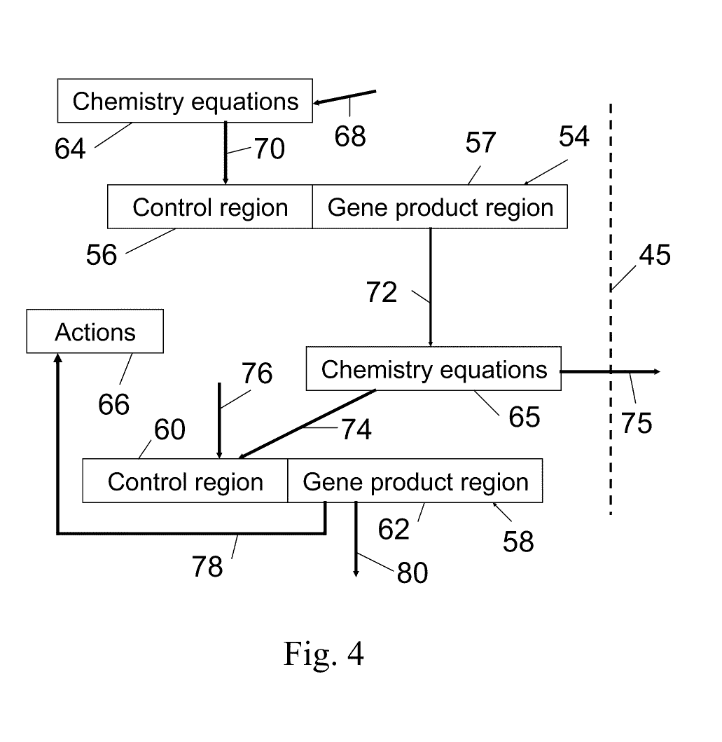

FIG. 4 is a schematic flow diagram illustrating interactions between gene units within a virtual cell in accordance with an embodiment of the disclosure. For example, FIG. 4 illustrates two gene units within a cell, whose “outer membrane” (e.g., abstract separation between the interior and exterior of a cell), is indicated at 45. A first gene unit 54 has a gene control region 56 and a gene-product region 57. In this example, the first gene unit 54 generates a gene product that, in turn, can affect a second gene unit 58. As shown in FIG. 4, the product of the first gene unit can interact with a control region 60 of the second gene unit 58 to, for example, promote the second gene unit and thereby generate 80 a second gene product as indicated by the code of the gene-product region 62. In the example illustrated in FIG. 4, the second gene product invokes a specific action rule 66, and thereby triggers a cell-based action (e.g., cell growth, cell division, etc.).

To expand on the example illustrated in FIG. 4, assume a cell encounters an intracellular signal 68 which is transformed through first metabolic equation(s) 64 to produce 70 an intracellular resource that has an affinity with the control region 56 of the first gene unit 54 for generating 72 a first product resource. The first product resource can trigger a second metabolic equation 65 for generating 74 another resource having affinity to the control region 60 of the second gene unit 58. In one example, the presence of resource generated at 74 is the result of the presence and/or availability of first product resource and an interaction 75 between the cell of interest and a neighbor. Thus, if gene unit 58 in FIG. 4 corresponds to GENE UNIT 3 listed in Table 1 in section C.1 above, the gene control region 60 responds to the presence of both DiffuseNutrients (indicated by directly presented resource 76), and NeighborPresent, indicated by resource 74, to produce 80 a second gene product which is accumulated 78 in accordance with cell behavior actions 66 to cause the cell to grow, for example. The same general mechanisms of gene unit control, metabolic-interaction rules and action rules can apply to GENE UNIT 4 (see Table 1) for cell division, for example. In another embodiment, GENE UNIT 1 (see Table 1), which controls cell adhesion events, can operate using similar gene regulatory mechanisms. One of ordinary skill in the art will recognize that gene units can operate using a variety of parameters and input. For example, GENE UNIT 1 may not require the presence of NeighborPresent.

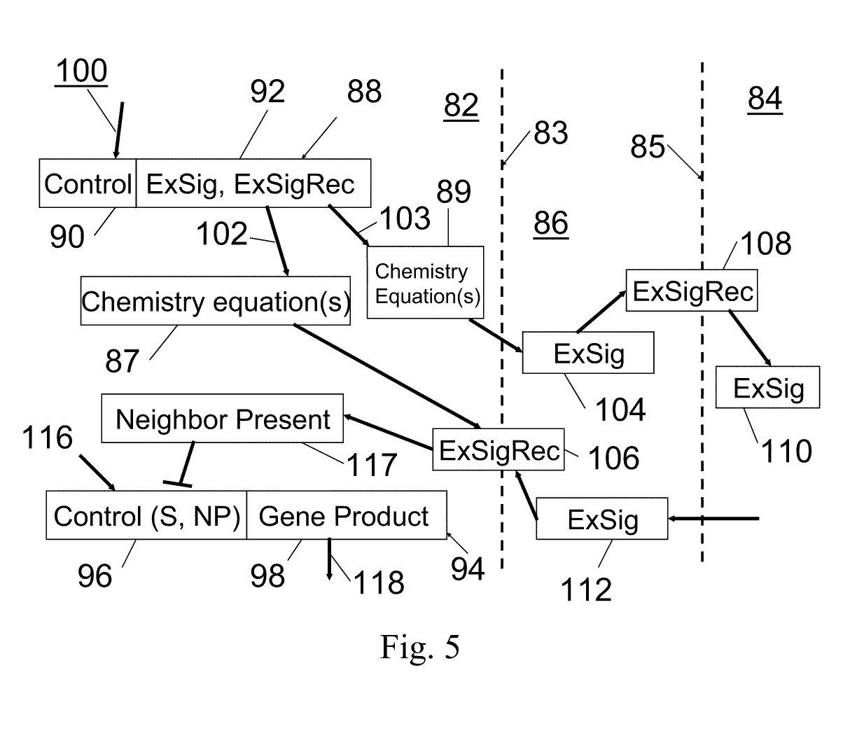

FIG. 5 is a schematic flow diagram illustrating interactions between gene units and gene unit products within a virtual cell and in a neighboring virtual cell in accordance with an embodiment of the disclosure. For example, continuing with the GENE UNIT examples listed in Table 1, FIG. 5 illustrates how GENE UNIT 2 (see Table 1) present in neighboring cells leads to intercellular signaling. The two cells, with their interior environments, are indicated at 82 and 84 and separated by outer “membranes” 83 and 85 to define an intercellular space 86 between the two cells.

Referring to FIG. 5, virtual cell 82 contains gene unit 88. In one embodiment, gene unit 88 can be substantially similar to GENE UNIT 2 (see Table 1) and be configured to produce a gene product resource for signaling and/or receiving signals to/from a neighboring virtual cell 84. Neighbor cell 84 may also contain a gene unit (not shown) substantially similar to gene unit 88 for producing a gene product resource for signaling and/or receiving signals to/from the virtual cell 82, among others. Gene unit 88 includes a control region 90 which can be responsive to DiffuseNutrients, and a gene product region 92. Upon promotion 100 of gene unit 88 by the presence of DiffuseNutrients gene unit 88 generates 102 and 103 both ExistanceSignalReceiver and ExistanceSignal resources. One or more metabolic equations 87 (e.g., EQ 5 listed in Table 2 in section C.2 above) can be used to simulate transportation of the ExistanceSignalReceiver to position 106 at the outer membrane 83 of the cell 82. Once the ExistanceSignalReceiver is at position 106, it can trigger a second metabolic equation (not shown in FIG. 5; e.g., EQ 6 listed in Table 2) with external ExistanceSignals 112 from one or more neighboring cells 84. The second metabolic equation can trigger the generation of NeighborPresent resource 117 that can, in turn, act on gene unit 94.

A third metabolic equation 89 (e.g., EQ 4 listed in Table 2) can trigger a move 103 of the ExistanceSignal (e.g., if a GenericExporter is also present), from inside cell 82 to the intracellular space 86 at location 104. In this example, ExistanceSignal 104 can interact with ExistanceSignalReceiver 108 on the outer membrane 85 of neighboring cell 84. Accordingly, ExistanceSignal can be further moved into cell 84 at location 110.

In one embodiment, gene unit 94 can be substantially similar to GENE UNIT 3 (see Table 1). Gene unit 94 can include a gene control region 96 and a gene product region 98. In this example, the gene control region 96 can be inhibited by NeighborPresent 117 and responsive 116 to a DiffuseNutrient resource. In one embodiment, the DiffuseNutrient resource can be a resource configured to trigger cell growth or division, through action triggered 118 by gene unit product resources. In one embodiment, metabolic equations EQ4 through EQ6 (listed in Table 2), along with gene units 88 and 96, can provide resemblance to intercellular signaling between neighboring cells for inhibiting cell growth and division. In other embodiments, additional gene units can be provided for simulating intercellular signaling and/or other modes of cellular signaling.

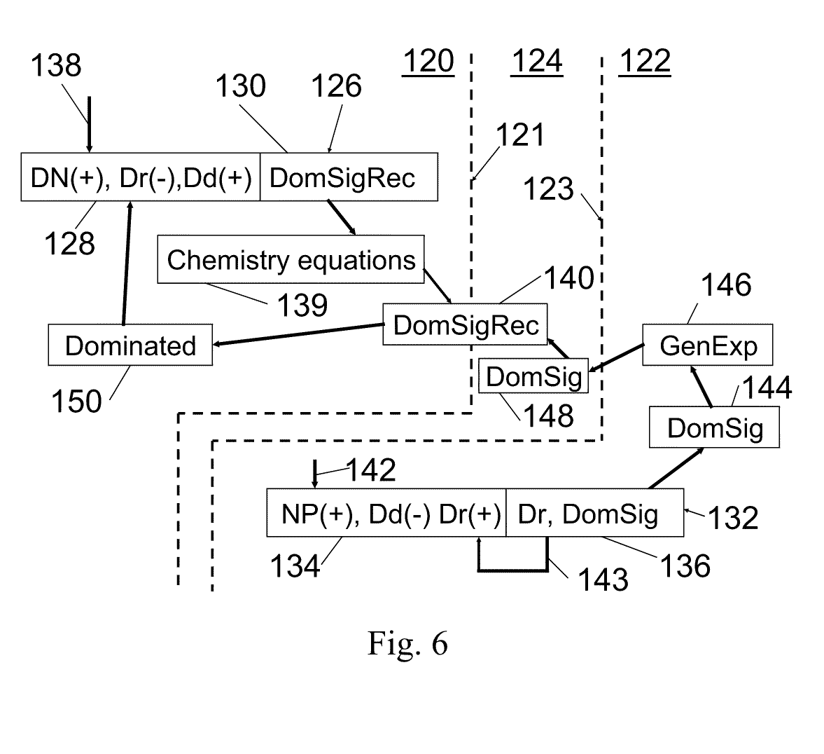

FIG. 6 is a schematic flow diagram illustrating interactions between genes units and gene unit products capable of establishing cell state in a virtual cell and in a neighboring virtual cell in accordance with an embodiment of the disclosure. For example, continuing with the GENE UNIT examples listed in Table 1, FIG. 6 illustrates how gene units (e.g., GENE UNIT 5 and GENE UNIT 6 listed above in Table 1) present in a virtual genome can influence a change in the relative status of two neighboring virtual cells. In some embodiments, the mechanism illustrated in FIG. 6 can be self-reinforcing, such that a cell can remain in a given state (e.g., analogous to a state of differentiation in a living biological tissue).

The two cells, with their interior environments, are indicated at 120 and 122 and separated by outer “membranes” 121 and 123 to define an intercellular space 124 between the two cells. Cell 120 is shown having a first gene unit 126 (e.g., GENE UNIT 5 listed in Table 1) which includes a control region 128 that responds 138 positively to DiffuseNutrients, negatively to Dominator resources, and positively to Dominated resources 150. The gene unit product region 130 can be configured to generate a DominationSignalReceiver resource which can be transported to the outer membrane 121 of the cell 120 at location 140 through metabolic equation 139 (e.g., EQ8 listed in Table 2).

Cell 122 is shown having a gene unit 132 (e.g., GENE UNIT 6 listed in Table 1) which includes a control region 134 that can respond 142 positively to NeighborPresent resources, negatively to Dominated resources, and positively to Dominator resources. The gene unit product region 136 can be configured to generate 143 both Dominator and DominationSignal resources. In this example, the Dominator resources generated from gene unit 132 can, via one or more metabolic-interaction rules, inhibit the control region 128 of gene unit 126 as well as positively promote the control region 134 of gene unit 132 (illustrated by loop 143 in FIG. 6).

In one embodiment, simulation conditions can favor increased promotion of gene unit 132 in cell 122, causing a further promotion of the gene unit (and additional generation of gene unit product resources) through feedback loop 143. The gene unit product of gene unit 132 includes DominationSignal 144, which can be transported out of the cell 122 if a GenericExporter 146 is present (e.g., via a metabolic equation, such as EQ 7 listed in Table 2). Gene unit 126 in cell 120, through the presence of DiffuseNutrients, can generate DominationSignalReceiver resources, which can subsequently be moved to the cell outer membrane 121 to location 140 via a metabolic equation as described above (e.g., EQ8 listed in Table 2). When DominationSignal resources 148 are located in the extracellular space 124, these resources can interact with DominationSignalReceiver 140 on outer membrane 121 of cell 120. If this interaction occurs within the simulated environment, a metabolic-interaction rule (e.g., EQ 9 listed in Table 2) can generate Dominated resources 150 within cell 120. In turn, the Dominated resources can positively promote gene unit 126, causing an increased accumulation of DominationSignalReceiver on the outer membrane 121 of cell 120. Conversely, cell 122, through its initial activation of gene unit 132, can continue to generate increasing levels of Dominator and DominationSignal resources, which can inhibit generation of DominationSignalReceiver in cell 122 (not shown). Thus, if each cell 120 and 122 each include gene units, such as GENE UNIT 5 and GENE UNIT 6 as listed in Table 1, the two virtual neighboring cells can be promoted to opposing and self-sustaining cell “states.” In one embodiment, a cell “state” may only be disrupted and/or reversed when one or more virtual neighboring cells is eliminated from the virtual environment, for example, by invoking a cell death event.

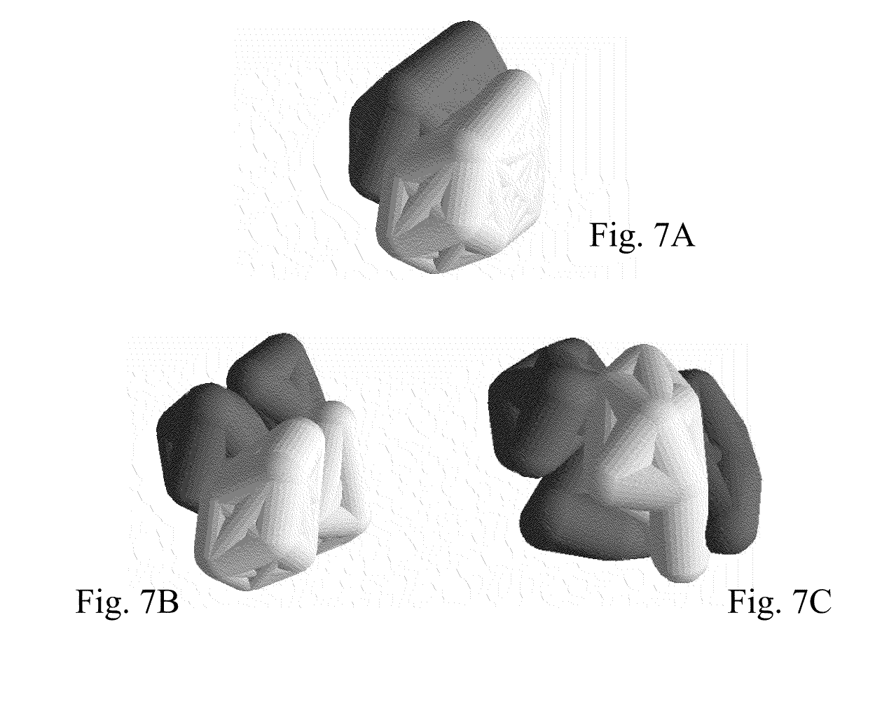

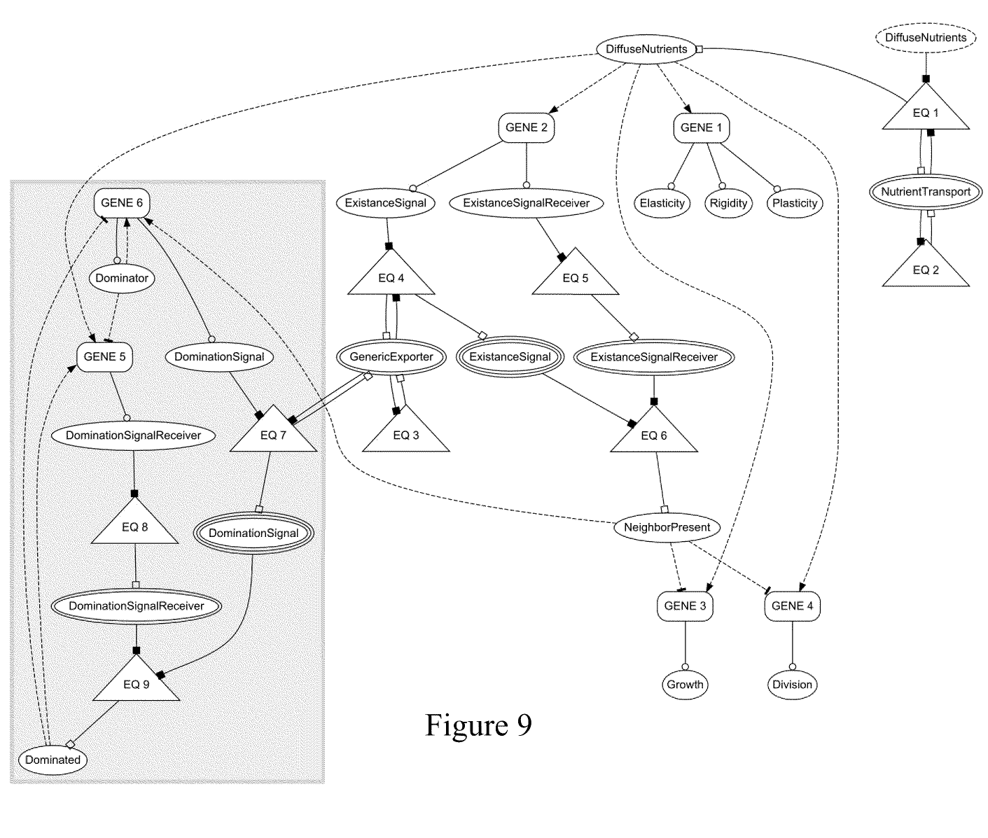

FIGS. 7A-7C are isometric views illustrating a simulation of a cell division event including an initial cell division event and a differentiation event resulting in two cell types (7A), a second cell division event resulting in two cells representing each cell type (7B), and a reversion event (7C) in accordance with embodiments of the disclosure. In one embodiment, an initial virtual cell having a configured virtual genome can be placed into a virtual environment having a specific molecular profile. Aspects of an emergent signaling and gene regulatory network (SGRN) consistent with this example are discussed below with respect to FIG. 9.

In FIG. 7A, the initial cell has divided to yield two virtual cells in the virtual environment. Following the division event depicted in FIG. 7A, signaling (e.g., as operated by a plurality of gene units, metabolic-interaction rules, action rules, physical-interaction rules, etc.) between the two progeny cells can result in each of the virtual cells establishing a cell state (e.g., state of differentiation, etc.) different from the other virtual cell. For instance, a first cell can be configured to have a light-colored surface, and a second cell can be configured to have a dark-colored surface as a result of their particular resource contents. Each of the light and dark colored cells can have properties that 1) allow the cell to retain its light or dark color, respectively, and/or 2) prevent the other cell from attaining its light or dark color, respectively. As such, this example illustrates one process used to simulate maintenance of cell identity and/or differentiation, as well as demonstrating how intercellular influences can influence a cell's identity.

FIG. 7B illustrates a second graphical image of the simulation output following a second division event. As shown in FIG. 7B the cell identity can be configured to be heritable and/or otherwise influenced by the parent cell. For example, the light-colored cell gave rise to two light-colored daughter cells, and the dark-colored cell gave rise to two dark-colored daughter cells. In further embodiments, virtual cells can be configured to revert to previous and change to a different cell state. For example simulated intercellular signaling pathways (e.g., as operated by a plurality of gene units, metabolic-interaction rules, action rules, physical-interaction rules, etc.) can influence cells to alter a cell state. FIG. 7C illustrates this embodiment and shows that one of the light-colored cells has altered its cell state to become a dark-colored cell, leaving only one remaining light-colored cell in the virtual cell cluster.

The above-discussed model for differentiation does not include detailed a mechanism for maintaining, for example, a virtual stem cell following one or more cell division events. However, mechanisms and/or interaction pathways for abstracted (i.e., not detailed) virtual molecular interactions can be advantageous for investigative attempts to better appreciate the dynamics of such a regualtory model.

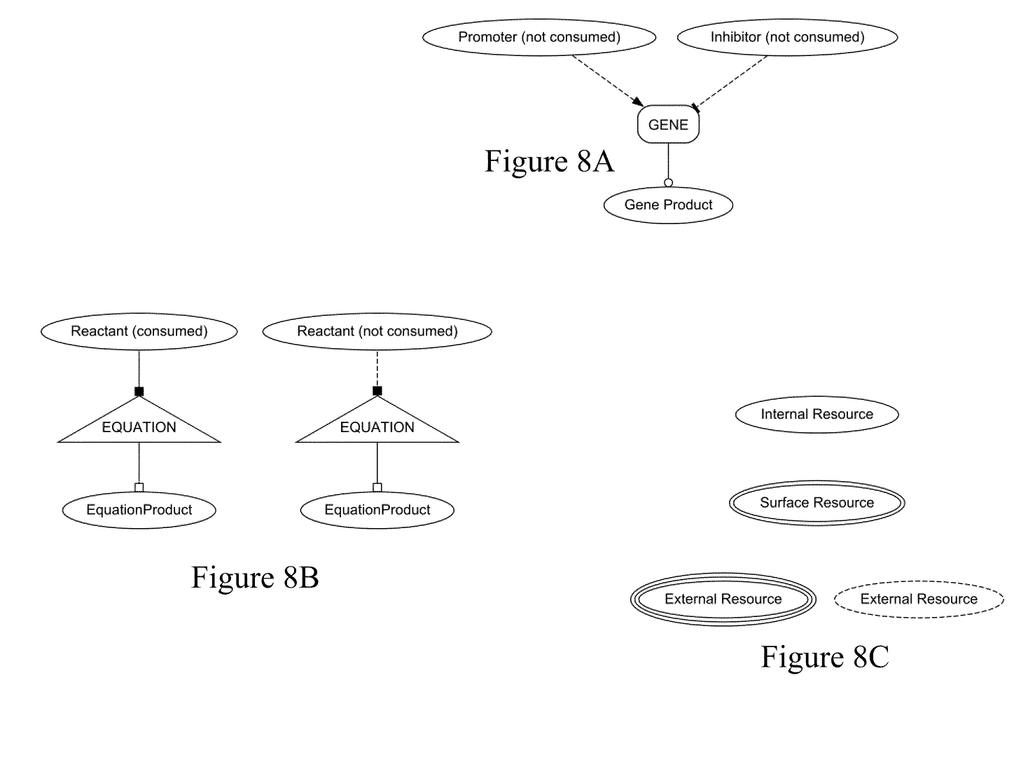

FIGS. 8A and 8B are schematic flow diagrams illustrating legends for interpreting flow diagrams describing resources and actions in a modeled signaling and gene regulatory network (SGRN) in accordance with an embodiment of the disclosure. As seen in FIG. 8A, a gene unit, represented by a square box in the SGRN diagram (GENE), can be acted upon by a variety of resources, indicated by single-line ovals (Promoter, Inhibitor). A dashed line with an arrow indicates that the promoter resource is not consumed and a dashed line with a tee indicates that the inhibitor resource is not consumed. Also in FIG. 8A, the gene unit produces a Product resource (GeneProduct) in response to the Promoter resource and Inhibitor resource. The Product resource is released internally to the virtual cell (as illustrated by the single-line oval), and is indicated by a solid line terminating at an open circle.

In a further example, the legend in FIG. 8B represents two metabolic equations. Reactants consumed by a metabolic equation are indicated by solid lines terminating in solid boxes. Reactants that are not consumed by a metabolic equation are indicated by dashed lines terminating in solid boxes. Products of the metabolic equation are indicated by solid lines ending in an unfilled box. FIG. 8C shows three ovals representing resources: those with a three-line perimeter represent extracellular resources, those with a two-line perimeter represent resources on a cell surface, and those with a single-line perimeter represent resources internal to a cell. In another embodiment, also shown in FIG. 8C, extracellular resources can be shown with a single dashed line perimeter.

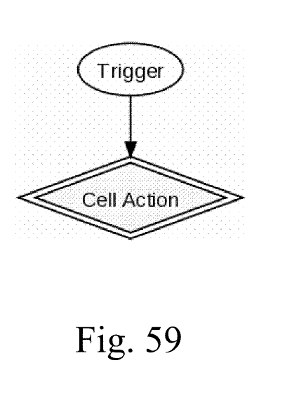

FIG. 59 is a legend that illustrates how a cell action may be triggered by a resource or “molecule.” Solid lines ending in a filled arrowhead to a diamond with a two-line perimeter represents that an action may be invoked (e.g., via a metabolic-interaction rule, etc.).

With continued reference to the exemplary SGRN diagrammed in FIG. 9, extracellular DiffuseNutrients can be available in the virtual environment (e.g., indicated in the top right of FIG. 9) from a molecular source described in the <Shade> section of the configuration file (described in more detail below). In this example, the shade configuration provides DiffuseNutrients in the extracellular environment. At the cell surface, NutrientTransport resources can react in the metabolic equation “EQ 1” with DiffuseNutrients for transporting the DiffuseNutrients into the cell. The metabolic-interaction rule/equation “EQ 2” can be provided to maintain the levels of NutrientTransport resources (provided for in the initial configuration file) at a cell surface at an initial desired level when NutrientTransport resource has a specified decay rate and/or to replenish the NutrientTransport resource when consumed in EQ 1. In another embodiment, NutrientTransport resource can be configured to be a “non-consumed” reactant in EQ 1 and further specified to be non-decaying, thereby obviating the need for EQ 2.

Once inside the cell, DiffuseNutrients (indicated in FIG. 9 with a single perimeter) can invoke one or more changes in the resource profile inside of the cell. For example, DiffuseNutrients can promote “GENE 1” to generate internal adhesion factors, such as “RIGIDITY,” “PLASTICITY” and “ELASTICITY”, to maintain a cell's cohesion. In another embodiment, RIGIDITY, PLASTICITY AND ELASTICITY may represent a cell property resource that can affect the rigidity, plasticity and elasticity properties of a cell via Cell Property Rules. Likewise, DiffuseNutrients can also promote other gene units: “GENE 2”, “GENE 3”, “GENE 4”, and “GENE 5”, for example.

Shown in the lower central portion of FIG. 9, surface GenericExporter resources, continually replenished by “EQ 3”, can be a reactant in “EQ 4” with the ExistanceSignal, expressed by “GENE 2”, to move the ExistanceSignal outside the cell. For example, GenericExporter can serve as a catalyst for transport of the ExistanceSignal resource such that the ExistanceSignal resource can function as a signaling resource to neighboring cells (e.g., via “EQ 6”).

The preceding description discusses configurable simulation information including cell metabolism information for simulating biological events such as growth, division, cell signaling, etc. The top, left shaded portion of the SGRN diagram in FIG. 9 included examples of configurable simulation information including information pertaining to cell differentiation. For example, this portion of the SGRN diagram illustrated in FIG. 9, represents a plurality of signaling events that can occur between virtual cells, including signaling events that promote development of, commitment to and/or maintenance of a cell state. For example, the presence of a neighbor cell, determined through “EQ 6”, can promote “GENE 6” to generate both Dominator and DominationSignal resources. Dominator resources can be configured to both amplify the promotion of “GENE 6” (and create a self-reinforcing signal loop), while also be configured to inhibit “GENE 5”.

With the presence of surface GenericExporter, “EQ 7” can move the DominationSignal expressed by “GENE 6” outside the cell. For cells receiving external DominationSignal, “EQ 9” can generate internal Dominated resources. These Dominated resources can be configured to both inhibit “GENE 6” and promote “GENE 5”. In one embodiment, “GENE 5” can also be promoted by DiffuseNutrients. If not sufficiently inhibited by Dominator resource, “GENE 5” can be configured to generate DominationSignalReceiver which, by “EQ 8”, can be moved to the cell surface, interacting in “EQ 9” to receive DominationSignal from other cells.

Accordingly, the SGRN can be configured such that the more a given cell generates Dominator resources, the more that cell can influence other cells in the virtual environment via DominationSignal. In contrast, the more DominationSignal a cell receives, the higher the level of Dominated resources it will accumulate, thereby inhibiting its own production of Dominator resources. In one embodiment, a first cell can progressively send more DominationSignal to a second cell. In such a scenario, the cells can commit to opposing states, thus having separate propensities to differentiate and to maintain these differences.

Daughter cells arising as a result of a cell division event from a parent cell having high DominationSignal levels can be initiated with some accumulated level of Dominator and DominatorSignal resources, and accordingly, remain predisposed to generating high levels of DominationSignal resources. Likewise, daughter cells arising as a result of a cell division event from a parent cell having high Dominated resource levels can be predisposed to generate high levels of Dominated resources. Additionally, following a cell division event, each daughter cell can be subjected to DominatorSignal versus Dominated resource competition until only once cell remains having a high level of Dominated resources. The resulting cell with high levels of Dominated resources can be configured to resist differentiation and/or further differentiation to other cell states or cell types. In this example, the neighboring cells in the virtual environment can proceed to differentiate if so stimulated.

The cell-centric simulator can be configured to create and initiate virtual cells having a variety of and/or different virtual genomes. However, GENE UNITS 1 through 6 listed above in Table 1 are representative of gene units that can be included in virtual genomes regardless of the model being queried. Similarly, metabolic equations 1 through 9 listed above in Table 2 can be representative of a “standard set” of metabolic interactions associated with cellular transport, decay or renewal of resources, and molecular interactions. Examples 1 through 5 described below illustrate different virtual tissue systems involving different and configurable virtual genomes and metabolic equations. The SGRN illustrated in FIG. 9 shows the interactions of gene units and metabolic-interaction rules relating to Example 1 (described below) for a simple tissue model having cells committed to differentiation.

### D. Physical Constraints

Physical constraints on the virtual cell and/or environment can be configured. This section discusses the representation of virtual cells, as fixed spheres, free-space solid spheres or free-space groups of subspheres. The following discussion also addresses embodiments of the disclosure relating to calculation of adhesion forces applied between and among cells (e.g., spheres, groups of subspheres, etc.), and where cells are composed of multiple subspheres, between and among the intracellular subspheres.

### D1. Grid Arrangement of Cells

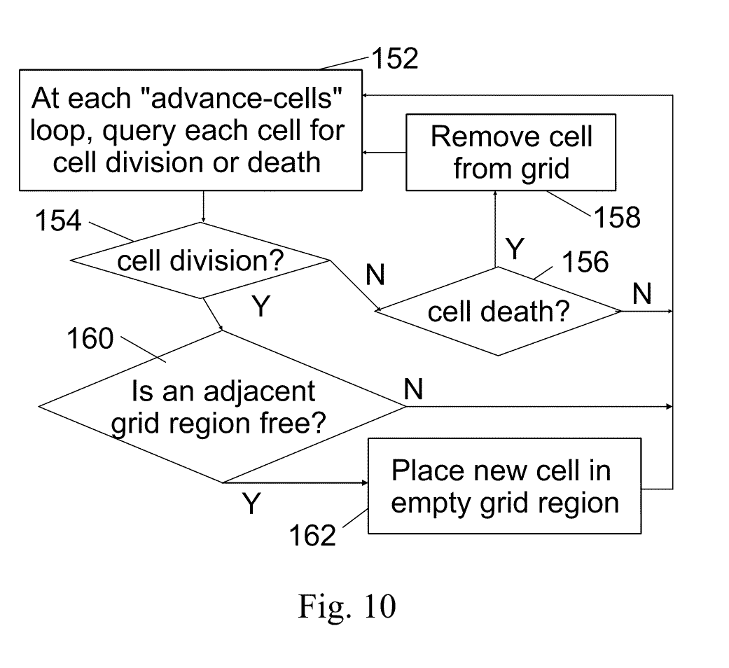

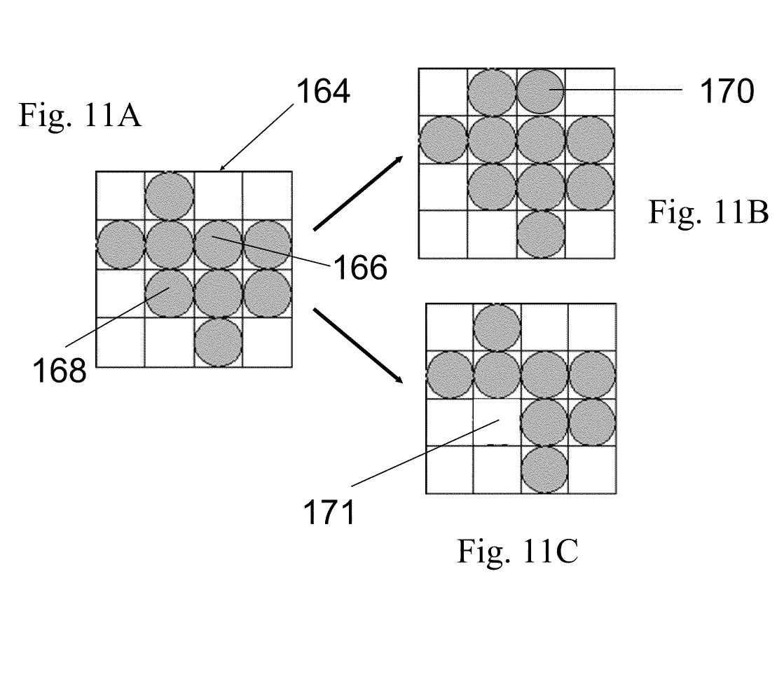

In one embodiment, modeling of virtual phenotypes by the ontogeny engine can be performed using a discrete-based environment space organized as a three-dimensional, uniformly divided grid, called “grid space”. In this embodiment, uniform spherical shapes represent the cells, with one such spherical cell positionable at each individual grid location. Therefore, adjacent cells are positioned a predetermined and fixed distance from a given cell and can only be in any of the 26 adjacent locations. FIG. 10 is a flow diagram illustrating a routine invoked by a stepPhysics module using an egg-carton model (e.g., grid space model) for cell placement in accordance with an embodiment of the disclosure. FIGS. 11A-11C are schematic block diagrams illustrating an embodiment of a planar egg-carton model for cell placement (11A), and illustrating virtual cell placement configurations after addition of a new virtual cell (11B), and after removal of one virtual cell (11C) in accordance with further embodiments of the disclosure.

Referring to FIG. 10, the illustrated steps are part of the “stepPhysics” function shown at 46 in FIG. 3B, and as part of each “advance-cells” loop, shown at 36 in FIG. 3B and, more specifically for this representation, at 152 in FIG. 10. As seen in FIG. 10, the routine queries each cell during an “advance-cells” loop 152 for a cell-division or cell-death event. If the routine determines that a cell-division event has occurred during the loop (at decision block 154), the routine can further determine (at decision block 160) if an adjacent grid location is empty. If an adjacent location is available, a new cell is placed in that previously empty location (block 162).

For example, with the configuration of cells in the 4×4 grid shown at 164 in FIG. 11A, assume that the cell marked 166 is to divide. The location identified at 170 in FIG. 11B is identified as an empty, adjacent location which can accommodate a new cell from the division. As all cells in this approach are of uniform size and in fixed locations, daughter cells can be configured to be immediately equal in size and mass as parent cells. Referring again to FIG. 10, if there is no empty adjacent location available, the routine takes no action, and returns to the “advance-cells” loop (block 152). Referring to FIGS. 10 and 11A-C together, if the cell 168 in FIG. 11A is marked for death by a “yes” decision at block 156, the routine can remove that cell from the grid, as indicated at decision block 158 in FIG. 10 and at grid space 171 in FIG. 11C.

The grid space cell placement model provides cell-centric simulation without imposing increased complexity of a more realistic environment space. Cellular division, cell signaling, and phenotype evolution events can result from simplified calculations such as space available for division or discovery of cellular neighbors. If modeling some types of behavior or development wherein it is desirable to model a cell that is smaller than the fixed grid location volume, the modeled cell may not be in contact with other cells as it might in a more flexible (e.g., free-space) model. Since cell size varies in vivo, a living cell may have more than eight smaller adjacent cells or fewer than eight larger neighbors when considered in two dimensions (26 neighbor cells when considered in three dimensions): Such configurations may not be possible with the above described grid space cell position approach.

It is also feasible to consider other discrete space variations than the grid space description above. Grid locations can be made more granular allowing an individual cell to cover multiple locations but with each location allocated to at most one cell, or the shape of the grid organization can be changed from cubical locations to allow greater sphere packing and so potentially vary adjacency. Further, non-spherical shapes can exhibit different patterns of adjacency than are possible with simple spheres.

### D2. Free Arrangement of Cells

In another embodiment, the cell-centric simulator can be configured to model cell position using a “free-space” approach. In the free-space modeling approach, cell positions are not constrained to a fixed grid using discrete coordinates, but can be specified in continuous coordinates. Furthermore, the free-space model allows for cell movement throughout a defined and/or constrained space or area.

For free-space modeling, the following are considered: (i) creating adjacent space wherein a cell division event can place two daughter cells that are at most slightly overlapped offset from the center of the original parent cell; (ii) detecting cell boundaries so that cell bodies do not simultaneously occupy the same space and/or so that overlapping cell boundaries can be resolved during a stepPhysics function; (iii) moving cells within free-space, (iv) adhering cells to one another so that some cells are considered attached; (v) locating neighboring cells for exchange of cell signals; and (vi) shaping cells, in embodiments wherein free-space modeling is configured to allow non-spherical cell shapes.

In living biological cells, the process of cytokinesis results in two daughter cells having a joint mass approximately equal to the mass of the parent cell. If division is symmetric, each daughter cell is approximately half the size of the parent and the two new cells occupy roughly the same space as the original cell (Alberts, B. et al., 2002). Since the division halves the mass into two new cells, these cells can subsequently grow to reach the size of their parent cell.

By dividing virtual cells in the same way as living cells, cell placement can be realistically achieved in free-space. Further, cell division and growth can be configured as separate cell actions. Most of the space for daughter cells is immediately available since it was occupied by the pre-division parent cell. To resolve adjacency, cells can be placed such that an adjoining point between the daughter cells is at a coordinate approximately equal to the parent cell's center point prior to the division event.

Though partially solving adjacency and vacancy, it is the cell mass, and thus its volume, that is halved (assuming constant density). A spherical cell's radius is not likewise halved. Since the volume of a uniform sphere is

$$V = \frac{4}{3} π {R}^{3}$$

where V is the volume and R is the radius, the radius of the new sphere is

$$r = \sqrt[3]{\frac{1}{2}} R \approx 0.79 R$$

which is quite larger than

$$\frac{1}{2} R .$$

A free-space model with realistic cell division must either accept that new cells overlap by more than 25% of their radii and so simultaneously occupy the same space or they must push away from one another (possibly pushing on other adjacent cells) to resolve this overlap.

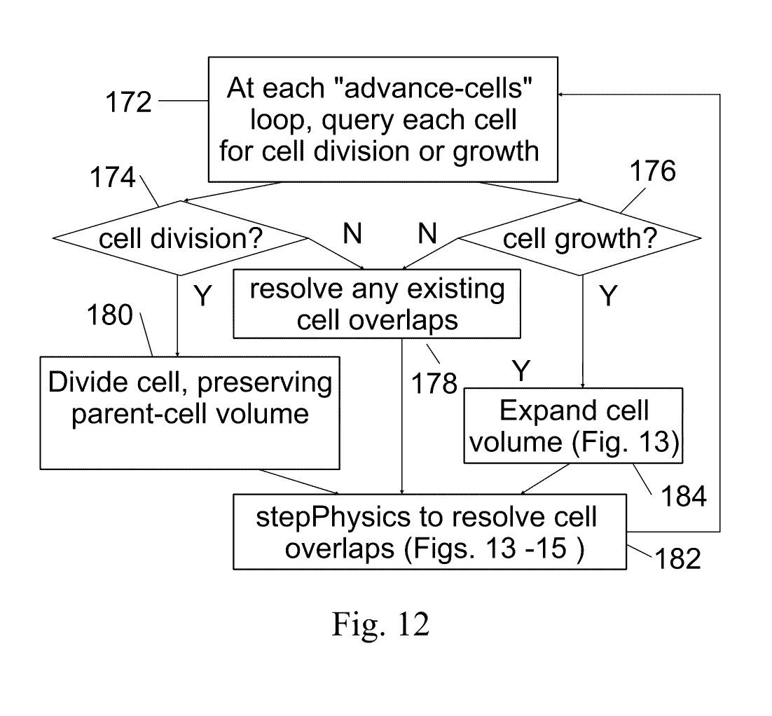

FIG. 12 is a flow diagram illustrating a routine invoked by a stepPhysics module using a free-space model for cell placement in accordance with an embodiment of the disclosure. Referring to FIG. 12, the illustrated steps are part of the “stepPhysics” function shown at 46 in FIG. 3B, and as part of each “advance-cells” loop, shown at 36 in FIG. 3B and, more specifically for this representation, at 172 in FIG. 12. As seen in FIG. 12, the routine determines, for each cell during an “advance-cells” loop 172, if a cell-division event (decision block 174) or cell-growth event (decision block 176) will occur. If a cell-division event is indicated at block 174, the routine includes dividing the cell while preserving the parent cell volume (block 180). In one embodiment, the cell-division event can include dividing a parent cell into two daughter cells having approximately equal volume. Following cell division at block 180, the routine can invoke a stepPhysics function to resolve cell overlaps (block 182). Following resolution of cell overlap at block 182, the routine can return to block 172.

If a cell-growth event is indicated at block 176, the routine includes expanding the cell volume (block 184). Following cell growth and/or expansion at block 184, the routine can invoke a stepPhysics function to resolve cell overlaps (block 182). Following resolution of cell overlap at block 182, the routine can return to block 172. If a cell-division and/or a cell-growth event does not occur (as determined at blocks 174 and 176, respectively), the routine can resolve existing cell overlaps (block 178) by invoking a stepPhysics function at block 182.

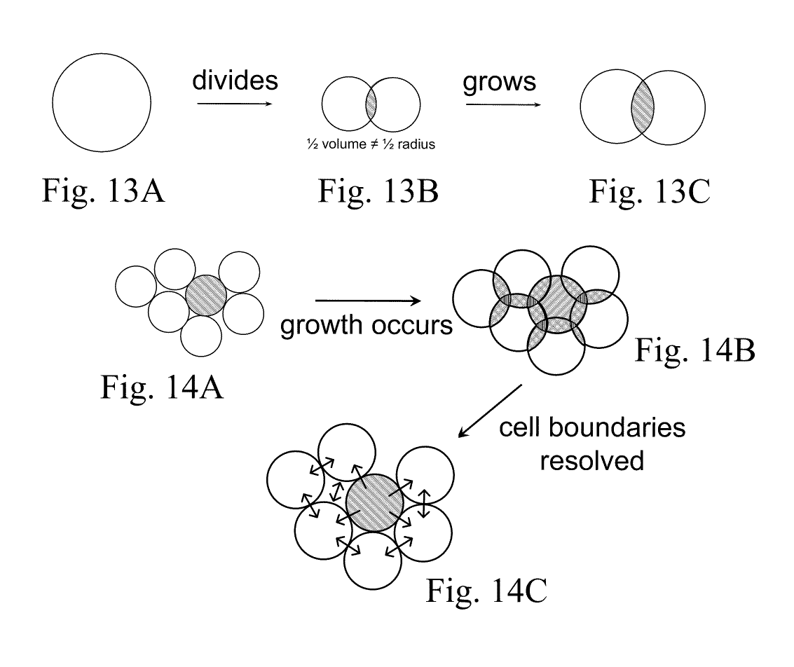

FIGS. 13A-13C are schematic block diagrams illustrating modeled cell division and cell growth events using a solid sphere free-space model in accordance with an embodiment of the disclosure. As illustrated in FIGS. 13A-13C, a cell division event giving rise to two cells of equal volume, but with radii that are substantially greater than half of the parent cell's radius, results in cell overlap (FIG. 13B). As the daughter cells grow (FIG. 13C), there is progressively greater cell overlap that must be accommodated by movement of the cells away from one another.

FIGS. 14A-14C are schematic block diagrams illustrating modeled cell growth and cell spatial resolution events for a plurality of virtual cells using a solid sphere free-space model in accordance with an embodiment of the disclosure. For example, FIG. 14A illustrates a cluster of cells that have not been positioned to accommodate cell growth. As the cells grow, there is increasing overlap among adjacent cells (FIG. 14B), exerting mutual repulsion forces on each pair of overlapping cells. FIG. 14C illustrates how these repulsion forces are resolved by movement of the cells in the direction of the indicated arrows.

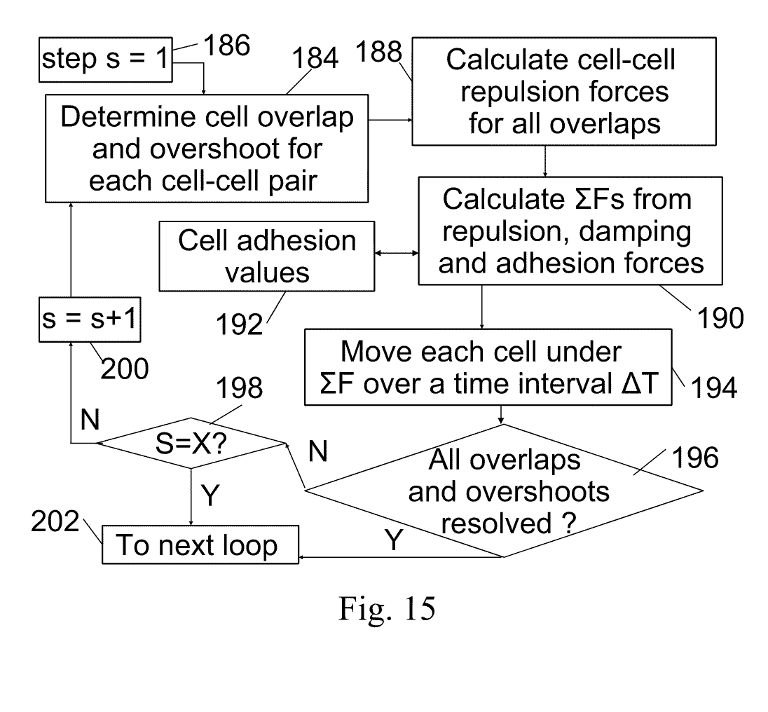

FIG. 15 is a flow diagram illustrating a routine invoked by a stepPhysics module for resolving cell overlap and overshoot events for a plurality virtual cells using a solid sphere free-space model in accordance with an embodiment of the disclosure. As described below, these steps can be part of a single “successive loop” operation of the system (e.g., “advance-cells” loop shown at 36 in FIG. 3B). In a particular example, in each cycle of this loop, the stepPhysics function can be configured to carry out a predetermined number of cell position adjustments designed to reduce the extent of overlap or overshoot, such that changes in volume and position from division, growth, or death preserve overall cell shape and intercellular contact.

In the first stage, and with the step number set to 1 at block 186, the routine can determine the extent of cell overlap or overshoot for each pair of cells in the virtual environment (block 184), and calculate intercellular repulsion forces for cell-pair overlaps (block 188). Using cell adhesion values (block 192), the routine can compute forces acting on each cell (block 190). In one embodiment, the computed forces can include repulsion forces, damping forces or adhesion forces, etc. Each cell can be moved under the calculated forces over a given time interval, ΔT (block 194). After the position adjustment at block 194, the routine can evaluate, at decision block 196, whether the cell movement at block 194 was effective to resolve overlaps and overshoots. If not, the steps described above can be repeated, through the logic illustrated at blocks 198 and 200. The process can be reiterated until all of the overlaps and overshoots are resolved, as indicated at 196 and 202, or until a given number of iterations (e.g., 20, 50, 100, etc.) has been performed, as indicated at 198 and 202. In additional embodiments, the process can be reiterated until an a time-per-step allowance is exhausted. Individual aspects of the routine and its logic are detailed below.

### D3. Cell Movement in Free-Space

Exemplary forms of cell motion or movement available to natural living cells are listed in Table 4 below.

TABLE 4
Categorical Examples and Descriptions of Cell Movement

| | |
|---|---|
| TRANSLOCATION | PASSIVE DISPLACEMENT WHERE THE CELL IS MOVED |
| | ACROSS SPACE BY FORCES EXTERNAL TO THE CELL; |
| | ALSO CALLED TRANSLATION. |
| LOCOMOTION | ACTIVE DISPLACEMENT WHEN THE CELL MOVES ITSELF |
| | OR TRAVELS ACROSS SPACE. |
| RESHAPING | MODIFICATION OF THE CELL SHAPE, REGARDLESS OF |
| | WHETHER IT REMAINS IN PLACE. |

Regardless of its cause, cell overlap may be resolved by considering an opposing cell to apply an external force on the subject cell such that the subject cell is translocated. Cell translocation may also occur due to forces applied outside the phenotype. For instance, pressure from a blunt instrument such as a probe may push on cells and so motion is one effect on a cell from an external force. From a cell's frame of reference, a force from an external probe or from another cell can result in translocation.

In one embodiment, computational support of cell translocation can be included in free-space cell position modeling. As the ontogeny engine advances from a current step boundary to a next step boundary, a plurality of operations is applied to the virtual cells and environment. Accordingly, cell movement can also be “advanced” from a current step boundary to a next step boundary.

In a particular example of cell movement in a virtual environment, cell A can travel a path. If a boundary for cell A overlaps with the boundary of another cell B along the travel path, the path of cell A can be altered and/or cell B can be displaced. When using discrete time steps (such as advancing from a current step boundary to a next step boundary), movement of cell A might be seen as a series of jumps. For example, a collision between cells A and B will only be noticed as long as jumps end where cells A and B overlap. One solution is to graduate the time steps such that the smallest possible translocation that might precede a collision can be taken and make the effect of the current boundary to next boundary step proportionate in relation to other cells' processes (e.g., transcription). In the one embodiment, a fixed number of movements, say 20 (indicated as X at 198 in FIG. 15), can be applied for one or more steps during a simulation session. For example, the fixed number of movements can be user-specified and/or empirically determined.

In some embodiments, cell translocation can also affect a phenotype when external forces are applied. For example, possible effects can include rotation, deformation, displacement of a cellular mass, separation of cells, etc. Accordingly, the motion of a cell and the forces upon a cell can be transmitted to other cells according to the structure of the phenotype.

### D4. Cell Adhesion through Connections

The transmission of force between cells is not applicable in the grid space model since those cells do not move from one grid location to another. However, in most living tissues (Alberts et al., 2002), cells are connected to each other in a network of physical attachments. These connections can determine how cells transmit force to other cells. From the cell translocation example above, if cell A moves, another cell might be pushed because of boundary collisions. Further, if cell A moves, a connected cell B may be dragged along to stay in contact with cell A.

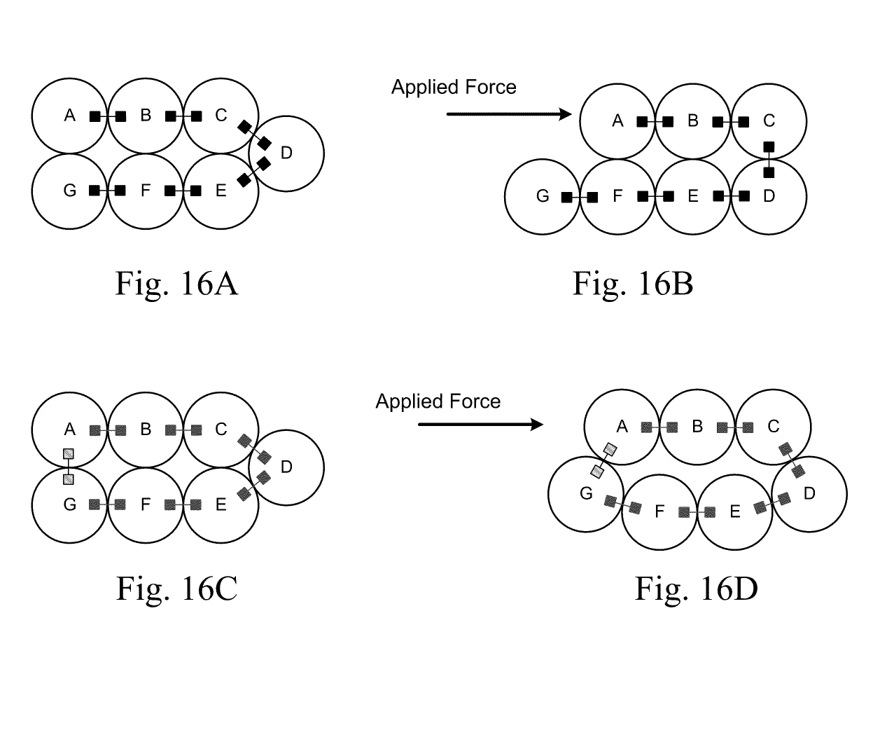

The concept of cell adhesion can be applicable when considering the transmission of force between some cells while not applying it to others. FIGS. 16A-16D are schematic block diagrams illustrating modeled distribution of forces among solid-spheres upon application of force to one of a group of connected solid-spheres, in the absence (16A and 16B) and presence (16C and 16D) of end-to-end sphere connections in accordance with en embodiment of the disclosure. As illustrated in FIGS. 16A and 16B: if a string of cells, labeled A through G are connected, but the string of cells is bent such that A and G have immediate physical proximity but are not directly connected, then pushing A away from G will not directly affect G. Instead A would drag B along with it and B would drag C and so on. Eventually G might be dragged along, but only when affected by a force from cell F.

In a second scenario depicted in FIG. 16C and FIG. 16D, adding adhesion between A and G changes the respective cells' behavior as well as how the remaining cells are affected by an applied force. Adhesion connections can be configured to occur between multiple cells, for example, one cell can be independently connected to many cells. For example, Cell A can be directly connected to adjacent cells B and G, and so it may take more force to pull and/or push cell A since two other cells would also have to be moved.

Connected cells may also have other connections, increasing the resistance to translocate. In another example (not shown), pairs of cells may have multiple connections between them rather than just one large connection. This is analogous to some types of adhesion events seen in biology wherein cells attach themselves together with several connections (Alberts et al., 2002).

During and/or following cell division events, adhesion connections between cells can be resolved. In one embodiment, the proximity of the associated cell's surface to the surfaces of the new daughter cells can be determined. Following a cell-division event, the stepPhysics function can determine if the connecting neighboring cell is closer to the surface of one of the daughters than the other. The closest daughter cell can be assigned the already established adhesion connection. In some embodiments, the proximity of a connecting neighbor cell to each daughter cell can be approximately equal. In these embodiments, both daughters can be assigned an adhesion connection to the neighboring cell.

Adhesion connections can be configured to be rigid or flexible. If a connection is rigid and there is no inertia or other applied forces, pushing a cell also transfers that force to any adhered cells. Thus pushing a peripheral cell may cause a cluster of cells to rotate. Pushing a center cell of a cluster of cells may move the cluster of cells across a distance, but the cluster may otherwise remain unchanged. However, if the adhesion connection is flexible adhesion connection, then a cluster of cells having a first cluster shape may deform to a second cluster shape, with some of the cluster cells unaffected. Accordingly, it would take a greater force to affect cells further away from the point of contact.

### D5. Generalizing Connections

In one embodiment, cell connections/adhesions can be modeled as a mathematical graph where the cells are represented by vertices and the connections represented by edges. In this manner, a cyclic undirected graph can be implemented, allowing operations upon cells using graph theory techniques such as shortest-path algorithms.

Other cell associations can be modeled as connections distinct from adhesion-type connections. In one embodiment, simulation of cell signaling events can be modeled as signals traveling along signal paths, thereby forming a signal connection. As in biological cell arrangements, signals can be transmitted to/from virtual cells that are not immediately physically adjacent to each other. To model such a relationship, a cyclic directed graph, distinct from a graph modeling adhesion connections, can be employed. For example, vertices on the graph can represent virtual cells, and edges can represent the applied signal connections.

In some embodiments, cell position can be calculated with reference to other cells, such as connected cells, or as an absolute position in the virtual environment. For example, a cell can be tracked during simulation with reference to the cell's absolute position in the general environment space. If the cell moves, its new location can be recalculated as a function of that translocation across the total space. In further embodiments, however, a cell position can be calculated with reference to other cells to which the cell is connected (e.g., in a multicellular tissue) and movement of the tissue and/or the cell can be integrated such that calculation of any individual cell position (e.g., following movement) can be in reference to that of that of the other cells (e.g., other cells in a multicellular tissue, other cells in a cell cluster, etc.). For example, the plurality of connections that can associate cells to other cells, can determine the relative position between the cells. For instance, if two cells are connected by a positional connection, the connection information generated during simulation can include information relating to a separation distance between the cells as well as a relative direction. In this way, cells can have a “position” relative to other cells. By treating one cell, in a group of cells, as anchored to an absolute position in the environment, absolute positions can be calculated for the remaining cells. Thus, if a single cell is moved such that a group of cells moves with it, the absolute anchor position can be recalculated, without requiring recalculation of the relative connections between the individual cells.

### D6. Cell Signaling and Neighboring Cells

A cell in the ontogeny engine sends a signal by releasing virtual resources to its neighbors. If the neighbor has receptors for the resources it is presented with, it absorbs the signal and processes it. In grid space, such signals can be applied within a specific radius from the cell's center. Individual grid locations within this radius can be readily calculated. Grid space models can also be configured to calculate grid locations within a linear distance, or in another embodiment, with falloff-type signaling principals (e.g., signal decreases over exponential curve as configured). In free-space models, a cell's neighbors cannot be determined with a simple check of enumerated adjoining spaces. Instead the same approach used for cell overlap resolution is applied: each cell in the phenotype is checked to see if it is a neighbor based on the distance of its surface from that of the other cell. If this separation of the two cells is within the configurable threshold, then they are neighbors and can share signals. In additional embodiments, signaling between cells can occur outside a preset threshold distance when the range of a signal is dynamically calculated, when the signal is transported by some media, such as fluid droplets (described further below), or when signals are temporarily housed on ECM subunits.

### D7. Cell Shaping

To further improve fidelity with living cells, the ontogeny engine can support cell shaping. If two rigid, uniform spheres are positioned such that their shapes overlap, it is reasonable to treat this as a collision and resolve the overlap. However, most living cells do not have rigid shells, but have some plasticity and can deform. Further, through differentiation, cells adopt shapes that best fit the function they serve.

The various approaches to computing the shape of cells may be categorized in Table 5 as follows:

TABLE 5
Categorical Examples and Descriptions of Cell Shape

| | |
|---|---|
| EXTERNALLY | A CELL'S SHAPE IS A FUNCTION FOR ITS SURFACE |
| SPECIFIED: | SUCH AS A SPHERE OR COMPLEX EQUATION; SHAPE |
| | IS IMPOSED UPON THE CELL. |
| CALCULATED | THE CELL HAS NO PRESCRIBED SHAPE, BUT RATHER |
| AD-HOC: | IS CALCULATED WHEN NEEDED. AN EXAMPLE |
| | MIGHT BE THE RENDERING OF TWO CELLS CLOSE |
| | TOGETHER: FROM AN ASSUMPTION OF SPHERES, |
| | CHOOSE A MIDPOINT BETWEEN THE CENTERS OF |
| | THE CELLS AGAINST WHICH TO FLATTEN THE SIDES |
| | OF THE CELLS. |
| INTERNALLY | THE CELL'S SHAPE IS MAINTAINED THROUGH |
| DERIVED: | INTERNAL DATA STORAGE AS A FUNCTION OF ITS |
| | OWN BEHAVIOR. |

External specification of cell shape requires that known shapes be catalogued and defined rigorously. Such cataloguing inherently limits the range of cell shapes possible and removes the possibility that unconsidered or unrecognized cell shapes might better solve a phenotype development challenge.

Ad hoc shape calculation treats shape as completely dynamic, existing only as long as the influences on it continue. Cells then do not have their own shape but instead adopt whatever shape is most immediately useful. While some living cells may be very plastic, many cells (e.g., bone, skin) have a shape that, while deformable, are essentially static and continue for the duration of the cell's existence (Alberts et al., 2002).

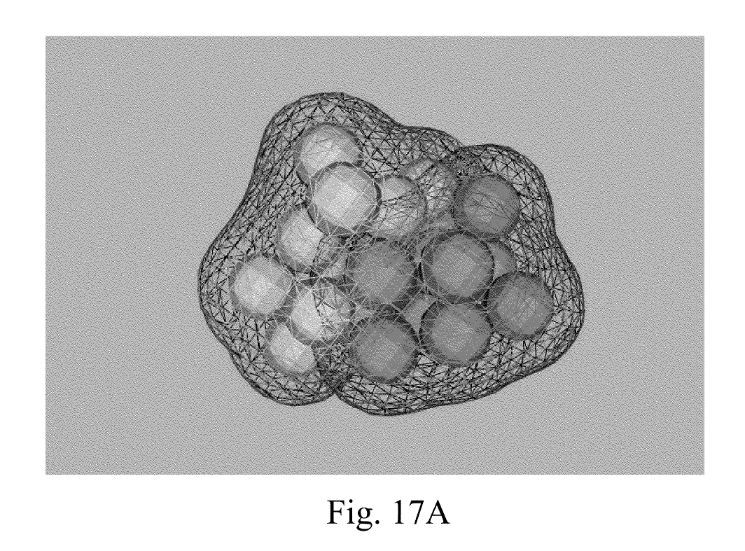

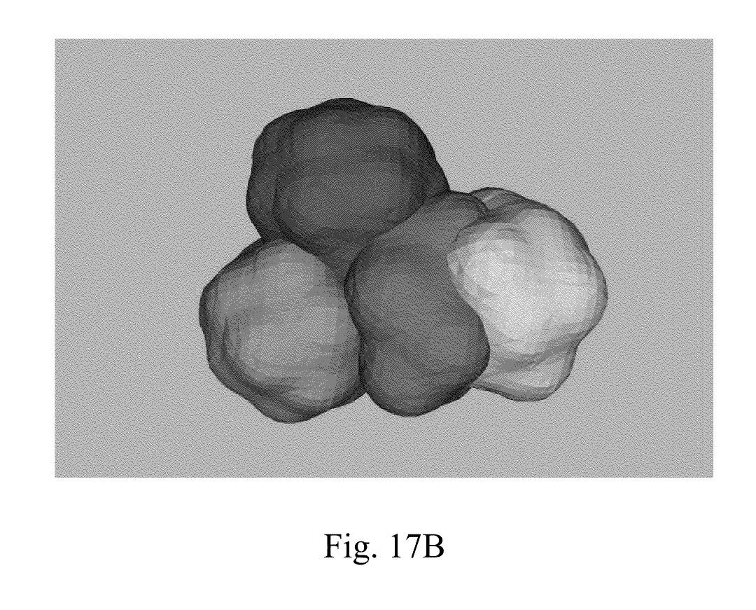

Internally derived shapes can provide fidelity with living cells. Cell shape can be modeled as collection of hard spheres held together with varying cohesion in the same way. FIGS. 17A and 17B are isometric views illustrating simulated cells using a subsphere free-space model with (17A) and without (17B) visible internal subspheres and in accordance with an embodiment of the disclosure.

FIGS. 17A and 17B show such hard spheres depicted as “bags of marbles”. FIG. 17A depicts the bags as wire-framed envelopes representing adjacent cells. The shapes of these cells are determined, as will be detailed below, by intracellular interactions among the subspheres in each cell, and by extracellular interactions among subspheres of adjacent cells. FIG. 17B depicts fully visualized “bags” without the internal subspheres directly visible.

As an analogy, shifting a closed bag of marbles around moves the marbles around each other: the enclosing bag's shape is given from the arrangement of the enclosed marbles. Depending on forces imposed externally onto the bag (and thus the enclosed marbles) and how tight the bag holds the marbles together, the bag may become roughly spherical, fairly flat, or some arbitrary shape. For a pile of many such bags, each bag takes a form based on the surrounding bags and how each bag holds its marbles as cohesive collections. Forcing rigid connections between some of the marbles, such as with glue, constrains the potential shapes the bag can take.

This bag-of-marbles model is abstracted to remove the enclosing bag as a design construct, instead holding the marbles together in cohesive collections via virtual adhesions. The resulting shape of the marble collection is derived from whichever marbles are then exposed at the collection's surface. As before, forces applied to such collections cause the contained marbles to shift around until equilibrium is reached.

As in the previously described free-space adhesion implementation, adhesions exist between sphere centers, but instead of uniform spheres representing whole cells, the spheres represent the proverbial marbles bound together to shape cells. These constituent spheres are referred to as subspheres or subunits. For each step of simulation, adhesions influence the arrangement of the subspheres.

Two methods of adhesion creations have been considered: completely-connected and proximity-based. When subspheres in a cell are completely connected, cell shapes tend to be spherical and highly coherent. When adhesions are created only between subspheres within a proximity threshold, cell shapes are frequently irregular and less coherent. Each of a cell's subspheres can be connected to at least one other intracellular subsphere, unless the cell is made up of only one subsphere. In other arrangements, intracellular subspheres need not be connected to other subspheres (e.g., the cell can be pulled apart without breaking adhesion bonds between subspheres).

Unlike adhesions between cells, these intracellular adhesions are not intended to faithfully model physical forces and constraints but more as a design mechanism from which to derive cell shape.

Again as described above in D5, the bag-of-marbles approach may be further abstracted as a graph with subsphere centers as vertices and center-to-center bonds as edges.

Biologically, cell size can be constrained by the physical characteristics of the cell membrane and other necessary structures. In the bag-of-marbles model, the minimum cell size is that of a single subsphere. For multi-subsphere cells, a single subsphere determines minimum cell thickness. Single-subsphere cells grow to multi-subsphere cells by the addition of subspheres. The cell's mass is taken as the sum of the contained spheres' given mass. In general, the cell size can be controlled by the number of subspheres and by the size of those spheres. Several smaller spheres allow more resolution of shape while fewer, larger spheres reduce computational cost and range of shape variety. In one embodiment, subsphere size is uniform across all cells. Although calculations will be eased if all of a given cell's subspheres are of uniform size with or without regard to those of other cells, other embodiments can include subspheres of variable size. One of ordinary skill in the art will recognize that the shaping mechanism described herein is not limited to spheres and subspheres. For example, the cell may include other shaped subunits (e.g., cubic, triangular, bacillus-shaped, non-uniform shaped, etc.) instead or in addition to spherical subunits.

All collisions of subspheres, whether within or between cells, are simply between the involved spheres and so are handled identically. The effect on the shape of the cell is derived then from the resulting arrangements. This approach simplifies the simulation.

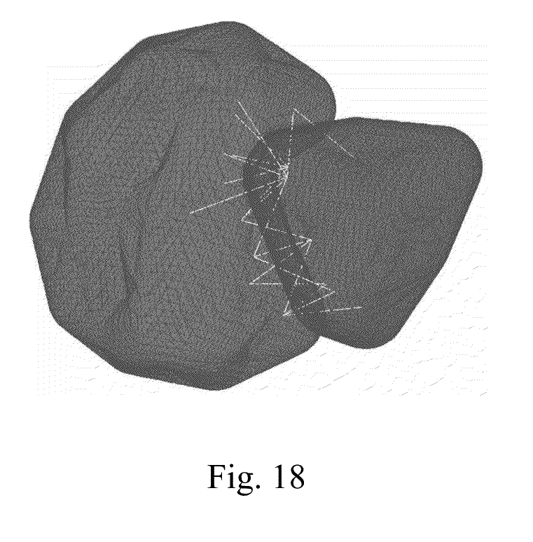

Although intracellular adhesions need not be faithful to real physical behavior for realistic modeling, fidelity is required with regard to adhesion between cells. Therefore, intercellular adhesions follow separate, though similar, logic than adhesions within cells. Nonetheless, intercellular adhesions are still anchored to cell subspheres. Cells pressed together are thus capable of forming many adhesions, creating an adhesion “contact patch”, depending on how many of their contained spheres come into contact. FIG. 18 is a isometric view illustrating two simulated cells behaving in accordance to simulated forces determined by intercellular adhesion rules and in accordance with an embodiment of the disclosure. Such a contact patch is shown in FIG. 18 for two cells that are each shaped using the bag of marbles model, where the contact lines in the figure represent lines connecting the centers of each adjacent pair of spheres.

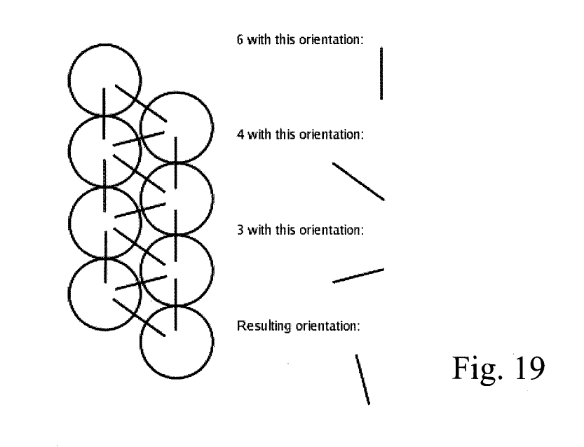

Similarly, lines connecting subspheres can help determine cell orientation. FIG. 19 is a schematic block diagram illustrating one embodiment for calculating the sum vector force of subsphere placement within a virtual cell for determining a modeled cell's resultant spatial orientation in accordance with an embodiment of the disclosure. As illustrated in FIG. 19, the right side of the figure summarizes the orientations of these connecting lines. From this summary, the cell's overall spatial orientation can be evaluated for later application, analysis or reporting, such as determining a direction for cell division. Determining the orientation direction of a cell relative to the amount of resource it contains can be useful for several cell functions. In one example, direction can be designated as a ray or vector originating at the cell center and passing through the center of the subsphere (e.g., cell subunit) with the highest amount of a chosen resource (internal and/or surface concentrations). If the resource is not contained in any of the cell's subspheres, an orientation direction can be chosen randomly. Likewise, if the center of the cell coincides with the center of the subsphere containing the highest amount of resource, an orientation can be chosen randomly.

In one embodiment, without an internally maintained skeleton, there is no need for cells to have a separate coordinate system from that of the overall simulation context (e.g., environment). Rotation and translation of cells can be simple derivatives of the interactions between the subspheres. Further, a cell's orientation can be calculated for specific actions such as cell division.

In some embodiments, when a cell is to divide, its center of mass is determined. For example, a partitioning plane is chosen to intersect the center of mass with a random orientation. In another embodiment, the partitioning plane can be chosen based on asymmetric resource distribution in the cell or among the subspheres. Based on their relation to the dividing plane, the parent cell's subspheres are then allocated to the daughter cells. Any existing intracellular adhesions that cross the dividing plane are removed. Therefore, if division is to take place, the cell must have at least two subspheres. In other configurable embodiments, a cell can have a minimum size requirement that is greater than one subsphere. In such instances, the cell must be twice (2×) the minimum cell size before a division event is permitted.

To represent cells visually, an envelope is rendered around each cell's collection of subspheres. Using various calculations for this visual envelope, cells may be made to appear more lumpy or smooth as aesthetics warrant.

An embodiment including a bag of marbles approach can support the following refinements:
Differences in intracellular adhesions can indicate cellular differentiation as cells undergo continuing development.
Cell energy levels can be integrated with intracellular adhesions: intracellular adhesions can lengthen or relax as cell energy increases. High-energy cells will be more malleable and become more rigid as they lose energy.
Bond stability, the likelihood of two subspheres to continue to adhere, can be treated as a separate factor from energy and so independently control cell cohesion. The higher the cohesion, the more spherical it may tend to be. Stability and adhesion strength (or lengthening) will combine to determine cell rigidity. Further, a cell might be easily deformable (via lower adhesion strength) while retaining a shape memory (via stability) while another cell could resist deformation but readily accept the new shape when deformed.
If subspheres are considered as having mass at uniform density, then the density at which the spheres are held to one another by adhesions allows for varying density of the overall cell.
Cell orientation may be derived from the orientation of the vectors between all subspheres' centers (i.e., a fully connected graph of the marbles). Such orientation may be applied to influence the cell's plane of division. FIG. 19 depicts the determination of cell orientation from intracellular sphere relations.

### D8. Cell Polarity

Because metabolism may be carried out at the subunit level, internal and surface cell resources are localized within subunits. This allows for cell polarization. In one embodiment, a separate resource container for each cell subsphere allows diffusion between subspheres. One subsphere may be chosen to be the “nucleus,” and the only subsphere to perform transcription, while the other subspheres may participate only in metabolic equations. In another embodiment, subspheres may be defined as “inside” or “outside” subspheres, wherein surface molecules are placed on the “outside” subspheres. In further embodiments, cell-cell interactions (e.g., signaling, adhesion strength) represent each cell as some canonical shape (e.g., sphere, cube, diamond, heart, club, spade, etc.) based on the arrangement of cell subspheres. The canonical shape may be used to represent the surface of the cell, with surface molecules distributed on the canonical surface based on the underlying sub spheres.

In other embodiments, signaling may be replaced with fluid droplet signaling. Interior spheres would not have contact with the outside environment in this case. In another embodiment, spheres may be replaced with a different shape, an extreme case being a cube, such that each subunit of the cell would fit together without any gaps between them. A rotation force on subunits would likely be needed (adding additional computation by the system, but would result in more coherent cells and a surface that is easier to calculate. In still other embodiments, different resolution may be used for different molecular and physical interactions. For example, physical shape and presence of a cell may be represented by 10 equal-sized subunits. However, a cell's metabolic portion may be represented by one large sphere (representing the inside core), approximately a dozen medium spheres (allowing for internal differences) and approximately a hundred small spheres representing the outer shell. The numbers used above are used as an example only, and should not be construed as being limiting in terms of quantity or ratio or subunits per cell.

### D9. Projectiles

Projectiles are simulation objects which can be introduced at any step of a simulation for perturbing cells and other objects in the simulation. In one embodiment, projectiles can be configured to be present in a simulation for a specified number of steps. A projectile can be assigned with physical characteristics, such as mass and velocity, as well as assigned a virtual location within the simulation. In one embodiment, the mass, velocity and location can be selected by the user. Projectiles can allow a user to physically interact in real-time with a simulation, allowing for perturbations to developing and/or homeostatic tissue, cells or other objects. In addition to the physical interaction of the projectile, the projectile can be a deadly projectile, e.g., configured with the ability to kill any cells with which the projectile comes into contact. In one embodiment, a projectile can be a spherical object. In one specific example, a user can aim a projectile (using the visualization engine), designate a projectile mass and speed, select whether the projectile is deadly or non-deadly, and fire the projectile.

### D10. Fluid

In some embodiments, the simulation system may use fluids to model various biological systems or phenomena, including, but not limited to the circulatory system, endocrine signaling, tissue barriers to signals or fluid flows, a waterproof epidermis, circulatory transport of nutrients and signals, and drawing blood through a syringe. In living systems, fluids support growing and moving cells and carry dissolved nutrients, wastes, signals, and other chemicals. Fluids are also an important factor in the mechanical and thermal properties of tissues.

A model that incorporates fluids should consider the physical and chemical properties of real fluids (Table 6). Physically, virtual fluids should appropriately occupy space and interact with cells and ECM, both for mechanics and permeation; such capabilities should address fluid pressure, viscosity, density, and resulting flow and any other appropriate physical property of fluids. Chemically, virtual fluids should be capable of containing dissolved molecules or other resources and also capable of dispersing or carrying molecules or other resources by transport via diffusion or other gradients. Such capabilities will also improve signaling, molecule consumption, and cellular barriers to movement of environmental molecules.

TABLE 6
Fluid Concepts

| Physical | Chemical |
|---|---|
| Pressure | Solvency |
| Flow | Diffusion |
| Viscosity | Reactivity |
| Density | |
| Surface tension | |
| Thermal properties | |
| State transitions | |
| Optical properties | |

There are several ways to approach fluid simulation research. The cell-centric fluid simulation described herein focuses on balancing of fidelity, performance, and computational effort. In addition, the fluid simulation described herein is primarily concerned with fluid dynamics within the volume. Higher-fidelity fluid animation models incorporating motion within the volume can be broadly categorized as either grid-based, particle-based or discrete element based models.

Two exemplary fluid model approaches provide different approaches to produce desired capabilities. In one embodiment, a “Fluid Droplets” virtual fluid model may be used, and in another embodiment, an “Environment Nodes” virtual fluid model may be used.

### D10.1 Fluid Droplets Model

According to embodiments of the disclosure, one approach to fluid modeling is a Fluid Droplets model, which is a discrete element-type approach. The fluid droplets model is a bottom-up approach to fluid simulation that keeps with the general philosophy of the simulation system described herein and its design allows straightforward physical interactions.

A discrete element model, like a particle-based model, approaches model fluid as a finite number of particles exerting forces on one another according to their separation (Premoze et al., 2003; Muller et al., 2003; Miller and Pearce, 1989; Desbrun and Gascuel, 1996; and Terzopoulos et al., 1989). Most particle-based approaches balance global interactions using Navier-Stokes equations.

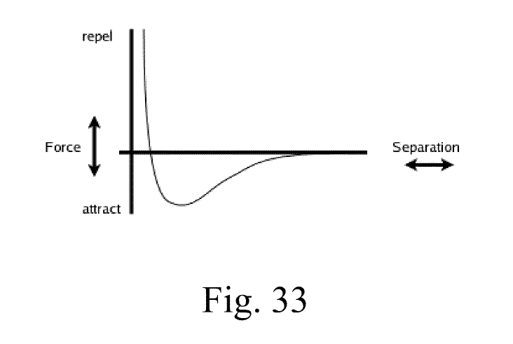

Discrete element methods, however, do not globally balance forces according to the Navier-Stokes equations. Instead, interactions between discrete elements and the environment produce the overall fluid properties in a bottom-up fashion, similar to physical interactions between cells that produce physical tissue properties in a simulation system described herein. Discrete element methods allow simulation of fluids down to a molecular scale with element interactions determined by Coulomb's law, Pauli repulsion, and van der Waals forces as seen in FIG. 33.

In one embodiment, fluid can be represented in the virtual environment by spherical objects designated “droplets.” Droplets can be configured similarly to cell subspheres, ECM subunits, and other physical entities in the simulation system as described herein. For example, droplets can be assigned a radius and density, and can invoke physical-interaction rules for resolving object overlap during stepPhysics iterations.

In some embodiments, fluid droplets can be configured with fluid-type properties such as fluid viscosity. For example, droplets can be configured with an attraction force, analogous to adhesion, that is applied when two or more droplets are within a preset proximity to each other.

Further, fluid models utilized in a virtual environment should be able to work with and interact with all signaling entities within the virtual environment. Examples of signaling entities that may interact with fluid are, but are not limited to, cells and their subspheres, ECM, droplets from different pools, point sources or gradient builders, fixed spheres, differently shaped sources, and any combination thereof.

Cellular subunits receive signals without regard to where they originate. Anything in the virtual environment that isn't part of the cell is “external” to the subunits, including signals that are (1) “floating free” in contacting fluid droplets, (2) presented on the surface of a contacting neighbor cell, (3) presented on the surface of contacting ECM units, and/or (4) presented from a gradient builder. In some embodiments where the cellular subunit does not know where the resources come from, unused externally-presented resources (and those it has produced for export in metabolism) are distributed between all of the signaling entities it is contacting.

Particle-based and discrete element methods have proven especially useful for state transition simulations, interactive simulations, mixing of different fluids, and where fine-grained features such as pore-sizes in barriers become important. In some cases, particle interaction rules may require careful consideration to avoid producing an O(n²) problem with limited scalability.

Further, discrete element models are the most appropriate when the amount of fluid in the simulation is relatively small compared to the total environmental volume or the demand for fine-grained interactions justifies potential computational penalties. Particle-based and discrete element methods are infrequently used in high-resolution simulations where visual quality is a high priority due to the difficulty in making larger particles look like a smooth fluid (Carlson, 2004). Increasing the number of particles to improve resolution increases the computational costs.

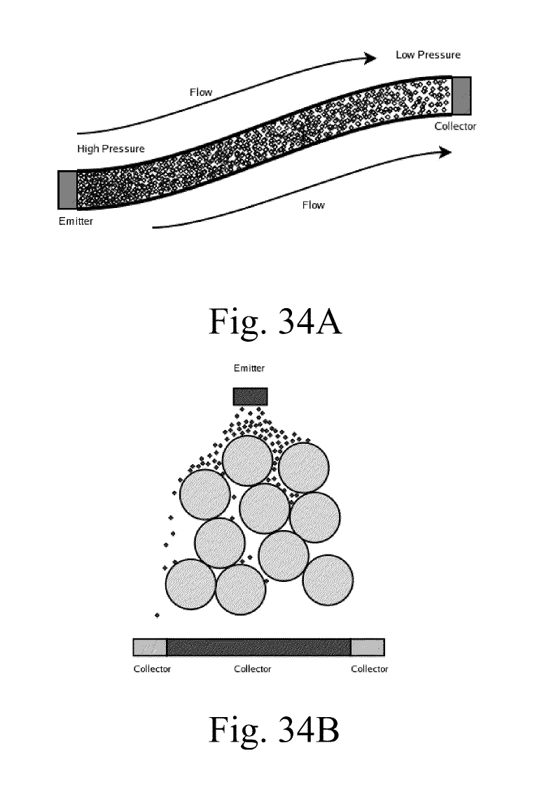

Fluid Droplets can be represented by relatively small physical spheres, similar to those of which cellular subunits and ECM are composed. Existing sphere collision rules provide fluid pressures consistent and compatible with the embodiments described herein. Flow results from a pressure imbalance, wherein fluid droplets move from higher pressure to lower pressure as illustrated in FIG. 34A.

In some embodiments, fluid viscosity may be modeled by separation-based weak attractions between droplets as in particle-based or discrete element models. Viscosity is varied by altering attraction relationships between fluid droplets, wherein an increased attraction relationship will create friction-like forces, increasing the virtual viscosity. Unlike adhesions between other physical entities, attraction relationships do not require droplets to contact one another. For fluids to exert friction-like forces on or stick to non-fluid elements, similar attraction forces may be applied between fluid and non-fluid elements.

In some embodiments, fluid droplets are integral to intercellular resource transport. Resource transport requires that fluid droplets accept molecules from the environment and later release them back to the environment. While in the fluid, resources diffuse between droplets. The transportation process, then, consists of at least these three steps. First, the resources are absorbed into fluid droplets according to the concentration differential between the source and fluid droplet. Second, resources diffuse from one fluid droplet to a contacting droplet according to the concentration differential between the two units and/or diffusion rate modifiers particular to each resource type and/or the fluid itself. Third, resources carried in fluid droplets are released to non-fluid target entities according to the concentration differential between the fluid droplet and target.

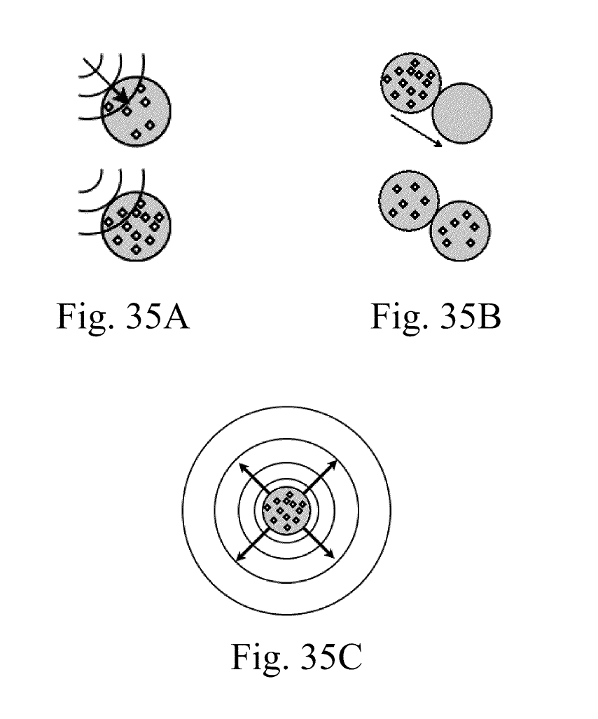

When the concentration of a resource is higher in the environment or other contacting entity than in a fluid droplet, the droplet absorbs resources at a rate relative to the difference in concentration (FIG. 35A). Likewise, if the concentration in the droplet is higher than in the environment or other contacting entity, it releases that resource back to that target at a rate relative to the concentration difference and decreases its internal concentration accordingly (FIG. 35C).

Resource exchanges can also occur as a result of contact between droplets. If a droplet containing a resource collides with a droplet containing less of that resource, a quantity relative to the concentration difference is transferred from the high-concentration droplet to the low-concentration droplet. Over time, such inter-droplet transfers will uniformly distribute transported resources throughout the liquid (FIG. 35B).

In some embodiments, emitter and collector objects may be used for inducing and sustaining flow through a vessel. An emitter produces some configurable number of fluid droplets per step in a particular direction while a collector removes any droplets that touch it. To create a circulatory system for resource transport without requiring a closed loop or pump mechanism, droplets removed by a collector at one end of a vessel can be placed into the pool for the emitter at the other end with their contents and any other properties preserved (FIG. 34A).

In other embodiments, emitters and collectors can test barrier functions of tissues (FIG. 34B). Placing a collector below the tissue, the rate of droplet collection can be compared to the rate of droplet emission. Alternatively, if the number of emitted droplets is fixed, the percentage of droplets reaching the collector could be measured. Additional non-tracking collectors placed around the tracking collector would remove any droplets falling outside the area of interest as shown.

### D10.2 Environment Nodes Model

In some embodiments, fluid can be represented in the virtual environment by a grid-based “node” environment known as an environment nodes fluid model. An environment nodes fluid model is similar to grid-based approaches. Grid-based methods have an environment that is divided into many small volumes (Carlson, 2004). Typically, faces of each grid cell provide locations for vector values including velocities. Scalar values such as pressure are stored in the center. The velocity field, pressures, and other forces are globally rebalanced in each simulation step according to Navier-Stokes equations describing movement within a fluid.

Statically-sized and organized grids are efficient for computation. However, a grid-based approach must account for the whole environment at all times (i.e., anywhere fluid could be), which may impact performance and hinder scalability where fluids do not occupy a significant portion of the total simulation volume. Therefore, grid-based methods are most appropriate when all or most of the environment is fluid-filled, the environmental bounds can be fixed for the duration of the simulation, and the grid resolution provides both realism and performance.

The basic fluid concepts for an environmental node model are similar to the fluid droplets model, but rather than approaching fluids as a collection of many small elements or spheres, an environment nodes model subdivides the entire simulation environment into smaller volume units, or “nodes,” and tracks the contents of each node. Movement of contents from one node to another is based on unresolved forces (e.g., pressure differences) in the case of fluids and on concentration differences in the case of dissolved or suspended resources.

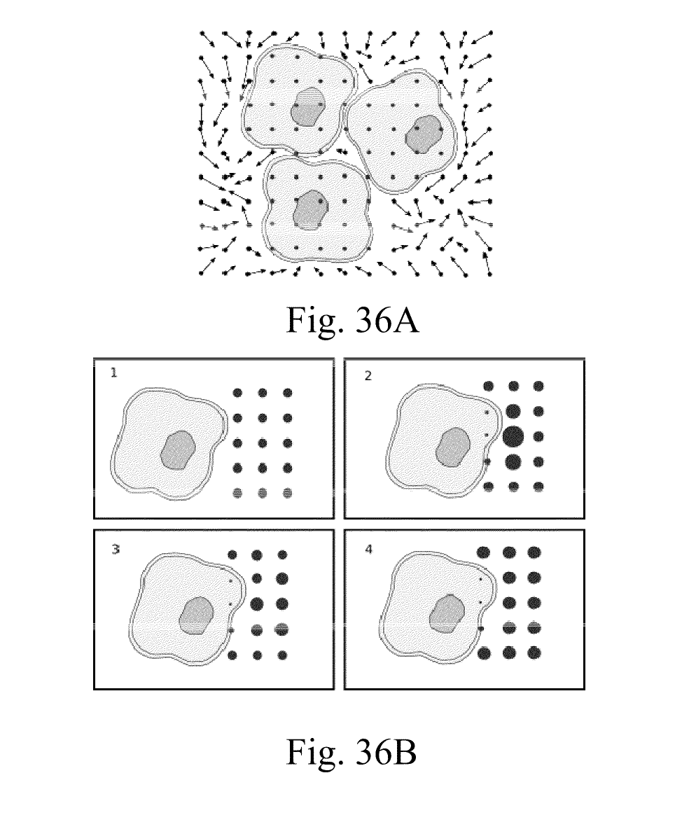

According to some embodiments, a plurality of environment nodes can be found in a particular virtual environment at specific regularly-spaced locations. Each node represents a solution comprising one or more solutes in one or more solvents. In some aspects, the solutes may be in the form of a resource or molecule. The quantity of molecules found in solution at each node is represented by a list of resources found in solution at that specific location. The solution that contains the resources has a solvent, or fluid as described herein. Different amounts of solvent in adjacent nodes reflect a difference in pressure that is resolved through movement of the solution (FIG. 36A). When solvent moves and flows from node to node due to an unresolved force, the solutes (or resources) similarly flow within the solvent.

In addition to resource transportation through solvent flow, resource concentrations in one node are compared to those of neighboring nodes to identify concentration differentials. Resources shift between neighboring nodes according to these concentration differentials, modeling diffusion. Diffusion rates could be universal or could depend on properties of resources or fluids.

When a node is occluded by a cell or ECM, its fluid and solutes are displaced to adjacent nodes. This is illustrated in FIG. 36B: In frame 1, a cell moves toward a stabilized region of environment nodes. In frame 2, the cell fully occludes 2 nodes and partially occludes a third node, displacing the contents of those nodes to adjacent nodes. Rebalancing of pressures in frame 3 leads to a new stable organization in frame 4. When a node is vacated, on the other hand, its zero pressure causes an influx of resources from adjacent nodes to fill the void. For fluids to exert forces on other entities, node pressures can be translated into forces on adjacent physical entities.

As with the fluid droplets model, some aspects of the environment nodes model can also test tissue barrier functions. In some embodiments, the simulation space is filled with fluid, and a marker resource may be introduced into nodes on one side of the barrier by a resource emitter. Measuring the marker concentration in collectors on the opposite side of the barrier after some elapsed time would give an indication of its diffusion through nodes within the barrier. In another embodiment, wherein the simulation space is not filled with fluid, fluids may be introduced by an emitter above a barrier and collected below the barrier.

In another embodiment, the environment nodes model may be used for aspects of visualization. In some aspects, fluid flows may be visualized by showing the velocity vector field. In other aspects, movement of each particular resource can also be visualized by showing its diffusion vector field or concentration differential vector field.

### D10.3 Intercellular Signaling and Resource Distribution in Fluid Models

According to embodiments of the disclosure, the use of fluid droplet and environment node fluid models may be used in intercellular signaling and resource distribution. One method may utilize point sources for distribution of extracellular resources that travel by diffusion. As an alternative embodiment to distributing resources from a cell or point source, resources may be placed into fluid contacting the source. In one aspect of this embodiment, resources may be transported by fluid through some combination of diffusion and flow, and then may be transferred to contacting cells with matching surface receptors. Resources carried by droplets require a contiguous medium to be transported from a signaling cell (or other resource emitter) to a non-contacting receiving cell; therefore, fluid signaling makes it possible for tissues to form signaling barriers. Resources can be added to a simulation (e.g., by a user) and absorbed by the droplets, and droplets can be configured to uptake resources exported by cells. Such extracellular resources can be transferred between droplets or between droplets and other cells, e.g., from droplets with higher concentration to droplets with lower concentration in accordance with relative concentration differences. This is an alternative embodiment, and is not meant to limit cell contact. Contacting cells may also communicate directly with one another as described herein.

### D10.4 Performance, Compromise and Optimization

Simulating fluids is computationally demanding. Even when rendering is excluded, it may take hours to calculate the motions in a single second of simulation time for a modest-sized, high-fidelity simulation. For example, in Carlson's grid-based “gears-and-bunnies” test described in, computing time for the first second of simulation time ranged between 1 and 3 hours on a 2 GHz Pentium 4 with 1 GB of RAM (Carlson, 2004; Carlson, et al., 2004].

Particle-based techniques are similarly demanding. Muller et al. (2003) are considered noteworthy for having achieved interactive rates with up to 5,000 particles using a “Smoothed Particle Hydrodynamics” model and Premoze et al. (2003) reported interactive rates with as many as 10,000 particles using a Moving Particle Semi-implicit approach. By comparison, moderately-sized tissues modeled by a cell-centric simulator described herein may contain more than 10,000 cell subunits.

In an environment nodes model, the computational demand may be attributed to, in part, through the use of Navier-Stokes equations to globally balance many factors including the velocity field of the fluid, pressures, density, viscosity, and other forces (Premoze et al., 2003). The Navier-Stokes equations may also consider additional factors including molecular diffusion, surface effects such as surface tension and surface curvature, conservation of mass and energy, thermal properties, and state transitions. Although discrete element methods, such as droplet models, avoid global balancing, computation of the forces between many elements can also be extremely costly and may often require optimization to run at acceptable rates.

The simulations described herein require biologically-faithful models, but also demand high performance for the sake of interactive sessions and for inclusion in genetic algorithm searches which must execute and evaluate many simulation runs quickly. Because of the strengths and weaknesses of each approach, a simulation can use different approaches or models based on the type of environment or performance needed.

To strike the appropriate balance between fidelity/accuracy and performance, a selected fluid model approach should be chosen that is conceptually sound from a biological viewpoint, but not overly complex. In some aspects, complexity may be added incrementally to provide desired functionality.

In some embodiments, virtual fluids transport environmental resources, occupy space, appropriately pass through openings, and exert and respond to pressure and other forces, including gravity. Pressure differentials can produce flows within a fluid. Tissue permeability testing requires that fluids pass through barrier pores. For resource transport, resources should pass from cells to fluid, diffuse through the fluid, and finally pass from the fluid to other cells.

Strict global balancing of fluid pressures and velocities would place a higher demand on physical fidelity than other non-fluid embodiments described. Collision interactions in an ontogeny engine of a cell-centric simulator described herein take an iterative approach, allowing imbalances at the end of one step to carry over to the next step. A similar degree of physical fidelity in a virtual fluid model may be used in currently identified applications.

The fluid droplets model calls for either a large number of small droplets or fewer larger droplets for appropriate occupation of space and exertion of pressures. Larger droplets can improve performance while smaller droplets can improve fidelity. Optimization of the fluid droplets model to achieve high performance with high fidelity operates by a balance. In some embodiments, when performance is more important than fidelity, larger fluid droplets may be used and, where finer-grained fidelity is required, smaller fluid droplets may be used with the understanding that performance will be adversely affected.

In other embodiments, particle-based techniques including the fluid droplets model, may merge particles in areas of low activity or where interactions do not require fine resolution. For example, in a static fluid volume, interior droplets interact only with other fluid particles and there is little movement between steps. Many of these particles may be merged. Similarly, within a vessel, interior droplets are surrounded only by other fluid droplets moving in the same direction. Interior droplets might be merged while droplets adjacent to the vessel walls remain at a smaller size to more accurately interact with the vessel walls.

In some embodiments, droplets may come in two sizes—one for interactions between droplets and another for interactions with any non-fluid units. Interior droplets, then, could occupy a substantial volume while still allowing perimeter droplets to pass through small openings. In some aspects, a larger sized droplet may be used for exerting pressures and a smaller size may be used to determine when a droplet can pass through an opening. This may require a way of recognizing gaps and deciding whether a droplet is being pressured toward them. In further embodiments, small droplets may occupy larger volumes if each droplet were moved some distance in random directions some number of times in each simulation step, providing opportunities for each droplet to collide with neighboring objects.

In other embodiments, optimization of the environment nodes model may also be considered. Similar to the fluid droplet model, some embodiments of environment nodes may be optimized by merging nodes that do not have fluids, are in low activity areas, or are in non-critical area. Nodes without fluids may also be eliminated from operations such as diffusion.

It is likely that there would be more nodes than droplets in any non-trivial simulation given similar granularity. This does not necessarily translate into decreased performance because of the temporal coherence inherent in the grid layout. By virtue of their static arrangement, nodes detect the contents of neighboring nodes without need for any calculation while droplets must continually detect fluid and non-fluid neighbors alike.

However, environment nodes do not avoid collision detection in their interactions with cells and ECM. Node occlusion checking should be dovetailed with physics steps and, whereas droplets require no special consideration to interact with other physical entities, physical interactions between nodes and physical entities require translation.

### D11. Extracellular Matrix

According to embodiments of the disclosure, a simulation system and platform described herein may include the production (and destruction) of an extracellular matrix (ECM). Extracellular matrix (ECM) is a broad term that includes a wide variety of extracellular macromolecule components created by cells that provide support for the cells themselves and any tissue with which it is associated. ECM is important to tissues, and support by ECM components may include providing structure and mechanical properties to tissues, influencing survival, development, shape, polarity, and behavior of cells. The ECM components may also affect extracellular chemistry. Bone, cartilage, tendons and ligaments are examples of tissues that primarily comprise ECM, but most tissues in the body contain at least some ECM components. The dermis of the skin, for example, comprises ECM components that may include collagens, elastic tissue, and assorted ground substance molecules, such as hyaluronan. Basal lamina under epithelial tissues (such as the basement membrane under the epidermis of the skin) are constructed of a mesh of different ECM component types. In general, ECM components include various protein fibers interwoven in a hydrated gel of glycosaminoglycan (GAG) chains.

Most collagens are strong filaments that can be bundled to form stronger and more stable cable-like fibers. Collagen fibers provide a great deal of the strength and elasticity of the dermis. Elastic fibers in the dermis form a network of arbitrary branches throughout the dermis and help return the dermis (and, by extension, the skin) to its original configuration after deformation. Ground substance molecules like hyaluronan are non-fibrous, loosely folded molecules that are often thought of as merely “filler.” However, ground substance molecules contribute both to the mechanical and chemical properties of tissues. The high water-binding capacity of these molecules give the dermis its compression resistance while offering little resistance to active movement of cells. Depending on the specific substrates from which they are constructed, they also affect the passage of other molecules and signal contacting cells.

Cells may excrete ECM molecules in their entirety, they may excrete precursors and assemble them in deep pockets on their surfaces, or they may excrete precursor building blocks for self-assembly in the extracellular space. ECM molecules, like most other substances in the body, break down and need to be maintained. Different ECM components break down at different rates and those rates can depend on the organization of the ECM. For example, collagen fibers will decay at the ends faster than in the middle. Thus, their organization into thick bundles protects the individual strands. To facilitate cell migration, cells may release proteases (chemicals that dissolve target proteins) to clear a path through ECM or may have proteases on their surfaces to facilitate moving through or crawling on ECM.

### D11.1 Extracellular Matrix Components

The Extracellular Matrix (ECM) and its components as provided for herein includes a very diverse set of molecules with different properties. The ECM interacts with cells chemically as well as physically, and is produced, formed and organized by the cells.

There are two main classes of ECM molecular components: (1) glycosaminoglycans (GAGs), which are often in the form of proteoglycans (PGs), but are not limited to such, and (2) fibrous proteins including, but not limited to collagen, elastin, fibronectin, and laminin. Members of both classes come in a great variety of shapes and sizes. PGs form a highly hydrated, gel-like “ground substance” in which the fibrous proteins are embedded.

Individual collagen fibrils are thin structures (10-300 nm in diameter) but may be many hundreds of micrometers long in mature tissues. (By comparison, the diameter of a very small human cell like a red blood cell is about 8 um.) They often aggregate into larger, cable-like bundles up to several micrometers in diameter (˜0.5-3 um) which can be seen in light microscopes as collagen fibers. Fibrils are much narrower than any cell, but when bundled into fibers they may be nearly as thick as a very small cell.

Basal laminae are flexible, thin (40-120 nm thick) mats of ECM that underlie all epithelial sheets and tubes and surround individual muscle cells, fat cells, and Schwann cells (which in turn wrap around peripheral nerve cell axons to form myelin). Thus, they separate these cells and epithelia from underlying or surrounding connective tissue. Basal laminae may also act as a filter, such as in the kidney glomerulus, which has a basal lamina that lies between two cell sheets that acts as a highly selective filter.

In one embodiment ECM components are comprised of a plurality of ECM “units” or “subunits,” that can be represented in the virtual environment by spherical (or other suitable configured shape) objects having cellular subsphere properties that are similar to intracellular properties. To simulate the long, thin properties of fibrils and their fiber aggregates, the ECM units may configured using adhesion connections to create chains that are more or less strong (rigidity) and more or less elastic (elasticity). The strength of these adhesion connections contributes to strength of resistance of the fibrils and their fiber aggregates to tension stress; that is, their tensile strength. However, a, ECM unit sphere binds indiscriminately, whereas ECM fibers have a distinct orientation. Therefore, orientation may be incorporated to ECM unit spheres and attachment points may be limited to encourage specific organization. For filament construction, for example, strong adhesions may be made to exist only at 2 opposing points on the ECM unit sphere. For cross-linking, however, a certain number of attachments of a different kind orthogonal to the main axis may be allowed. For two-dimensional (2D) meshes (like basement membranes) we can allow ECM unit spheres to have 2 equivalent orthogonal axes.

The ECM unit spheres should not be of the same size or size range as cellular spheres and cells described herein, otherwise the scale of ECM will be off and minimal chains will be too big. Cells should be much larger than the fibrils. ECM units may have a variety of physical interactions. Properties such as elasticity, rigidity and others may be useful in creating structurally distinct ECM types.

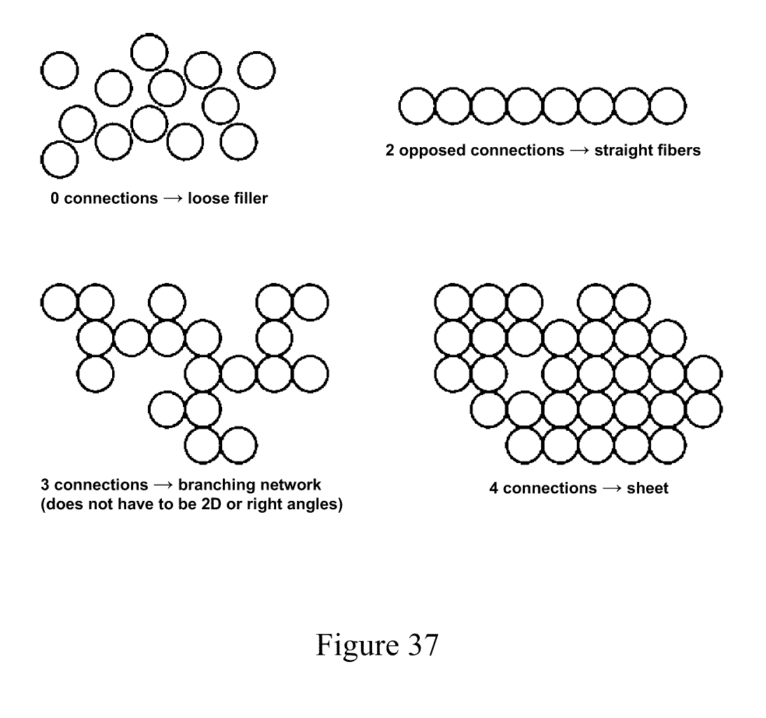

In some embodiments, collagen fibers and a variety of other ECM fibers may be modeled by limiting attachments to opposing points or “ends” of the spheres, and giving the spheres and attachments high rigidity. For a more simplistic model, cells could interact with fibers to simply increase the rigidity of filaments for a similar net effect. (FIG. 37, “2 opposed connections”). For example, a two-connection fiber as shown in FIG. 37 can make a good foundation for collagen if the rigidity is high enough that the fiber is straight.

In some embodiments, elastic fibers may be modeled by limiting attachments to a few (e.g., 3) attachment points to allow branching and giving the spheres and attachments high elasticity. (FIG. 37, “3 connections”) The 3-connection network as shown in FIG. 37 can make a foundation for elastic fibers if elasticity is high enough that networks are very hard to break and rigidity is high enough that stretched networks exert meaningful force to return to compact organization.

In further embodiments, ground substance molecules (such as PGs) can be modeled by loose spheres that resist compression and interact chemically in the model and would be easy to move around provided all adhesions between them or with cells are weak at best. (FIG. 37, “0 connections”)

In yet further embodiments, a basement membrane may be modeled by forming a 2D mesh or sheet. The sheet may be constructed by allowing 4-6 evenly spaced connections around each sphere in a plane. To form a flat sheet out of randomly oriented spheres, it may be necessary to orient the axes of a previously unattached sphere to those of an already attached sphere when an attachment is made. (FIG. 37, “4 connections”).

Cells may be configured to manipulate the ECM units in many ways. Cells can deposit molecules within the ECM units, leaving markers in the environment. ECM units can be destroyed by nearby cells causing the cells to rearrange, thereby causing the tissue to function differently.

### D11.2 Production and Organization of ECM

According to some embodiments, an ECM unit may be created by a structural gene that may encode the information necessary to specify a particular ECM unit including its cellular adhesion and signaling properties and its connectivity properties such as 2-opposed connections with rigidity X, elasticity Y, plasticity Z, etc. When a particular threshold of such a product is reached, it is placed into the environment just outside the cell. In some embodiments, this process may be automatic, wherein in other embodiments, the product could be transported as part of a metabolic equation. In some embodiments, ECM resources can have a decay probability that depends on the number of connections. If a collagen unit, for example, is placed in the environment and doesn't join others as part of a fiber, it will likely decay. A collagen-type ECM unit within a fiber can be more protected from decay than a collagen-type ECM unit on the end of a fiber.

According to some embodiments, ECM units may be configured as if they are a specialized cell line or cell type. In some embodiments, the ECM cell line or subunits may be configured to model a basement membrane. Constructing and repairing the basement membrane requires development of many of the basic capabilities that are needed for general ECM modeling.

To place new ECM units into the environment where they are needed and where they may become integrated into a target ECM structure, a cell must be able to detect from which direction signals are coming. For example, basal epidermal cells are responsible for forming and repairing the basement membrane which has the form of a contiguous sheet and may be constructed of spheres with only 4-6 allowed adhesions in a plane to like ECM units. To produce and repair the basement membrane, basal cells should be able to detect when new ECM needs to be produced. In addition, basal cells should be able to add a non-cell sphere, or ECM unit, to the extracellular environment containing all necessary configurations to assume its role in the basement membrane. In some embodiments, ECM units in an existing basement membrane may present signals to basal epidermal cells. By directing the placement of an ECM unit toward these signals, basal cells will more likely place a new ECM unit in the proper location.

If a cell is able to recognize that it is on an edge of the basement membrane (based on the amount of signal it is receiving from contact with the basement membrane), the direction where new ECM units should be added with the greatest probability of being assimilated with the existing membrane is in the direction from which existing basement membrane signal is being received.

Basement membrane ECM units that are misplaced or otherwise fail to become part of the basement membrane should decay. Units with no adhesions to other ECM units are more prone to decay than units with one or more allowed adhesions. For example, a unit that is allowed 4 adhesions with other units might have a 0% probability of decay for each step if it is fully connected. If a unit has no adhesions, it might have a probability of decay of 40%, or some other reasonable configured rate). The probability of decay would be scaled according to the proportion of potential adhesions an ECM unit has. The hypothetical 4-adhesion sphere might have 40% decay probability for no adhesions, 30% for 1 adhesion, 20% for 2 adhesions, 10% for 3 adhesions and 0% for 4 adhesions.

### D11.3 Oriented Responses and ECM

Cells may respond to external influences with an “oriented response,” which allows action to be taken by cells with recognition of orientation and position relative to other cells and environmental components. In one embodiment, an oriented response may be beneficial when a group of cells needs to collectively produce ECM components in the same direction, or divide along a common plane. External influences such as gradients, signaling, and adhesions have associated positional information. This positional information can be used in model rules to produce behavior oriented with the direction of the influence. The external influences should include, but should not be limited to, external molecules, intercellular adhesions and ECM-cell adhesions.

A rule specifies orientation using a surface molecule involved with external influence. For example, when a cell is presented with a molecule from another cell, the contributions from those cells would produce a ‘location of highest influence’ (LHI) somewhere on the membrane. The vector from the center of the cell to the LHI is called the direction of influence. A cell might use this information in several ways. The cell could divide along the plane that is perpendicular to the direction of the LHI. The cell could prefer (or boost) internal adhesions that were nearly parallel (or perpendicular) to the direction of the LHI. The cell could send external products in the direction of the LHI (or the reverse, or perpendicular).

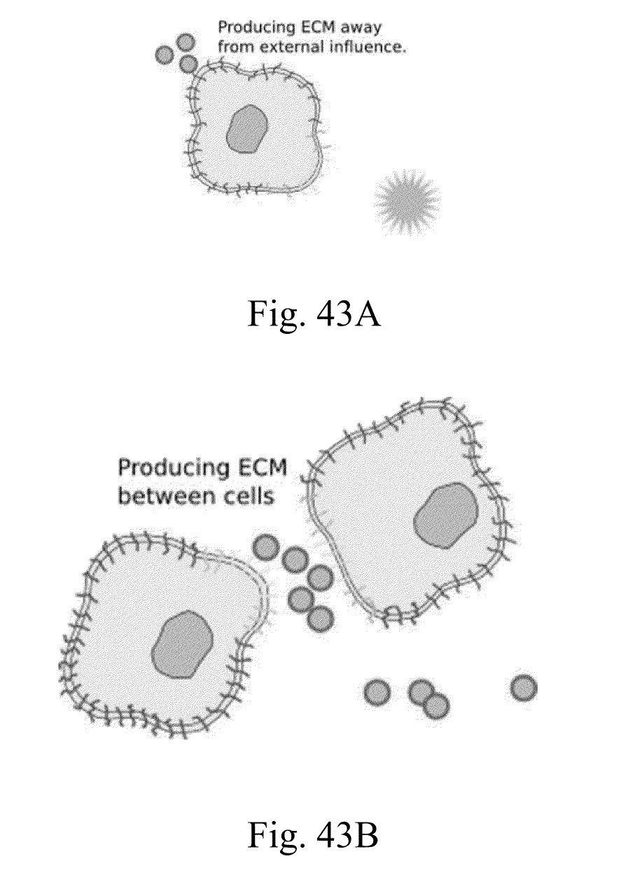

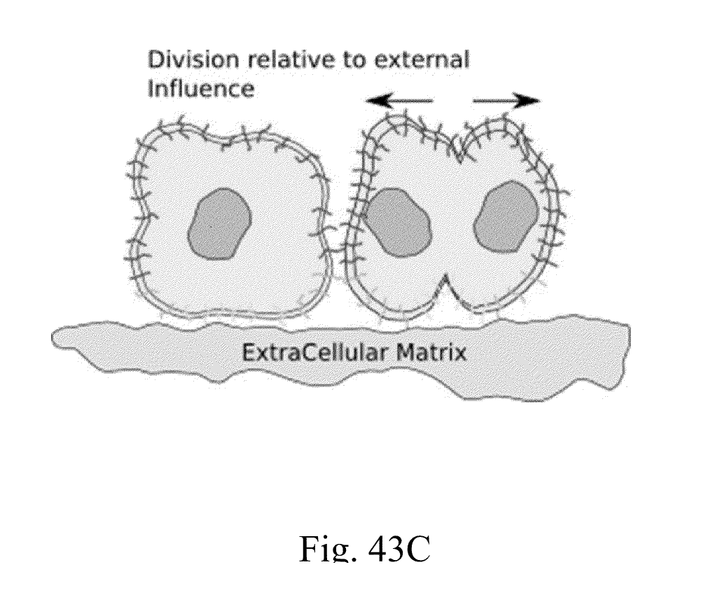

The trans-membrane lines in FIGS. 43A-43C represent surface molecules. They are situated to be both receptive to outside influence and informative to the cell interior. In one embodiment, the surface molecules closest to the sun-like gradient source in FIG. 43A are most activated by the molecular gradient and provide the cell with its LHI point of reference. If the direction modifier for ECM production is away from this point of reference, ECM units are produced opposite the LHI (FIG. 43A). In another embodiment, a nearby cell may provide another cell with its LHI point of reference. If the direction modifier for the ECM production is toward this point of reference, ECM units are produced between cells (FIG. 43B). In another embodiment, an external influence such as a basement membrane or other ECM units may influence the cell to divide relative to the external influence (FIG. 43C)

BasementMembraneReceptor in these examples is the surface molecule denoting direction. In the case of external gradients and signaling, the surface molecule responsible for transport or reception should have the direction associated with it. In the case of adhesions, the surface molecule responsible for the adhesion will have the direction associated with it. One of three keywords indicate the cell orientation relative to the LHI: toward, away, or perpendicular. A direction may be used for each rule. The direction may be formatted in the configuration file as: <modifier (toward, away, perpendicular)> <surface molecule>.

To maintain model fidelity, the simulated cell should not be able to detect the location of the external resource source, but instead may only detect the location on its surface at which external resources are being presented. The surface of the cell may be divided according to the cellular subspheres as surface subspheres. External resources are then cached into the cell by way of each cellular subsphere. Because external resources only affect metabolic equations, this mapping is passed to metabolic equations during their processing. Metabolic equations are then processed on a sphere by sphere basis to determine the activity level of surface resources in each sphere.

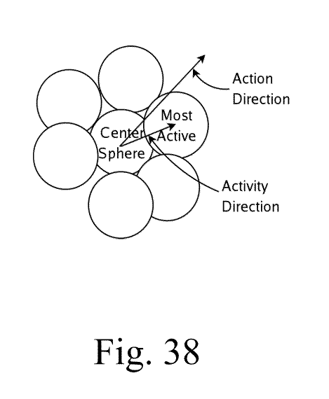

As illustrated in FIG. 38, when an action needs to have a direction based on oriented response, an activity direction vector and an action direction vector are determined. First, the surface subsphere having the most active surface resource matching the resource specified in the direction (determined by the metabolic equations) and the center sphere (i.e., the sphere closest to the center of mass) are identified. The activity direction vector is determined by creating a direction vector from the center sphere to the active sphere. The action direction is then a random vector at a specified angle from the activity direction. This angle can be specified by using a floating point value representing the angle in degrees or by keywords (toward, away, perpendicular, random) where toward is 0 degrees, away is 180 degrees, and perpendicular is 90 degrees. Having found the action and activity direction vectors, the cell may place and arrange ECM units, the details of which are described below.

### D11.4 Placement and Arrangement of ECM Units

When ECM units are produced, they are placed at a point on the surface of the cell. The methods for determining where an ECM unit should be placed according to an oriented response by first finding action and activity direction vectors as described above.

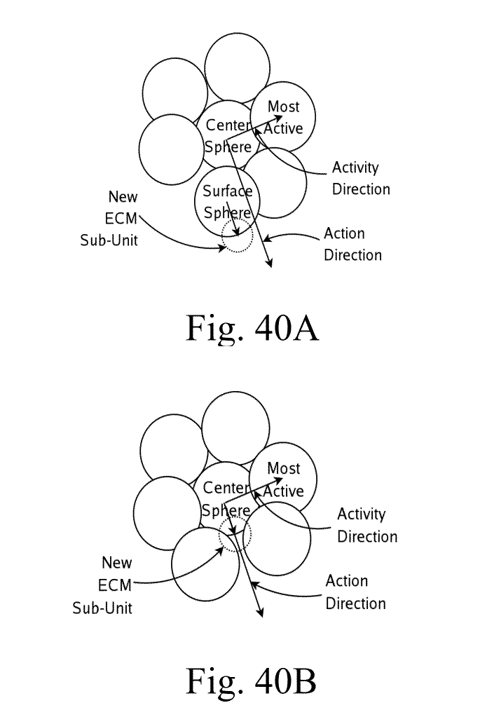

As illustrated in FIG. 40A, one way to determine placement location is as follows. First, action and activity direction vectors are determined according to an oriented response to external influence as described above. The cellular subsphere that intersects the action direction vector and is the farthest from the center sphere is used as the surface sphere. Then, a point on the selected surface sphere in the direction of the action direction vector is chosen as the point of placement for the center of the ECM unit.

Occasionally, as demonstrated in FIG. 40B, the action direction vector does not intersect with what would be considered a surface sphere, and the ECM is placed in a location that is internal to the cell. When this occurs, the ECM subunit will likely decay, given a sufficient decay rate.

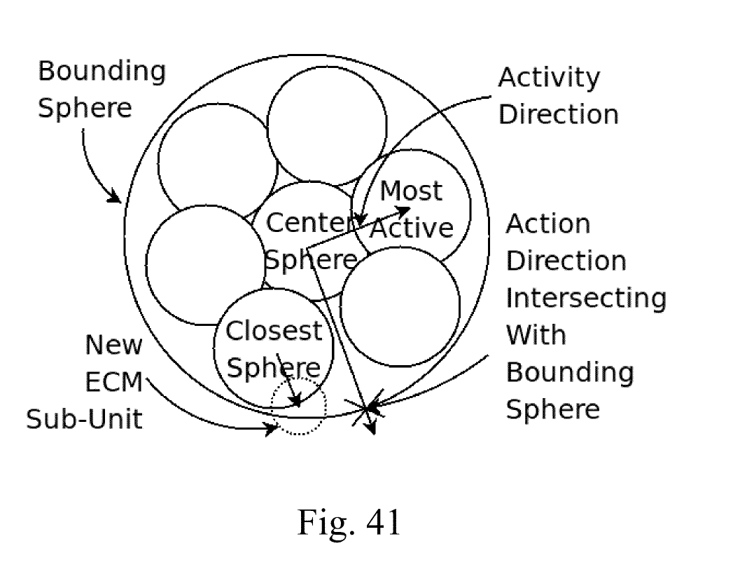

In some embodiments, a user may want to ensure that an ECM unit is placed on a surface sphere. In this case, as shown in FIG. 41, after finding the action direction vector as described above, a bounding sphere is created around the cell, and then the intersection of the action direction vector and the bounding sphere is determined. The closest sphere to the intersection between the bounding sphere and the action direction vector will be a surface sphere. The ECM subunit is then placed on the surface of the sphere in the action direction.

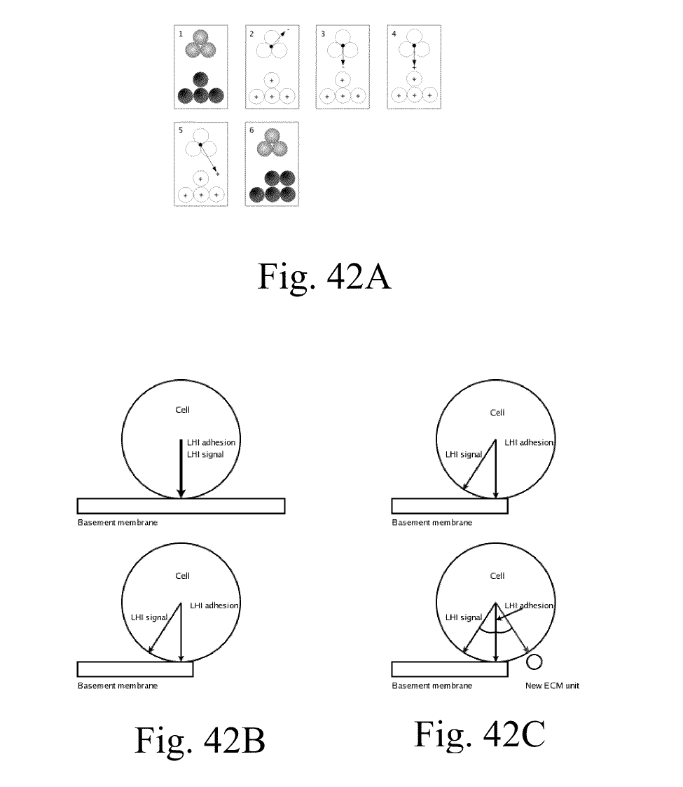

In another embodiment, ECM placement may be accomplished using attraction and repulsion concepts of opposing or matching polarity. FIG. 42A shows a cell above a collection of ECM units. FIG. 42A frame 2 shows the ECM units as having a positive charge while the cell has a non-physical appendage anchored at one end at its center of mass, but freely movable at the other end where it is negatively-charged. In frame 3 of FIG. 42A, the attraction of the negative and positive charges has drawn the cell's appendage into orientation with the direction of the positive field from ECM. When the cell is ready to place a new ECM unit in the environment, it may switch the polarity of its appendage and allow it a limited range of deflected motion as shown in frame 4, such that placement is not always perfectly in-line with the electrostatic field as shown in frame 5 (FIG. 42A). In FIG. 42A, frame 6, a new ECM unit has been placed according to this procedure.

In some cases, a discrepancy between two locations of highest influence may exist. For example, as shown in FIGS. 42B-C, if the LHI from a basal cell's adhesion to the basement membrane points one way but the direction of highest influence of a signal coming from the basement membrane points in another direction, the cell might conclude that it is on an edge and place a new ECM unit in a position mirrored from the signal LHI through the adhesion LHI.

The method of arranging ECM units is accomplished by two types of adhesions, “mutually repulsive” and “coplanar,” each of which contains a central sphere and any number of connected spheres. These adhesion types are reflected in the ECM definition. The Maximum binding distance was added to the ECM definition to specify the breaking distance of intra-ECM adhesions. The breaking distance is analogous to the elasticity property of intracellular adhesions and defined the distance at which the adhesion would be severed. Alignment strength was added to help the user fine tune the alignment properties of ECM. This value is a multiplier used in the application of forces which attempt to align the ECM subunits in their desired configuration. Alignment strength is further discussed in section E8. below.

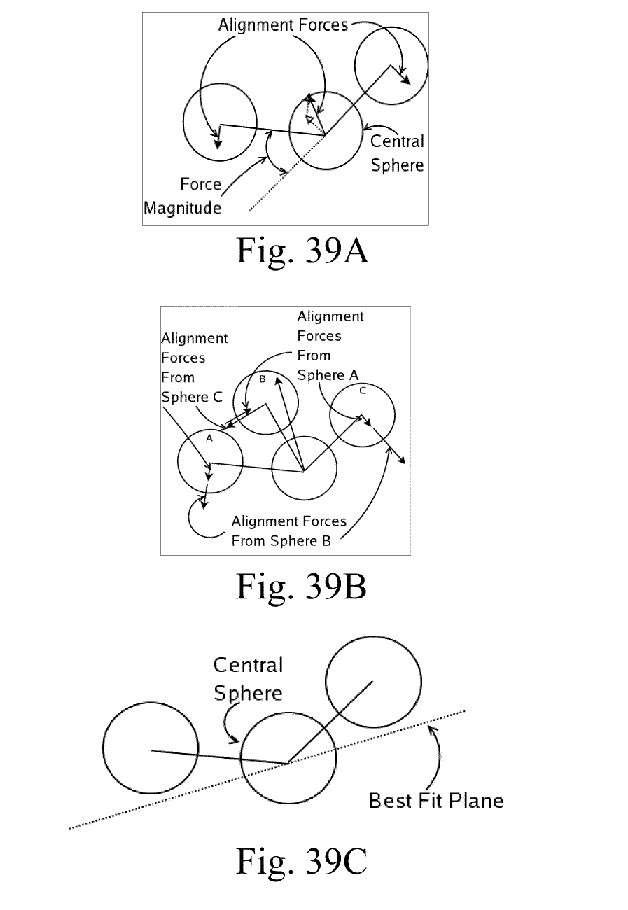

As illustrated in FIGS. 39A and 39B, to arrange the ECM units in a mutually repulsive fashion, each possible pair of connected spheres in a mutually repulsive adhesion is considered, along with the central sphere. These three spheres form an angle with the vertex at the center of the central sphere, and rays passing through the center of each of the other two spheres. A force proportional to the supplement of this angle is then added to the connected spheres in a direction which will help them move apart. The opposite of these forces is also applied to the central sphere.

As illustrated in FIG. 39C, to arrange the ECM subunits in a coplanar fashion, the location of the connected spheres is used to determine the best fit plane which minimizes the total distance from the plane to each sphere. This best fit plane is then used in a similar fashion to the mutually repulsive adhesions to apply forces which would help the spheres align on this plane. In addition, when 3 or more spheres exist in this adhesion, they are also treated as mutually repulsive, to help them line up evenly around the central sphere.

### D11.5 ECM Destruction

In one embodiment, ECM that is introduced in a particular model may be removed by allowing it to decay naturally. The decay rate of ECM may be a combination of a specified decay rate and a probability based on how many of the ECM subunits available adhesion points are used. ECM subunits that are completely connected—that is, they have no free adhesion binding sites—should not decay.

Cells may construct, destroy, and change ECM to produce tissue level results in the organism. Therefore, in some embodiments, virtual cells in the modeling platform may be configured to selectively remove extra-cellular matrix (ECM) from the simulation.

In another embodiment, virtual cells may have a resource on their surface that will destroy ECM on contact. The ECM definition includes “Destroyer Resource” and “Destroyer Amount” fields that specify a name and the amount of resource required to destroy it, so a cell may destroy some types of ECM units while leaving others alone. In one embodiment, the effect of the destroyer resource is not cumulative, meaning that ECM which is in contact with multiple cells can only be destroyed if at least one of them has reached the amount of resource required to destroy it and furthermore, the destroyer resource is not accumulated in ECM subunits over multiple steps In another embodiment, ECM units may be removed by the cumulative destroyer signals from any nearby cells or other sources.

### D11.6 General Performance of System Having ECM

The addition of ECM adds more objects to the simulation and may have an effect on the system's performance. For example, metabolic equations would require more passes to calculate, and an oriented response adds a significant amount of calculation to determine. To reduce the overhead of copying, creating and comparing resources and to make it easier to use resources in maps, the resource catalog holds an array of resources. The index of the array for each resource contains an alias, or molecule ID, and throughout the code the molecule ID is used in place of actual resources.

The resource catalog is consulted during transcription to determine affinity values, which can be cached for performance. All other places can now compare for resource equality with a simple check for integer equality. Since solutions use the molecule ID, a solution now uses a Map, with the molecule ID as the key, as the underlying storage for solutes. A query of a solution for the presence or concentration of a molecule has become a O(log n) operation as opposed to the O(n) operation it was before. Since metabolic equations use O(n) operations where each operation queries the solution, this reduced metabolic equations to a O(n log n) operation from a O(n²) operation. Other locations in the code have similarly benefited.

### E. Simulation Configuration File

To illustrate how the virtual genes, metabolic equations, environmental parameters, and other settings are specified to the ontogeny engine, it can be useful to consider a configuration hierarchy. One of ordinary skill in the art will recognize additional embodiments for specifying parameters and settings to the ontogeny engine, and the examples described below are considered to be exemplary. A detailed description and examples of configuration files and narrative pseudocode (a high level description of a computer programming algorithm for human reading) for developing a simulation model can be found in detail in U.S. patent application Ser. No. 11/899,927 and International Application No. PCT/US2008/075514, both of which are incorporated by reference in their entireties. For purposes of understanding the simulation models highlighted in Examples 1-3, elements of exemplary configuration files are described below. Moreover, pseudocode described and presented herein is understood to be exemplary only. Accordingly, one of ordinary skill in the art will recognize that other code and program instructions, order of steps, etc. can be used to implement the features and functions described herein.

In one embodiment, configurations are written in XML. An XML file consists of nested pairs of bracketed tags. Each opening tag has a matching closing tag. A closing tag has the same name as the opening tag but the name is preceded by a forward slash (“/”):

<SomeTag>
more nested tags or data
</SomeTag>

Tags without nested content can be opened and closed with separate tags or in a single tag:

<SomeTag/>.

Comments for the reader of the configuration file are ignored by the ontogeny engine. These are introduced with a comment tag (“<!—comment—>”):

<!-- comment --> The following tag indicates something interesting.
<SomeTag>
more nested tags or data
</SomeTag>

Where periods of ellipsis (“ . . . ”) appear in the following description within opening and closing tags, subordinate tags may be nested. That is, the tags surrounding the ellipsis may contain subordinate tags, whose detail is not relevant to the immediate description but may be described elsewhere as appropriate.

Editing of the XML configuration file is conventionally done with specialized editors which are given the structure of the XML file by the server. In one example, a text editor, such as an ASCII text editor, can be used as is commonly done for computer configuration files.

In one embodiment, all configuration files have <CsIndividual> . . . </CsIndividual> as the root tag. The tags detailed below are subordinate to the <CsIndividual> tags.

### E1. Development Engine

DevelopmentEngine options cue the server to watch for certain events and pause when they are reached. Each stopping condition is used only once. The user has the option to continue the simulation after a halting condition has been encountered. In the example below, the simulation will run until the earlier of 2000 simulation steps, until the phenotype has been stable for 1,000 steps (the default stopping condition), or a maximum number of 250 cells has been reached.

```
<DevelopmentEngine>
  <MaxSteps>2000</MaxSteps>
  <StableSteps>1000</StableSteps>
  <MaxCells>250</MaxCells>
</DevelopmentEngine>
```

### E2. Resource Catalogue

The ResourceCatalog provides translations between named aliases and resource signatures and properties. Each resource can have a name, a two-part signature, a decay rate, a DispersalRate, a RedistributionRate, and other properties. The name is for ease of user reference during simulation or configuration; the signature is described in more detail below; and the decay rate describes a how quickly a resource is reduced and removed from the simulation as a percentage (0.1=10% of the resource per simulation step). The DispersalRate affects any exhaustible gradients which are placed in the simulation, such as gradients established by pressure, concentration, temperature, fluids, etc. These could be placed by dying cells, or by user interaction. In either case, the decay rate is applied to the strength of the gradient, then the dispersal rate is applied to the strength. If the decay rate is 0, then a dispersal rate of greater than 0 will guarantee that the gradient will eventually be exhausted. The RedistributionRate is applied once per step to move resources within a cell. A rate of 0 would indicate that this resource will stay in the cell sub-unit in which it is located. A rate of 1 will ensure that all sub-units will have equal amounts of this resource. Redistribution occurs as follows: multiply the redistribution rate of each resource with the amount of that resource in a subunit. Remove that amount of each resource from the subunit. Do this for all subunits in the cell, collecting the removed amounts. Divide the collected amounts evenly amongst all subunits of the cell.

In some embodiments, subunits keep track of their own resources, allowing a cell to sequester resources to one side and divide in such a way as to have all of the sequestered resources in one of the daughter cells.

In one embodiment, the decay rate can be a default decay rate and set to an arbitrary value (“0.1”, for example, represents a 10% decay per step). The rate of increase of a promoted resource (produced at a constant rate) changes based on the resource's decay rate. This, coupled with changes to effect values for gene units and coefficients for metabolic equations, can change the number steps it would take for a resource to reach a critical value, thus delaying any activity which is directly or indirectly depending upon this resource. Therefore, mechanisms can be employed for controlling a resource's decay rate independently and with variability. In some embodiments, metabolic equations can be included to increase a resource's decay rate. For example, a metabolic equation can be provided for which a single resource is the only reactant and the equation product is a reduced amount of the same resource. In a further embodiment, a resource can have a configurable decay rate. For example, a resource can be assigned a decay rate of 0 if the resource concentration should be held constant. Likewise, a rapidly decaying resource can be assigned a very high decay rate in the configuration file. One of ordinary skill in the art will recognize that there are other methods for designating resource decay, such as assigning a resource a half-life (e.g., a function of time) and/or other probability of decay over time, per step, etc.

ResourceA in the below example uses the above described default settings, so it only matches the alias ‘ResourceA’ with its signature ‘[10, 10]’. ResourceB specifies a decay rate of 0.2. ResourceC does not decay.

In one embodiment, a resource may include an optional indivisible tag (I), but is not required. If a resource is indivisible, it cannot be divided between daughter cells during division, but must instead be allocated to only one of the two.

A molecular or resource signature consists of an Indicant and a Sensitivity value. These values are used to calculate the Affinity between resources and gene units. The Indicant is the resource's interactive identity and the Sensitivity affects how much Affinity the resource has for other resources or gene units with different Indicants. An exact Indicant match between a resource and gene unit yields a maximum Affinity of 1.0. As the difference between Indicants increases, Affinity decreases at a rate determined by the Sensitivity values of the resource and gene unit. A resource with a Sensitivity of 0.0 matches any gene unit; likewise, a gene unit with a Sensitivity of 0.0 matches any resource. As Sensitivity increases, Indicants must match more closely for there to be significant interaction between resources and gene units. Resources A, B, and C below have very high Sensitivities (10) and call for a nearly exact Indicant match with a gene unit to have any effect. Resources D, however, with a low sensitivity of 0.5, could interact significantly with gene units having Indicants differing by as much as 5 from ResourceD's Indicant.

In one embodiment, the <ResourceCatalog> may include Resources that do not have a ResdistributionRate or DispersalRate, and may be configured as follows:

```
<ResourceCatalog>
    ResourceA [10, 10];
    ResourceB [20, 10]0.2;
    ResourceC [31, 10]0.0 I;
    ResourceD [40, 0.5];
</ResourceCatalog>
```

In another embodiment, the <ResourceCatalog> may be configured as pure XML as follows:

```
<ResourceCatalog>
    <ResourceDefinitions>
        <Define>
          <Resource>
              <Indicant>10</Indicant>
              <Sensitivity>10</Sensitivity>
          </Resource>
          <ResourceName>ResourceA</ResourceName>
        </Define>
        <Define>
          <Resource>
              <Indicant>20</Indicant>
              <Sensitivity>10</Sensitivity>
              <Decay>0.2</Decay>
          </Resource>
          <ResourceName>ResourceB</ResourceName>
        </Define>
        <Define>
          <Resource>
              <Indicant>30</Indicant>
              <Sensitivity>10</Sensitivity>
              <Decay>0.0</Decay>
          </Resource>
          <ResourceName>ResourceC</ResourceName>
        </Define>
        <Define>
          <Resource>
              <Indicant>40</Indicant>
              <Sensitivity>0.5</Sensitivity>
          </Resource>
          <ResourceName>ResourceD</ResourceName>
        </Define>
        <Define>
          <Resource>
              <Indicant>40</Indicant>
              <Sensitivity>10</Sensitivity>
              <DispersalRate>0.25</Dispersal>
              <RedistributionRate>0.175</RedistributionRate>
          </Resource>
          <ResourceName>ResourceE</ResourceName>
        </Define>
    </ResourceDefinitions?
</ResourceCatalog>
```

### E3. Simulation

The Simulation tag encloses parameters for simulation conditions, as described below in Subsections E.3.1 to E.3.7:

<Simulation>
...
</Simulation>

### E3.1 Signal

The choice of Signal method and Signal settings determines how all signals originating in cells will be distributed between non-contacting cells. <FallOff> signaling allows signals to decrease in concentration in a smooth curve as distance increases. The meanings of settings for <FallOff> signaling are discussed under <Shade> below. <Local> signaling presents a fully concentrated signal across the specified separation distance, but none beyond. <Droplet> signaling diffuses signals through fluid droplets when fluid droplets are present in the simulation. <Linear> signaling decreases signal concentration linearly with distance. In some embodiments, a No signal option, <No/>, may be used to disable all signals.

```
<FallOff>
    <Exponent>0.5</Exponent>
    <Modifier>2.0</Modifier>
    <Radius>1.0</Radius>
    <Threshold>0.05</Threshold>
</FallOff>
<Local>
    <Separation>0.2</Separation>
</Local>
<Droplet>
    <Separation>0.25</Separation>
</Droplet>
<Linear>
    <Slope>2</Slope>
    <Threshold>0.1</Threshold>
</Linear>
<No/>
```

### E3.2 MaxInterAdhesionLength

Adhesions between two cells break if they exceed the specified separation distance. The example below specifies a separation distance of 0.25. This parameter primarily accounts for small separations that potentially result from incomplete physics resolution rather than breaking of an adhesion. In general, cell flexibility via Rigidity determines when cell adhesions are broken.

<MaxInterAdhesionLength>0.25</MaxInterAdhesionLength>

### E3.3 SingleAdhesionRule

If the binary parameter <SingleAdhesionRule> is present, each sphere of a cell may adhere to only one sphere of one other cell, regardless of contact with other spheres of other cells. If the <SingleAdhesionRule> is not present, the number of intercellular adhesions between spheres is limited only by physical contact constraints.

### E3.4 The Physics Profile

The Physics profile encompassed within the opening and closing tags below, addresses those parameters related to the operation of stepPhysics, and includes sections E.3.4.1 to E.3.4.7

<Physics>
...
</Physics>

### E3.4.1 RepulsionMultiplier

When any two objects in the simulation overlap, a force is applied to separate them. This multiplier adjusts how strong the repulsion force will be. More significant than the absolute value of the specified <RepulsionMultiplier> is the ratio between <RepulsionMultiplier> and <DampingMultiplier>. For example, 1:2 and 100:200 ratios will result in similar collision physics. In the example below, the multiplier is set to 1.

<RepulsionMultiplier>1</RepulsionMultiplier>

### E3.4.2 DampingMultiplier

Any object has a resistance force applied opposite its direction of motion. This force is relative to the object's velocity rather than its mass or volume, so a lightweight object at a certain velocity will be slowed more rapidly than a heavier object at the same velocity. In the example, below, the multiplier is set to 2.

<DampingMultiplier>2</DampingMultiplier>

### E3.4.3 TimePerStep

<TimePerStep> relates time for physics resolution to the simulated metabolism. Smaller values specify faster metabolism relative to simulated physics resolution, and conversely for larger values. The value specified is in seconds, but has no relation to real time. Thus the reciprocal of the value specified is the number of metabolic steps per second. In this example, there are two (=1.0/0.5) metabolic steps per physics second.

<TimePerStep>0.5</TimePerStep>

### E3.4.4 MaxVelocityChange

All forces and collisions are attempted to be resolved within the simulation time allocated to each step in as few physics iterations as possible. To maintain smooth, realistic physics simulation, <MaxVelocityChange> specifies the largest velocity change (i.e., acceleration or deceleration) allowed per physics iteration before overlaps and other physics issues are rechecked. Small values improve physics fidelity at the expense of performance and conversely for large values.

<MaxVelocityChange>0.5</MaxVelocityChange>

### E3.4.5 NudgeMagnitude

This parameter specifies the force applied when a user nudges a cell during a simulation run.

<NudgeMagnitude>3</NudgeMagnitude>

### E3.4.6 Container

The growth of the simulated cells and other objects can be physically constrained by specifying a container. A default simulation setting can include no container and the environmental bounds are infinite in all directions. Containers can define physical entities within the simulation environment. In one embodiment, containers are considered in physical resolution calculation during stepPhysics operations in the same manner as other simulation objects (e.g., cells, ECM). Varying sizes and/or shapes of containers can be selectable when desired for a simulation. For example, a table container can be specified that has an infinite XZ plane at a configured Y coordinate such that the modeled objects in the simulation are constrained to the space above the plane. Other shaped container could be implemented, such as a dish container. In one embodiment, dish container can be configured as a virtual Petri dish with a specified radius centered at the specified X, Y, Z coordinates. In some embodiments, the dish container can have infinitely high walls so the modeled objects can extend infinitely along the Z coordinate. In the example below, the “dish” is centered at coordinates 0, −3, 0 with a radius of 10.

For a Dish:

<Container>

<Dish>

<Center>

<X>0</X>
<Y>−3</Y>
<Z>0</X>

</Center>
<DishRadius?10</DishRadius>

</Dish>

</Container>

For no container:

<Container>

<NoCont/>

</Container>

To specify a Table:

<Container>

<Table>

<TableHeight>−2.3</TableHeight>

</Table>

</Container>

### E3.4.7 Gravity

The simulation has no gravity by default. Simulated gravity is added with the <Gravity> tag. Its value adjusts the gravitational force applied throughout the environment.

<Gravity>0.2</Gravity>

### E3.5 FixedSpheres

Fixed spheres are immovable, inert, uniform spheres placed in the environment as a physical constraint to phenotype development. Each fixed sphere is described with X, Y, and Z coordinates followed by a radius. In some embodiments, fixed spheres can be used in lieu of or in addition to containers (described above) for bounding a simulation environment.

The example below describes two very large fixed spheres are placed above and below the center of the environment where the initial cell is placed. In effect, the cells are sandwiched between flat plates because the radius of these fixed spheres is much larger than the 0.5 radius of the cells. In one embodiment, the FixedSpheres tag may be configured as follows:

<FixedSpheres>

<FixedSphere>

<X>0</X>
<Y>−1000</Y>
<Z>0</X>

</FixedSphere>
<FixedSphere>

<X>0</X>
<Y>1000</Y>
<Z>0</X>
<Radius>1000</Radius>

</FixedSphere>

</FixedSpheres>

In another embodiment, the FixedSpheres tag may be configured as follows:

<FixedSpheres>

[0, −1000, 0] 1000,
[0, 1001, 0] 1000

</FixedSpheres>

### E3.6 Cells

The Simulation contains a Cells tag, which contains multiple cell definitions, along with associated names. Thus, an arbitrary number of distinct cell lines, each with independent genomes, metabolism, initial size, initial contents, initial locations, subunit size and density, and all other parameters associated with cell definition. In addition to initializing a simulation with any combination and organization of cells from defined cell lines, cells from any cell line can be added ad hoc to running simulations at user-chosen coordinates.

These capabilities enable many additional simulations. In one embodiment, a simulation can begin with any desired organization of “pre-differentiated” cells. In other embodiments, foreign cells, such as pathogenic bacteria may be added ad hoc to a running simulation at any time or location during development of a tissue.

In some embodiments, a “BasementMembrane” construct may exist, which can be implemented as an independent, second cell definition. This can be seen in some of the examples below. However, in other embodiments, a “Basement Membrane” may be added as a specific “cell line” or cell type as defined herein. A Basement Membrane has a “Boxed” size and shape initialization, which may be implemented (see “BoundingBox” as in <InitialShape> found at E3.6.3.), therefore does not need its own specialized construct.

Initial locations for placing each cell type are also specified. If no locations are specified, no cells of that type will be placed in the simulation at the start of the simulation, but cells of that type may be placed by the user during the running of the simulation. The Cell tag encompasses various virtual cell parameters, described below in E.3.6.1 to E.3.6.15:

<Cells>

<Definition>

<Name>Cell Type 1</Name>
<Cell>
...
</Cell>
<InitialCellLocations>

<Location>

<X>1</X>
<Y>2</Y>
<Z>3</Z>

</Location>
<Location>

<X>1</X>
<Y>2</Y>
<Z>3</Z>

</Location>

</InitialCellLocations>

</Definition>
<Definition>

<Name>Cell Type 2</Name>
<Cell>
...
</Cell>

</Definition>

</Cells>

### E3.6.1 Chemistry

<Chemistry> determines how Affinity will be calculated between resources and gene units. <Default/> chemistry specifies that Affinity will follow a normally distributed bell curve.

### For Default:

<Chemistry><Default/></Chemistry>

In addition to <Default> chemistry, <Exact/> and <Smooth/> chemistries may be used. The <Exact/> chemistry option performs the affinity calculation as follows: 1 if the indicants of the two resources match, 0 if the indicants do not match. Sensitivity is not taken into account in the <Exact/> chemistry affinity calculation. Therefore, in some embodiments, sensitivity may not be needed.

### For Exact:

<Chemistry><Exact/></Chemistry>

### For Smooth:

<Chemistry><Smooth/></Chemistry>

### E3.6.2 Promoter

<Promoter> determines how Promotion will be calculated in gene unit transcription. In one embodiment, promotion is based on the Affinity of resources for a regulatory gene unit and their concentrations. Promotion includes Default, Linear, Smoother and Smooth.

In one embodiment, a <Promotor> may be a <Default> promotion. The <Default> is a Binary promoter, if the total affinity for a resource is above the Affinity Threshold, then a promotion calculation will be made as Affinity*Concentration*Effect. If promotion is above the threshold, then the gene will be promoted fully.

<Promoter>

<Default>

<AffinityThreshold>0</AffinityThreshold>
<PromotionThreshold>3</PromotionThreshold>
<ActiveConcentration>1</ActiveConcentration>

</Default>

</Promoter>

In another embodiment, a <Promotor> may be a <Linear> promotion, wherein promotion of a gene is the affinity of a resource*the concentration*the effect:

<Promoter>

<Linear/>

</Promoter>

In yet another embodiment, one such <Promoter>, <Smoother> promotion, has a sigmoidal curve with 0.0 Promotion at 0.0 Affinity and Concentration, and approaches 1.0 Promotion as Affinity and Concentration increase In some embodiments, the <Smoother> promoter may include a Standard Deviation option to configure promotion noise.

```
<Promoter>
  <Smoother>
    <PromotionMidpoint>5</PromotionMidpoint>
    <Slope>3</Slope>
    <ActiveConcentration>1</ActiveConcentration>
    <StandardDeviation>0.1</StandardDeviation>
  </Smoother>
</Promoter>
```

In another embodiment, a <Smooth> promotion uses a sigmoidal curve to determine promotion, similar to the <Smoother> promotion:

```
<Promoter>
  <Smooth>
    <PromotionMidpoint>5</PromotionMidpoint>
    <ActiveConcentration>1</ActiveConcentration>
  </Smooth>
</Promoter>
```

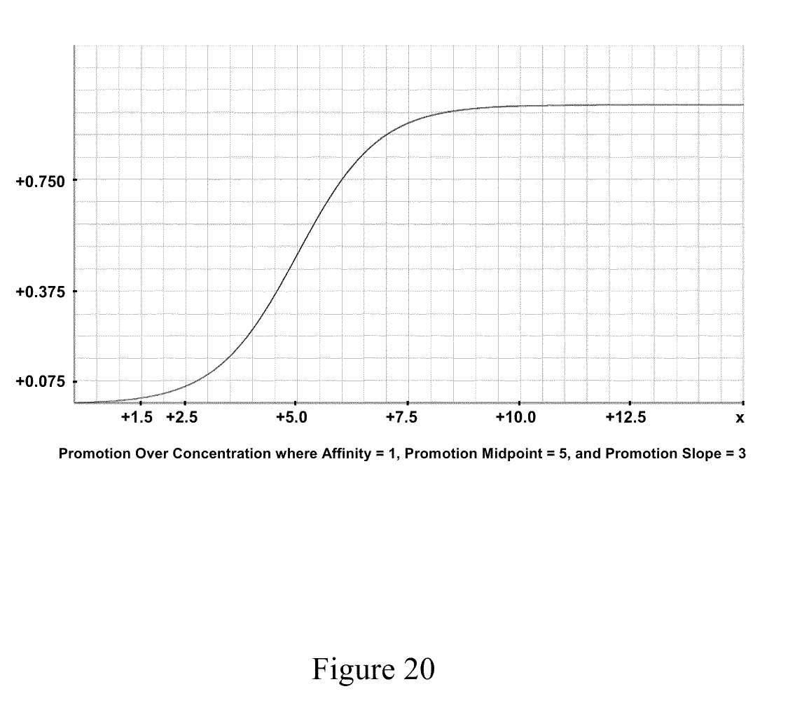

FIG. 20 is a graph illustrating a promotion curve for a modeled resource interacting with a modeled regulatory gene unit wherein the affinity between the resource and gene unit is equal to one in accordance with an embodiment of the disclosure. FIG. 20 depicts the promotion curve for a perfect match between a single resource interacting with a single regulatory gene unit. In this case, the Affinity between the resource and gene unit is 1.0. The promotion of the gene unit given the current concentration of the resource is multiplied by the gene unit's Effect value to compute the partial promotion of the gene unit by that resource. Total promotion of the gene unit is the sum of such partial promotions from all resources. Where a regulatory region contains multiple gene units, the promotion of the region is the sum of all constituent gene unit promotions.

Net positive promotion results in internal production of corresponding structural gene unit product equal to the net positive promotion. The volume of the cell determines how this amount affects concentration: smaller cells experience a greater increase in concentration through transcription than larger cells for the same gene unit promotion level.

From the example configuration above, the promotion curve in FIG. 20 has a midpoint of 5 and slope of 3. As a result, 50% promotion occurs at concentration 5 and ramps sharply from 25% to 75% between concentrations 4 and 7, with asymptotically approaching 100% at concentrations above 10. With consideration of the promotion curve, a researcher can develop intuition with practice from watching resulting molecular concentration levels to appreciate the influence any internal resource is having on gene units.

### E3.6.3 InitialShape

The <InitialShape> tag allows a user to determine the initial shape of cells in a particular cell line. In some embodiments, a <Spherical> tag option specifies a style with initialized cells are close packed subunits in a spherical manner. The <InitialSize> tag option specifies the number of sub-spheres in the initial cell placed in the environment at the beginning of the simulation.

```
<InitialShape>
  <Spherical>
    <InitialSize>13</InitialSize>
  </Spherical>
</InitialShape>
```

In other embodiments, a bounded box style may be specified as an initial shape of cells, which creates a cubic cell.

```
<InitialShape>
  <BoundingBox>
    <Width>4</Width>
    <Height>2</Height>
    <Length>18</Length>
  </BoundingBox>
</InitialShape>
```

### E3.6.4 MaximumSize

A cell can be configured to have a maximum cell size to restrict the growth of each size. In a free-space model, for example, a cell can be configured to have a maximum number of subspheres. In this model, if a cell has the maximum number of subspheres at a particular step, a growth event cannot occur that step even if a growth trigger is available to induce a growth action. The initial size of a cell (<InitialSize>) at the start of a simulation session may be specified as larger than the maximum allowed size (<MaximumSize>); however this cell would be prevented from further growth.

<MaximumSize>13</MaximumSize>

### E3.6.5 MinimumSize

A cell can be configured to have a minimum cell size to restrict division at a small cell size. In a free-space model, for example, a cell can be configured to have a minimum number of subspheres. In this model, a cell may not divide if one of the equally sized daughter cells would have fewer than the designated minimum number of subspheres. For example, a cell can be configured to not divide, even if a threshold for a division resource has been reached, if the size of the cell is not greater than or equal to two-times (2×) the configured MinimumSize. In some embodiments, the minimum size requirement will not guarantee that each daughter cell resulting from a division event will have the minimum number of subspheres to meet the minimum cell size requirement. For example, during a division event, the division algorithm can select a plan of division which divides the cell into two collections of unequal subspheres, which could result in one of the daughter cells having fewer than the minimum number of subspheres. The initial size of a cell (<InitialSize>) at the start of a simulation session may be specified as smaller than the minimum allowed size (<MinimumSize>).

<MinimumSize>6</MinimumSize>

### E.3.6.6 InitialChemistry

By default, the initial cell in a simulation contains no resources and so has no way to import resources from the environment. <InitialChemistry> specifies the contents with which to initialize this cell. In the example below, the initial cell is primed with 80 units of Nutrient, 10 units of NutrientReceptor on its surface, and 13 units of NutrientSignal in the external environment. In addition to embodiments wherein an amount of a resource can be specified, additional embodiments can provide the resources in a cell's initial chemistry as a specified, calculated concentration. The concentration of these resources depends on the volume of the initial cell as specified by <InitialSize>.

```
<InitialChemistry>
  <Internal>
    <Resource>
      <Name>Nutrient</Name>
      <Value>80</Value>
    </Resource>
    <Resource>
      <Name>NutrientAsConcentration</Name>
      <Value>8</Value>
      <Concentration/>
    </Resource>
  </Internal>
  <Surface>
    <Resource>
      <Name>NutrientReceptor</Name>
      <Value>10</Value>
    </Resource>
  </Surface>
  <External>
    <Resource>
      <Name>NutrientSignal</Name>
      <Value>13</Value>
    </Resource>
  </External>
</InitialChemistry>
```

### E3.6.7 Metabolic-Interaction Rules

Metabolic-interaction rules, designated as MetabolicEquations or ChemistryEquations, are direct conversions of substrate resources to produce resources independent of gene unit transcription. In one embodiment, the simulation can be configured with metabolic equations in which the terms to the left of the equal sign describe necessary reactants and must include at least one internal or surface resource. The terms to the right of the equal side can describe the products of the interaction, for example. In some instances, any equation with external resources as either reactants or products must have a surface resource reactant.

In the example below, the first equation specifies that internal NutrientReceptor is to be consumed to produce an equal amount of surface NutrientReceptor. The second equation specifies that external Nutrient is to be transported into the cell by surface NutrientReceptor. The surface NutrientReceptor is replaced on the product side and so acts as a catalyst in the equation. Coefficients can be specified for any reactants or products to describe proportion and amounts as demonstrated in the third example equation. In additional embodiments, resources can be configured as non-consumed reactants in metabolic equations.

```
<MetabolicEquations>
  NutrientReceptor = ( NutrientReceptor );
  { Nutrient } + ( NutrientReceptor ) = Nutrient + ( NutrientReceptor );
  1.5 SubstrateA + 2 SubstrateB = SomeProduct;
</MetabolicEquations>
```

In another embodiment, ChemistryEquations or MetabolicEquations may be subordinate to <Metabolic>, which is subordinate to <Cell>. In addition, Reactivity Multipliers have been added to the configuration. Example:

```
<Metabolic>
  <ChemistryEquations>
    <Equation>
      <ReactivityMultiplier>0.5</ReactivityMultiplier>
      <Reactants>
        <Term>
        <ResourceName>NutrientReceptor</ResourceName>
        <Location>
          <Internal/>
        </Location>
        </Term>
      </Reactants>
      <Products>
        <Term>
        <ResourceName>NutrientReceptor</ResourceName>
        <Location>
          <Surface/>
        </Location>
        </Term>
      </Products>
    </Equation>
    <Equation>
      <Reactants>
        <Term>
        <ResourceName>Nutrient</ResourceName>
        <Location>
          <External/>
        </Location>
        </Term>
        <Term>
        <ResourceName>NutrientReceptor</ResourceName>
        <Location>
          <Surface/>
        </Location>
        <NotConsumed/>
        </Term>
      </Reactants>
      <Products>
        <Term>
        <ResourceName>Nutrient</ResourceName>
        <Location>
          <Internal/>
        </Location>
        </Term>
      </Products>
    </Equation>
    <Equation>
      <Reactants>
        <Term>
        <ResourceName>SubstrateA</ResourceName>
        <Coefficient>1.5</Coefficient>
        </Term>
        <Term>
        <ResourceName>SubstrateB</ResourceName>
        <Coefficient>2</Coefficient>
        </Term>
      </Reactants>
      <Products>
        <Term>
        <ResourceName>SomeProduct</ResourceName>
        </Term>
        <Term>
        <ResourceName>OtherProduct</ResourceName>
        <Coefficient>1.75</Coefficient>
      </Products>
    </Equation>
  </ChemistryEquations>
</Metabolic>
```

In some embodiments, transcription and translation have been separated into independent processes. As a result, resources are produced in the cell at the locations where energy and molecular resources to translate them are available.

Protein synthesis can be represented as a set of metabolic equations, one for each encoded product. By default, one reactant is the Template and the products are the Template and its corresponding Regular Resource. Additional Regular Resources can also be added as reactants by inclusion in the Translation Resources list for the Regular Resource in the Resource Catalog. Mean concentrations of transcription factor molecules in the cell can be used to calculate promotion of each gene assembly, gene products can be transcribed at the rate determined by promotion, and gene products can be uniformly distributed throughout the cell. However, the gene products will not be the final encoded proteins, but intermediate template molecules analogous to mRNA. Translation equations may be generated automatically for all gene products based on the resource costs defined for those molecules. The following is an example:
a molecule catalog entry consists of

Alias [Signature] Decay Indivisible (Resources Sequence);

```
<MoleculeCatalog>
M1 [1,10] 0.1 0 (1 E);
M2 [2,10] 0.1 0 (2 E, 1 A);
M3 [3,10] 0.1 0 (1 E);
</MoleculeCatalog>
<Genome>
[
  [P1 1]
  [M1]
],
[
  [P2 1]
  [M1]
],
[
  [P3 1]
  [M2]
]
</Genome>
```

M1 and M2 appear as gene products. Translation equations are automatically generated for them and included in the collection of metabolic equations:

M1t+1.0 E=M1;

M2t+2.0 E+1.0 A=M2;
M3 is not a gene product and no translation equation is generated. Transcription produces template resources for encoded products rather than the products directly. Translation to final products, then, occurs in subunits where resources are available.

The translation equations above consume the template molecule as a cost of translation. This is inline with the current transcription/translation model. However, mRNA is not generally destroyed during translation and a strand of RNA may be translated multiple times. RNA does decay over time and its nucleic acids are reclaimed and reused to assemble new strands. We can model translation more accurately by replacing template molecules as products and allowing decay alone to reduce template molecule availability:

M1t+1.0 E=M1+M1t;

M2t+2.0 E+1.0 A=M2+M2t

If a molecule or other resource is not a gene product, then no translation equation is generated. Transcription produces template molecules for encoded products; translation to final products occurs in subunits where resources are available.

### E3.6.8 DivisionRules

By default, cell divisions have random or specified resource distribution directional orientation. By specifying DivisionRules, division can occur in a direction relative to the highest activity of a surface resource, for example. Rule choice can also depend on the concentration of internal or surface resources, as modified by a positive, multiplier coefficient; single division rules must specify a positive coefficient. Directional keywords are “perpendicular”, “toward”, “away”, and “random”. For DivisionRules, “toward” and “away” are equivalent. Alternatively, directions may be specified as angles in real degrees from 0 to 180. DivisionRules can specify a trigger resource and its threshold concentration in addition to a directional reference resource and the division rule is triggered whenever a trigger resource meets or exceeds the threshold.

### EXAMPLES

```
<DivisionRules>
  <DivisionRule>
    <ResourceName>Nutrient</ResourceName>
    <Threshold>0.5</Threshold>
    <Direction>
      <Perpendicular>
        <ReferenceResourceName>ContactReceptor
        </ReferenceResourceName>
      </Perpendicular>
    </Direction>
  </DivisionRule>
  <DivisionRule>
    <ResourceName>NeighborhoodMarker</ResourceName>
    <Threshold>1</Threshold>
    <Direction>
      <Toward>
  <ReferenceResourceName>NeighborhoodReceptor
  </ReferenceResourceName>
      </Toward>
    </Direction>
  </DivisionRule>
  <DivisionRule>
    <ResourceName>ContactMarker</ResourceName>
  </DivisionRule>
  <DivisionRule>
    <ResourceName>Divider</ResourceName>
    <Threshold>2.7</Threshold>
    <Direction>
      <Angle>
        <ReferenceResourceName>DivisionDirector
        </ReferenceResourceName>
        <Angle>27.5</Angle>
      </Angle>
    </Direction>
  </DivisionRule>
  <DivisionRule>
    <ResourceName>RandomDivision</ResourceName>
    <Threshold>132.32</Threshold>
    <Direction>
      <Random>
    </Direction>
  </DivisionRule>
</DivisionRules>
```

In one embodiment, a cell may or group of cells that collectively produce ECM may divide along a common plane. For example, a cell may divide along the plane that is perpendicular to the direction of the LHI (as described above). According to this embodiment, an example DivisionRule is illustrated below (BasementMembraneReceptor in this example is the surface molecule denoting direction):

```
<DivisionRules>
<!-- ChemicalSignature Threshold <Direction with optional modifier> -->
  DivideAlongBasement 10 toward BasementMembraneReceptor;
  DivideAwayFromBasement 6 perpendicular
  BasementMembraneReceptor;
</DivisionRules>
```

### E3.6.9 SubunitRadius

This setting allows the user to specify the radius of all of the subunits which will be used to initialize this cell line. Different cell lines can have different cell subunit size. The default is 0.5.

<SubunitRadius>0.32</SubunitRadius>

### E3.6.10 SubunitDensity

This setting allows the user to specify the density of a cell by way of its subunits. The density along with the radius will determine the mass of a cell subunit. The mass is subsequently used in physics calculations. The default is 0.95493, which yields a default mass of 1 with the default radius of 0.5.

<SubunitDensity>1.5</SubunitDensity>

### E3.6.11 MProperties

This tag contains the settings for the mechanical properties of a cell: Rigidity, Elasticity and Plasticity. In some embodiments, these properties may be configured to be dependent upon any resource, or may use a fixed value rather than being hard coded resources within a cell.

```
<MProperties>
  <Rigidity>
    <DependentPropStyle>
      <PropMol>Strength</PropMol>
    </DependentPropStyle>
  </Rigidity>
  <Elasticity>
    <DependentPropStyle>
      <PropMol>Stretchiness</PropMol>
    </DependentPropStyle>
  </Elasticity>
  <Plasticity>
    <FixedPropStyle>
      <PropValue>0.2</PropValue>
    </FixedPropStyle>
  </Plasticity>
</MProperties>
```

### E3.6.12 DeathRules

DeathRules specify which resources cause death. When a concentration of the specified resource falls below the LowThreshold, or is accumulated above the Threshold the death action is triggered and the cell will die. A <LowThreshold> value of 0 means there is no low threshold. Any number of rules may be specified. In one embodiment, DeathRules can specify one or more trigger resource(s) and each upper and lower threshold concentration and the death rule is triggered whenever a trigger resource meets or exceeds the upper threshold or fails to meet the lower threshold. Example:

```
<DeathRules>
  <DeathRule>
    <ResourceName>Life Force</ResourceName>
    <Threshold>10000</Threshold>
    <LowThreshold>2.5</LowThreshold>
  </DeathRule>
  <DeathRule>
    <ResourceName>Toxin</ResourceName>
    <Threshold>3.45</Threshold>
  </DeathRule>
</DeathRules>
```

### E3.6.13 Bounded Resources and Sequences

A BoundedResourceList establishes a list of resources that, when their given upper or lower threshold is reached, a cellular action will occur. Because only selected resources need to be monitored, boundaries are not defined for all resources. In one embodiment, a BoundedResourceList may be a <FatalBoundaries/> list, which associates resources with an upper and lower threshold concentrations.

A cell with a resource concentration less than its lower bound or greater than its upper bound dies. A lower bound of 0.0 means the cell will not die even if the molecule concentration is 0.0 because it isn't lower than 0.0. An upper bound of the maximum float value means the concentration cannot be greater than the upper bound. Example:

<FatalBoundaries>
M1 0.1 MAX; (lower bound, but no upper bound)
M2 0.0 1.0; (upper bound of 1.0, but no lower bound)
M3 1.0 2.0; (lower bound of 1.0, upper bound of 2.0)
</FatalBoundaries>

In other embodiments, other BourdedResourcesLists may be established for Actions such as Division and Growth. Growth and Death Rules may each have a determining resource and threshold concentration. If any determining resource exceeds its threshold concentration, the action takes place and the amount of determining resource that triggered the action is consumed. Division Rules have additional parameters for orienting the plane of division. A reference resource can be specified with a relative direction option: toward, away, perpendicular, or an angle. These directions are relative to the subunit with highest combined internal and surface concentration of the reference molecule. If no reference molecule is specified, the plane of division is randomly chosen.

In further embodiments a BoundedOrderedSequence instruction may be inserted. In particular, a DivisionSequence tag may be added to model division in cells that is regulated via an ordered cell cycle. Division does not occur until each preliminary checkpoint has been passed in order. An example of a potential cell cycle is given here:

<DivisionSequence>
P1 0.0 1.0 ADVANCE;
P2 0.0 5.0 CONSUME;
P3 2.0 MAX ADVANCE;
Division 0.0 1.0 DIVIDE;
</DivisionSequence>

In the above example, P1 is checked until its concentration exceeds 1.0. Until then, none of the other values in the sequence are considered. When the P1 checkpoint passes, the instruction is to advance to the next checkpoint. The P1 molecule is not consumed. When P2 exceeds 5.0 concentration, its instruction is to consume the amount of P2 producing 5.0 concentration and the checkpoint advances. When P3 is below 2.0, the checkpoint advances to the final boundary condition. When Division exceeds 1.0, it is consumed, the cell divides, and the checkpoint is returned to the first condition.

### E3.6.14 Growth Rules

The user can specify rules which determine how a cell grows. Each rule specifies the resource used for growth, a threshold for that resource which when crossed will cause the cell to consume the resource and add a new subunit, and optionally, a direction which will indicate where the new subunit is to be located. If a direction is specified, the new subunit is placed at the periphery of the cell in the direction indicated, otherwise the subunit is placed at the center of mass of the cell. GrowthRules can specify one or more trigger resource(s) and each threshold concentration and the growth rule is triggered whenever a trigger resource meets or exceeds the threshold. Example:

```
<GrowthRules>
  <GrowthRule>
    <ResourceName>NormalGrowth</ResourceName>
    <Threshold>2.7</Threshold>
  </GrowthRule>
  <GrowthRule>
    <ResourceName>GrowthAwayFromPoison</ResourceName>
    <Threshold>.35</Threshold>
    <GrowthDirection>
      <Away>
        <ReferenceResourceName>Poison</ReferenceResourceName>
      </Away>
    </GrowthDirection>
  </GrowthRule>
  <GrowthRule>
    <ResourceName>GrowthAroundPerimeter</ResourceName>
    <Threshold>1.34</Threshold>
    <GrowthDirection>
      <Perpendicular>
        <ReferenceResourceName>Nutrient</ReferenceResourceName>
      </Perpendicular>
    </GrowthDirection>
  </GrowthRule>
  <GrowthRule>
    <ResourceName></ResourceName>
    <Threshold>7.25</Threshold>
    <GrowthDirection>
      <Angle>
        <ReferenceResourceName>Nutrient</ReferenceResourceName>
        <Angle>15</Angle>
      </Angle>
    </GrowthDirection>
  </GrowthRule>
  <GrowthRule>
    <ResourceName>GrowthTowardNutrient</ResourceName>
    <Threshold>5.1</Threshold>
    <GrowthDirection>
      <Toward>
        <ReferenceResourceName>Nutrient</ReferenceResourceName>
        <Angle>15</Angle>
      </Toward>
    </GrowthDirection>
  </GrowthRule>
  <GrowthRule>
    <ResourceName>Swelling</ResourceName>
    <Threshold>4.2</Threshold>
    <GrowthDirection>
      <CenterOfMass>
    </GrowthDirection>
  </GrowthRule>
<GrowthRules>
```

### E3.6.15 ECMProductionRules

ECM Production Rules can control how cells produce ECM into the environment. In order for cells to produce ECM, at least one production rule must be defined. There can be any number of ECM production rules.

A production rule specifies what resource is needed to make ECM with <TriggerResourceName>. The amount of <TriggerResourceName> (or <chemical signature or alias>) needed (and should be consumed each time ECM is produced) to make a unit of ECM is specified by the <Threshold> tag. The type of ECM unit to make is specified by <ECMName>. The type of ECM is defined in ECMDefinitionRules. The placement of a new unit of ECM is determined by an oriented response rule the is given by a <Direction> tag. Direction allows choosing a direction of toward, away, perpendicular, or at a specific angle with respect to a specific resource within the cell, or it can be random. A selected direction may cause a cell or collection of cells to send external products in the selected direction relative to the LHI (discussed above).

```
<ECMProductionRules>
  <ECMProductionRule>
    <TriggerResourceName>CollagenProducer</TriggerResourceName>
    <Threshold>2.35</Threshold>
    <ECMName>Collagen</ECMName>
    <Direction>
      <Toward>
        <ReferenceResourceName>CollagenSignal</
        ReferenceResourceName>
      </Toward>
    </Direction>
  </ECMProductionRule>
  <ECMProductionRule>
    <TriggerResourceName>PeripheralCollagenProducer</
    TriggerResourceName>
    <Threshold>1</Threshold>
    <ECMName>Collagen</ECMName>
    <Direction>
      <Perpendicular>
        <ReferenceResourceName>CollagenSignal</
        ReferenceResourceName>
      </Perpendicular>
    </Direction>
  </ECMProductionRule>
  <ECMProductionRule>
    <TriggerResourceName>BaseECM</TriggerResourceName>
    <Threshold>1.75</Threshold>
    <ECMName>BaseECM</ECMName>
    <Direction>
      <Away>
        <ReferenceResourceName>CollagenSignal</
        ReferenceResourceName>
      </Away>
    </Direction>
  </ECMProductionRule>
  <ECMProductionRule>
    <TriggerResourceName>BaseECMFiller</TriggerResourceName>
    <Threshold>1</Threshold>
    <ECMName>BaseECM</ECMName>
    <Direction>
      <Angle>
        <ReferenceResourceName>CollagenSignal</
        ReferenceResourceName>
        <Angle>165</Angle>
      </Away>
    </Direction>
  </ECMProductionRule>
  <ECMProductionRule>
    <TriggerResourceName>GenericECMProducer</
    TriggerResourceName>
    <Threshold>0.25</Threshold>
    <ECMName>GenericECM</ECMName>
    <Direction>
      <Random/>
    </Direction>
  </ECMProductionRule>
</ECMProductionRules
```

In some embodiments, the ECMProductionRules may be represented by an ECMProductionRule signature:

<chemical signature or alias> <threshold> <ECM name> <direction>

According to this embodiment, an example ECMProductionRule is illustrated below (BasementMembraneReceptor in this example is the surface molecule denoting direction):

<ECMProductionRules>
<!-- ChemicalSignature Threshold ECM-type Direction -->
BuildBasement 4 Collagen toward BasementMembraneReceptor;
</ECMProductionRules>

### E3.7 AdhesionRules

Adhesion Rules can determine which surface molecules must exist for adhesion to take place. Adhesion rules use exact matching on molecules, rather than the affinity calculation, to determine if a rule applies. When two objects are considered for adhesion the adhesion strength for each adhesion rule is summed to determine the overall strength of adhesions between these two objects. The adhesion strength for a rule where the pair of molecules are identical is the minimum concentration of that molecule in either cell. If the rule has two different molecules the strength is calculated twice: once as the minimum concentration of the first molecule in the first cell and the second molecule in the second cell, and again as the minimum concentration of the first molecule in the second cell and the second molecule in the first cell. For example, consider the following concentrations of molecules in two cells (Table 7):

TABLE 7
Molecule Concentrations

| | Molecule A | Molecule B | Molecule C |
|---|---|---|---|
| Cell 1 | 2.5 | 1.2 | 0.2 |
| Cell 2 | 1.1 | 0.3 | 0.4 |

There may be an adhesion rule between identical Molecule As, and Molecule A adheres to Molecule A. This rule may be applied once, taking the strength as the minimum of 2.5 and 1.1. There may another adhesion rule wherein different molecules, Molecule B and Molecule C, adhere to each other. This rule may be applied twice, once taking the strength as the minimum of 1.2 and 0.4 and once taking the strength as the minimum of 0.3 and 0.2, resulting in a total strength of 0.4+0.2=0.6. If both of the above rules were used together the strength would be the sum of the strengths of each rule, which is 1.1+0.6=1.7.

When two cells contact one another, the list of adhesion rules and the resources on the cells' surfaces are compared to determine if an adhesion is to be formed. In one embodiment, AdhesionRules may be specified by pairs of colon-separated surface resources:

```
<AdhesionRules>
  ( CellAdhesion ) : ( CellAdhesion );
  ( CellAdhesionA ) : ( CellAdhesionB );
</AdhesionRules>
```

In another embodiment, AdhesionRules may comprise one or more configured AdhesionRules, each designated by an <AdhesionRule> tag:

```
<AdhesionRules>
  <AdhesionRule>
    <ResourceAName>CellAdhesion</ResourceAName>
    <ResourceBName>CellAdhesion</ResourceBName>
  </AdhesionRule>
  <AdhesionRule>
    <ResourceAName>CellAdhesionA</ResourceAName>
    <ResourceBName>CellAdhesionB</ResourceBName>
  </AdhesionRule>
</AdhesionRules>
```

An adhesion is formed if each cell has CellAdhesion resource on its surface. In the second example AdhesionRule, one cell must have CellAdhesionA on its surface and the other cell must have CellAdhesionB. The strength of an adhesion depends on the concentrations of the adhering resources.

In some embodiments, AdhesionRules may be specified for how ECM units and cells may be connected. Such adhesion rules may govern the physical interaction of every combination of cell and ECM contact (i.e., cell-cell, cell-ECM, ECM-ECM). Each rule should be a specification of which surface resources must exist in the participants for adhesion to take place. Some examples of adhesion rules for ECM unit interactions are illustrated below:

...
<AdhesionRules>
<!-- {A resource} {B resource} -->

| | |
|---|---|
| AttachToECM | CollagenECM |
| Collagen | ElastinIII |
| Keratinized | Keratinized |

</AdhesionRules>

In other embodiments, IntracellularAdhesionRules may be specified for a cell or group of cells that collectively produce ECM. In some aspects, a cell may prefer or boost internal adhesions that were nearly parallel or perpendicular to the direction of the LHI (described above). According to this embodiment, an example IntracellularAdhesionRule is illustrated below (BasementMembraneReceptor in this example is the surface resource denoting direction):

```
<IntracellularAdhesionRules>
<!-- ChemicalSignature Threshold <Direction with or without
modifier> -->
  ElongateAwayFromBasement 4 perpendicular
  BasementMembraneReceptor;
  FlattenOverBasement 6 away BasementMembraneReceptor;
</IntracellularAdhesionRules>
```

### E4. Genome

As discussed in Section D above, Genome may be represented by a bracketed, comma-separated set of gene units. A gene unit consists of a bracketed Regulatory Region and a bracketed Structural Region. A Regulatory Region consists of a comma-separated set of Regulatory gene units. Each Regulatory Region has a resource alias or an Indicant-Sensitivity pair, called a “signature”, and an Effect multiplier value. A Structural Region consists of a comma-separated set of Structural gene units, each of which is a resource alias or signature.

```
<Genome>
[
  [ Nutrient 0.9 ]
  [ NutrientReceptor ],
  [ Nutrient 1.0, SomeInhibitor −1.0 ]
  [ProductA, ProductB, SomeInhibitor ]
]
</Genome>
```

Regulatory gene units either promote, with positive Effect values, or inhibit, with negative Effect values, transcription of the structural region of the gene unit. In each metabolic step, all internal resources in a cell are compared to all Regulatory gene units and the promotion of the gene unit, based on the Affinity and concentration of each resource, is multiplied by the gene unit's Effect value. If the net promotion of a Regulatory Region is positive, the resources listed in the Structural Region are produced in the cell at a quantity matching the net positive promotion. If the net promotion of the Regulatory Region is zero or negative, no resources are produced.

In some embodiments, <Genome> has been moved to be subordinate to <Metabolic>, which is subordinate to Cell, which allows different cell lines to have different genomes. In this embodiment, indicant and sensitivity can no longer be specified directly, but may be specified through the resource name which is the intended target of the binding site.

```
<Metabolic>
  <Genome>
    <GeneAssembly>
      <RegulatoryRegion>
        <BindingSite>
          <ResourceName>Nutrient</ResourceName>
          <Effect>0.9</Effect>
        </BindingSite>
      </RegulatoryRegion
      <StructuralRegion>
        <Product>
          <ResourceName>NutrientReceptor</ResourceName>
        </Product>
      </StructuralRegion>
    </GeneAssembly>
    <GeneAssembly>
      <RegulatoryRegion>
        <BindingSite>
          <ResourceName>Nutrient</ResourceName>
        </BindingSite>
        <BindingSite>
          <ResourceName>SomeInhibitor</ResourceName>
          <Effect>−1</Effect>
        </BindingSite>
      </RegulatoryRegion
      <StructuralRegion>
        <Product>
          <ResourceName>ProductA</ResourceName>
        </Product>
        <Product>
          <ResourceName>ProductB</ResourceName>
        </Product>
        <Product>
          <ResourceName>SomeInhibitor</ResourceName>
        </Product>
      </StructuralRegion>
    </GeneAssembly>
  </Genome>
</Metabolic>
```

### E5. Shade

Shade is a collection resource point sources, sometimes called gradient builders. In one embodiment, <UseRadius/> and <UseModified> are specified to designate a more complete description of the point sources. In another embodiment, any gradient automatically specifies a radius and modifier without having to specifically designate these options in the configuration file.

Each point source description includes a molecular alias or signature, the X, Y, and Z coordinates of the point source, the concentration, <Strength>, at the source location, and values for <Exponent>, <Modifier> and <Radius> to describe the shape of the gradient away from the source.

Setting the <Exponent> value to 0 causes the gradient to be uniform at the full source concentration throughout the environment space. An <Exponent> specified at greater than 1 describes a decrease in concentration at distance increases from the source.

```
<Shade>
  <Gradient>
    <ResourceName>Nutrient</ResourceName>
    <X>0</X>
    <Y>0</Y>
    <Z>0</Z>
    <Strength>1</Strength>
    <Exponent>0</Exponent>
    <Modifier>1</Modifier>
    <Radius>1</Radius>
  </Gradient>
  <Gradient>
    <ResourceName>Morphogen</ResourceName>
    <X>0</X>
    <Y>0</Y>
    <Z>0</Z>
    <Strength>1</Strength>
    <Exponent>0.5</Exponent>
    <Modifier>2</Modifier>
    <Radius>1</Radius>
  </Gradient>
</Shade>
```

An alternative syntax for <Shade> is as follows:

```
<Shade><UseRadius/><UseModifier/>
[
  S Nutrient @ 0 0 0 1 0 1 1,
  S Morphogen @ 0 0 0 1 0.5 2 1
]
</Shade>
```

### E6. RandomSeed

Each run of a simulation uses randomness in various calculations. When the simulation is started it uses a random number generator. If this tag is present and non-zero, the random number generator will be initialized with this value, ensuring that successive runs of a simulation will produce identical results. Without this value, successive runs of the simulation may produce different results.

<RandomSeed>76765</RandomSeed>

### E7. DisperseDeadCellContents

If this tag is present, the surface and internal resources of a dead cell or cells will be converted to exhaustible point sources and moved into an exhaustible gradient in the environment before removing the cell from the simulation. Resources moved into an exhaustible gradient may dispersed in a stepwise manner, as defined by a <DispersalRate>.

<DisperseDeadCellContents/>

### E8. ECMDefinitionRules

These rules define different types of ECM units. In some embodiments, cells may be capable of producing individual subunits that may assemble in the environment based on their state and any applicable rule sets. The signature of an ECM definition rule is as follows:

<chemical signature or alias> <concentration> <size>
<# of homophilic binding sites> <arrangement
properties> <decay probability>

First, each ECM unit type has a name (or chemical signature) for reference but the name also represents a resource which will be presented by the ECM in the same way that cells present resources on their surfaces. Second, the concentration of this resource is also specified for determining adhesion strength with other ECM components and cells. Third, the radius of the ECM is specified to determine how large the ECM subunits are compared to cell sub-spheres. All ECM units have the same density, so mass is calculated based on this radius value. Fourth, the number of homophilic binding sites specify how many ECM subunits can be attached to any other subunit. This will help to control the structure of the ECM. Fifth, arrangement properties will control how the subunits are organized in relation to each other. The arrangement options are:
A) Arbitrary—The subunits may be in any configuration.
B) Mutually Repulsive—The subunits will be evenly distributed around other units. (2 adhesions would automatically produce a linear arrangement)
C) Coplanar—A specialization of Mutually Repulsive, the subunits will align evenly around the center subunit on an arbitrary plane. (compound structures would produce a larger plane)

Sixth, each ECM subunit has a probability of decay which is related to how many binding sites are used. The more binding sites used, the less likely it will be that that subunit will decay. Maximum probability is specified when no binding sites are used. When all binding sites are used, the probability of decay is zero. The user can specify both the number of binding sites and the probability of decay. All binding sites can be arranged if the user selects, this arrangement is controlled by an alignment strength which the user specifies. This alignment strength determines how much force is applied to rotate attached subunits toward the desired arrangement, and affects the rigidity of an ECM fiber or other ECM component. Specifically, increased alignment strength increases rigidity. An example of a completed ECMDefinitionRules configuration is as follows:

```
<ECMDefinitionRules>
  <ECMDefinitionRule>
    <ResourceName>Collagen</ResourceName>
    <Concentration>2.7</Concentration>
    <Size>0.25</Size>
    <BindingSites>5</BindingSites>
    <DecayProbability>0/01>/DecayProbability>
    <MaxBindingDistance>0.175</MaxBindingDistance>
    <AlignmentStrength>1.2</AlignmentStrength>
    <ECMDestruction>
      <TargetedDestruction>
        <DestroyerName>Collagen Destroyer</DestroyerName>
        <DestroyerThreshold>2.3</DestroyerThreshold>
      </TargetedDestruction>
    </ECMDestruction>
    <Arrange>
      <CoplanarArrangement>
    </Arrange>
  </ECMDefinitionRule>
  <ECMDefinitionRule>
    <ResourceName>Elastin</ResourceName>
    <Concentration>0.75</Concentration>
    <BindingSites>9</BindingSites>
    <ECMDestruction>
      <NoDestruction>
    </ECMDestruction>
    <Arrange>
      <RepulsiveArrangement>
    </Arrange>
  </ECMDefinitionRule>
  <ECMDefinitionRule>
    <ResourceName>GenericECM</ResourceName>
    <Concentration>0.75</Concentration>
    <BindingSites>3</BindingSites>
    <Arrange>
      <ArbitraryArrangement>
    </Arrange>
  </ECMDefinitionRule>
</ECMDefinitionRules>
```

### E9. Fluids

Fluid behavior and plumbing specifications are listed here. This includes fluid Pools, Emitters, Collectors, and FluidFillers, explained below. In some embodiments, Fluid Droplets (FD) and Environment Nodes (EN) fluid models may both be implemented in a cell-centric simulator. A user may then choose between the two fluid models during configuration of the simulator system based on how the fluid model is to be implemented. In some aspects, droplet size may be configurable for the FD model and grid resolution configurable for the EN model. In other aspects, the starting volume of fluid in the simulation space should be configurable. Any optimizations to either model to achieve acceptable performance, whether described above or not, are at the discretion of the implementer, provided they preserve the integrity of the model.

In some aspects, molecules or other resources in fluid decay as they do within cells, therefore, the concentration of any transported molecule will decline over time if not replenished. In the first pass of fluid implementation, all molecules may diffuse through fluids at the same configurable rate, and there may be only one fluid type, analogous to water.

In some embodiments, fluid droplets in the FD model and fluid in nodes in the EN model may be added or removed from the models by implementing emitter and/or collector objects. In some aspects, these objects should be available for placement into a simulation that is already running, allowing interactive ad hoc testing of tissues at varying stages of development. They should also be available in configuration files to allow barrier testing as a fitness metric. In further aspects, collected droplets or node fluids with their molecular contents should be placed into the pool from which droplets or node fluids are drawn by emitters. This enables modeling of a circulatory system without requiring connected loops.

In other embodiments, a bounding container or a bounding box may be specified. In some embodiments, a bounding box may be necessary for the EN model and may be preferable to fixed sphere bounding for the FD model. Cells, ECM, and fluids may not pass container boundaries. Fixed spheres, however, may overlap boundaries.

In further embodiments, gravity may be implemented to provide a constant directional force on fluids and other entities. Simulating gravity may result in the settling of entities at the bottom of the bounding container, the flow of free fluids toward the container bottom, higher pressure at the bottom of a column of static fluid than at the top, and observed buoyancy in entities according to relative density. For example, red blood cells can have a density approximately 1.06 times greater than plasma making them slightly negatively buoyant. Cells can be slightly negatively buoyant as well.

<Fluids>
...
</Fluids>

### E9.1 Fluid Pools

A fluid Pool defines a reservoir for fluid droplets. An initial set of droplets can be defined using <Droplet> (defined below) and placed in the pool using <Quantity>. The fluid pool must be named and can be connected using this name to Emitters and/or Collectors as defined in those objects. There can be multiple pools in any simulation.

```
<Pools>
  <Pool>
    <PoolName>Bathtub</PoolName>
    <Droplet>
    ...
    </Droplet>
    <Quantity>1000</Quantity>
  </Pool>
  <Pool>
    <PoolName>Sink</Poolname>
    <Quantity>0</Quantity>
  </Pool>
</Pools>
```

### E9.1.1 Droplet

This tag defines the property of droplets which are initialized in a pool. Radius and mass can be specified. AttractionDistance and AttractionStrength can be adjusted to affect how the droplets will stick together. The attraction is similar to a magnetic field, with strength increasing with decreasing distance. The maximum strength as configured using AttractionStrength is achieved when the droplets are touching. No force will be applied beyond the AttractionDistance. InitialChemistry is used to specify what kinds of resources are contained within the droplets from the start, however, resources can still decay within droplets, and resources can be removed from droplets by cells, or droplets can have additional resources added to them by cells or fluid fillers. The DiffusionRate determines how quickly resources will disperse through a collection of fluid. The higher the rate, the faster it will disperse.

```
<Droplet>
  <Radius>0.125</Radius>
  <Mass>0.25</Mass>
  <AttractionDistance>0.32</AttractionDistance>
  <AttractionStrength>0.075</AttractionStrength>
  <InitialChemistry>
    <ResourceAndAmount>
      <ResourceName>ResourceA</ResourceName>
      <Amount>1.25</Amount>
    </ResourceAndAmount>
    <ResourceAndAmount>
      <ResourceName>ResourceB</ResourceName>
      <Amount>275</Amount>
    </ResourceAndAmount>
  </InitialChemistry>
  <DiffusionRate>0.75</DiffusionRate>
</Droplet>
```

### E9.2 Emitters

Emitters are objects in the simulation which do not interact with anything in a physical way. Their purpose is to introduce fluid droplets into a simulation. To do this an emitter must be connected to a fluid pool. This pool must either contain droplets or must be connected to a collector which can place collected droplets into the pool. The emitter will emit droplets from the pool in a FIFO (“first in, first out”) manner at a rate configured by the user using <Rate>. The rate indicates how many drops per step the emitter will produce. Since only whole drops can be emitted, any fraction is accumulated per step until the accumulation exceeds 1. The location of the droplet as it is introduced into the simulation is determined by the location and shape of the emitter, and which side of the emitter the droplets will be emitted from. The droplet will appear at a random location on this side of the emitter. In one embodiment, emitters are boxes, and are oriented in parallel with the axes. The emission sides may be bottom, top, front, back, left, or right.

```
<Emitters>
  <Emitter>
    <Name>Spigot</Name>
    <FluidPool>Bathtub</FluidPool>
    <Rate>2.25</Rate>
    <BoundingBox>
      <Width>2</Width>
      <Height>3</Height>
      <Length>4</Length>
    </BoundingBox>
    <BoundingBoxLocation>
      <X>4</X>
      <Y>5</Y>
      <Z>0</Z>
    </BoundingBoxLocation>
    <EmitSide>
      <EmitFromLeft>
    </EmitSide>
  </Emitter>
  <Emitter>
    <Name>Faucet</Name>
    <FluidPool>Sink</FluidPool>
    <Rate>0.29 </Rate>
    <BoundingBox>
      <Width>1</Width>
      <Height>2</Height>
      <Length>1</Length>
    </BoundingBox>
    <BoundingBoxLocation>
      <X>0</X>
      <Y>3</Y>
      <Z>2</Z>
    </BoundingBoxLocation>
    <EmitSide>
      <EmitFromBottom>
    </EmitSide>
  </Emitter>
</Emitters>
```

### E9.3 Collectors

Collectors are similar to emitters, however their purpose is to remove droplets from the simulation. If a collector is connected to a fluid pool, any droplets removed will be added to that pool. If no pool is connected. Then those droplets will be permanently removed from the simulation. Droplets are removed from the simulation when they intersect the side of the collector specified by the user.

```
<Collectors>
  <Collector>
    <Name>Drain</Name>
    <FluidPool>Sink</FluidPool>
    <BoundingBox>
      <Width>6</Width>
      <Height>1</Height>
      <Length>6</Length>
    </BoundingBox>
    <BoundingBoxLocation>
      <X>0</X>
      <Y>−3</Y>
      <Z>0</Z>
    </BoundingBoxLocation>
    <CollectSide>
      <CollectFromTop>
    </CollectSide>
  </Collector>
  <Collector>
    <Name>Crack</Name>
    <BoundingBox>
      <Width>1</Width>
      <Height>4.5</Height>
      <Length>0.5</Length>
    </BoundingBox>
    <BoundingBoxLocation>
      <X>−2</X>
      <Y>2</Y>
      <Z>0</Z>
    </BoundingBoxLocation>
    <CollectSide>
      <CollectFromBack>
    </CollectSide>
  </Collector>
</Collectors>
```

### E9.4 FluidFillers

FluidFillers are objects which do not interact physically with any objects in the simulation. They act as a source of resources which can be added to fluid droplets. They are conceptually a non-physical sphere which will transfer a fixed amount of resource for every step into any droplets whose center falls within the fluid filler boundaries. If no droplets are within the boundaries, no resource is distributed. A FluidFiller may be represented by a point in space (i.e., having an X, Y and Z value) and a radius. Droplets with a center point within the radius of the FluidFiller's point in space will receive a configurable amount (<DistAmt>) of the distributed resource, divided amongst the droplets receiving the resource. Each FluidFiller may handle only one resource, however if multiple resources should be emitted from the same point, any number of fluid fillers may share the same point and radius. If no droplets fall within the radius of the FluidFiller's point, nothing will be distributed, and the distribution will not accumulate for future steps.

```
<FluidFillers>
  <FluidFiller>
    <ResourceName>DiffuseNutrient</ResourceName>
    <X>0</X>
    <Y>0</Y>
    <Z>0</Z>
    <Radius>20</Radius>
    <DistAmt>1.25</DistAmt>
  </FluidFiller>
  <FluidFiller>
    <ResourceName>Nutrient</ResourceName>
    <X>0</X>
    <Y>0</Y>
    <Z>−5</Z>
    <Radius>0.75</Radius>
    <DistAmt>10</DistAmt>
  </FluidFiller>
<FluidFillers
```

### F. Ontogeny Engine

When a simulation is started, the configuration file is parsed and transmitted by the user interface to the ontogeny engine whereby the ontogeny engine is initialized to an initial step boundary from which subsequent steps may be taken. In one embodiment, the initial step boundary can define a reference point from which a simulation can commence or continue. In the present implementation, the ontogeny engine is driven one step at a time from the initial step boundary to subsequent step boundaries. The ontogeny engine may be implemented on any of a variety of computing systems known in the art. In one embodiment, the ontogeny engine supports user control of the number of steps performed in the simulation without additional instruction.

For each step in the ontogeny engine, the following functions, detailed below, can be performed until the user halts the simulation or a configured halting condition described in E1 is reached:

killCells

stepCells

stepECM

stepPhysics

One of ordinary skill in the art will recognize that the ontogeny engine can be configured to perform one or more of these functions in any combination and/or order. For example, in some embodiments, the ontogeny engine can be advanced from an initial step boundary to subsequent step boundary by performing a stepCells function. In another embodiment, the advancing can include performing a stepCells function and a stepPhysics function. It will also be recognized that each function employed during the advancing of the ontogeny engine can be performed in a sequential and/or simultaneous manner. In a further embodiment, one or more functions can be performed in an asynchronous manner. For example, advancing from a first current step boundary to a next step boundary may include a stepCells function and advancing from a second current step boundary to a next step boundary may include a killCells function and a stepPhysics function.

Pseudocode described and presented herein is understood to be exemplary only. Accordingly, one of ordinary skill in the art will recognize that other code and program instructions, order of steps, etc. can be used to implement the features and functions described herein.

### F1. Embodiments of Narrative Pseudocode for KillCells Function

As described above and in FIG. 3B at 37, killCells removes virtual cells marked for death. When first marked by a flag set in the source code controlling the cell, cell death can be treated as no longer performing any metabolic or transcription algorithms.

Upon being marked for death, the cell can begin a countdown to be removed from the simulation and so will no longer be involved in any physical interactions. In one embodiment, this countdown is satisfied immediately and so the cell will be removed immediately upon being marked for death.

```
function killCells
{
  while there are cells to kill
  {
    nextCellToDie ← the next cell to kill
    for each Cell in the simulation
    {
      if Cell == nextCellToDie
      {
        //internally, the cell simply flags itself as dead
        Cell.die
      }
    }
  }
}
```

In another embodiment, virtual cells marked for death in a previous step can be treated as no longer performing transcription algorithms; however, the cells are still capable of performing metabolic equations with available resources. In this embodiment, the “dead” virtual cells can continue to play a role in the simulation session as dead cells would in vivo. For example, cell death can result in formation of a temporary, diminishing point source for each of the remaining resources associated with the cell at the time of death to represent a necrotic cell or lysed cell.

In another embodiment, the killCells protocol message may accept a list of cell IDs (as opposed to a single cell id). This message removes cells from the simulation immediately.

### F2. Embodiments of Narrative Pseudocode for Step Cells Function

Described under Section B and in FIG. 3B at 38, this function can be performed in each simulation step. In some embodiments each virtual cell can be independently subjected to internal step logic. In summary, signals from source cells are copied to target regions for detection by potential target cells, cells gather signals so placed, and cell then performs a step of metabolism, as described in F5.

```
// this function is called on the simulation itself
function stepCells
{
  remove all dead cells from simulation
  if there are any cell signals
  {
    for each cell's region
    // where region is an imaginary sphere about the cell
    {
      exchange signal resources with overlapping regions
    }
  }
  // each cell's immediate region now recognizes external resources
  // signaled to it from overlapping regions from other cells.
  for each Cell in the simulation
  {
    update Cell's region with external resources
      from nutrient resource source
    metabolizeCell  // (see below)
  }
}
```

### F3. Embodiments of Narrative Pseudocode for StepECM Function

As described above and in FIG. 3B at 44, this function can update adhesions between sub-spheres (e.g., objects) that represent extra cellular matrix (ECM) and between cells and ECM objects in the virtual environment. Further, the stepECM function can update the creation of new ECM objects and the can update the decay of existing ECM objects.

```
function stepECM
{
  // based on simulation adhesions:
  breakOverextendedBindings between ECM subunits
  connectECM between subunits
  decayECM // over several steps, ECM subunits decay and
  are removed
}
```

### F4. Embodiments of Narrative Pseudocode for StepPhysics Function

As described under Section B and in FIG. 3B, physical interaction rules can be processed following metabolism to update a cell's location in response to cell death, division, growth, adhesion changes, or perturbation. In other embodiments, stepPhysics function can be performed at any time or in any order with respect to other function and operations during simulation. For stepPhysics operations, the unit spheres that represent the physical presence of cells (or ECM) can be treated with only limited regard to their cell (or ECM) membership. In other embodiments, physical interactions can be resolved for other objects in the simulation, such as fluid, fixed spheres, projectiles, haptic spheres and containers. In some embodiments, all objects can be defined as spherical. Accordingly, in one embodiment, each sphere location and velocity is updated iteratively based on forces calculated to be acting upon it.

```
// this function is called on the simulation itself
function stepPhysics
{
  Initialize Bag as an empty set of unit spheres
  Initialize Network as an empty set of general adhesions
  for each cell in the simulation
  {
    collect all cell subunit spheres into Bag
  }
  collect all ECM subunit spheres into Bag
  create inter-object adhesions if adhesion conditions met
  remove overextended adhesions between inter-object unit spheres
  update adhesion forces between collected inter-object unit spheres
  if projectile fired
  {
    add projectile to Bag
    if projectile is deadly
    {
      for each cell touched by projectile
      {
        //internally, the cell flags itself as dead
        instruct cell to die
      }
    }
  }
  for each cell to be nudged, collect forces from user nudges
  for each Iteration for configured-iterations-per-step
  {
    for each Subunit-Sphere in Bag
    {
      accumulate force from all nudges onto Subunit-Sphere
    }
    for each Subunit-Sphere in Bag
    {
      accumulate forces from all adhesions in Network
        onto Subunit-Sphere
    }
    for each Subunit-Sphere in Bag
    {
      accumulate repulsion force onto Subunit-Sphere
    }
    for each Subunit-Sphere in Bag
    {
      accumulate damping of forces onto Subunit-Sphere
    }
    for each Subunit-Sphere in Bag
    {
      // translocation distance based on current velocity, net
      // forces adjusting that velocity & elapsed time per iteration
      translocate Subunit-Sphere in Bag
    }
  }
}
```

As described above, the number of physical iterations during a stepPhysics operation can be determined by the simulation system during a simulation session based upon a user-defined maximum velocity change allowed during an iteration. An example of this embodiment is described in the pseudocode below.

```
determine time T of the physics step
set elapsed time E to 0
while E < T
{
  for each Subunit-Sphere in Bag
  {
    accumulate force from all nudges onto Subunit-Sphere
    accumulate force from all adhesions in network onto Subunit-Sphere
    accumulate repulsion force onto Subunit-Sphere
    accumulate damping of forces onto Subunit-Sphere
  }
  Set MinT to (T − E)
  For each Subunit-Sphere in Bag
  {
    Calculate time T1 that Subunit-Sphere would need to reach the
user configured Max-Velocity-Change if T1 < MinT set MinT to T1
  }
  for each Subunit-Sphere in Bag
  {
    //translocation distance based on current velocity, net
    //forces adjusting that velocity and MinT
    translocate Subunit-Sphere in Bag
  }
  set E to E
}
```

In some embodiments, fibrous ECM can be modeled as rods. Rods might be simpler to handle than a long chain of spheres for collagens. In one embodiment, rods can be as long as necessary. In some aspects, a rigid connection between two rods placed end-to-end is equivalent to a single, longer rod. A rigid rod is inexpensive computationally. In other aspects, a rod may be less rigid. To achieve a lower rigidity, the rods may need to be broken down into smaller rods with less rigid connections (to allow for bending). The more bendable a rod is, the more likely that smaller sections would be needed to be tracked. The focus of the computation should be where it is needed most, and it can be dynamic. For example, in one embodiment, two rods may have connection points at ends and mid points. When merged, the connected end points disappear but the long rod now has two mid point connection points.

To accommodate any possible subunit shape, a physics model may be generalized to allow objects other than spheres to be checked for collisions. A model can further allow objects to interact directly during a search for collisions by using a passed function as a parameter to the collision detection engine. When two objects are close enough to interact, the passed function is called upon with the two objects as parameters, and the interaction takes place. A collision report may be returned, but is not required.

In one embodiment, the user may to specify the number of stepPhysics iterations per simulation step. stepPhysics may then use this to calculate the time slice per physics iteration. In another embodiment, stepPhysics may calculate the time needed for each iteration to limit any velocity changes to a user specified maximum. A physics iteration may include calculating forces, determining the time needed to change the velocity by the maximum amount for each object using the equation:

$$TimeNeeded = \frac{maxChange \times mass}{magnitudeOfForces}$$

The smallest time needed is then used as the iteration time. If this time is greater than the physics step time, then the step time is used and only one iteration occurs. If the time is less than the physics step time, then the forces are applied for the iteration time, and this time is subtracted from the step time. The process is then repeated until all of the step time is exhausted.

In another embodiment, a user-defined maximum distance parameter may be specified, which would allow objects to move only a specified distance, thus defining the number of iterations per step.

While the above examples describe stepPhysics operations using a free-space model, stepPhysics operations can also be applied to a grid-space model. For example, cells in a grid-space environment can be configured to move from one discrete location to a second discrete location by displacing the object occupying the second discrete location to a third discrete location, etc.

### F5. Embodiments of Narrative Pseudocode for MetabolizeCell Function

The metabolizeCell function provides additional operation directives for stepCells function described above. In one embodiment, if a cell has not been marked for death, the stepCells function will invoke a metabolic processing step (“metabolic step”). In one embodiment, a metabolic step can be configured to apply rules directed to metabolic interactions and genetic transcription calculations. Each metabolic interaction is computed to assess resource flux (e.g., the resource value consumed and produced according to the configured metabolic equations and gene units) on either the cellular level, or in another embodiment, on an individual cellular subunit level. The resources produced from virtual metabolic and genetic transcription calculations are then accumulated in the context of resource strength and/or relative concentration. Over subsequent steps, the resource strength values can be reduced so as to simulate molecular decay. If the cell has not reached its death threshold (i.e., has not accumulated enough death action resources), growth, adhesion, and division actions are performed if the cell has reached those respective thresholds. An example of pseudocode corresponding to a metabolizeCell function described herein is as follows:

// this function is called on a given cell and/or individual cell subsphere in simulation
function metabolizeCell
{

if alive
{

// reaction will consume and produce resources inside, outside,
// or on the surface of the cell based on configured equations
react according to molecular interaction equations
produce ECM subunits according to configured ECM production

instructions

| | |
|---|---|
| transcribeGenome | // (see below) |

accumulate internal resources // from reaction & transcription above
accumulate action resources // from reaction & transcription above

| } | |
|---|---|
| decay action resources | // at a constant rate |
| decay internal resources | // at a constant rate |
| decay surface resources | // at a constant rate |

if alive
{

if flagged to die or reached threshold of death action resource
{

alive ← FALSE

}

}
if alive
{

position produced ECM subunits into environment
if reached threshold of growth action resource, and
if not already at configured maximum size
{

add a subunit sphere to cell
reduce accumulated growth action resource by the growth threshold

amount

}
// rigidity, elasticity, plasticity adhesions are
// added, removed, or amended according to applied forces
apply adhesions to cell sub unit spheres
if reached threshold of divide action resource
{

reduce accumulated divide action resource by the
divide threshold amount
divide cell sub unit spheres between the parent

cell and a new daughter cell

divide cell resources between parent and daughter cells
distribute and adjust adhesions between parent and daughter cells

}

}

}

Another example of pseudocode corresponding to a metabolizeCell function wherein metabolism occurs at the cellular subunit level is as follows:

// this function is called on a an individual cell subsphere in simulation
function metabolizeCell
{

if alive
{

| | | |
|---|---|---|
| transcribeGenome | // | (see below) |

}
For each subunit
{

// reaction will consume and produce resources inside, outside,
// or on the surface of the cell based on configured equations
react according to molecular interaction equations

}
distribute products of transcription equally to all subunits
for each subunit
{

| | |
|---|---|
| decay internal resources | // at a defined decay rate |
| decay surface resources | // at a defined decay rate |

}
produce ECM subunits according to configured ECM production instructions
remove proportional amounts of ECM producing molecules from subunits if any ECM was
made
if alive
{

if flagged to die or reached upper or lower threshold of any death rule
{

alive ← FALSE

}

}
if alive
{

if reached threshold of growth rule
if not already at configured maximum size
{

add a subunit sphere to cell
reduce accumulated resource which triggered growth action by the growth threshold
amount proportion

amount

}

}
redistribute molecules between subunits using their defined redistribution rate
add, remove, or adjust adhesions between cell subunits
if alive
{

if reached threshold of any division rule
{

reduce accumulated resource which triggered division action by the division rule
threshold amount
divide cell subunit spheres between the parent cell and a new daughter cell
distribute and adjust adhesions between parent and daughter cells.
}

}

}

A metabolic step may have a different order based on the organization of the cell and how transcription and translation is handled. In one embodiment, metabolism may occur at the cell level. In one embodiment, a metabolic step having gene transcription and metabolism carried out at the cell level, may have the following order:

(1) Cellular Metabolism (including Transcription). First, a cell is shown a “map” of presented external resources to cellular subunits (spheres). The cell then divides the internal and surface resources by number of cellular subunits. For each subunit with associated external resources and the subunit's portion of the cell's internal and surface resources, the requested amounts of all reactants based on provided amounts are calculated, and the requested amounts for each subunit are stored. Internal requests are added to the total requests, and for each gene assembly, calculate the promotion and subsequent resource requests based on internal concentrations and amounts. For each gene assembly, promotion and subsequent resource requests are calculated based on internal concentrations/amounts. Gene resource requests are added to total requests. Scale values are then calculated for all internal resources based on total demand and availability. For each gene assembly, transcription rates and resource demands are recalculated for all gene assemblies, incorporating scale values, then the amounts to consume and produce are stored. For each subunit with previous requests, all previous requests are adjusted by multiplying all requested amounts by the lowest scaling factor that applies to reactants in that equation, then the amounts to consume and produce, and activity levels are stored. Consumed internal and surface resources are removed from cell, produced internal and surface resources are added to the cell, and then produced internal and surface resources are returned to the cell.

(2) ECM Production. ECM units are produced based on internal resources.

(3) Decay resources. Resources will decay at a given or default constant rate.

(4) Check and perform other cell actions.

In another embodiment, each subunit is considered independently for metabolism, but the cell as a whole remains in charge of transcription, resource distribution and other actions. Further, transcription and translation may be treated as separate processes. An example metabolic step wherein each cellular subunit corresponds to its own metabolic subunit may have the following order:

(1) Transcription. First, the cell accumulates total internal resource amounts from subunits and calculates their concentrations. Then, the genome calculates promotion of all genes and subsequent amounts of transcribed template resources. The cell then distributes the transcribed template resources uniformly across subunits.

(2) Subunit Metabolism, to be carried out by each subunit independently. First, external resources are gathered at the Subunit's location. Second, initial reactant demands are calculated for all equations. Third, resources are scaled according to demand and availability. Fourth, initial demands are multiplied by the lowest scale factor for each equation to calculate amounts to consume and produce. Fifth, activity levels are updated for each surface resource. Sixth, resources decay according to their decay rates.

(3) ECM Production. First, the cell accumulates total amounts of ECM precursor resources from subunits. If there are sufficient precursor resources to produce ECM, the cell polls the subunits for associated surface activity levels to determine locations of highest activity. Next, the cell places ECM. The cell then notifies each subunit of the precursor totals and the total amounts of each to be consumed. Each subunit then calculates its relative contribution to the total available amount of each precursor and consumes that proportional amount of the total to be consumed.

(4) Death. The cell accumulates resources that are monitored for fatal conditions from all subunits. If any fatal condition is detected, the cell dies.

(5) If a cell is alive, then it may grow, redistribute its internal resources, and divide if the conditions so allow. To determine whether these actions will occur:
(A) Growth. The cell accumulates resources monitored for growth from the subunits. If all growth conditions are met, then the cell notifies all subunits regarding the totals of available resources, each subunit calculates its relative contributions to available resources and consumes proportional amounts, and the cell grows.
(B) Redistribution of Internal Resources. The cell requests the amounts of all resources for redistribution from all subunits, each subunit removes resources from local resources based on their redistribution rates and returns them to cell, and the cell then distributes all collected resources uniformly across the subunits.
(C) Division. The cell accumulates resources monitored for division from the subunits. If all division conditions are met, then the cell notifies all subunits regarding the totals of consumed resources and totals of available resources, each subunit calculates its relative contributions to available resources and consumes proportional amounts, and then the cell divides.

Another example of a metabolic step with gene resource consumption and wherein each subunit has its own metabolism may have the following order:

(1) Subunit Metabolism (including Transcription). Each subunit collects its presented external resources, then calculates its independent resource requests for each equation based on local resource availability. The mean resource concentrations by accumulating internal resource contents from all subunits are then calculated by the cell and divided by total cell volume. Each gene assembly calculates its promotion and subsequent resource requests based on mean internal concentrations and the cell calculates scale factors for all resources requested by genes based on total resource requests. Each gene assembly then recalculates its transcription rate and resource requirements based on its initial requests and scale factors. Consumed genetic resources are reported to each subunit according to its contribution to the cellular total and genetic products are reported to all subunits (distributed equally). Resource requests are recalculated by each subunit based on scaled local resource availability. Resources consumed by metabolic equations and transcription are removed by each subunit resources produced by metabolic equations and transcription are added. The cell then redistributes internal resources between subunits factoring in concentration differences, separation distances, and, potentially, resource properties.

(2) ECM Production. ECM units are produced based on internal resources.

(3) Decay resources. Resources will decay at a given or default constant rate

(4) Check and perform other cell actions.

Example pseudocode illustrating a metabolizeCell step wherein metabolism happens at the subunit level is as follows:

A cell contains 2 subunits, S,,1,, and S,,2,,, each with a volume of 1.0. S,,1,, is in contact
with a surface signal “{S}”. There is a uniform nutrient source in the environment providing
“{N}”.
Eight Resources:
{S} external surface signal
{N} external nutrient
N internal nutrient
(R) surface receptor
R receptor before embedding in surface
C catalyst used to get energy from nutrient
E energy
T transfactor
Four Equations:
{S} + (R) = T + (R);
{N} + (R) = N + (R);
N + C + E = C + 3E;
R = (R);
Two Gene Assemblies:
[T 2][E 1][R],
[T 2][E 1][C]
Initial Amounts:

| Resource | S1 | S2 |
|---|---|---|
| (R) | 1.0 | 1.0 |
| R | 1.0 | 1.0 |
| C | 1.0 | 1.0 |
| E | 2.0 | 2.0 |
| N | 1.0 | 1.0 |
| T | 10.0 | 10.0 |

1. Metabolism (including Transcription)

1. Each subunit collects its presented external resources

External Amounts:

| | | |
|---|---|---|
| Resource | S1 | S2 |
| {N} | 1.0 | 1.0 |
| {S} | 1.0 | 0.0 |

2. Each subunit calculates its independent resource requests for each equation based on

local resource availability
S,,1,, 1st Pass (each Eq bases requests on total available resources in subunit):

| | |
|---|---|
| Eq1: 1.0 {S} + 1.0 (R) | <− both equally limited |
| Eq2: 1.0 {N} + 1.0 (R) | <− both equally limited |

| Eq3: 1.0 N + 1.0 C + 1.0 E | | <− N and C limited | |
|---|---|---|---|
| Eq4: 1.0 R | | <− R limited | |
| S,,1,, 1st Pass Requested vs. Available: | | | |
| Resource | Requested | Available | |
| (R) | 2.0 | 1.0 | <− request exceeds available |
| R | 1.0 | 1.0 | |
| C | 1.0 | 1.0 | |
| E | 1.0 | 1.0 | |
| N | 1.0 | 1.0 | |
| T | 0.0 | 10.0 | |
| {N} | 1.0 | 1.0 | |
| {S} | 1.0 | 1.0 | |

Scale (R):
Requested Available

2.0N = 1.0
N = 0.5

(for all resources that were not overrequested, N = 1.0)
S,,1,, 2nd Pass:
0.5 (R) available to Eq1. All other resources available in original amounts.

| Eq1: 0.5 {S} + 0.5 (R) | | <− (R) is limiting reagent |
|---|---|---|
| 0.5 (R) available to Eq2. All other resources available in original amounts. | | |
| Eq2: 0.5 {N} + 0.5 (R) | | <− (R) is limiting reagent |
| All resources available in original amounts. | | |
| Eq3: 1.0 N + 1.0 C + 1.0 E | | <− N and C limited |
| All resources available in original amounts. | | |
| Eq4: 1.0 R | | <− R limited |
| S,,1,, 2nd Pass Requested vs. Available: | | |
| Resource | Requested | Available |
| (R) | 1.0 | 1.0 |
| R | 1.0 | 1.0 |
| C | 1.0 | 1.0 |
| E | 1.0 | 1.0 |
| N | 1.0 | 1.0 |
| T | 0.0 | 10.0 |
| {N} | 0.5 | 1.0 |
| {S} | 0.5 | 1.0 |

S,,2,, 1st Pass (each Eq bases requests on total available resources in subunit):

| Eq1: 0.0 {S} + 0.0 (R) | | <− {S} limited |
|---|---|---|
| Eq2: 1.0 {N} + 1.0 (R) | | <− both equally limited |
| Eq3: 1.0 N + 1.0 C + 1.0 E | | <− N and C limited |
| Eq4: 1.0 R | | <− R limited |
| S,,2,, 1st Pass Requested vs Available: | | |
| Resource | Requested | Available |
| (R) | 1.0 | 1.0 |
| R | 1.0 | 1.0 |
| C | 1.0 | 1.0 |
| E | 1.0 | 1.0 |
| N | 1.0 | 1.0 |
| T | 0.0 | 10.0 |
| {N} | 1.0 | 1.0 |
| {S} | 0.0 | 1.0 |

No overrequested resources, so 1st Pass requests stand.

3. Cell calculates mean resource concentrations by accumulating internal resource contents

from all subunits and dividing by total cell volume
Accumulated internal resource totals and concentrations:

| Resource | From S1 | | From S2 | Total | Concentration |
|---|---|---|---|---|---|
| R | 1.0 | + | 1.0 | = 2.0 | 2.0/2.0 = 1.0 |
| C | 1.0 | + | 1.0 | = 2.0 | 2.0/2.0 = 1.0 |
| E | 2.0 | + | 2.0 | = 4.0 | 4.0/2.0 = 2.0 |
| N | 1.0 | + | 1.0 | = 2.0 | 2.0/2.0 = 1.0 |
| T | 10.0 | + | 10.0 | = 20.0 | 20.0/2.0 = 10.0 |

4. Each gene assembly calculates its promotion and subsequent resource requests based on

mean internal concentrations
G,,1,, promotion:

| Regulatory Region | | T concentration | Promotion |
|---|---|---|---|
| | [T 2] | 10.0 | ~= 2.0 |

G,,1,, resource requests:
2.0 * [E 1] = 2.0 E
G,,2,, promotion:

| Regulatory Region | | T concentration | Promotion |
|---|---|---|---|
| | [T 2] | 10.0 | ~= 2.0 |

G,,2,, resource requests:
2.0 * [E 1] = 2.0 E

5. Cell calculates scale factors for all resources requested by genes based on total resource

requests
Total Requests (from Genes and Eqs) vs. Total Available:
Only E was requested by genes, so only E needs to be scaled.

| | |
|---|---|
| Total Requests | Total Available |
| 6.0 E | 4.0 E |
| Scale E: | |

| | |
|---|---|
| Requested | Available |
| 6.0N = | 4.0 |

N = 0.66

6. Each gene assembly recalculates its transcription rate and resource requirements based

on its initial requests and scale factors
G,,1,,:

| Consumed | | Produced |
|---|---|---|
| 0.66(2.0 E) | −> | 0.66(2.0 R) |
| 1.33 E | −> | 1.33 R |

G,,2,,:

| Consumed | | Produced |
|---|---|---|
| 0.66(2.0 E) | −> | 0.66(2.0 C) |
| 1.33 E | −> | 1.33 C |

1. Consumed genetic resources are reported to each subunit according to its contribution

to the cellular total
Consumed Resources Reported to S,,1,,:

| Resource | Cell Total | Subunit | Total | Total Consumed | | Reported to Subunit |
|---|---|---|---|---|---|---|
| E | 4.0 | 2.0 | 2.66 | 2.66*(2.0/4.0) | = | 1.33 |

Consumed Resources Reported to S,,2,,:

| Resource | Cell Total | Subunit | Total | Total Consumed | | Reported to Subunit |
|---|---|---|---|---|---|---|
| E | 4.0 | 2.0 | 2.66 | 2.66*(2.0/4.0) | = | 1.33 |

2. Genetic products are reported to all subunits (distributed equally)

Gene Products Reported to Each Subunit:

| Resource | Total | Produced | Subunits | | Reported to Each Subunit |
|---|---|---|---|---|---|
| R | 1.33 | 2 | 1.33/2 | = | 0.66 |
| C | 1.33 | 2 | 1.33/2 | = | 0.66 |

7. Each subunit recalculates resource requests based on scaled local resource availability

In S,,1,,:
Eq1 is unaffected by gene activity:
Eq1: 0.5 {S} + 0.5 (R) = 0.5 T + 0.5 (R)
Eq2 is unaffected by gene activity:
Eq2: 0.5 {N} + 0.5 (R) = 0.5 N + 0.5 (R)
Eq3 is affected by E scaling:
Eq3: 0.66( 1.0 N + 1.0 C + 1.0 E = 1.0 C + 3.0 E) <− See below
Eq3: 0.66 N + 0.66 C + 0.66 E = 0.66 C + 2.0 E
Eq4 is unaffected by gene activity:
Eq4: 1.0 R = 1.0 (R)

8. Each subunit removes resources consumed by metabolic equations and transcription and

adds resources produced by metabolic equations and transcription
In S,,1,,:

| Resource | Initial | | Removed | | Removed | | Added by | | Added by | | Ending |
|---|---|---|---|---|---|---|---|---|---|---|---|
| | Amount | | by Eqs | | by Genes | | Eqs | | Genes | | Amount |
| (R) | 1.0 | − | 1.0 | − | 0.0 | + | 1.0 | + | 0.0 | = | 1.0 |
| R | 1.0 | − | 1.0 | − | 0.0 | + | 0.0 | + | 0.66 | = | 0.66 |
| C | 1.0 | − | 0.66 | − | 0.0 | + | 0.66 | + | 0.66 | = | 1.66 |
| E | 2.0 | − | 0.66 | − | 1.33 | + | 2.0 | + | 0.0 | = | 2.0 |
| N | 1.0; | − | 0.66 | − | 0.0 | + | 0.5 | + | 0.0 | = | 0.83 |
| T | 10.0 | − | 0.0 | − | 0.0 | + | 0.5 | + | 0.0 | = | 10.5 |
| {N} | 1.0 | − | 0.5 | − | 0.0 | + | 0.0 | + | 0.0 | = | 0.5 |
| {S} | 1.0 | − | 0.5 | − | 0.0 | + | 0.0 | + | 0.0 | = | 0.5 |

In S,,2,,:

| Resource | Initial | | Removed | | Removed | | Added by | | Added by | | Ending |
|---|---|---|---|---|---|---|---|---|---|---|---|
| | Amount | | by Eqs | | by Genes | | Eqs | | Genes | | Amount |
| (R) | 1.0 | − | 1.0 | − | 0.0 | + | 1.0 | + | 0.0 | = | 1.0 |
| R | 1.0 | − | 1.0 | − | 0.0 | + | 0.0 | + | 0.66 | = | 0.66 |
| C | 1.0 | − | 0.66 | − | 0.0 | + | 0.66 | + | 0.66 | = | 1.66 |
| E | 2.0 | − | 0.66 | − | 1.33 | + | 2.0 | + | 0.0 | = | 2.0 |
| N | 1.0 | − | 0.66 | − | 0.0 | + | 1.0 | + | 0.0 | = | 1.33 |
| T | 10.0 | − | 0.0 | − | 0.0 | + | 0.0 | + | 0.0 | = | 10.0 |
| {N} | 1.0 | − | 1.0 | − | 0.0 | + | 0.0 | + | 0.0 | = | 0.0 |
| {S} | 1.0 | − | 0.0 | − | 0.0 | + | 0.0 | + | 0.0 | = | 0.5 |

Ending Amounts in S,,1,, and S,,2,,, Side-by-Side:

| Resource | S1 | S2 | |
|---|---|---|---|
| (R) | 1.0 | 1.0 | |
| R | 0.66 | 0.66 | |
| C | 1.66 | 1.66 | |
| E | 2.0 | 2.0 | |
| N | 0.83 | 1.33 | <−\ |
| T | 10.5 | 10.0 | <−\ |
| {N} | 0.5 | 0.0 | <− Not equal |
| {S} | 0.5 | 1.0 | <−/ |

9. Cell redistributes internal resources between subunits factoring in concentration

differences, separation distances, and, potentially, resource properties, then follows the steps
to Produce ECM, Decay resources and Check and perform other cell actions.

Cell accumulates ECM precursor totals and polls subunits to identify associated locations of highest surface activity for placement decisions. To consume resources proportionately to where they are located in subunits, the cell can pass to each subunit the total to be consumed and the total availability. Each subunit knows its local availability and can calculate its contribution to the total. Therefore, it can calculate how much of its local precursor amount to consume.

A consumption example in a 2-subunit cell where 1 ECM unit is produced for each 1 ECMPrecursor unit is as follows:

| Subunit | ECMPrecursor (before ECM production) |
|---|---|
| S1 | 1.50 |
| S2 | 0.25 |

Cell accumulates ECMPrecursor.
Total ECMPrecursor == 1.75
Cell can make 1 ECM unit with 0.75 ECMPrecursor left over.
Cell notifies S1 that 1 ECMPrecursor unit is to be consumed and the
total ECMPrecursor was 1.75.
S1 calculates its proportional contribution to the total as
1.5/1.75 = 0.857.
S1 consumes 0.857*1.0 = 0.857 ECMPrecursor.
Cell notifies S2 that 1 ECMPrecursor unit is to be consumed and the
total ECMPrecursor was 1.75.
S2 calculates its proportional contribution to the total as
0.25/1.75 = 0.143.
S2 consumes 0.143*1.0 = 0.143 ECMPrecursor.

| | |
|---|---|
| Subunit | ECMPrecursor (after ECM production) |
| S1 | 0.643 |
| S2 | 0.107 |

This method can also be applied for consumption of Growth and Division resources.

### F6. Embodiments of Narrative Pseudocode for transcribeGenome Function

The following function provides additional detail for metabolizeCell described above. (Also, see above for the description of a genome and its components.) In one embodiment, each gene unit of the genome can be compared for affinity and a corresponding promotion can be calculated. If the net promotion of a gene unit is positive, the gene unit products specified in its structural region are produced and added to the cell's internal resources, either as transfactors to be considered in future transcriptions or metabolic reactions or as potential action triggers accumulated for growth, division, etc. In another embodiment, promotion of a gene unit can be permitted only with an exact match of a promoter resource. In such embodiments, simulation computations can be decreased without compromising model integrity.

The affinity of a particular transcription factor (TF) for a particular control gene (CG) is a function of each object's affinityFactor and sensitivityFactor multiplied by the concentration of the TF. The default for this calculation may be:

affinity(TF, CG)=((TF.concentration)*(e^{(-((TF.affinityFactor-CG.affinityFactor)}2)*(TF.sensitivityFactor)*(CG.sensitivityFactor))

This means that the affinity scales linearly with the concentration, all other things being equal. In other words, with infinite concentration you have infinite affinity. In some embodiments, this relationship may not be desirable, and may be calculated in an alternative way.

For a given CG of a functional unit (FU), the affinity of each TF in the environment of the cell with the CG is then summed. The totalAffinity of all TFs with the CG is then compared to an XML configurable threshold, and the level of “promotion” of the CG on FU is then defined to be CG.effectFactor if totalAffinity>threshold, else the contributed level of promotion is 0.0. The promotion level is then summed for each CG in the FU, indicating the totalPromotion for the FU.

The totalPromotion is then compared against another XML configurable threshold, and if it is greater than the threshold the FU is turned on. Otherwise it is turned off. Finally, if the gene is turned on, each structural gene (SG) in the FU produces a resource with a concentration of 1. Example pseudo-code:

set totalPromotion = 0

For all CGs in the FU

set totalAffinity = 0
For all TFs

totalAffinity = totalAffinity + affinity(TF, CG)

if totalAffinity > affinityThreshold

totalPromotion = totalPromotion + CG.effectFactor

if totalPromotion > promotionThreshold then for all SG in FU

produce the resource defined by the SG with concentration
of 1.0

The calculation of promotion, referred to in the pseudocode below, is described above with respect to FIG. 5 at 100, and further described in FIG. 20 and corresponding description above. One such calculation is

$$\frac{SpecifiedEffect}{1 + {e}^{- ( SpecifiedAffinity - SpecifiedPromotionMidpoint )}}$$

The updating of concentration, referred to in the pseudocode below, is described in Section E.3.6.2 and specified by the genome (see above). In one embodiment, a calculation used is the product of the SpecifiedConcentration and the CalculatedPromotion from the promotion calculation.

// this function is called on a genome by its cell during simulation
function transcribeGenome
{

for each GeneUnit in Genome
{

calculate Promotion on GeneUnit based on present

transfactors and presented chemistry

update Concentration from Promotion
if Concentration > 0
{

for each Gene in GeneUnit's structural region

{

if Specified-Gene-Product is a Transfactor
{

accumulate concentration of Transfactor specified

in the GeneUnit into Cell's store

}

else
{

accumulate concentration of Action-Resource

product specified in the GeneUnit into
Cell's store

}

}

}

}

}

### G. Applications of the Cell-Centric Simulation System to Modeling Multicellular Tissue Development

This section describes methods and strategies for generating multicellular virtual tissues having selected behavioral and morphological properties, and for testing such virtual tissues.

Essentially, three steps can be followed to develop a particular model:
1) Describe the model: identify the criteria that indicates how the model will be recognized;
2) Define cell states: identify the various cell states expected to be seen in the model;
3) Write configuration file: encode the cell state transitions into a configuration with virtual genes and metabolic-interaction rules.

The following examples illustrate tissue modeling for three different tissue types and all assume a free-space environment where cells can be shaped with the marbles-in-a-bag approach described under section D7. The examples are intended to illustrate how the virtual genome and metabolic equations may be selected to achieve specific tissue behavior and morphology, but are in no way intended to limit the scope of the invention. Further, the basic models described below may be configured to run on a plurality of cell simulation systems or other application platforms. Accordingly, one of ordinary skill in the art will recognize that other code and program instructions, order of steps, etc. may be used to implement the features and functions described herein, including those that may or may not be explicitly described in section E and F above.

### G1. Example 1

### Simple Model of Cells Committed to Differentiation

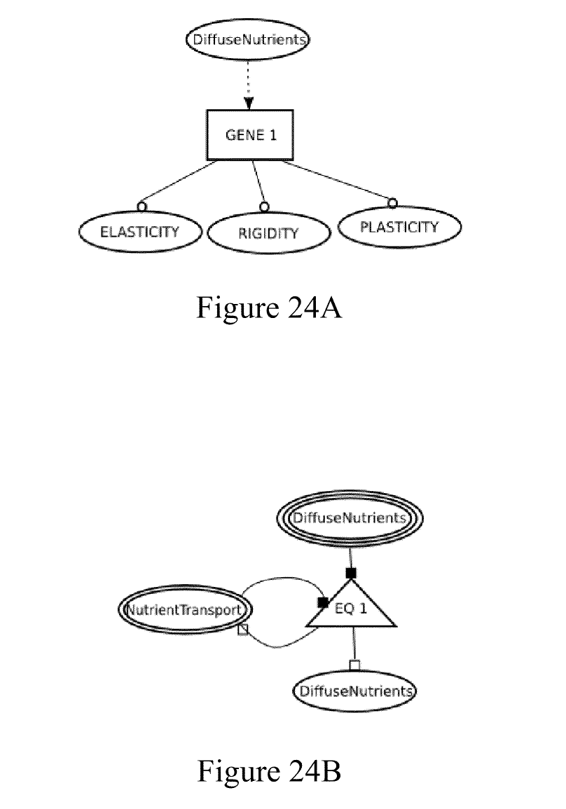

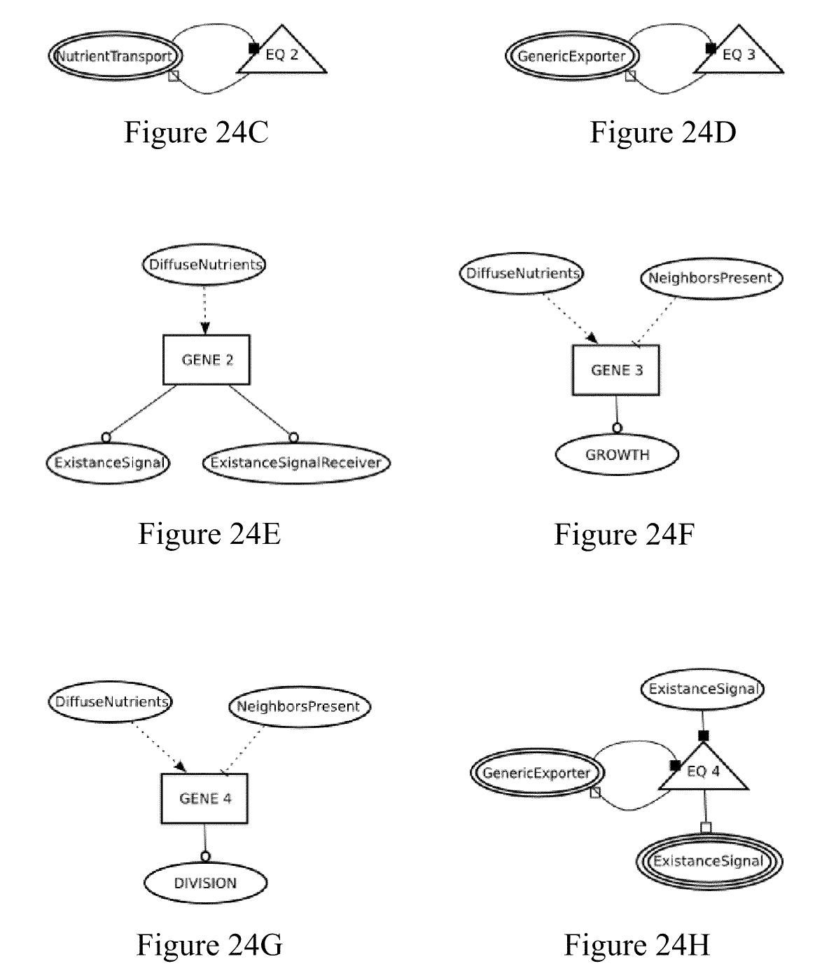

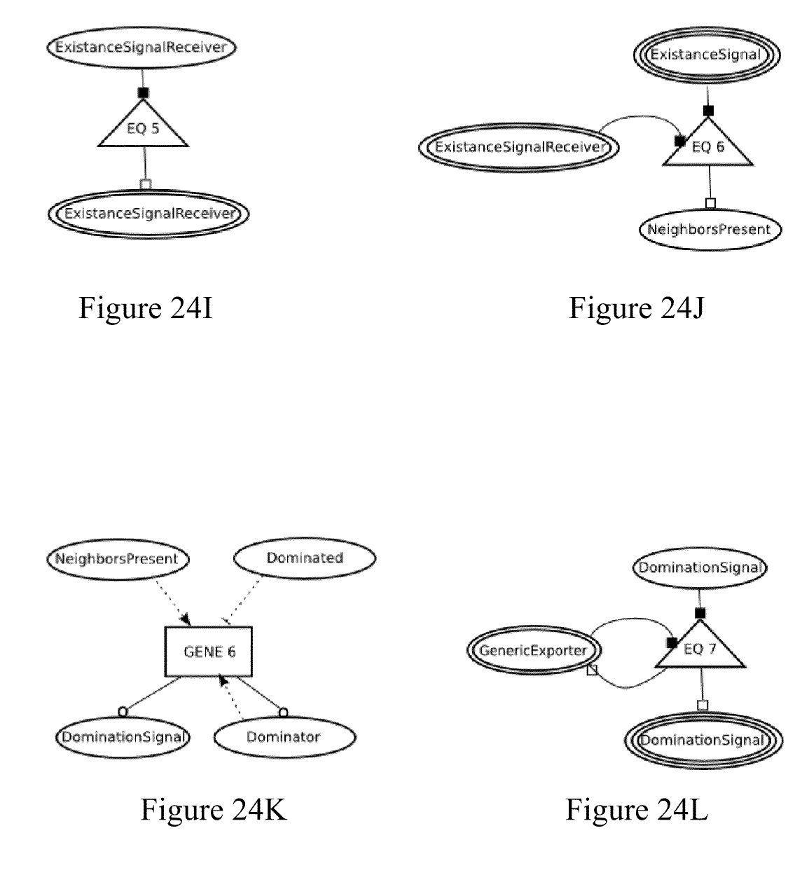

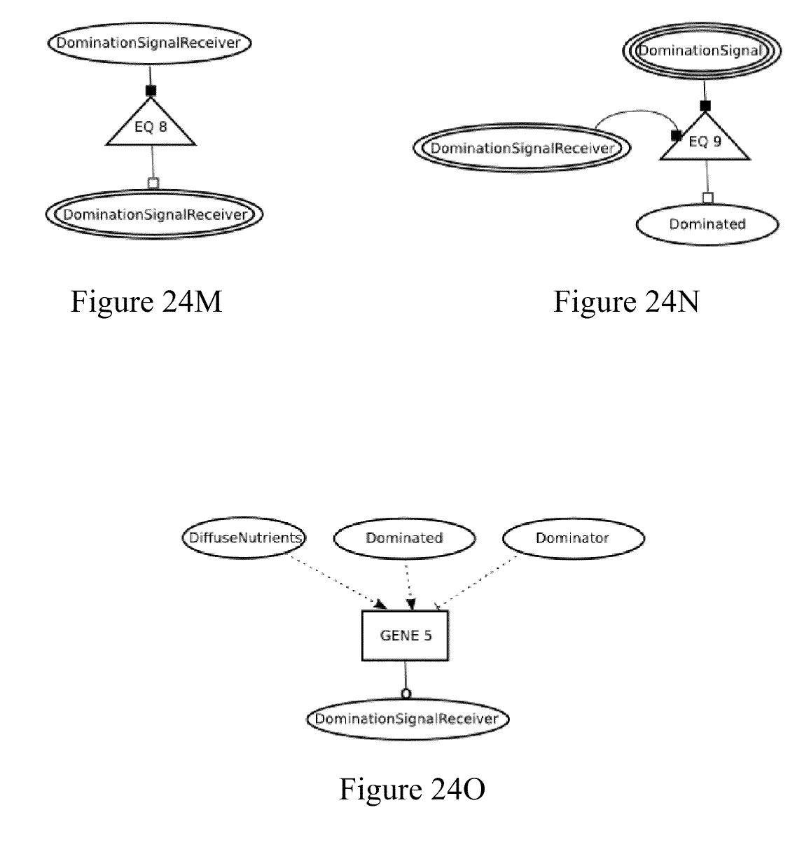

Introduced in Section D, the first example demonstrates how cells can develop a propensity to differentiate. This section describes an analysis and design approach with which to generate that example. The SGRN for this example is diagramed in FIG. 9 and discussed above in Section C. FIGS. 24A-24O are schematic flow diagrams illustrating resources and actions, virtual genes and gene products, and metabolic-interaction rules for modeling a multicellular tissue in accordance with the simulation of biological events described in Example 1 of sections C and G1, and in accordance with an embodiment of the disclosure.

### G1.1 Describing the Model

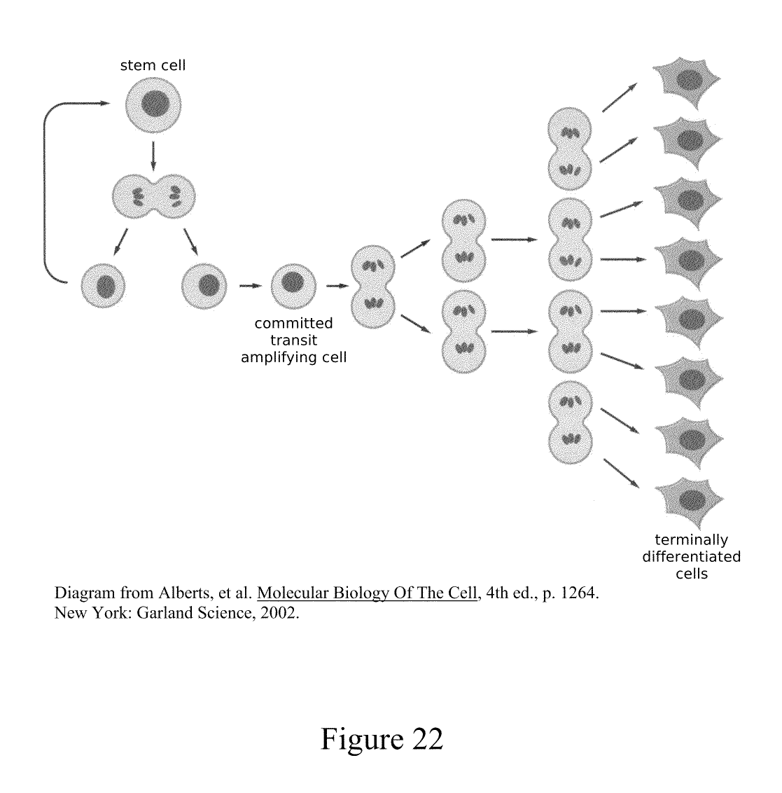

The object is to produce some kind of chemical disparity between two cells that can lead to a persistent or permanent difference between them. This mechanism closely resembles biological mechanisms for generating daughter cells from dividing stem cells. Typically one daughter cell remains a stem cell while the other daughter cell differentiates to some other type of cell. FIG. 22 is a schematic diagram illustrating the role of transient amplifying cells in the development of epithelial tissue.

To generate this model, the user begins with configuring the initial cell. The intent is to have this cell grow and divide such that two cell types result: Dominator, similar to the initial cell state, and Dominated, distinct from Dominator. The cells are to have chemical differences resulting from signaling from neighbor cells. The initial cell will produce new cells that will signal one other. Due to the nature of the signaling, no two cells will receive the exact same amount of signal.

The goal is to build a metabolic pathway and adjust it to use this difference in signaling strength to produce the intended differences in the cells. The cells will be competing to reach the Dominator state: the first to reach that state will commit to the Dominator state, suppress the other cells from reaching that state, and actively signal them to instead transition to the Dominated state. Until a cell reaches the Dominator state, all cells will be uncommitted.

### G1.2 Defining Cell States

First, a list of cellular states and their corresponding behaviors in different situations must be made from which to design a suitable genome. As appropriate, listed states may have mutual exclusivity with other states. In this example model, as shown in Table 8, three cell states are listed:

TABLE 8
Categorical Examples and Descriptions of Cell States

| | |
|---|---|
| NEUTRAL: | NEUTRAL CELLS HAVE NOT COMMITTED TO ANY |
| | PATH BUT PURSUE REACHING DOMINATOR STATE |
| | WHEN THEY DETECT ENOUGH NEIGHBORS AROUND |
| | THEM. THEY CAN GROW AND DIVIDE, SEND AND |
| | RECEIVE A “NEIGHBOR” SIGNAL, CAN RECEIVE |
| | “BECOME DOMINATED” SIGNAL, AND CAN ATTAIN |
| | EITHER DOMINATOR OR DOMINATED STATES. |
| DOMINATOR: | THESE CELLS PURSUE RETENTION OF THE |
| | DOMINATOR STATE AND INFLUENCE |
| | SURROUNDING CELLS TO REACH DOMINATED |
| | STATE. DOMINATOR CELLS CANNOT GROW AND |
| | DIVIDE. THEY CAN SEND AND RECEIVE A “BECOME |
| | DOMINATED” SIGNAL. |
| DOMINATED: | THESE CELLS HAVE REACHED A TERMINAL STATE |
| | AND SO CANNOT TRANSITION FURTHER. THESE |
| | CELLS CANNOT GROW OR DIVIDE. |

### G1.3 Writing the Configuration File

A configuration file to submit to the ontogeny engine can be written. Section E describes key syntax. From an initial simulation configuration template, features and details are successively added until the desired outcome is reached.

Below is a simulation configuration template; it does not yet contain any model specific equations or genetic information. Its content is based primarily on previous practice that worked well in various models. Configuration example:

<CsIndividual>

<Simulation>

<Cell>

<Chemistry><Smooth/></Chemistry>
// Starting the Cell off with some surface resources
<InitialChemistry>

(NutrientTransport) 50

(GenericExporter) 50
(ECMDetector) 50

</InitialChemistry>
<MetabolicEquations>

{ DiffuseNutrients } + (NutrientTransport) =

.1 DiffuseNutrients + ( 1.11 NutrientTransport );

( NutrientTransport ) =

( 1.111111111111111111 NutrientTransport );

( GenericExporter ) = ( 1.11 GenericExporter );

</MetabolicEquations>
// A pretty standard promotion curve
<Promoter>

<Smooth>

<PromotionMidpoint> 10 </PromotionMidpoint>
<ActiveConcentration> 1 </ActiveConcentration>

</Smooth>

</Promoter>
//This large maximum size makes us be careful about
regulating growth
<MaximumSize>300</MaximumSize>
// Size of the first cell, larger than a typical somatic
// cell for this model, more like an egg
<InitialSize>40</InitialSize>
<MinimumSize>6</MinimumSize>

</Cell>
<Signal> // A very short range signaling scheme

<Local>

<Separation> .1 </Separation>

</Local>

</Signal>
// These physics settings tend to work well, they're used in
// lots of models
<Physics>

<IterationsPerStep>50</IterationsPerStep>
<TimePerStep>.2</TimePerStep>
<DampingMultiplier>0.99</DampingMultiplier>
<NudgeMagnitude>1</NudgeMagnitude>

</Physics>
<MaxInterAdhesionLength>0.65</MaxInterAdhesionLength>

</Simulation>
<Genome>
[

[ DiffuseNutrients .3 ] [ Plasticity, Elasticity, Rigidity ]

]
</Genome>
// Our cells will live in an environment evenly covered with
// DiffuseNutrients
<Shade><UseRadius/><UseModifier/>
[

S DiffuseNutrients @ 0 1 0 5 1 1 1000

]
</Shade>

</CsIndividual>

This initial configuration template includes one gene unit, three metabolic equations, and surface resources that represent the state the cell is to start as. These surface resources allow the cell to bring in DiffuseNutrients. The single gene unit, illustrated in FIG. 24A, is to produce structural resources to give the cell a reasonable shape. The three metabolic equations, illustrated in FIGS. 24B-24D, are to maintain the initial surface resources and facilitate transport of DiffuseNutrients. The coefficients of 1.11 . . . are to help retain those nondecaying and unconsumed resources; that is, surface transport resources are replaced at a greater rate so as to offset their consumption or decay.

In practice, the template <Physics> settings produce a relatively stable environment; however, not all potential settings produce smooth results. The template <Smooth> promotion can allow any resource, no matter how poorly matched, to promote any gene unit, even at 0.0 affinity and concentration. For this reason, promotion midpoints for Smooth promotion are typically set relatively high to reduce the promotion at 0.0 affinity and concentration. With Smooth promotion, gene units often include explicit inhibitors to cancel out interference from resources that should not promote the assembly.

A simulation session with this initial configuration would develop a single, reasonably shaped cell that does not grow or divide, consumes DiffuseNutrients, and maintains its shape. Gene units and equations can be added to generate the desired differentiation behavior.

First, the state of the cells should reflect a neighbor cell concentration. For example, cells can be configured to send and receive a general awareness signal. ExistanceSignal can be a designated signal resource detectable by neighborhood cells alerting the neighborhood cells of given cell's existence. ExistanceSignalReceiver can be located on the surface of each cell for detecting and receiving ExistanceSignal resources from other neighborhood cells. FIG. 24E shows, as GENE 2, a gene unit that produces these resources with the promoter and product designations shown below. This gene unit is added inside the square brackets subordinate to the <Genome> tag.

### Configuration Example:

[DiffuseNutrients 5] [ExistanceSignal, ExistanceSignalReceiver]

To be a signal, the surface resource GenericExporter, established in <InitialChemistry>, can participate in a metabolic equation to transport the internally produced ExistanceSignal resources out of the cell; see FIG. 24H. The equation can also restore GenericExporter to prevent its consumption. In other embodiments, the metabolic equation can be configured such that GenericExporter is a non-consumed reactant. As with all metabolic interactions, the below text is to be added under the <MetabolicEquations> tag:

### Configuration Example:

ExistanceSignal+(GenericExporter)=(GenericExporter)+{ExistanceSignal};

To receive similar signals from other cells, ExistanceSignalReceiver can be placed onto the cell surface. Again, this can be done with a metabolic equation, see FIG. 24I and below:

### Configuration Example:

ExistanceSignalReceiver=(ExistanceSignalReceiver);

Further, the actual reception of ExistanceSignal external to the cell requires its transport into the cell by the surface ExistanceSignalReciever. Such resources transported into the cell can be represented by internal NeighborPresent resources. Again, this can be done with a metabolic equation, see FIG. 24J and below:

### Configuration Example:

{ExistanceSignal}+(ExistanceSignalReceiver)=NeighborPresent;

With the addition of the four previous configuration instructions, the signaling examples for recognizing the presence of neighboring cells and broadcasting a cell's presence is described. Therefore, the cell response to such signaling can be described.

In one embodiment, a small cluster of cells can be maintained by allowing the cells to grow and divide in the presence of nutrient only if there are not too many neighboring cells present. This does not preclude cells with a Dominated state from growing and dividing when they are isolated, but growth and division will stop in this configuration when in a small cluster. This behavior is configured by the addition of GENES 3 and 4, illustrated in FIGS. 24F and 24G. The configuration instructions for inclusion in the genome are given below:

### Configuration Example:

[DiffuseNutrients 0.18, NeighborPresent −3] [Growth]
[DiffuseNutrients 0.18, NeighborPresent −3] [Division]

To establish the potential for cell differentiation, cells can track their Dominator state and signal other cells of their progress to that state. In one example, a gene unit to promote a Dominator state in response to the presence of neighboring cells can be used to accomplish this objective. The NeighborsPresent resource received from other cells can promote this gene unit to produce both Dominator resource for internal accumulation and DominationSignal as a signal for negotiating the competition between cells to attain the Dominator state, FIG. 24K:

### Configuration Example:

[NeighborPresent 3, Dominated −10, Dominator 3] [Dominator, DominationSignal]

As in the signaling to indicate neighbor presence, this signal can be transported out, via GenericExporter for example, as it is produced, FIG. 24L:

### Configuration Example:

DominationSignal+(GenericExporter)=(GenericExporter)+{DominationSignal};

Likewise, similar signals from other cells can be received to complete the signal pathway. In this example, a surface resource, such as DominationSignalReceiver, can transport the externally detected signals into the cell. As the external signal resources are brought in, they will accumulate as internal Dominated resources, FIG. 24N:

### Configuration Example:

{DominationSignal}+(DominationSignalReceiver)=Dominated;

By attenuating the production of the surface resources for signal reception, cells can vary their response to signals from other cells. As cells accumulate internal Dominator resource by their own signal production (see above), resistance to other cells' signal should increase until that cell attains the Dominator state. As cells accumulate internal Dominated resource from other cells' signals, the cells can be configured to reduce their signaling until they become inert and no longer send or receive Domination signals from their neighbors. The above example describes one mechanism for simulating a basic form of differentiation.

As illustrated in FIG. 24O and the configuration instruction below, the “Dominator −10” in a new gene unit's control region will inhibit the expression of internal DominationSignalReceiver resource. Conversely, as cells accumulate Dominated resources from other cells, this expression is promoted. Cells reinforce the expression of this gene unit with DiffuseNutrients, further setting them on the path of terminal differentiation.

### Configuration Example:

[DiffuseNutrients 5, Dominator −10, Dominated 5] [DominationSignalReceiver]

As before, a metabolic equation can be added to the configuration file to move any produced DominationSignalReceiver to the cell surface, FIG. 24M:

### Configuration Example:

DominationSignalReceiver=(DominationSignalReceiver);

In practice, the design of configuration instructions to create desired gene unit and metabolic equations can require trial and error of the involved coefficients to refine the model. If cells receive too much signal and transition too quickly, the signal receptor coefficient can be adjusted. If cells only partially transit to another state and continue uncommitted for longer than desired, a user can adjust the gene unit expression for state transitions to be more definite.

The following is an exemplary configuration file generated from the Example 1 described above:

<CsIndividual>

<ResourceCatalog></ResourceCatalog>
<Simulation>

<ECMDefinitionRules></ECMDefinitionRules>
<AdhesionRules>

Dominator : Dominator ;

</AdhesionRules>
<Cell>

<Axisifier><Random/></Axisifier>
<Chemistry><Smooth/></Chemistry>
<InitialChemistry>

(NutrientTransport) 50
(GenericExporter) 50

</InitialChemistry>
<MetabolicEquations>

{ DiffuseNutrients } + (NutrientTransport) =

.1 DiffuseNutrients + ( 1.11111111111111 NutrientTransport );

( NutrientTransport ) =

( 1.111111111111111111 NutrientTransport );

( GenericExporter ) = ( 1.111111111111111111 GenericExporter );
ExistanceSignal + ( GenericExporter ) =

( 1.1111111111111 GenericExporter ) + { ExistanceSignal };

ExistanceSignalReceiver = ( ExistanceSignalReceiver );
{ ExistanceSignal } + ( ExistanceSignalReceiver ) =

20 NeighborPresent;

DominationSignal + ( GenericExporter ) =

( 1.1111111111111 GenericExporter ) + { DominationSignal };

DominationSignalReceiver = ( DominationSignalReceiver );
{ DominationSignal } + ( DominationSignalReceiver ) =

20 Dominated + 20 GrowABit;

</MetabolicEquations>
<Promoter>

<Smooth>

<PromotionMidpoint> 10 </PromotionMidpoint>
<ActiveConcentration> 1 </ActiveConcentration>

</Smooth>

</Promoter>
<MaximumSize>300</MaximumSize>
<InitialSize>40</InitialSize>
<MinimumSize>6</MinimumSize>
<ECMProductionRules></ECMProductionRules>

</Cell>
<Signal>

<Local>

<Separation> .1 </Separation>

</Local>

</Signal>
<Physics>

<IterationsPerStep>50</IterationsPerStep>
<TimePerStep>.2</TimePerStep>
<DampingMultiplier>0.99</DampingMultiplier>
<NudgeMagnitude>1</NudgeMagnitude>

</Physics>
<MaxInterAdhesionLength>0.65</MaxInterAdhesionLength>

</Simulation>
<DevelopmentEngine>

<MaxSteps>10000</MaxSteps>
<StableSteps>10000</StableSteps>

</DevelopmentEngine>
<Genome>

[ DiffuseNutrients .3 ] [ Plasticity, Elasticity, Rigidity ],
[ DiffuseNutrients 5 ] [ ExistanceSignal, ExistanceSignalReceiver ],
[ DiffuseNutrients .18, NeighborPresent −3 ] [ Growth ],
[ DiffuseNutrients .18, NeighborPresent −3 ] [ Division ],
[ DiffuseNutrients 5, Dominator −10, Dominated 5 ]

[ DominationSignalReceiver ],

[ NeighborPresent 3, Dominated −10, Dominator 3 ]

[ Dominator, DominationSignal ]

</Genome>
<Shade><UseRadius/><UseModifier/>
[
S DiffuseNutrients @ 0 1 0 5 1 1 1000
]
</Shade>

</CsIndividual>

The resulting SGRN from this configuration is given by FIG. 9 and may be read as described in Section C.

### G2. Example 2

### Tissue Sheet with Stem Cell Niches

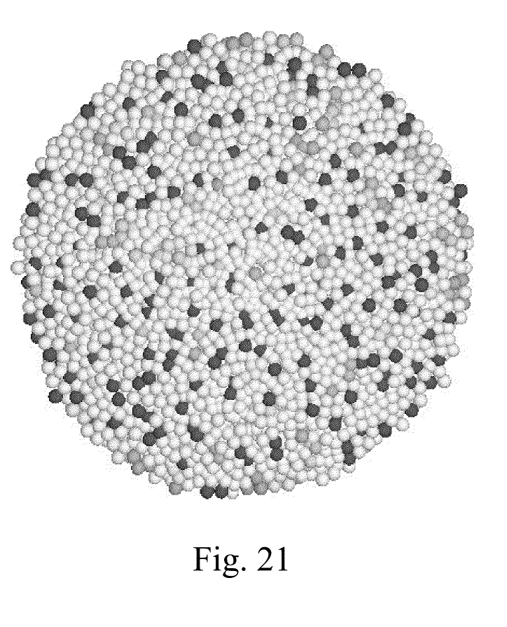

FIG. 21 is an isometric view illustrating a modeled cellular sheet including virtual stem cells, in accordance with an embodiment of the disclosure. In addition to the differentiation properties described above in Example 1, the model described here includes stem cell niches and cell differentiation, rather than just demonstrating the propensity for differentiation. The sheet is formed by placing two very large fixed spheres (see description in section E3.5 above) about the initial cell to establish relatively flat, metabolically inert obstacles in the environment and so physically limiting the growth of the cellular sheet. The user may configure the visualization engine to inhibit display of these large fixed spheres to allow unobstructed examination of the subject sheet.

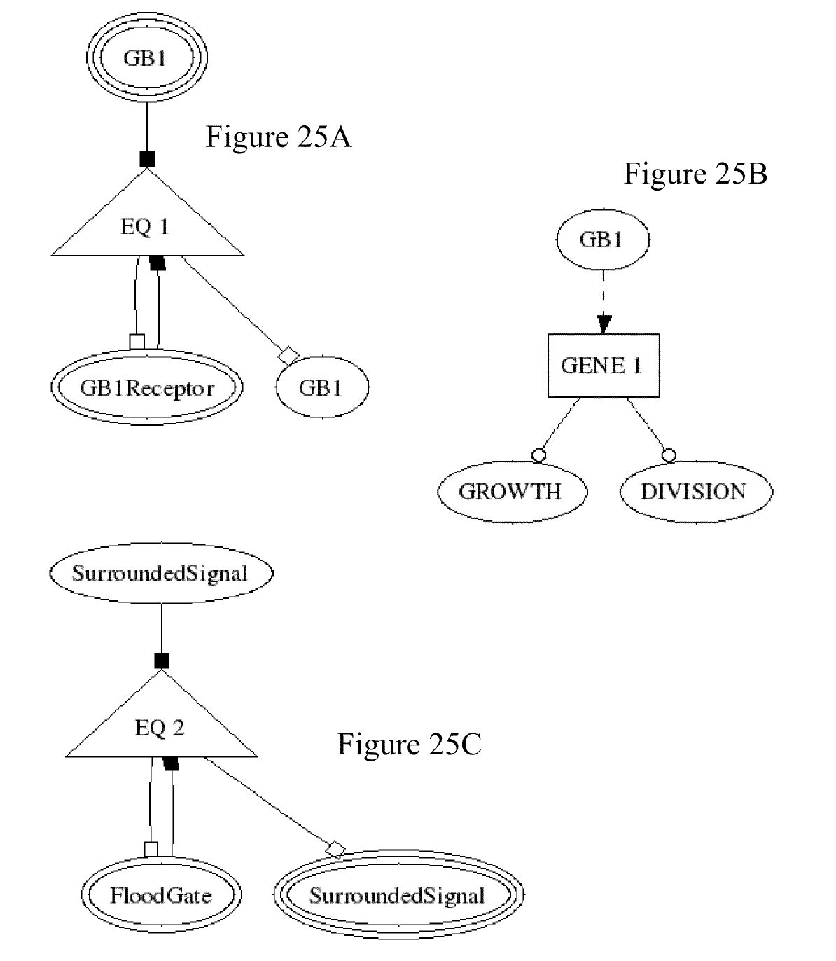

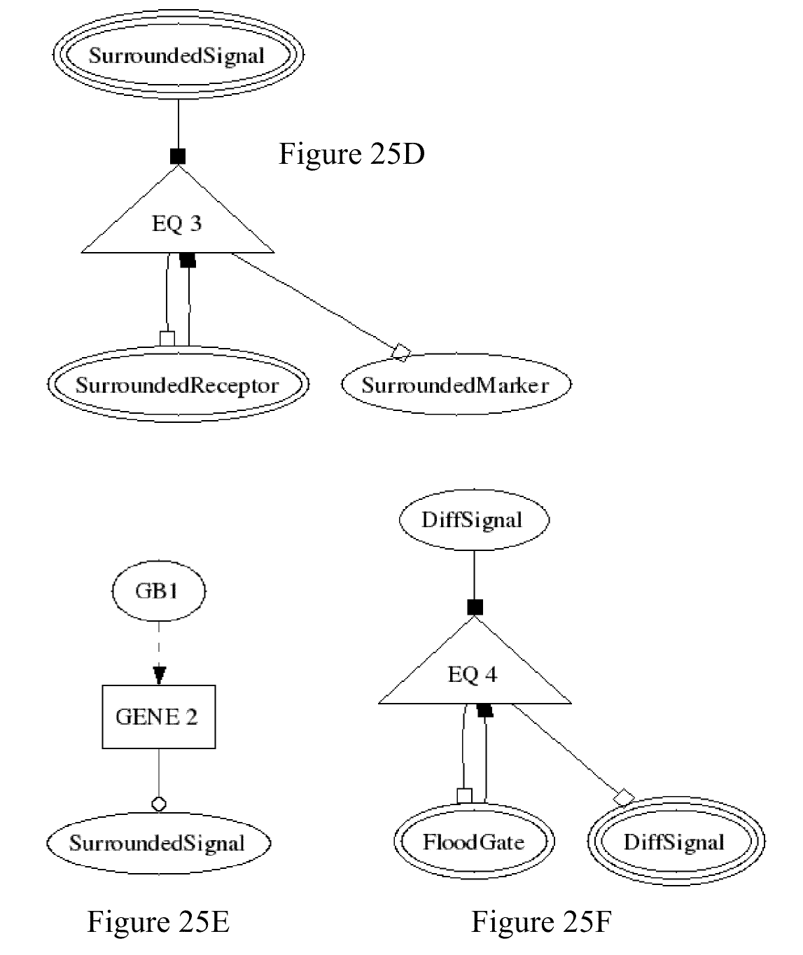

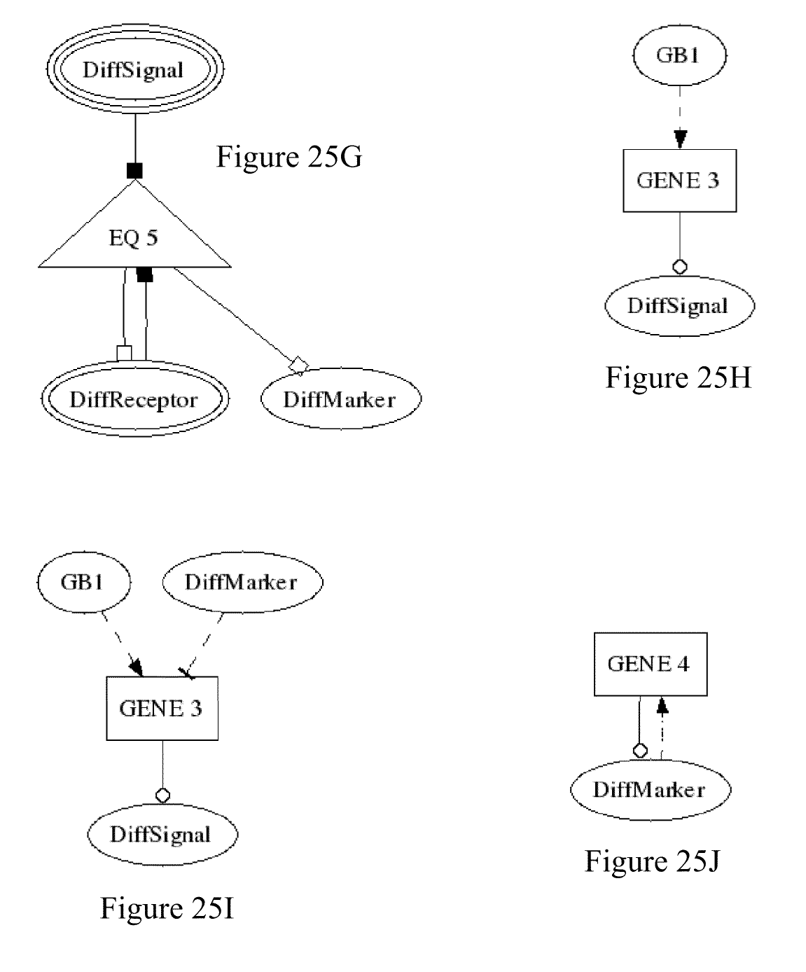

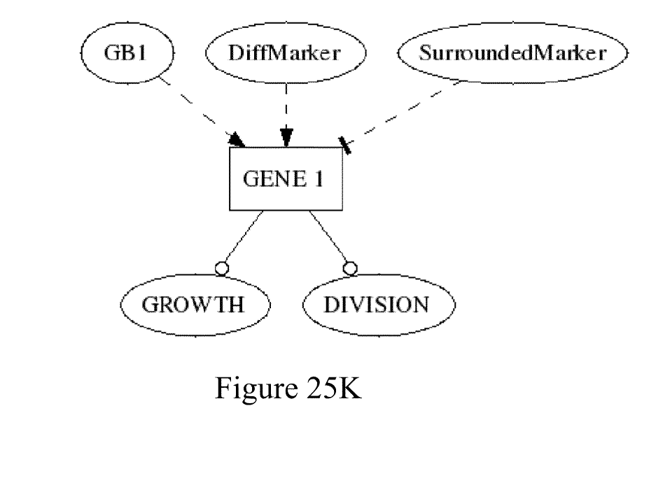

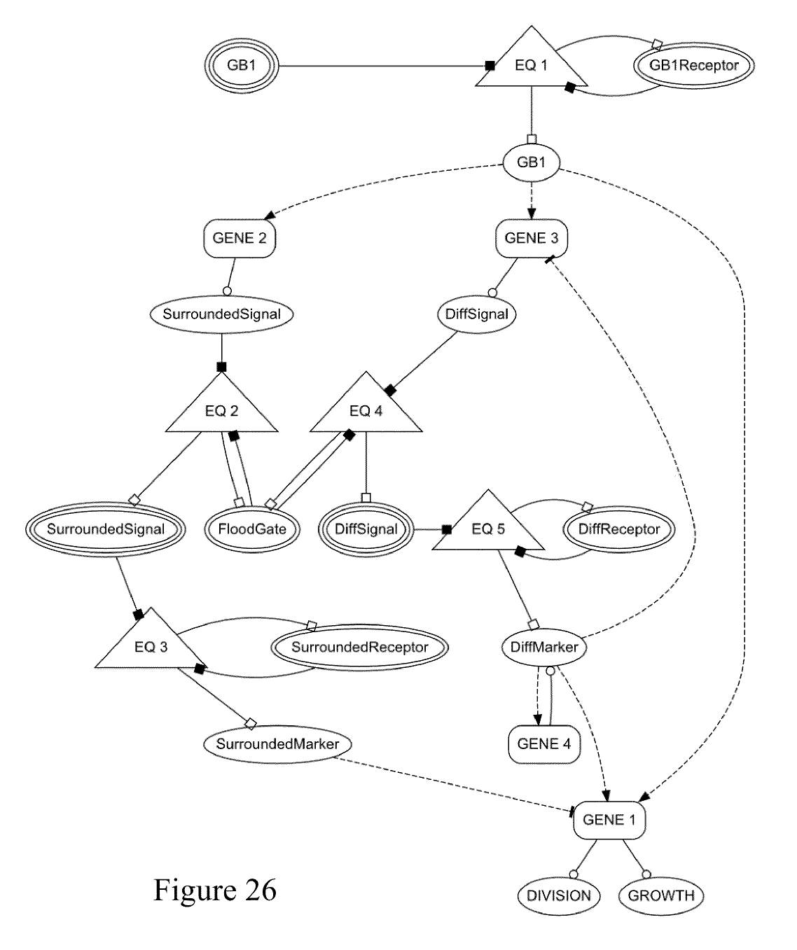

Signal isolation similar to that seen in Example 1 was used to establish cell differentiation leading to two types of cells: undifferentiated stem-cell-like cells and differentiated cells analogous to transit amplifying cells. FIGS. 25-A-25K are schematic flow diagrams illustrating resources and actions, virtual genes and gene unit products, and metabolic-interaction rules for modeling a multicellular tissue in accordance with the simulation of biological events herein, and in accordance with an embodiment of the disclosure. FIG. 26 is a schematic flow diagram illustrating a modeled SGRN for simulating development of a multicellular tissue with stem-cell niches in accordance with the simulation of biological events described herein, and in accordance with an embodiment of the disclosure.

### G2.1 Describing the Model

This model is designed to investigate a signaling mechanism for explaining how stem cell niches might become evenly distributed within a tissue. In a physically constrained sheet of cells, slow-growing, isolated, stem-like cells are each surrounded by numerous, faster-growing, transit-amplifying cells.

### G2.2 Dissecting the Problem to Identify Cell-Level Features

There are two basic cell conditions in this model: (1) the undifferentiated condition assigned to the initial cell and (2) a committed cell condition in which cells have been induced to commit by signals from an undifferentiated cell and which remain committed to differentiating in the presence of minimal ongoing signal. These conditions loosely represent the relationship between stem cells and transit-amplifying cells in the basal layer of epidermis.

In general, stem cells are regulated by niches. In some tissues, these niches are clearly defined and precisely located. In others, they may be scattered throughout the tissue with no apparent specialized niche cells. Regardless, the number of stem cells is relatively small compared to the number of differentiating or differentiated cells and the stem niches are relatively isolated from one another. In this example, individual virtual stem cells are isolated, effectively representing an entire niche. When an undifferentiated cell divides, one of them is to remain undifferentiated and the other commits to differentiation. This dynamic keeps the density of stem-like cells nearly constant. Additionally, the resultant cellular behavior suggests a signaling competition or asymmetric division. The cell-based model developed in Example 2 investigates which signal isolation mechanism supports the intended behavior.

In basal epidermis, transit-amplifying cells normally remain transit-amplifying cells until they are removed from the basal layer by population pressure or asymmetric division with respect to the basement membrane. However, in the event of injury where stem cell populations are damaged, some transit-amplifying cells may revert to stem cell conditions as part of the repair process. This implies that although commitment to differentiation is not trivial, at least some minimal signaling from stem cells may be required to keep transit-amplifying cells from reverting to stem cells.

### G2.3 Writing the Configuration File

The configuration is designed starting from a minimal simulation template. A <MaxInterAdhesionLength> setting of 0.25 allows adhesions between cells to stretch up to half the radius of unit spheres (i.e., r=0.5) before breaking (see E.3.2). This allows some computational variance for physics resolution and acknowledges that unlike model spheres, cells are flexible.

### Configuration Example:

<CsIndividual>

<Simulation>

<MaxInterAdhesionLength>0.25</MaxInterAdhesionLength>
<SingleAdhesionRule>0</SingleAdhesionRule>
<Cell>

<Chemistry><Default/></Chemistry>

</Cell>

</Simulation>

</CsIndividual>

Default <Physics> settings can be used to establish an initial configuration. Unlike the configuration of Example 1, <IterationsPerStep> is not specified. The simulation of Example 2 dynamically adjusts this parameter for each step based on the <MaxVelocityChange> and <TimePerStep> values and current calculated velocities. As in Example 1, the <DampingMultiplier> and <RepulsionMultiplier> values are close to one another (e.g., identical or close to identical). In some embodiments, balanced values tend to work better and absolute values tend to be less significant than the ratio.

### Configuration Example:

<Physics>

<MaxVelocityChange>2</MaxVelocityChange>
<TimePerStep>0.5</TimePerStep>
<DampingMultiplier>2</DampingMultiplier>
<RepulsionMultiplier>2</RepulsionMultiplier>

</Physics>

Instead of the <Smooth> promotion from Example 1, <Smoother> promotion is used to yield 0.0 promotion at 0.0 affinity and concentration; this allows lower promotion midpoints to be chosen for user convenience. In this example, <PromotionMidpoint> is set to 5 so that the effective range of promotion is covered by concentrations from 0 to 10. The <Slope> is set at 3 so that key promotion levels occur at convenient concentrations. Fifty percent of the promotion range is covered between concentration 4, where promotion is 25%, and concentration 6, where promotion is 75%. Above concentration 10, promotion is asymptotically maximal.

### Configuration Example:

<Promoter>

<Smoother>

<PromotionMidpoint>5</PromotionMidpoint>
<Slope>3</Slope>
<ActiveConcentration>1</ActiveConcentration>

</Smoother>

</Promoter>

The following is the resulting initial configuration from which to begin development of the second example:

### Configuration Example:

<CsIndividual>

<Simulation>

<MaxInterAdhesionLength>0.25</MaxInterAdhesionLength>
<SingleAdhesionRule>0</SingleAdhesionRule>
<Physics>

<MaxVelocityChange>2</MaxVelocityChange>
<TimePerStep>0.5</TimePerStep>
<DampingMultiplier>2</DampingMultiplier>
<RepulsionMultiplier>2</RepulsionMultiplier>

</Physics>
<Cell>

<Chemistry><Default/></Chemistry>
<Promoter>

<Smoother>

<PromotionMidpoint>5</PromotionMidpoint>
<Slope>3</Slope>
<ActiveConcentration>1</ActiveConcentration>

</Smoother>

</Promoter>

</Cell>

</Simulation>

</CsIndividual>

To simplify the example, mechanisms for cell cohesion or division orientation can be eliminated. The below instructions, under <Simulation>, constrain the model to grow between a pair of effectively infinite plates or “fixed spheres” (see description in section E3.5 above), limiting tissue growth to a single-layer sheet.

### Configuration Example:

<FixedSpheres>

[0, −1000, 0] 1000,
[0, 1001, 0] 1000

</FixedSpheres>

For simplicity and speed, a very short range Local signaling with Separation 0.2 is used (see description section E3.1 above). This short range signal requires cells to be touching or nearly touching for cell signals to be exchanged. The following is added under <Simulation>.

### Configuration Example:

<Signal>

<Local>

<Separation>0.2</Separation>

</Local>

</Signal>

To develop numerous cells quickly in minimal space, the minimum cell size is set to one subsphere and the maximum cell size to two subspheres. However, the initial cell will be larger than the maximum and have an odd number of subspheres to guarantee an asymmetrically-sized first division. As the initial 13-subsphere cell divides into thirteen individual cells in the first few steps, it will rapidly generate a mix of cells with different signaling environments and resource concentrations. The following is added under <Cell>.

### Configuration Example:

<InitialSize>13</InitialSize>
<MinimumSize>1</MinimumSize>
<MaximumSize>2</MaximumSize>

In this example, a cell nutrient resource named GB1 is uniformly available throughout the environment. As an entry of <Shade> under <CsIndividual>, a gradient builder for GB1 is added (see description in section E5 above) with a strength parameter of 1.0 and an exponent of 0.0. With an exponent of 0.0, the concentration of GB1 will be at the full strength of 1.0 everywhere in the environment; the location, modifier, and radius values are irrelevant here.

### Configuration Example:

<Shade><UseRadius/><UseModifier/>

[S GB1 @ 0 0 0 1 0 1 1 ]

</Shade>

For reference ease, a <ResourceCatalog> is established, under <CsIndividual>, with GB1 as its first entry. A high Sensitivity setting of 10 in the resource signature effectively demands exact matching with regulatory gene units.

### Configuration Example:

<ResourceCatalog>
GB1 [10, 10];
</ResourceCatalog>

As in the first example, surface transport resources are specified as both reactants and products so that they are not consumed or altered during resource transport. To import external GB1 via surface GB1Receptor, a metabolic equation is added, FIG. 25A:

### Configuration Example:

<MetabolicEquations>
{ GB1 } + ( GB1Receptor ) = GB1 + ( GB1Receptor );
</MetabolicEquations>

So cells do not have to maintain surface transport resources via gene unit expression as in the first example, all surface transport resources in this model are configured with decay rates of 0.0. The instruction below is added to the <ResourceCatalog>:

### Configuration Example:

GB1Receptor [20, 10] 0.0;

GB1 provides a reference concentration for gene unit promotion. To keep associated gene units fully promoted in this example, cells require importation of GB1 and maintenance of its concentration at or above 10. Therefore, the initial cell is primed with internal GB1 and surface GB1Receptor by adding these resources to <InitialChemistry> under <Cell>. The amounts of initial resources are chosen so that the initial cell contains a GB1 concentration of 10 and the surface GB1Receptor concentration is greater than the concentration of external GB1, making the signal the limiting factor and not the receptor.

To simplify searches for appropriate coefficients in signaling, it is often useful to explicitly make either the signal or the receptor the limiting factor by ensuring an abundance of the other factor. In this case, the cell should be initialized with enough GB1Receptor so that the cell can take in all of the presented external GB1 and maintain an internal GB1 concentration at or above 10, where its effect on gene unit promotion is maximal.

### Configuration Example:

```
<InitialChemistry>
  GB1 10
  ( GB1Receptor ) 5
</InitialChemistry>
```

All cells in this model are able to grow and divide. In undifferentiated cells, only GB1 will internally promote growth and division. The <Genome>, under <Cell>, is established. Its first gene unit, depicted in FIG. 25B, is written for production of Growth and Division resources upon promotion by GB1. The promotion effect value is adjusted so that growth and division occur in the initial cell and continue in the daughter cells.

### Configuration Example:

<Genome>
[
[ GB1 0.112 ] [ Growth, Division ]
]
</Genome>

To keep the tissue together and minimize drifting and shuffling of cells, cells must adhere to one another and so a non-decaying CellAdhesion resource is added to the configuration file. The resource is defined in the <ResourceCatalog>:

### Configuration Example:

CellAdhesion [90, 10] 0.0;

It is also added to the <InitialChemistry> as a surface resource so that no production expression or equation is necessary:

### Configuration Example:

(CellAdhesion) 0.1

An <AdhesionRule> is added under <Simulation> to associate the surface CellAdhesion resources of one cell to the surface CellAdhesion resources of another cell.

### Configuration Example:

<AdhesionRules>
( CellAdhesion ) : ( CellAdhesion );
</AdhesionRules>

Because of the high pressure situation created by the constrained environment and an intentionally rapidly growing tissue, surrounded cells grow and divide more slowly than cells on the perimeter. The concept of “contact inhibition” in living tissues can be applied here. To accomplish contact inhibition, cells need to recognize their position with respect to neighboring cells.

A metabolic equation is added to create internal SurroundedMarker in response to receiving external SurroundedSignal via surface SurroundedReceptor, FIG. 25D. The coefficient on SurroundedMarker (e.g., 2.0) is adjusted through experimentation so that a fully surrounded cell has a concentration of SurroundedMarker near 10, such that promotion of gene units by SurroundedMarker will be high, while a cell with only 1 or 2 neighbors has a SurroundedMarker concentration below 2 or 3, such that promotion of gene units by SurroundedMarker will be very low.

### Configuration Example:

{SurroundedSignal}+(SurroundedReceptor)=2.0 SurroundedMarker+(Surrounded Receptor);

These resources are added to the <ResourceCatalog>. As with GB1Receptor, SurroundedReceptor is configured as a non-decaying resource.

### Configuration Example:

SurroundedSignal [30, 10];
SurroundedReceptor [40, 10] 0.0;
SurroundedMarker [50, 10];

Also as with GB1Receptor, SurroundedReceptor is added to the <InitialChemistry> in sufficient quantity to guarantee that signal amounts will be the limiting factor in signaling:

### Configuration Example:

(SurroundedReceptor) 50

Another metabolic equation is added to export internal SurroundedSignal to the environment via a general-purpose surface exporter resource, FloodGate, FIG. 25C:

### Configuration Example:

SurroundedSignal+(FloodGate)={SurroundedSignal}+(FloodGate);

FloodGate, as a surface transporter, is added to the <ResourceCatalog> as a non-decaying resource:

### Configuration Example:

FloodGate [100, 10] 0.0;

As with the other surface transporters, FloodGate is added to the Initial Chemistry in sufficient quantity to guarantee that signal amounts will be the limiting factor in signaling.

### Configuration Example:

(FloodGate) 50

All cells will send the SurroundedSignal, so a gene unit promoted by GB1 is added to the <Genome> to produce SurroundedSignal, FIG. 25E. The promotion effect value is set to something large enough that signals produced each step will be detectable by neighboring cells, but not so large as to require neighbors to sustain a high concentration of receptors. Values near 0.125 meet these requirements given these other initial configuration settings.

### Configuration Example:

[GB1 0.125] [SurroundedSignal]

By the Kepler conjecture regarding maximum packing density of spheres in any three dimensional space, a maximally-surrounded single-sphere cell can receive contact signal from at most twelve single-sphere neighbors (Hales, 2005). Therefore, for such a cell to be able to distinguish between the maximum number of neighbors and one less than the maximum number of neighbors, its concentration of SurroundedReceptor must be at least 12 times greater than the maximal signal concentration. Internally, the range of SurroundedMarker concentration sustained by receiving from minimum to maximum SurroundedSignal should be between 0 and 10, the effective range of the simulation's configured promotion curve.

To reduce the rate of Growth and Division in surrounded cells, an inhibitory region matching SurroundedMarker is added to the already existing gene unit producing Growth and Division. The promotion and inhibition effect values may need to be balanced so that surrounded cells are still capable of growth and division at a very low rate while perimeter cells grow and divide at a noticeably higher rate. The changed gene unit is now as follows:

### Configuration Example:

[GB1 0.112, SurroundedMarker −0.001] [Growth, Division],

The configuration written thus far will grow a sheet of adhered cells where the edge cells of the sheet grow and divide more rapidly than those surrounded within:

### Configuration Example:

```
<CsIndividual>
  <ResourceCatalog>
    GB1 [10, 10];
    GB1Receptor [20, 10] 0.0;
    SurroundedSignal [30, 10];
    SurroundedReceptor [40, 10] 0.0;
    SurroundedMarker [50, 10];
    CellAdhesion [90, 10] 0.0;
    FloodGate [100, 10] 0.0;
  </ResourceCatalog>
  <Simulation>
    <MaxInterAdhesionLength>0.25</MaxInterAdhesionLength>
    <SingleAdhesionRule>0</SingleAdhesionRule>
    <Physics>
      <MaxVelocityChange>2</MaxVelocityChange>
      <TimePerStep>0.5</TimePerStep>
      <DampingMultiplier>2</DampingMultiplier>
      <RepulsionMultiplier>2</RepulsionMultiplier>
    </Physics>
    <FixedSpheres>
      [0, −1000, 0] 1000,
      [0, 1001, 0] 1000
    </FixedSpheres>
    <Signal>
      <Local>
        <Separation>0.2</Separation>
      </Local>
    </Signal>
    <Cell>
      <Chemistry><Default/></Chemistry>
      <InitialSize>13</InitialSize>
      <MinimumSize>1</MinimumSize>
      <MaximumSize>2</MaximumSize>
      <InitialChemistry>
        GB1 10
        ( GB1Receptor ) 5
        ( FloodGate ) 50
        ( SurroundedReceptor ) 50
        ( CellAdhesion ) 0.1
      </InitialChemistry>
      <MetabolicEquations>
        { GB1 } + ( GB1Receptor ) = GB1 + ( GB1Receptor );
        SurroundedSignal + ( FloodGate ) =
          { SurroundedSignal } + ( FloodGate );
        { SurroundedSignal } + ( SurroundedReceptor ) =
          2.0 SurroundedMarker + ( Surrounded Receptor );
      </MetabolicEquations>
      <Promoter>
        <Smoother>
          <PromotionMidpoint>5</PromotionMidpoint>
          <Slope>3</Slope>
          <ActiveConcentration>1</ActiveConcentration>
        </Smoother>
      </Promoter>
    </Cell>
    <AdhesionRules>
      ( CellAdhesion ) : ( CellAdhesion );
    </AdhesionRules>
  </Simulation>
  <Genome>
  [
    [ GB1 0.112, SurroundedMarker −0.001 ] [ Growth, Division ],
    [ GB1 0.125 ] [ SurroundedSignal ]
  ]
  </Genome>
  <Shade>
    <UseRadius/><UseModifier/>
    [ S GB1 @ 0 0 0 1 0 1 1 ]
  </Shade>
</CsIndividual>
```

From this base model, the signal isolation and differentiation relevant to stem cell formation can now be implemented. Undifferentiated cells can behave as stem cells and so should signal their neighbors to differentiate. Where two or more undifferentiated cells are together, a signaling competition similar to that in Example 1 should result in only one of the cells remaining undifferentiated.

All cells should be capable of receiving signals to differentiate. A metabolic equation is added to produce DiffMarker in response to receiving external DiffSignal via surface DiffReceptor, FIG. 25G:

### Configuration Example:

{DiffSignal}+(DiffReceptor)=DiffMarker+(DiffReceptor);

The three resources are added to the Resource Catalog and the receptor is configured as a non-decaying resource:

### Configuration Example:

DiffSignal [60, 10];
DiffReceptor [70, 10] 0.0;
DiffMarker [80, 10];

As with previous receptors, DiffReceptor is added to the Initial Chemistry:

### Configuration Example:

(DiffReceptor) 50

Another equation is added to export internal DiffSignal via surface FloodGate, FIG. 25F:

### Configuration Example:

DiffSignal+(FloodGate)={DiffSignal}+(FloodGate);

An instruction to produce DiffSignal is not yet written and so this signal pathway will not yet be exercised. Undifferentiated cells need to signal neighbors to differentiate, but differentiated cells should not signal their neighbors. A gene unit producing DiffSignal is added, promoted by GB1, FIG. 25H:

### Configuration Example:

[GB1 0.4] [DiffSignal]

An inhibiting gene unit matching DiffMarker is provided to prevent differentiated cells from signaling. Similar to the way SurroundedSignal and SurroundedMarker were balanced, the effect value promoting DiffSignal in the genome and the coefficient of DiffMarker in the metabolic equation for response to DiffSignal can be balanced so that a fully surrounded cell has a concentration of DiffMarker near 120 (12 maximum contacting cells times the concentration of 10).

The following instruction amends the gene unit for the balanced inhibition, FIG. 25I. The magnitude of the inhibitory effect should be larger than the promotion effect to ensure that a differentiated cell will not produce and send DiffSignal.

### Configuration Example:

[GB1 0.4, DiffMarker −0.5] [DiffSignal]

The previously added metabolic equation for importing the signal from the environment is amended to complete the balance:

### Configuration Example:

{DiffSignal}+(DiffReceptor)=3.0 DiffMarker+(DiffReceptor);

At this point, the model produces isolated undifferentiated cells with low concentrations of DiffMarker surrounded by differentiated cells with high concentrations of DiffMarker. Four factors are balanced to produce the central feature of signal isolation: promotion and inhibition effect values controlling DiffSignal expression, promotion effect of DiffMarker on expression of DiffMarker, and the coefficient on DiffMarker in the metabolic equation responding DiffSignal. This is sufficient to meet the basic design requirements.

To reinforce the distinction between differentiated and undifferentiated cells and to reduce the likelihood of differentiated cells reverted to an undifferentiated state, a positive reinforcement gene unit for DiffMarker, FIG. 25J, can be added to the <Genome>. The promotion effect value should be as high as possible without allowing a differentiated cell to maintain its concentration of DiffMarker through expression of this gene unit alone.

### Configuration Example:

[DiffMarker 0.25] [DiffMarker]

As a demonstration of a tangible potential behavioral effect of differentiation and to complete the model requirements from G2.1, differentiating cells in the model can be made to grow and divide more rapidly than undifferentiated cells, analogous to transit-amplifying cell division rates versus stem division rates. This is accomplished by amending the gene unit controlling growth and division to include DiffMarker as a promoter with its effect magnitude similar to the inhibition magnitude of SurroundedMarker, FIG. 25K. In general, all effect values in the assembly are adjusted as necessary to yield the slowest growth by internal undifferentiated cells, slightly faster growth by internal differentiated cells, and the fastest growth by perimeter differentiated cells.

### Configuration Example:

[GB1 0.112, DiffMarker 0.006, SurroundedMarker −0.001] [Growth, Division],

Once this simple model is working as intended, it can be used as-is or enhanced to explore patterns of signal isolation within a tissue given different signaling ranges and distributions.

In the example discussed above, a resulting configuration is shown below:

```
<CsIndividual>
  <ResourceCatalog>
    GB1 [10, 10];
    GB1Receptor [20, 10] 0.0;
    SurroundedSignal [30, 10];
    SurroundedReceptor [40, 10] 0.0;
    SurroundedMarker [50, 10];
    DiffSignal [60, 10];
    DiffReceptor [70, 10] 0.0;
    DiffMarker [80, 10];
    CellAdhesion [90, 10] 0.0;
    FloodGate [100, 10] 0.0;
  </ResourceCatalog>
  <Simulation>
    <MaxInterAdhesionLength>0.25</MaxInterAdhesionLength>
    <SingleAdhesionRule>0</SingleAdhesionRule>
    <Physics>
      <MaxVelocityChange>2</MaxVelocityChange>
      <TimePerStep>0.5</TimePerStep>
      <DampingMultiplier>2</DampingMultiplier>
      <RepulsionMultiplier>2</RepulsionMultiplier>
      <NudgeMagnitude>3</NudgeMagnitude>
    </Physics>
    <FixedSpheres>
      [0, −1000, 0] 1000,
      [0, 1001, 0] 1000
    </FixedSpheres>
    <Signal>
      <Local>
        <Separation>0.2</Separation>
      </Local>
    </Signal>
    <Cell>
      <Chemistry><Default/></Chemistry>
      <Promoter>
        <Smoother>
          <PromotionMidpoint>5</PromotionMidpoint>
          <Slope>3</Slope>
          <ActiveConcentration>1</ActiveConcentration>
        </Smoother>
      </Promoter>
      <InitialSize>13</InitialSize>
      <MinimumSize>1</MinimumSize>
      <MaximumSize>2</MaximumSize>
      <InitialChemistry>
        GB1 10
        ( GB1Receptor ) 5
        ( FloodGate ) 50
        ( DiffReceptor ) 50
        ( SurroundedReceptor ) 50
        ( CellAdhesion ) 0.1
      </InitialChemistry>
      <MetabolicEquations>
        { GB1 } + ( GB1Receptor ) = GB1 + ( GB1Receptor );
        SurroundedSignal + ( FloodGate ) =
          { SurroundedSignal } + ( FloodGate );
        { SurroundedSignal } + ( SurroundedReceptor ) =
          2.0 SurroundedMarker + ( SurroundedReceptor );
        DiffSignal + ( FloodGate ) = { DiffSignal } + ( FloodGate );
        { DiffSignal } + ( DiffReceptor ) =
          3.0 DiffMarker + ( DiffReceptor );
      </MetabolicEquations>
    </Cell>
    <AdhesionRules>
      ( CellAdhesion ) : ( CellAdhesion );
    </AdhesionRules>
  </Simulation>
  <Genome>
  [
    [ GB1 0.125 ] [ SurroundedSignal ],
    [ GB1 0.112, DiffMarker 0.006, SurroundedMarker −0.001 ]
      [ Growth, Division ],
    [ GB1 0.4, DiffMarker −0.5 ] [ DiffSignal ],
      [ DiffMarker 0.25 ] [ DiffMarker ]
  ]
  </Genome>
  <Shade>
    <UseRadius/><UseModifier/>
    [ S GB1 @ 0 0 0 1 0 1 1 ]
  </Shade>
</CsIndividual>
```

The resulting SGRN from this configuration is given by FIG. 26 and may be read as follows:

Nutrient for this model is provided by the external GB1 resource which is moved to the interior of a cell via “EQ 1” with surface GB1 Receptors.

Once inside the cell, GB1 promotes each of gene units “GENE 1”, “GENE 2”, and “GENE 3. Gene unit “GENE 1” directly promotes division and growth of cells and in the beginning of development provide stimulus for the model to expand.

However, “GENE 2” is also promoted by GB1 to produce SurroundedSignal. When moved to the outside of a given cell by “EQ 2” using surface FloodGate resources, other cells may receive it. In this way, a cell can signal to others that it exists and so contributes to how surrounded the receiving cell is. The receiving cell accepts SurroundedSignal with “EQ 3” and its own surface SurroundedReceptor. It is received as SurroundedMarker which in turn inhibits “GENE 1” and so counteracts the influence of the nutrient.

GB1's promotion of “GENE 3” leads to the production of DiffSignal which also combines with surface FloodGate in “EQ 4” to be transported outside the cell. Other cells receive this through their DiffReceptor surface resources in “EQ 5” as DiffMarkers. Once in a cell, “GENE 4” amplifies these DiffMarker resources which go on to contribute to the promotions of “GENE 1” and “GENE 4”.

The more a cell is signaled to differentiate, the more it is likely to grow and divide; those cells not so differentiated are essentially rudimentary stem cells. Independent of that dynamic, the more a cell is signaled that it is surrounded, the less it will grow and divide.

### G3. Example 3

### Virtual Epithelium

The third example applies principles from the previous examples to model epithelial tissue. Several approaches with varying fidelity and complexity can be taken to model more complex subjects such as epithelial tissue; however, the present example describes one solution. It will be appreciated that by practicing development principles applied in this and the previous examples, a range of such solutions can be generated.

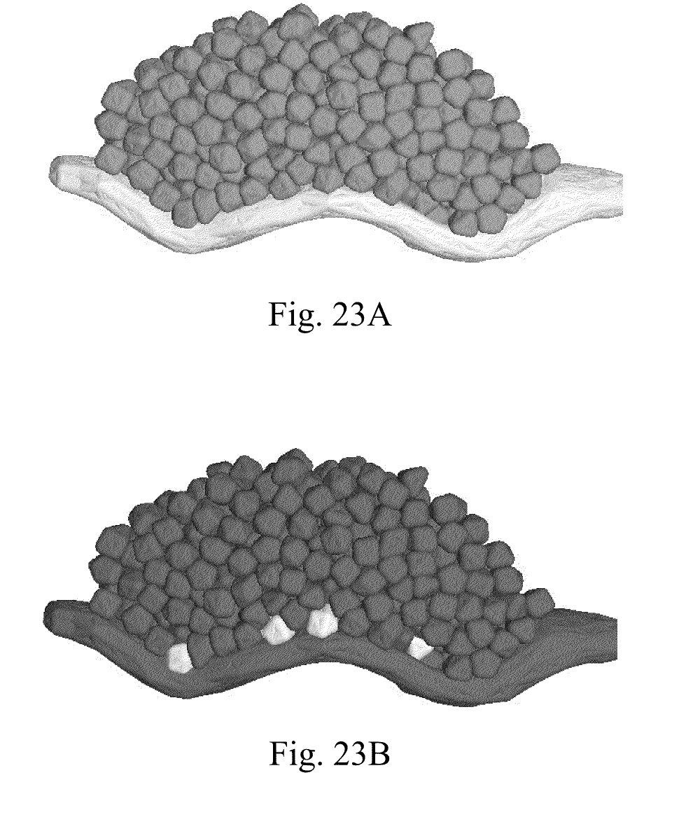

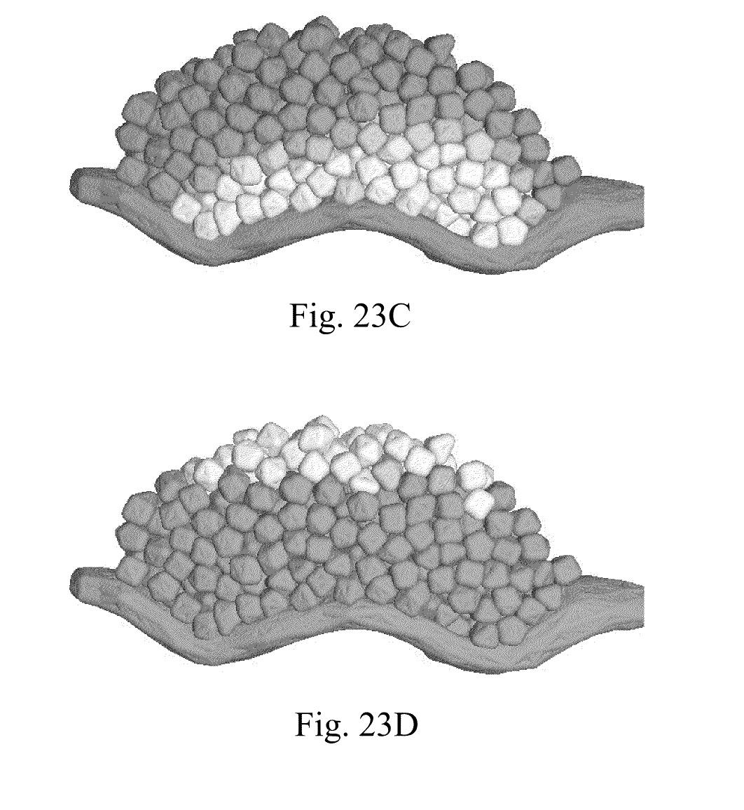

FIGS. 23A-23D are isometric views illustrating a modeled epithelial tissue, with the modeled basement membrane highlighted (23A), the modeled tissue's stem cells highlighted (23B), with the modeled cells neighboring the stem cells highlighted (23C), and with a population of modeled lipid-producing cells highlighted (23D) in accordance with an embodiment of the disclosure. This small cross-section of epithelial tissue rests on a slightly irregular basement membrane, highlighted in FIG. 23A. From the same simulation moment as FIG. 23A, the tissue's stem cells are highlighted in FIG. 23B. In FIG. 23C, again from the same simulation moment as FIGS. 23A and 23B, all cells near the stem cells are highlighted. This indicates that any highlighted stem or transit amplifying cells are influenced to suppress their stem character. From a later simulation moment, FIG. 23D highlights the virtual cells producing resources corresponding to lipids.

### G3.1 Describing the Model

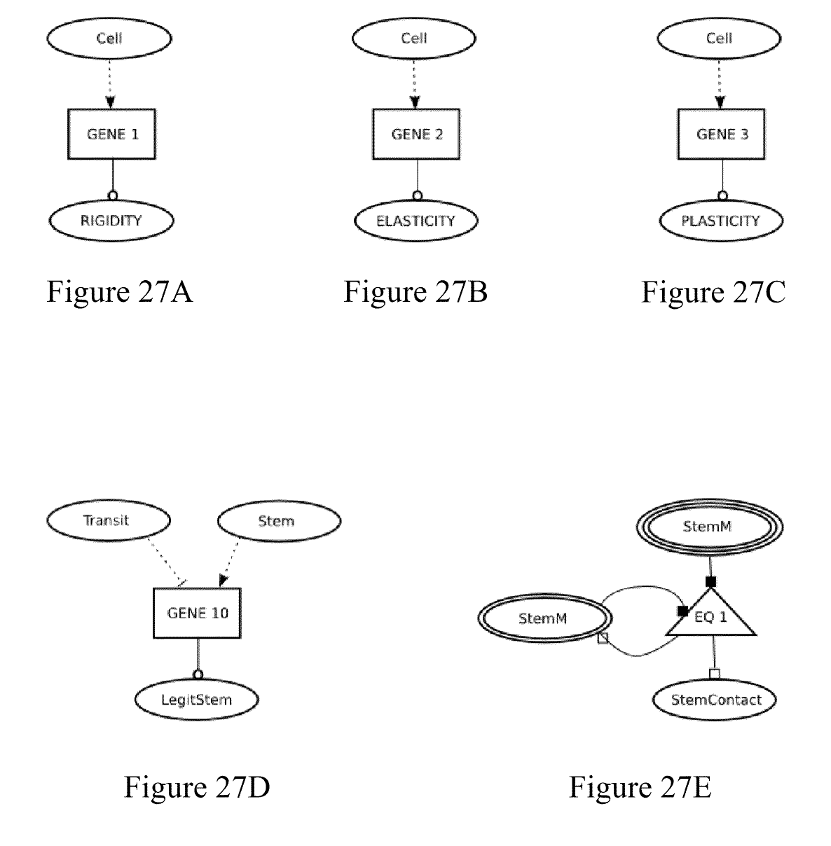

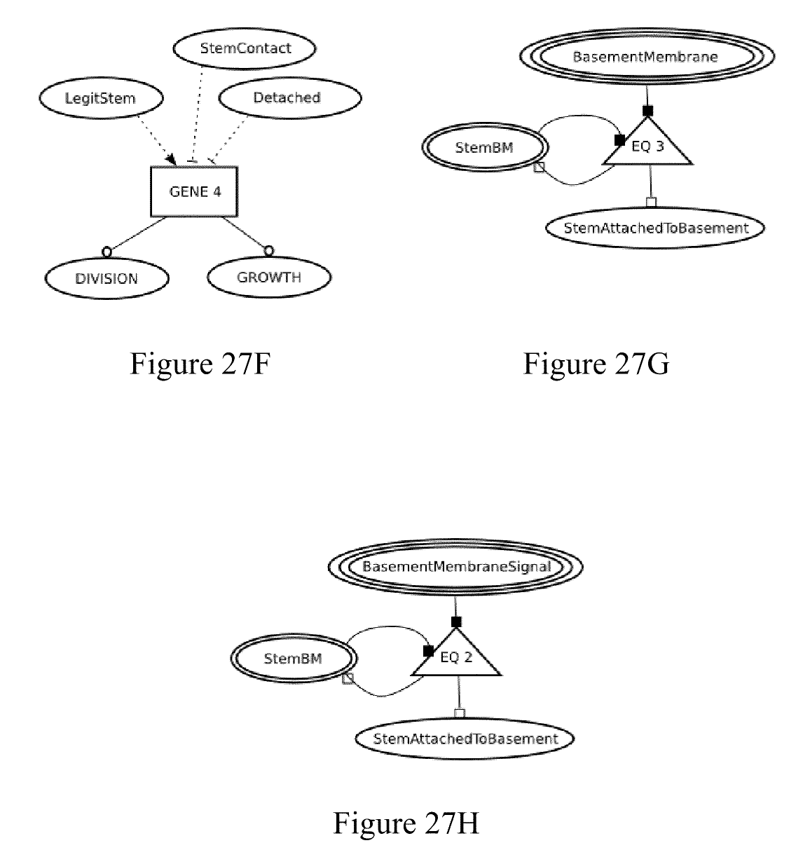

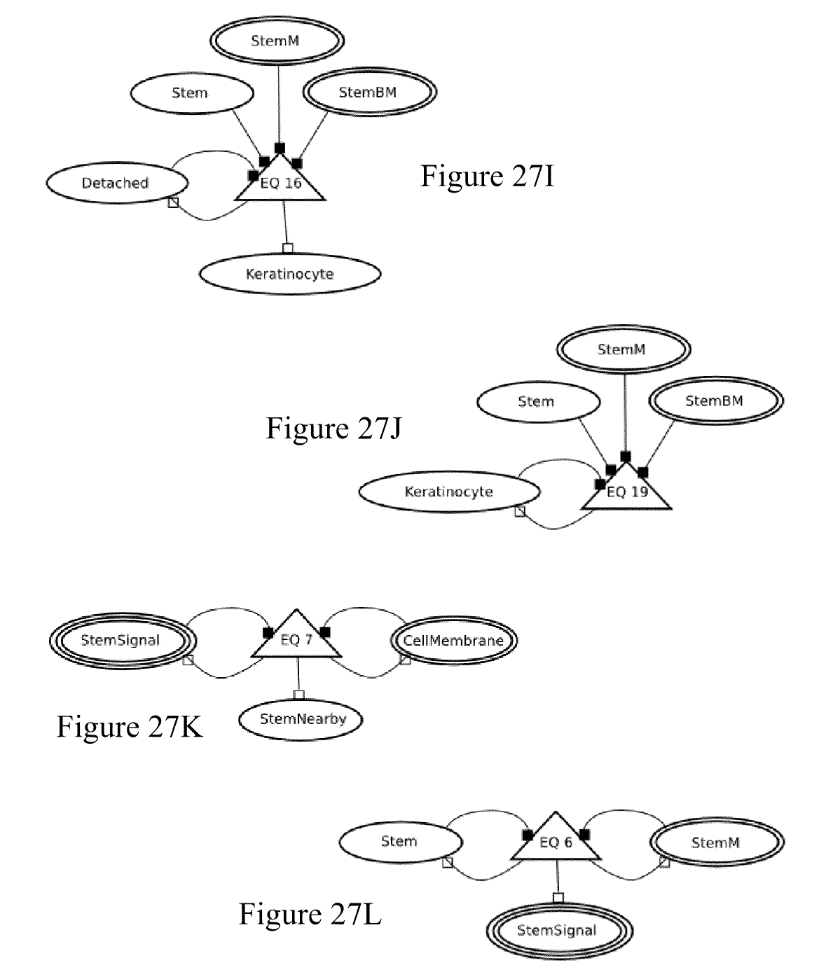

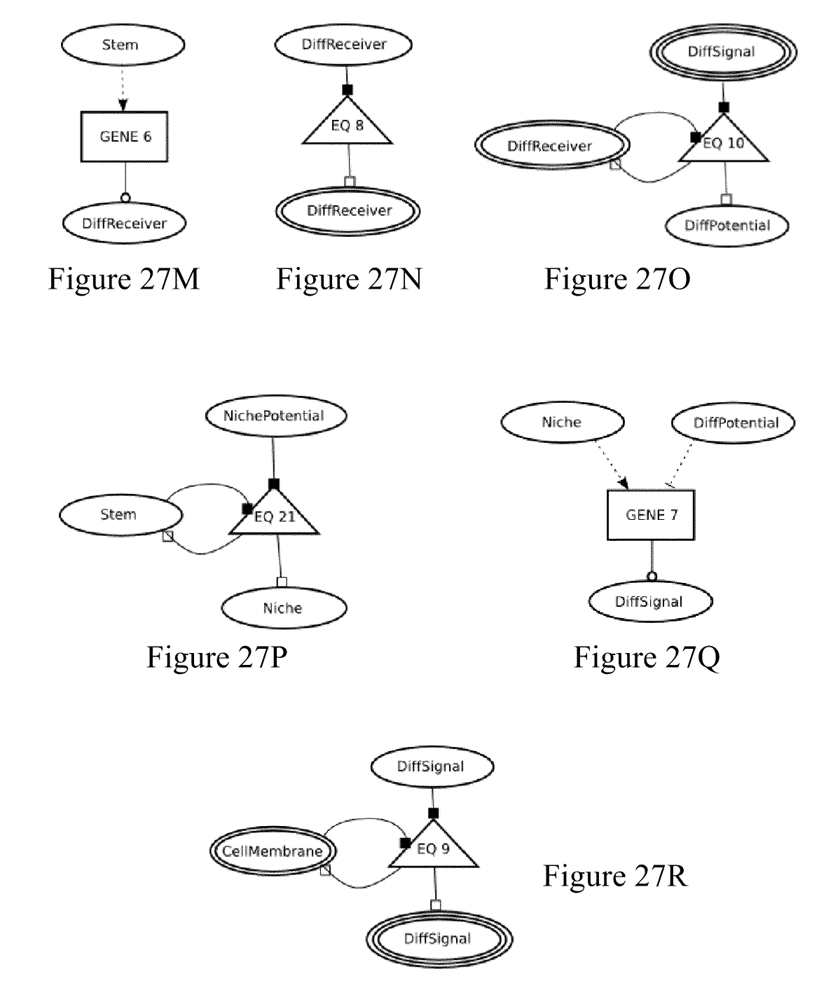

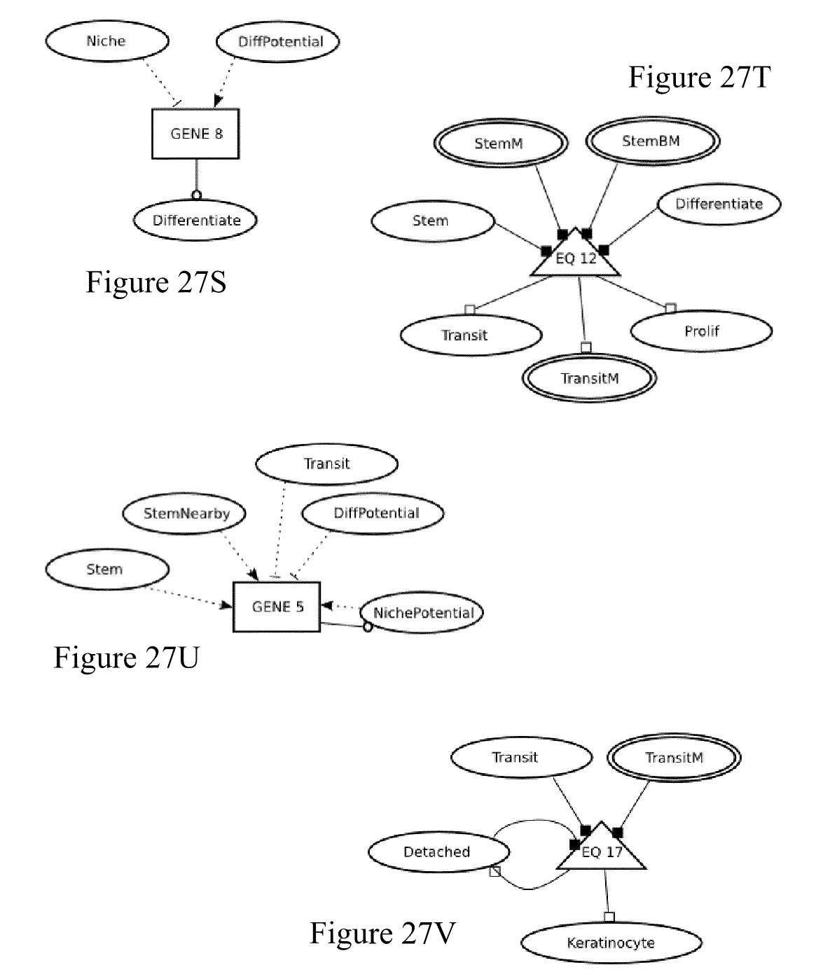

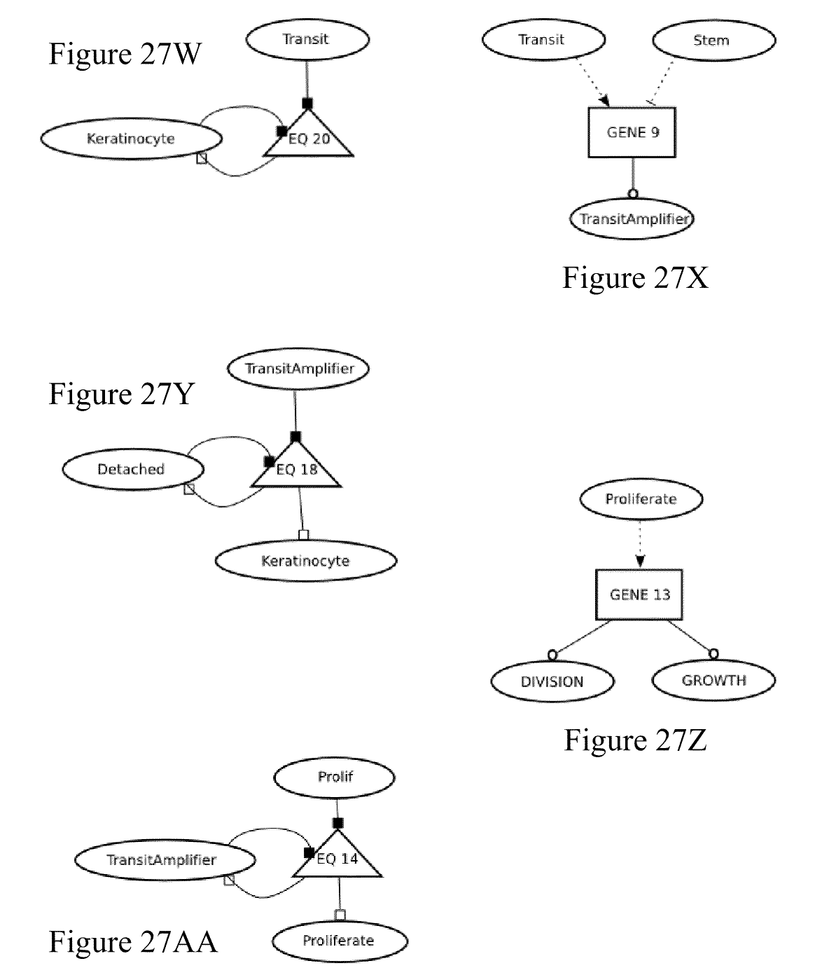

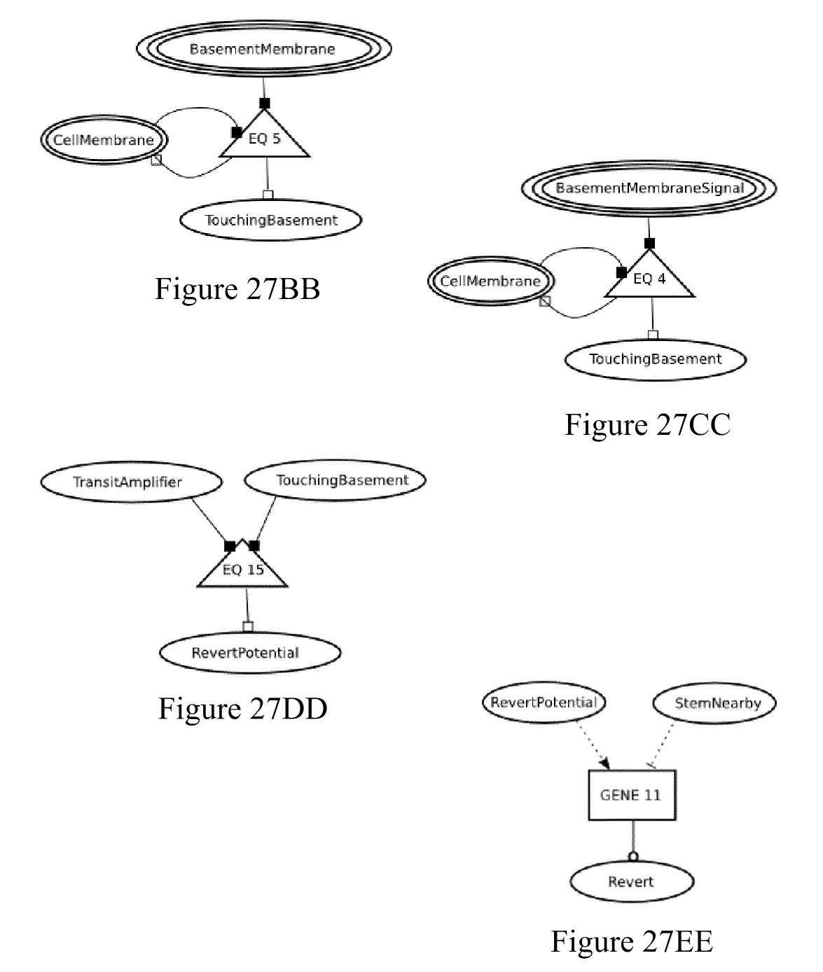

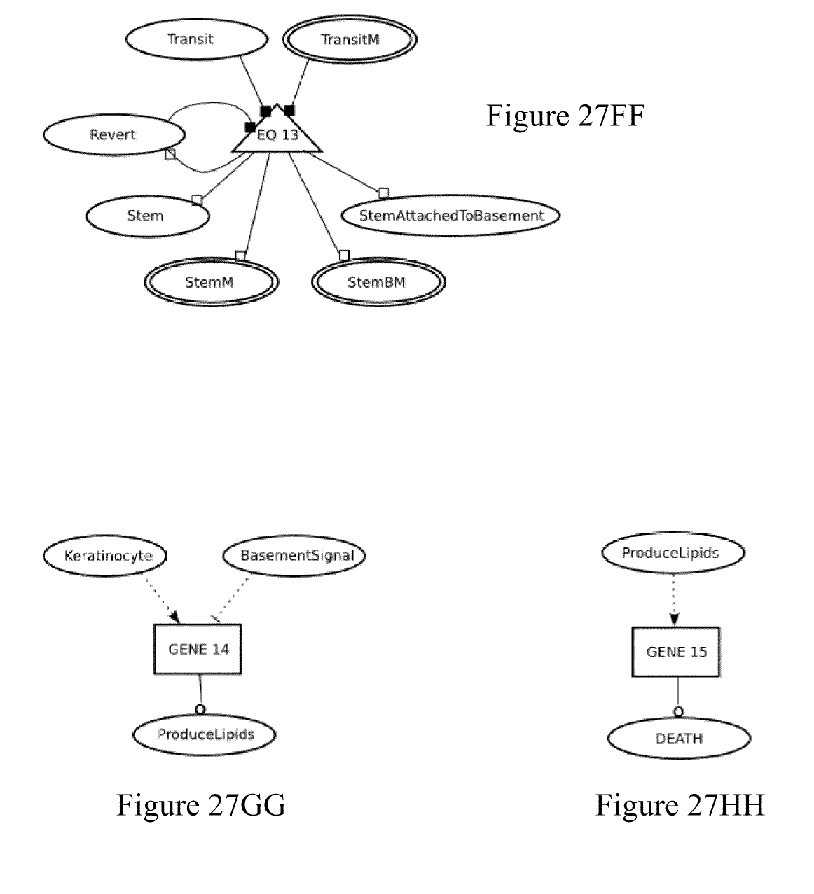

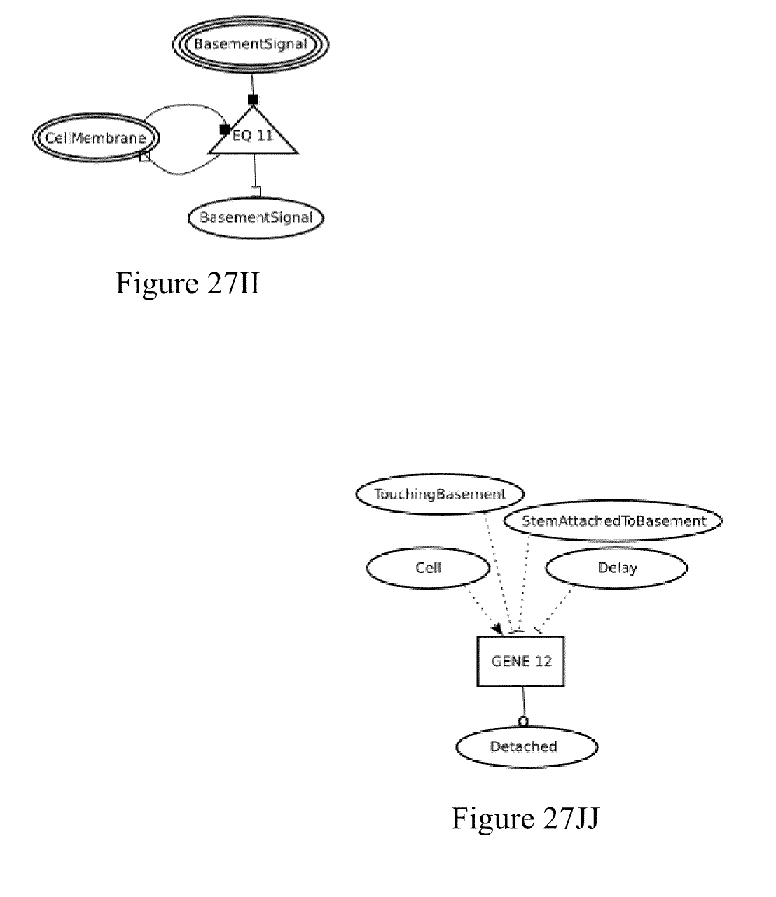

FIGS. 27A-27JJ are schematic flow diagrams illustrating resources and actions, gene units and gene unit products, and metabolic-interaction rules for modeling a multicellular epithelial tissue in accordance with the simulation of biological events described herein, and in accordance with an embodiment of the disclosure. Living epithelial tissue can be characterized by a constant generation and flow of cells from a basement membrane to its surface. Across the basement membrane, stem cells and transit amplifier cells proliferate. As they do so, they become physically pressured to detach from the membrane. Stem cells adhere most strongly to the basement membrane; as cells differentiate, their attachment to the membrane weakens. Thus, most cells that detach are transit amplifier cells. Cells that detach from the basement continue to differentiate into keratinized cells; these keratinocytes eventually produce fatty oils, called lipids.

The stem cells exist in small groups called niches. As a niche enlarges, the cells on its periphery become transit amplifying cells. Not yet committed to differentiation, these cells retain some stem cell character and so can revert to stem cells. This reversion can happen if the cells stay attached to the basement membrane and find themselves sufficiently far from already established stem cell niches. The establishment and maintenance of stem cell niches is consistent with living stem cell formation in epithelial tissue. Peripheral stem cells are not able to become transit amplifier cells unless there is a sufficiently large population of stem cells nearby. In this model, the niches arise from such stem cells. The stem cells most likely to retain their stem character are those at the center of the niche. Once the niche is reduced in size by peripheral attrition to transit amplifying cells, the central stem cells divide and the process continues.

As the population of keratinocytes increases, they are pushed away from the basement membrane. As these cells detach from the basement membrane, they no longer sense contact with the membrane and begin to produce lipids.

### G3.2 Dissecting the Problem to Identify Cell-Level Features

As in the previous examples, descriptions of cell types are listed in Table 9 below.

TABLE 9
Categorical Examples and Descriptions of Cell Type

| | |
|---|---|
| STEM: | UNDIFFERENTIATED CELL ATTACHED TO THE |
| | BASEMENT MEMBRANE. THE INITIAL CELL OF THE |
| | SIMULATION IS A STEM CELL. |
| TRANSIT | PROLIFERATING CELLS STILL ATTACHED TO THE |
| AMPLIFIER: | BASEMENT MEMBRANE BUT NOT INCORPORATED IN A |
| | STEM CELL NICHE. THESE CELLS DIFFERENTIATED |
| | FROM STEM CELLS. |
| KERATINOCYTE: | CELLS THAT WERE TRANSIT AMPLIFIER CELLS WILL |
| | DIFFERENTIATE FURTHER WHEN DETACHED FROM THE |
| | BASEMENT MEMBRANE. THESE CELLS CANNOT GROW |
| | OR DIVIDE NOR REVERT TO TRANSIT AMPLIFIER CELLS. |
| LIPID | KERATINOCYTES, ONCE DETACHED FROM THE |
| PRODUCING | BASEMENT MEMBRANE, NO LONGER SENSE CONTACT |
| | WITH THE MEMBRANE AND PRODUCE LIPIDS. |

Dead cells are simply removed from the simulation to optimize computation. These dead cells are interpreted as those sloughed off in the normal cycle of living epithelial development.

The initial cell start can start on a special construct called a Basement Membrane, described further below. In another embodiment, the basement membrane can be created through designating and placing in the virtual environment a “cell line.” The basement membrane is to be the anchor point for the virtual epithelium and corresponds to the basal lamina in vivo. Virtual stem cells are to proliferate in the simulation and produce more cells than can fit on the basement membrane. The cells that detach from the membrane undergo several stages of changes as they are pushed up by younger cells from the basement membrane.

For simplicity and to avoid having to grow a basement membrane, which would have led to growing other anatomical structures, a special construct may be supported by the ontogeny engine for specification of a basement membrane. This example <BasementMembrane> construct is treated as a large cell of numerous subspheres arranged as a sheet. It is specified with its own genome and metabolic equations and so may be considered as a special initial cell or “cell line”. In other embodiments (not shown), a user may configure the model to produce a BasementMembrane by creating a second cell type that is subordinate to a <Cells> tag (see section E3.6).

### G3.3 Writing the Configuration File

The configuration is designed starting from a simulation configuration template, with details interpreted in previous examples and in section E.

### Configuration Example:

```
<CsIndividual>
  <ResourceCatalog>
  </ResourceCatalog>
  <Simulation>
    <Physics>
      <TimePerStep>.2</TimePerStep>
      <DampingMultiplier>1</DampingMultiplier>
      <RepulsionMultiplier>2</RepulsionMultiplier>
      <NudgeMagnitude>3</NudgeMagnitude>
    </Physics>
    <Signal>
      <Local>
        <Separation>.3</Separation>
      </Local>
    </Signal>
    <ECMDefinitionRules></ECMDefinitionRules>
    <Cell>
      <Chemistry><Default/></Chemistry>
      <Promoter>
        <Smoother>
          <PromotionMidpoint>5</PromotionMidpoint>
          <Slope>10</Slope>
          <ActiveConcentration>1</ActiveConcentration>
        </Smoother>
      </Promoter>
      <MaximumSize>50</MaximumSize>
      <InitialSize>8</InitialSize>
      <MinimumSize>6</MinimumSize>
      <ECMProductionRules></ECMProductionRules>
      <InitialChemistry>
      </InitialChemistry>
      <MetabolicEquations>
      </MetabolicEquations>
    </Cell>
  </Simulation>
  <Genome>
  [
  ]
  </Genome>
</CsIndividual>
```

### G3.3.1 Establishing a Basement Membrane and Initial Environment

The special <BasementMembrane> construct described above includes subordinate <Cell> and <Genome> sections separate from those of other cells in the simulation to supply special genome and metabolic equations sufficient to keep its shape and supply it with the desired adhesive and signaling characteristics of an epithelial basement membrane. It may also support a special <Bounds> tag to specify its size and location in the environment. The <Bounds> describes two opposing “corners” of the membrane sheet to be filled with subspheres.

The following adds an inert basement membrane:

### Configuration Example:

```
<BasementMembrane>
  <Bounds>[−22, −2.5, −5][28, −1.0, 7]</Bounds>
  <Cell>
    <Chemistry><Default/></Chemistry>
    <Promoter>
      <Smooth>
        <PromotionMidpoint>6</PromotionMidpoint>
        <ActiveConcentration>1</ActiveConcentration>
      </Smooth>
    </Promoter>
    <InitialChemistry>
    </InitialChemistry>
    <MetabolicEquations>
    </MetabolicEquations>
  </Cell>
  <Genome>
  [
  ]
  </Genome>
</BasementMembrane>
```

The initial shape and physical responsiveness of the membrane is given by specifying initial values for Rigidity and Elasticity resources under <InitialChemistry> for the <BasementMembrane>:

### Configuration Example:

Rigidity 10
Elasticity 10

As Rigidity and Elasticity resources are special adhesion factors, the ontogeny engine is configured to impose a constant decay. Therefore, these adhesion resources must be replenished throughout the simulation. One technique is genetic production of Rigidity and Elasticity. A non-decaying internal resource can be configured to promote the production of these resources.

First, this internal resource is defined in the simulation's <ResourceCatalog>:

### Configuration Example:

BasementMembrane [8000, 10] 0;

The resource is then established in the <InitialChemistry> for the <BasementMembrane>:

### Configuration Example:

BasementMembrane 10

Finally, it is used to constantly promote production of Rigidity and Elasticity by the <Genome> of the <BasementMembrane>:

### Configuration Example:

[BasementMembrane 2.8][Rigidity],
[BasementMembrane 0.2] [Elasticity]

For this example, a basement membrane is useful for cell signaling so that basal cells can recognize attachment. As with all signals, this is done by moving resources into the environment with a surface resource. The following reuses the non-decaying BasementMembrane resource to supply surface resource in the <InitialChemistry> of the <BasementMembrane>. Since metabolism of a basement membrane is not the subject of the present example and has no analogy in living membranes, there is no need for a mechanism to move an internal resource to the surface. Instead, the resource can be configured to be reused.

### Configuration Example:

(BasementMembrane) 10

The above surface resource will be directly seen as an external resource by any contacting cell. To allow portions of a cell in contact to the membrane recognize contact proximity, a spontaneous, constant signal from the membrane itself is established. Given that the simulation's local signal distance is less than subsphere radii (see initial configuration template, G3.3), a cell must be in or near contact to receive this signal. The following instruction is added to the <MetabolicEquations> of the <BasementMembrane>.

### Configuration Example:

(BasementMembrane)=(BasementMembrane)+{50 BasementMembraneSignal};

<FixedSpheres> are added below the basement membrane to give it an undulated shape similar to skin epithelium:

### Configuration Example:

```
<FixedSpheres>
  [0,−5,0] 7,
  [17,−5,0] 7,
  [−17,−5,0] 7,
</FixedSpheres>
```

Large fixed spheres are added around the basement membrane to the above <FixedSpheres> as a virtual container to prevent cells from going beyond the edge of the basement membrane surface:

### Configuration Example:

[−10000,0,0] 9975,
[10000,0,0] 9975,
[0,0,−10000] 9997.5,
[0,0,10000] 9997.5,
[0, −10000, 0] 9996

To produce a gradient consistent with that of dermal tissue under an undulating basement membrane, new source points are added below the membrane. This is done by adding a gradient Shade to the simulation with gradient builders:

### Configuration Example:

| <Shade> | |
|---|---|
| <UseRadius/> | |
| <UseModifier/> | |
| [ | |
| S [6000,10] @ | 17 −6 0 10 0.8 1 10, |
| S [6000,10] @ | 0 −6 0 10 0.8 1 10, |
| S [6000,10] @ | −17 −6 0 10 0.8 1 10 |

]
</Shade>

For ease of reference later, an entry matching this new signal's resource signature is made to the simulation's <ResourceCatalog> as BasementSignal:

### Configuration Example:

BasementSignal [6000, 10];

The configuration so far produces an undulated, signaling basement membrane draped over three large spheres with large spheres on its sides to keep the cells from falling off the membrane's edge. Following is an exemplary intermediate configuration from which to begin developing epithelial form and behavior:

```
<CsIndividual>
  <ResourceCatalog>
    BasementMembrane [8000, 10] 0;
    BasementSignal [6000, 10];
  </ResourceCatalog>
  <Simulation>
    <Physics>
      <TimePerStep>.2</TimePerStep>
      <DampingMultiplier>1</DampingMultiplier>
      <RepulsionMultiplier>2</RepulsionMultiplier>
      <NudgeMagnitude>3</NudgeMagnitude>
    </Physics>
    <Signal>
      <Local>
        <Separation>.3</Separation>
      </Local>
    </Signal>
    <ECMDefinitionRules></ECMDefinitionRules>
    <BasementMembrane>
      <Bounds>[−22, −2.5, −5][28, −1.0, 7]</Bounds>
      <Cell>
        <Chemistry><Default/></Chemistry>
        <Promoter>
          <Smooth>
            <PromotionMidpoint>6</PromotionMidpoint>
            <ActiveConcentration>1</ActiveConcentration>
          </Smooth>
        </Promoter>
        <InitialChemistry>
          Rigidity 10
          Elasticity 10
          BasementMembrane 10
          (BasementMembrane) 10
        </InitialChemistry>
        <MetabolicEquations>
          (BasementMembrane) =
            (BasementMembrane) + {50 BasementMembraneSignal };
        </MetabolicEquations>
      </Cell>
      <Genome>
        [
          [ BasementMembrane 2.8 ][ Rigidity ],
              [ BasementMembrane .2 ] [ Elasticity ]
        ]
      </Genome>
    </BasementMembrane>
    <Cell>
      <Chemistry><Default/></Chemistry>
      <Promoter>
        <Smoother>
          <PromotionMidpoint>5</PromotionMidpoint>
          <Slope>10</Slope>
          <ActiveConcentration>1</ActiveConcentration>
        </Smoother>
      </Promoter>
      <MaximumSize>50</MaximumSize>
      <InitialSize>8</InitialSize>
      <MinimumSize>6</MinimumSize>
      <ECMProductionRules></ECMProductionRules>
      <InitialChemistry>
      </InitialChemistry>
      <MetabolicEquations>
      </MetabolicEquations>
    </Cell>
    <FixedSpheres>
      [0,−5,0] 7,
      [17,−5,0] 7,
      [−17,−5,0] 7,
      [−10000,0,0] 9975,
      [10000,0,0] 9975,
      [0,0,−10000] 9997.5,
      [0,0,10000] 9997.5,
      [0, −10000, 0] 9996
    </FixedSpheres>
  </Simulation>
  <Genome>
    [
    ]
  </Genome>
  <Shade>
    <UseRadius/>
    <UseModifier/>
    [
```

| | |
|---|---|
| S [6000,10] @ | 17 −6 0 10 0.8 1 10, |
| S [6000,10] @ | 0 −6 0 10 0.8 1 10, |
| S [6000,10] @ | −17 −6 0 10 0.8 1 10 |

```
    ]
  </Shade>
</CsIndividual>
```

### G3.3.2 Initial Epithelial Stem Cell

For a cell to be considered a stem cell, a cell will be required to have sufficient Stem resource. This must be added to the <InitialChemistry> of the starting cell in a sufficient amount to promote gene units to be added later in this example:

### Configuration Example:

Stem 50

It then must also be added to the <ResourceCatalog> to not decay:

### Configuration Example:

Stem [100, 10] 0;

A division rule (see Section E.3.6.7.8.) is added under <Cell> to assure that stem cells divide along the basement membrane; that is, perpendicular to the line between the centers of the contacted membrane subsphere and the contacting cell. Because it is a single rule, the coefficient is arbitrary. To avoid conflicts with tracking the cell state, a new surface resource, StemBM, is introduced solely for support of this division:

### Configuration Example:

<DivisionRules>
.1 Stem perpendicular (StemBM);
</DivisionRules>

The new resource StemBM is added to the <ResourceCatalog> and set to not decay:

### Configuration Example:

StemBM [180, 10] 0;

Because the initial cell should have this property, StemBM is added to <InitialChemistry> as a surface resource:

### Configuration Example:

(StemBM) 50

Since an undifferentiated cell must be attached to the basement membrane for it to be considered a stem cell, adhesion rules must be established, under <Simulation>, to attach the initial cell to the basement membrane. Alternatively, the adhesion could equivalently involve Stem resources moved to the surface instead of the special surface StemBM.

### Configuration Example:

<AdhesionRules>
( BasementMembrane ) : ( StemBM );
</AdhesionRules>

### G3.3.3 Production of Stem Cells and Terminally Differentiated Keratinocytes

To promote regular cell shaping, three gene units are added to the <Genome>, depicted in FIGS. 27A, 27B, and 27C. Since the Stem and StemBM resources will not exist in differentiated cells, a new resource Cell is made present in all cells for shaping.

### Configuration Example:

[Cell 0.4][Rigidity],
[Cell 0.2][Elasticity],
[Cell 0.6][Plasticity],

The Cell resource is now added to the <ResourceCatalog> to not decay so as to be perpetuated in all cells:

### Configuration Example:

Cell [400, 10] 0;

For this, the <InitialChemistry> must include Cell in the initial cell:

### Configuration Example:

Cell 10

Stem cells have the ability to grow and divide and so a gene unit is added to support stem cell growth and division. However, as stem cells differentiate, the Stem resource will be lost. Therefore, a resource LegitStem is introduced to control growth and division of stem cells:

### Configuration Example:

[LegitStem 1.] [Division, Growth],

LegitStem's production then is promoted by the presence of Stem and inhibited by transition away from a stem cell. The following gene unit promotes the production of LegitStem resource when Stem resource is present and inhibits it in the presence of a Transit resource, FIG. 27D. The production of the Transit resources is discussed later in this example.

### Configuration Example:

[Stem 2, Transit −4] [LegitStem],

In this example model, stem cells can not divide if surrounded by other stem cells. Therefore, the gene unit added earlier can be amended to inhibit growth and division upon contact with other stem cells. For this, the resource StemContact is introduced. The coefficient for StemContact in this gene unit was determined from iterative experimentation during this configuration's development.

### Configuration Example:

[LegitStem 1, StemContact −0.87] [Division, Growth],

Contact with another stem cell can be determined through detection of a surface resource that exists on both the subject and contacting stem cells. For this, a metabolic equation using a dedicated resource StemM is added to produce internal StemContact resource, FIG. 27E. Again, iterative experimentation establishes its coefficient.

### Configuration Example:

{StemM}+(StemM)=(StemM)+0.2 StemContact;

Since StemM is to be present in all stem cells, it is added as a non-decaying resource to the <ResourceCatalog>:

### Configuration Example:

StemM [150, 10] 0;

The initial cell is also imbued with StemM as a surface resource, under <InitialChemistry>:

### Configuration Example:

(StemM) 50

An epithelial stem cell can not grow and divide if it is detached from the basement membrane. The gene unit promoting growth and division is amended once again to be inhibited if the cell has detached, recognized through a Detached resource. The gene unit controlling growth and division is now complete with three conditions, FIG. 27F:

### Configuration Example:

[LegitStem 1, StemContact −0.87, Detached −2] [Division, Growth],

The production of Detached is dependent on attachment to the basement membrane. As long as a cell is attached, the resource should not be produced. When a cell gets pushed off the basement membrane, it produces Detached resource.

### Configuration Example:

[StemAttachedToBasement −3.2] [Detached],

Without promotion, Detached will never be produced. The gene unit can be amended with the common Cell resource to always produce Detached in the absence of attachment to be basement membrane. Later in this example description other amendments to this gene unit are discussed.

### Configuration Example:

[Cell 1.5, StemAttachedToBasement −3.2] [Detached],

Production of StemAttachedToBasement is produced from contact of a stem cell to the basement membrane. The metabolic equation below establishes a contact signal between the membrane and the cell, FIG. 27G:

### Configuration Example:

{BasementMembrane}+(StemBM)=(StemBM)+StemAttachedToBasement;

If a portion of the cell (i.e., one or more subspheres) is not in contact with the membrane, then its reception of signal is dramatically reduced compared to a cell in more complete contact with the membrane. The metabolic equation below moderates this by relying on a signal direct from the membrane to even out the production when portions of a cell are very near to the membrane, FIG. 27H:

### Configuration Example:

{BasementMembraneSignal}+(StemBM)=(StemBM)+StemAttachedToBasement;

As stem cells divide and fill the basement membrane, daughter cells are forced by physics to detach from the membrane and so begin to differentiate permanently into keratinocytes. From the earlier gene unit producing Detached, such cells produce Detached resource and so promote stem cells to transition. This is implemented with a metabolic equation, FIG. 27I:

### Configuration Example:

Stem+(StemBM)+(StemM)+Detached=Detached+5 Keratinocyte;

Since the keratinocytes are terminally differentiated, the internal resource should not decay; the Keratinocyte resource is added under the <ResourceCatalog>:

### Configuration Example:

Keratinocyte [2000, 10] 0;

Further, as the cells make this transition, they lose their stem cell characteristics. The following metabolic equation consumes the stem cell resources to implement this loss, FIG. 27J:

### Configuration Example:

Keratinocyte+Stem+(StemBM)+(StemM)=Keratinocyte;

### G3.3.4 Stem Niches and Transit Amplifier Cells

To this point, the model produces only stem cells and keratinocytes. The production of the keratinocytes is limited by the production of the stem cells to produce detached cells. This approach is insufficient to generate the volume of cells needed for model fidelity and does not recognize how living epithelial tissue leverages stem cell production to produce many more cells. Therefore, the mechanisms associated with stem cell niches and transit amplifying cells are added to the model configuration.

As described previously in this example and in the second example under G2, stem niches are isolated clusters of stem cells and non-stem cells. Potential for stem niches arise and are reinforced as stem cells acquire and keep stem cell neighbors through the following gene unit:

### Configuration Example:

[Stem 0.7, StemNearby 0.4, NichePotential 0.25] [NichePotential],

The internal resource StemNearby is the product of a signal from other stem cells. A portion of StemSignal is passed along by a receiving cell to adjoining cells and so is dampened as it travels. A general surface resource, CellMembrane, acts as a receiver for the StemSignal to produce the internal StemNearby resource. This metabolic equation is depicted in FIG. 27K:

### Configuration Example:

{StemSignal}+(CellMembrane)=(CellMembrane)+0.7 StemNearby+{0.5 StemSignal};

An adjustment to the decay of StemNearby is suggested. It is specified in the <ResourceCatalog>.

### Configuration Example:

StemNearby [2600, 10] 0.5;

As is typical in this example for transport resources, CellMembrane is marked as nondecaying in the <ResourceCatalog>:

### Configuration Example:

CellMembrane [300, 10] 0;

Likewise, CellMembrane is added as a surface resource to the <InitialChemistry>:

### Configuration Example:

(CellMembrane) 50

For stem cells to broadcast their proximity, the following metabolic equation, FIG. 27L, causes stem cells to externally produce StemSignal resource:

### Configuration Example:

Stem+(StemM)=Stem+(StemM)+{StemSignal};

Stem cells in this example use a similar approach as the previous examples to promote differentiation of other stem cells based on signal competition, and so further separate stem niches. As long as a cell remains a stem cell it produces differentiation receiver resources via the following gene unit, FIG. 27M:

### Configuration Example:

[Stem 2] [DiffReceiver],

A metabolic equation moves the receiver resource to the cell surface, FIG. 27N:

### Configuration Example:

DiffReceiver=(DiffReceiver);

Signals received from other cells increase the potential for cell differentiation through a metabolic equation, FIG. 27O:

### Configuration Example:

{DiffSignal}+(DiffReceiver)=(DiffReceiver)+2 DiffPotential;

As a cell maintains its stem cell state and gains NichePotential, it gains internal Niche resource through a metabolic equation, FIG. 27P.

### Configuration Example:

NichePotential+Stem=Stem+Niche;

As a cell maintains its membership in a stem niche and resists reception of DiffSignal from other cells, it produces more DiffSignal through the following gene unit, FIG. 27Q, to signal neighbor cells to differentiate.

### Configuration Example:

[Niche 1, DiffPotential −2] [DiffSignal]

Produced DiffSignal is exported by metabolic equation, FIG. 27R, as a signal through the cell membrane's transport resource, CellMembrane:

### Configuration Example:

DiffSignal+(CellMembrane)=(CellMembrane)+{DiffSignal};

As a cell loses membership in a stem niche, accepts more DiffSignal and so gains DiffPotential, it produces more internal Differentiate resource through the following gene unit, FIG. 27S:

### Configuration Example:

[DiffPotential 4, Niche −6] [Differentiate]

Increasing DiffPotential should also inhibit a cell's potential to stay with a stem niche. This is done by amending the gene unit for NichePotential added earlier in this section:

### Configuration Example:

[Stem 0.7, StemNearby 0.4, DiffPotential −3, NichePotential 0.25] [NichePotential],

Transit amplifying cells are proliferating cells still attached to the basement membrane but not part of a stem niche. The transition from a stem cell to a transit amplifying cell is not immediate. Before a cell reaches the transit amplifying state and begin proliferating as in FIG. 22, any internal resources from its stem cell state must be disposed and so a mechanism is required by which the cell progressively gains the potential to proliferate while consuming any remaining resources related to its prior stem cell state.

Transit resource represents a cell's state of transition from a stem cell to a transit amplifying state. Transit resource is configured to not decay with an entry in the <ResourceCatalog>.

### Configuration Example:

Transit [1400, 10] 0;

The following metabolic equation, FIG. 27T, converts stem cell resources to produce transit resources. The internal Stem resource, its associated surface StemM and adhesive surface StemBM resources are consumed with Differentiate to produce internal Transit resources. TransitM surface resources, with a coefficient of 0.5, replace StemBM to maintain a weaker adhesion to the membrane. Prolif, discussed later, is also produced and accumulated to support cell proliferation once the transitioning cell becomes a transit amplifier.

### Configuration Example:

Stem+(StemM)+(StemBM)+Differentiate=Transit+(0.5 TransitM)+0.3 Prolif;

A new <AdhesionRule>, under <Simulation>, establishes TransitM as adhering to the basement membrane:

### Configuration Example:

(BasementMembrane):(TransitM);

Cells in transition should not continue or establish membership in a stem niche and so the gene unit previously added is amended to its final configuration, FIG. 27U:

### Configuration Example:

[Stem 0.7, Transit −3, StemNearby 0.4, DiffPotential −3, NichePotential 0.25] [NichePotential],

Cells that are in the transition process are still subject to differentiation should they detach from the basement membrane. The following equation, FIG. 27V, supports that transition, similar to the equation of FIG. 27I in Section G3.3.3:

### Configuration Example:

Transit+(0.5 TransitM)+Detached=Detached+5 Keratinocyte;

The cell should be both in transition and a keratinocyte and so will not tolerate the presence of both Transit and Keratinocyte; differentiating cells consume away the Transit resource, FIG. 27W:

### Configuration Example:

Keratinocyte+Transit=Keratinocyte;

Once a cell has sufficiently transitioned from a stem cell, it has reached a transit amplifying state exhibiting production of TransitAmplifier resource, FIG. 27X:

### Configuration Example:

[Transit 2, Stem −4] [TransitAmplifier]

Like other cells (see FIG. 27I and FIG. 27V), transit amplifying cells differentiate into keratinocytes upon detachment, FIG. 27Y:

### Configuration Example:

TransitAmplifier+Detached=Detached+5 Keratinocyte;

Upon reaching a transit amplifier state, a cell begins to proliferate. With sufficient Proliferate resource, the cell rapidly grows and divides, FIG. 27Z. The growth and division continues until the decay of the Proliferate resource (e.g., three or four rounds of division).

### Configuration Example:

[Proliferate 2] [Division, Growth]

While in transition, the cell produced Prolif resource to prepare for this prolific state (see FIG. 27T). The <ResourceCatalog> includes an entry to prevent decay of the Prolif resource:

### Configuration Example:

Prolif [1450, 10] 0;

Once a TransitAmplifier, all of the previously produced Prolif resource can become Proliferate resource with the following equation, FIG. 27AA:

### Configuration Example:

TransitAmplifier+Prolif=TransitAmplifier+Proliferate;

This example began with a single stem cell on the basement membrane. With the pathways described thus far, daughter cells from the initial cell either continue as stem cells in the same initial niche or differentiate to transit amplifying cells or keratinocytes. Therefore, only a single stem cell niche would form for the whole epithelium, yet the model should have some niches at intervals along the membrane. These niches form from transit amplifying cells that revert to stem cells when they are sufficiently far from other stem cells and have not yet detached from the basement membrane.

So far in the configuration file, only the StemAttachedToBasement resource supports internal recognition of attachment and is only produced will the cell is a stem cell. One solution is to allow all cells to recognize contact with the basement membrane. Similar to those of FIG. 27G and FIG. 27H, these metabolic equations, FIG. 27BB and FIG. 27CC, allow all cells to produce TouchingBasement when in contact with the basement membrane:

### Configuration Example:

{BasementMembrane}+(CellMembrane)=(CellMembrane)+TouchingBasement; {BasementMembraneSignal}+(CellMembrane)=(CellMembrane)+TouchingBasement;

Just as with StemAttachedToBasement resource, the production of Detached should be inhibited by TouchingBasement. The gene unit controlling production of Detached, added in Section G3.3.3, is amended:

### Configuration Example:

[Cell 1.5, StemAttachedToBasement −3.2, TouchingBasement −3.2] [Detached],

TouchingBasement is given a high (0.5) decay rate in the <ResourceCatalog>, so that it only exists in the cell while in contact:

### Configuration Example:

TouchingBasement [2900, 10] 0.5

While a transit amplifier cell is still touching the basement membrane, it gains some potential to revert to stem cells, FIG. 27DD:

### Configuration Example:

TransitAmplifier+TouchingBasement=10 RevertPotential;

If a cell has sufficient RevertPotential and is far enough away from another stem cell, the following gene unit will cause the cell to begin reversion, FIG. 27EE:

### Configuration Example:

[RevertPotential 2, StemNearby −4] [Revert]

The reversion process converts a cell's transition resources (Transit and TransitM) to their stem cell counterparts (Stem, StemM, and StemBM) while maintaining Revert resource, FIG. 27FF:

### Configuration Example:

Revert+Transit+(0.5 TransitM)=Stem+(StemM)+(StemBM)+Revert+10 StemAttachedToBasement;

The example configuration now supports stem cell niches and transit amplifying cells. Further, while cells are in transition but still attached, they can establish new stem cell niches if sufficiently distant from other stem cells by reverting.

### G3.3.5 Lipid Production and Cell Death

As differentiated cells rise to the surface of the epithelia, the model requires that they begin to produce lipids, eventually die, and slough off.

When the basement membrane was defined in section G3.3.1, gradient signals were added as a <Shade> to represent a general signal from the dermis layer. In the model, this signal can be used by cells to recognize their contact with the basement membrane, and so begin to produce lipids when no longer in contact.

As keratinocytes are pushed further away from the basement membrane they begin to produce lipids, FIG. 27GG, and eventually die to be sloughed off, FIG. 27HH:

### Configuration Example:

[Keratinocyte 3, BasementSignal −3] [ProduceLipids], [ProduceLipids 0.3] [Death]

The cell's reception of the basement signal determines the range of lipid production. This reception can be attenuated as desired by either adjusting the signal gradients under <Shade> or by adjusting the coefficient of the signal received in the cell. The equation below uses the latter technique, FIG. 27II:

### Configuration Example:

{BasementSignal}+(CellMembrane)=(CellMembrane)+0.9 BasementSignal;

### G3.3.6 Completed Example

In accordance with one embodiment, the configuration so far works but the initial cells differentiate too quickly to allow a critical mass of stem cells to form. This can be attenuated by adding a new Delay resource to the structural region of the gene unit that produces Detached resource upon cell detachment. FIG. 27JJ depicts the final configuration for this gene unit.

### Configuration Example:

[Cell 1.5, StemAttachedToBasement −3.2, TouchingBasement −3.2, Delay −5] [Detached],

This new Delay resource must then be added to the <InitialChemistry>:

### Configuration Example:

Delay 100

With Delay not included in the <ResourceCatalog>, the default decay rate of 10% will be applied to act as a countdown in the initial cells before they begin to detach. This can be further attenuated by either changing the initial value of the resource under <InitialChemistry> or adding it under the <ResourceCatalog> with a different decay rate.

In the example discussed above, a resulting configuration is shown below:

<CsIndividual>
<ResourceCatalog>

| | |
|---|---|
| Stem | [100, 10] 0; |
| StemM | [150, 10] 0; |
| StemBM | [180, 10] 0; |

CellMembrane [300, 10] 0;

| | |
|---|---|
| Cell | [400, 10] 0; |
| Transit | [1400, 10] 0; |
| Prolif | [1450, 10] 0; |

```
    Keratinocyte [2000, 10] 0;
    StemNearby [2600, 10] 0.5;
    TouchingBasement [2900, 10] 0.5;
    BasementMembrane [8000, 10] 0;
    BasementSignal [6000, 10];
  </ResourceCatalog>
  <Simulation>
    <Physics>
      <TimePerStep>.2</TimePerStep>
      <DampingMultiplier>1</DampingMultiplier>
      <RepulsionMultiplier>2</RepulsionMultiplier>
      <NudgeMagnitude>3</NudgeMagnitude>
    </Physics>
    <Signal>
      <Local>
        <Separation>.3</Separation>
      </Local>
    </Signal>
    <ECMDefinitionRules></ECMDefinitionRules>
    <BasementMembrane>
      <Bounds>[−22, −2.5, −5][28, −1.0, 7]</Bounds>
      <Cell>
        <Chemistry><Default/></Chemistry>
        <Promoter>
          <Smooth>
            <PromotionMidpoint>6</PromotionMidpoint>
            <ActiveConcentration>1</ActiveConcentration>
          </Smooth>
        </Promoter>
        <InitialChemistry>
          Rigidity 10
          Elasticity 10
          BasementMembrane 10
          (BasementMembrane) 10
        </InitialChemistry>
        <MetabolicEquations>
          (BasementMembrane) =
            (BasementMembrane) + { 50 BasementMembraneSignal };
        </MetabolicEquations>
      </Cell>
      <Genome>
      [
        [ BasementMembrane 2.8 ][ Rigidity ],
        [ BasementMembrane .2 ][ Elasticity ]
      ]
      </Genome>
    </BasementMembrane>
    <Cell>
      <Chemistry><Default/></Chemistry>
      <Promoter>
        <Smoother>
          <PromotionMidpoint>5</PromotionMidpoint>
          <Slope>10</Slope>
          <ActiveConcentration>1</ActiveConcentration>
        </Smoother>
      </Promoter>
      <MaximumSize>50</MaximumSize>
      <InitialSize>8</InitialSize>
      <MinimumSize>6</MinimumSize>
      <ECMProductionRules></ECMProductionRules>
      <InitialChemistry>
        Delay 100
        Cell 10
        (CellMembrane) 50
        Stem 50
        (StemM) 50
        (StemBM) 50
      </InitialChemistry>
      <MetabolicEquations>
        { StemM } + (StemM) = (StemM) + .2 StemContact;
        { BasementMembraneSignal } + (StemBM) =
          (StemBM) + StemAttachedToBasement;
        { BasementMembrane } + (StemBM) =
          (StemBM) + StemAttachedToBasement;
        { BasementMembraneSignal } + (CellMembrane) =
          (CellMembrane) + TouchingBasement;
        { BasementMembrane } + (CellMembrane) =
          (CellMembrane) + TouchingBasement;
        Stem + (StemM) = Stem + (StemM) + { StemSignal };
        { StemSignal } + (CellMembrane) =
          (CellMembrane) + .7 StemNearby + { .5 StemSignal };
        DiffReceiver = (DiffReceiver);
        DiffSignal + (CellMembrane) = (CellMembrane) +
        { DiffSignal };
        { DiffSignal } + (DiffReceiver) =
          (DiffReceiver) + 2 DiffPotential;
        {BasementSignal} + (CellMembrane) =
          (CellMembrane) + .9 BasementSignal;
        Stem + (StemM) + (StemBM) + Differentiate =
          Transit + (.5 TransitM) + .3 Prolif;
        Revert + Transit + (.5 TransitM) =
          Stem + (StemM) + (StemBM) + Revert +
          10 StemAttachedToBasement;
        TransitAmplifier + Prolif = TransitAmplifier + Proliferate;
        TransitAmplifier + TouchingBasement = 10 RevertPotential;
        Stem + (StemBM) + (StemM) + Detached = Detached +
        5 Keratinocyte;
        Transit + (.5 TransitM) + Detached = Detached +
        5 Keratinocyte;
        TransitAmplifier + Detached = Detached + 5 Keratinocyte;
        Keratinocyte + Stem + (StemBM) + (StemM) = Keratinocyte;
        Keratinocyte + Transit = Keratinocyte;
        NichePotential + Stem = Stem + Niche;
      </MetabolicEquations>
      <DivisionRules>
        .1 Stem perpendicular (StemBM);
      </DivisionRules>
    </Cell>
    <AdhesionRules>
      ( BasementMembrane ) : ( StemBM );
      ( BasementMembrane ) : ( TransitM );
    </AdhesionRules>
    <FixedSpheres>
      [0,−5,0] 7,
      [17,−5,0] 7,
      [−17,−5,0] 7,
      [−10000,0,0] 9975,
      [10000,0,0] 9975,
      [0,0,−10000] 9997.5,
      [0,0,10000] 9997.5,
      [0, −10000, 0] 9996
    </FixedSpheres>
  </Simulation>
  <Genome>
  [
    [ Cell .4 ][ Rigidity ],
    [ Cell .2 ][ Elasticity ],
    [ Cell .6 ][ Plasticity ],
    [ LegitStem 1, StemContact −0.87, Detached −2 ]
    [ Division, Growth ],
    [ Stem 0.7,
      Transit −3,
      StemNearby 0.4,
      DiffPotential −3,
      NichePotential .25 ]
      [ NichePotential ],
    [ Stem 2 ] [ DiffReceiver ],
    [ Niche 1, DiffPotential −2 ] [ DiffSignal ],
    [ DiffPotential 4, Niche −6] [ Differentiate ],
    [ Transit 2, Stem −4 ] [ TransitAmplifier ],
    [ Stem 2, Transit −4 ] [ LegitStem ],
    [ RevertPotential 2, StemNearby −4 ] [ Revert ],
    [ Cell 1.5,
      StemAttachedToBasement −3.2,
      TouchingBasement −3.2,
      Delay −5 ]
      [ Detached ],
    [ Proliferate 2 ] [ Division, Growth ],
    [ Keratinocyte 3, BasementSignal −3 ] [ ProduceLipids ],
    [ ProduceLipids .3 ] [ Death ]
  ]
  </Genome>
  <Shade>
    <UseRadius/>
    <UseModifier/>
    [
```

| | |
|---|---|
| S [6000,10] @ | 17 −6 0 10 0.8 1 10, |
| S [6000,10] @ | 0 −6 0 10 0.8 1 10, |
| S [6000,10] @ | −17 −6 0 10 0.8 1 10 |

```
    ]
  </Shade>
</CsIndividual>
```

### H. Additional Examples of Models that Validate System Capabilities

One goal of the simulation system described herein is to develop in silico modeling techniques that can make an accurate prediction about the behavior of gene regulatory networks (GRNs) in vivo. The following examples described below are meant to more fully illustrate the capabilities of the various embodiments of the simulation system described herein and are not to be interpreted as limiting the scope of any claimed embodiment. Further, the following examples validate the ability of the simulation system to predict various in vivo behaviors based on matching known experimental or clinical data.

### H1. Example 1

### Cellular Response to an External Chemical Stimulus

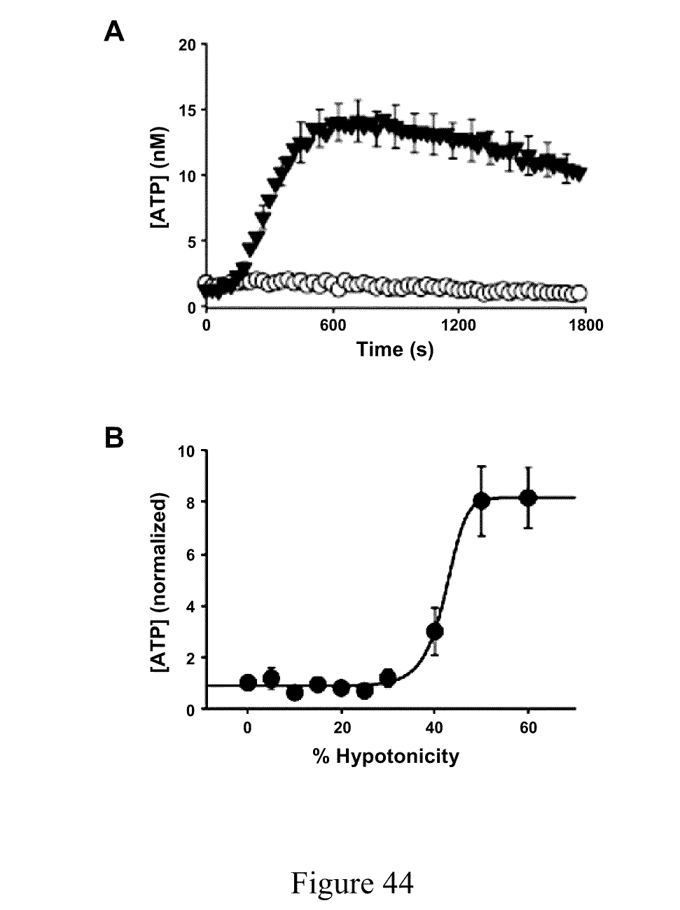

To validate system capabilities for accurately modeling cellular response to external chemical stimulus in ways familiar and useful to wet lab researchers, a paper was identified (Reigada and Mitchell, 2005) that describes ATP release in response to a hypotonic shock (i.e., sudden dilution of the extracellular medium), and was chosen as a target for creation of an in silico model that responds to hypotonic shock in the same manner as the in vivo data of the Reigada and Mitchell paper as shown in FIGS. 44A and 44B.

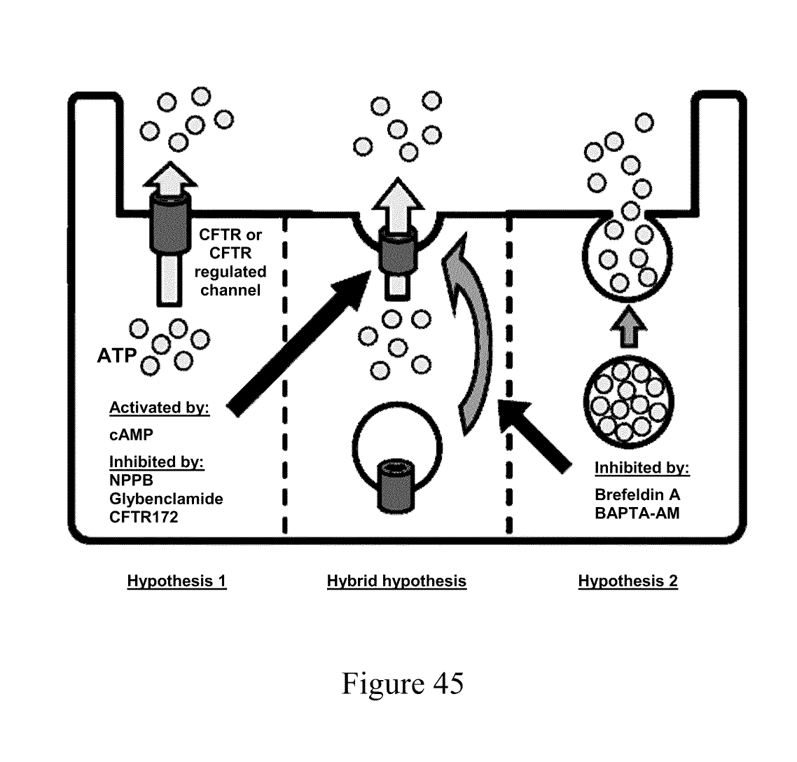

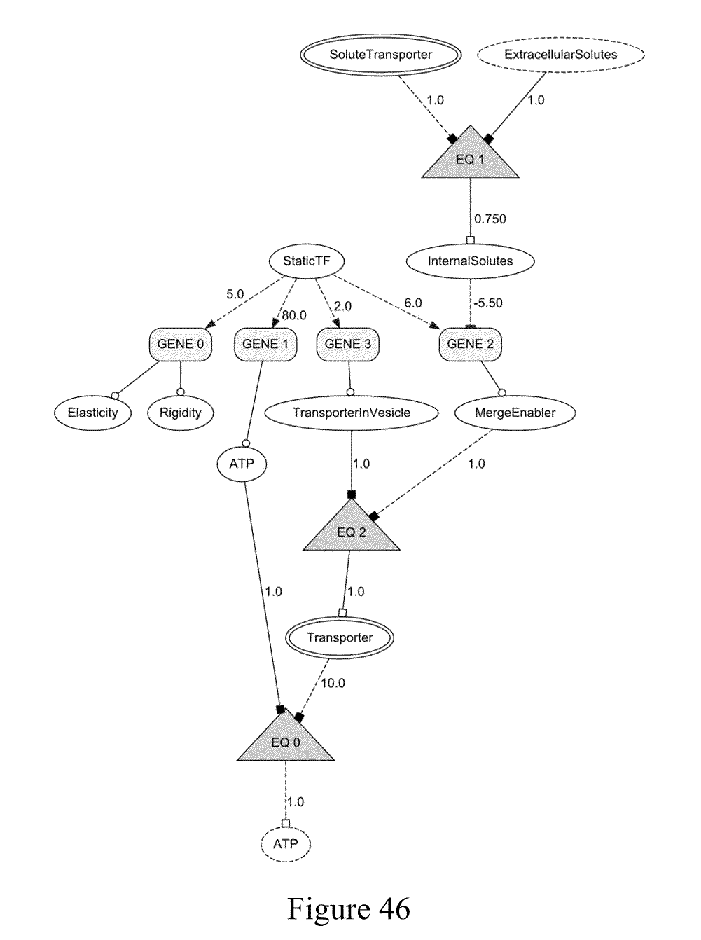

A model GRN was generated (FIG. 46) based on the “hybrid hypothesis” mechanism of suggested by Reigada and Mitchell to explain the in vivo data in FIGS. 44A and 44B. The hybrid hypothesis proposes that insertion of CFTR and/or Chloride (Cl—) channels into the membrane by vesicular fusion is necessary for ATP release (FIG. 45). As illustrated in FIG. 46, the hybrid hypothesis GRN stimulates the cell to build a reserve of vesicles containing ATP transport channels (“TransporterinVesicle”; FIG. 46). When there is a high availability of InternalSolutes, expression of a resource that enables these vesicles to merge with the cell's surface (“MergeEnabler”; FIG. 46) is suppressed. In the absence of InternalSolutes, the cell produces MergeEnabler and ATP is then able to leave the cell through Transporter.

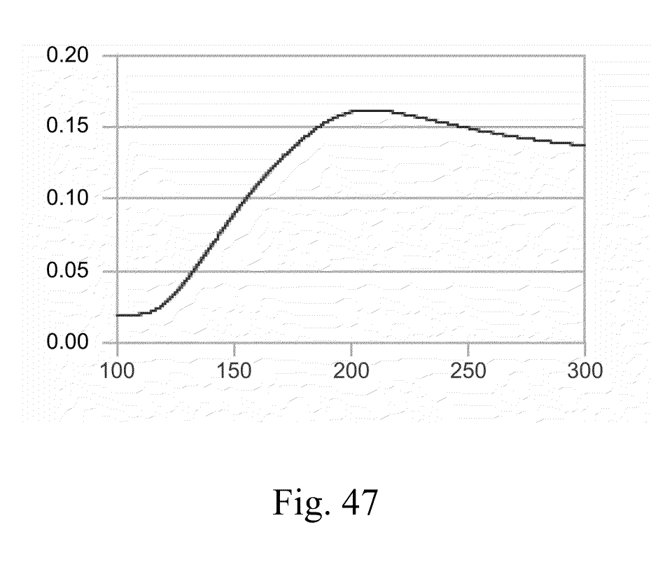

The hybrid hypothesis model produced a similar external ATP curve in response to hypotonic shock (FIG. 47) similar to that shown in FIG. 44A. Several experiments were run to show the model's normal behavior and response to variations (e.g., changing cell size, introduction of gene promotion noise, change in equation reaction rates), resulting in little to no change to the overall results.

In further embodiments, GRNs that are based on the first and second hypotheses described in FIG. 45 may be produced and compared with the hybrid hypothesis model by performing interference experiments on all models to confirm the involvement of both transport channels and vesicles in ATP release.

### H2. Example 2

### Viral Transformation

To implement a model GRN with basic viral transformation and infection capabilities, host-virus interactions may be represented by five general schemes for modeling purposes:
Scheme 1: virally-encoded proteins may inactivate a cellular activity (enzymatic or transcriptional).
Scheme 2: virally-encoded proteins may activate or enhance a cellular activity (enzymatic or transcriptional).
Scheme 3: virally-encoded proteins may alter transcription from the viral genome.
Scheme 4: cellular proteins may alter viral transcription or destroy the viral genome itself.
Scheme 5: the inverse of schemes 1-4 are also possible.

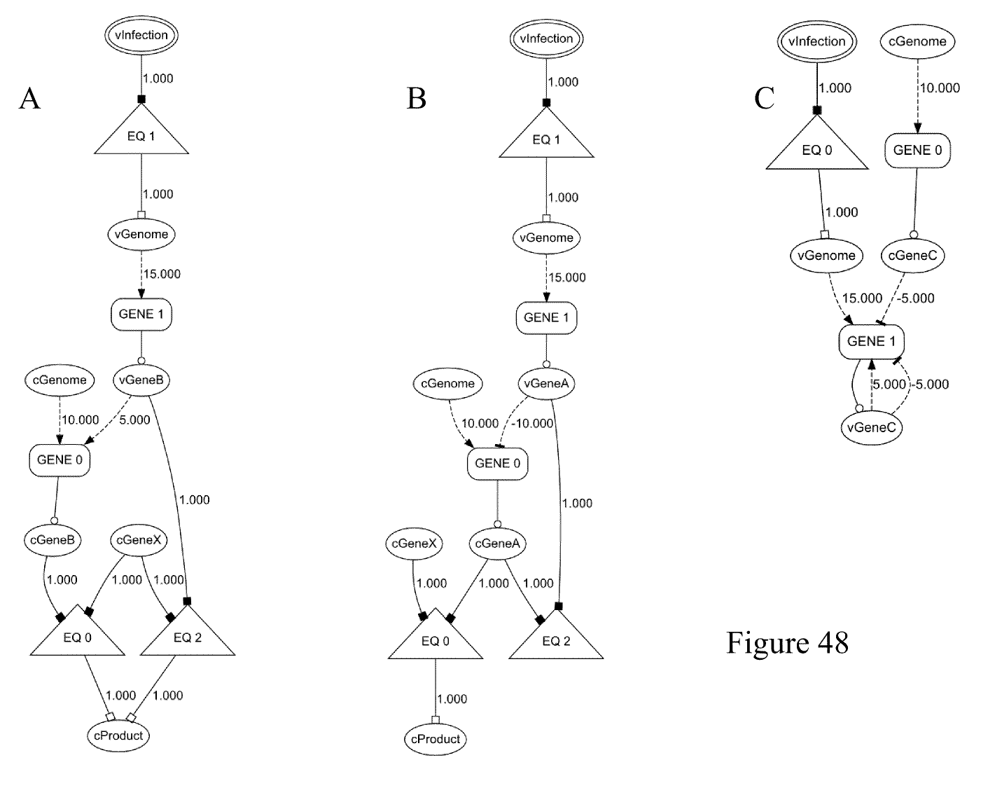

Basic static metabolic networks were generated that depict examples of schemes 1-4, and wherein examples of scheme 5 can be inferred. These sample metabolic network diagrams are included as FIGS. 48A-48C. Each network involves a viral genome (vGenome) that produces a single gene (vGeneA, vGeneB, or vGeneC) through transcription. In each case, a resource has also been defined to represent the cellular genome (cGenome), which produces a single gene (cGeneA, cGeneB, or cGeneC). FIGS. 48A and 48B also include a cellular resource (cGeneX) that exists within the cell, but whose transcription reaction was withheld for simplicity. Finally, a resource (vInfection) is used to indicate a viral infection has occurred and will be converted directly into vGenome. These basic networks show how a viral network could be defined within the host cell, would be completely silent under normal conditions, and would be triggered by the production of vGenome following infection. In these models the trigger for a viral infection could be a secreted factor from a neighboring cell, a point source, or a pre-defined external resource available at the start of the simulation.

In FIG. 48B, a network depicting a conceptual implementation of scheme 1 is illustrated. In this network, a viral infection triggers accumulation of a viral genome (vGenome) followed by transcription of the virus specific resource, vGeneA. As shown, the vGeneA resource can negatively regulate transcription of the cellular resource, cGeneA, by inhibiting the regulatory region of cGeneA (Gene 0). Alternatively, vGeneA can alter the activity of cGeneA by depleting its availability in the cell through an equation (EQ 2). Thus, a virus may negatively regulate transcription and/or activity of cellular resources. Similarly, a cellular resource could be shown negatively regulating viral resources.

In FIG. 48A, a network that is conceptually similar to the network depicted in FIG. 48B, but further shows, as described in scheme 2, how a virus could alter the cellular environment by increasing transcription of a cellular resource (cGeneB) through promotion of its regulatory region by the virus-specific resource (vGeneB). Similarly, the viral resource (vGeneB) can increase production of a cellular resource (cProduct) by participating in an enzymatic equation with the cellular resource (cGeneX). Again, the reverse relationship is also plausible and easily implemented.

In FIG. 48C, a network that provides a conceptual implementation of schemes 3 and 4 is shown. In this example, the resource (vGeneC) is encoded by the viral genome. The network shows a basic scheme where vGeneC regulates its own production by either inhibiting or promoting transcription from the viral genome. The same schematic is used to show how the cellular resource (cGeneC) can act directly on the viral genome by inhibiting the regulatory region of vGeneC. Alternatively, an equation could be added taking vGenome and cGeneC as input that would lead to active destruction of the viral genome in the presence of cGeneC.

In addition to the basic networks depicted in FIGS. 48A-48C, a more complicated model based upon the latent to lytic switch that occurs within CD34+ monocytes infected by the human cytomegalovirus (HCMV) was developed.

HCMV is a DNA virus that is a member of the herpes virus family. Like other herpes viruses it has a very large double-stranded DNA genome (minichromosome) that is introduced into the nucleus of an infected cell, replicated similarly to the host genome, and passed to daughter cells. Following HCMV infection, some cell types fail to enter a mode of active/productive replication. In these latent cells, the viral genome is generally considered to be transcriptionally inactive until a latent to lytic switch occurs. When the virus switches state from latency to a lytic replication mode, it first transcribes a set of genes called immediate early (IE) genes. The role of these genes are to alter the cellular environment to make it more amenable and productive for the viral replication that is about to ensue. These genes have been linked to a number of processes, such as interfering with the cell's ability to notify the immune system of the virus' presence. A second role of the IE genes is to interfere with apoptosis in the infected cell. It is advantageous for the virus if the host cell is prevented from an early death or if its normal longevity is extended. Following expression of the IE genes, a battery of genes are transcribed that lead to replication of the viral genome. Thus, during this phase there is an increase in the copy number of viral genomes within the cell. When sufficient replicated genomes have accumulated, the virus transcribes a third battery of genes, termed the late genes. These genes include the factors that are included within the newly forming infectious virus, as well as the proteins necessary for packaging and release of infectious virus particles, such as envelope proteins. Once these proteins accumulate, virus release occurs and infectious virus is released.

The secreted virus can (a) infect nearby cells with the appropriate receptors, (b) be recognized by antibodies and be degraded by the immune system and (c) leave the host to transmit the virus to a new host. Interestingly, it has been estimated that 50-90% of adults have been exposed to HCMV and likely harbor latent virus within their bodies. These individuals are asymptomatic, unless their immune system becomes compromised, such as in AIDS patients or individuals who have received organ transplants. The virus can also infect the offspring of pregnant women through the umbilical cord, leading to congenital defects, such as hearing loss (1 out of 2000). There are also indications that it may be associated with atherosclerosis and cancer. One of the goals of HCMV research has been to understand which cells in the body harbor latent viruses, how it becomes latent, and what triggers the switch to lytic replication (HIV is also known to hide in a latent state in infected individuals). Perhaps counter-intuitively, a promising therapeutic approach may be to trigger latently infected cells to replicate the virus giving the immune system a chance to remove the latent stores and clear the virus.

A recent study shows that one type of cell that is latently infected by HCMV is the CD34 expressing (CD34+) stem cells in the bone marrow that give rise to leukocytes, such as macrophages and dendrites (Goodrum et al., 2007). Though the details have not been worked out, it is known that infection of CD34+ cells leads to a latent infection. It has been shown that a five kilodalton viral RNA (UL138) is expressed in CD34+ cells and is necessary to establish latency (Goodrum et al., 2007). When the latently-infected CD34+ cells differentiate, they lose expression of the CD34 marker and UL138 (among other things), and become developmentally committed. As a result, the virus switches to a lytic state and replication ensues. It is presumed that UL138 leads to modification of the genome-associated histones making it transcriptionally inactive.

HCMV was chosen as the basis for the model development because it is biologically and medically relevant, enables us to show viral transforming properties, and allows us to visualize virus spread in the population. Based on the known work relating to HCMV infection described above in Goodrum et al., a model was developed that successfully satisfied the following pre-determined requirements:
(1) CD34+ cells can be infected by virus, but must be maintained in a latent state.
(2) CD34+ cell division always results in regeneration of a CD34+ daughter cell and a committed CD34− daughter cell. Thus each CD34+ cell will define a separate lineage and only one CD34+ cell will exist in each lineage.
(3) The simulation should initiate with at least one latently infected CD34+ cell, but there should be no virus particles present in the simulation. Production of infectious HCMV virus capable of spreading within the cell population is dependent upon the original infected cell undergoing a latent to lytic switch.
(4) The conversion of a CD34+/UL138+ cell to a CD34− cell should trigger loss of UL138 and a latent to lytic switch. The CD34+ parent should remain latent.
(5) The production of new viral genomes should depend upon: (A) production of IE genes, (B) production of replication factors and (C) presence of a viral genome.
(6) The production of infectious virus should follow from (5) when late genes and viral envelope proteins are produced.
(7) Virus should be secreted from replicating cells that satisfy (5) and (6) and have the ability to infect uninfected cells through interaction with a virus receptor present on the cell surface.
(8) Infection of CD34+ cells should lead to latent infection, whereas infection of CD34− cells should result in a productive infection.
(9) A virus undergoing replication should modify the physiology of the infected cell by increasing its lifespan in the population. Specifically the virus should be able to extend the host cells' longevity by inhibiting the cell death pathway in infected cells.

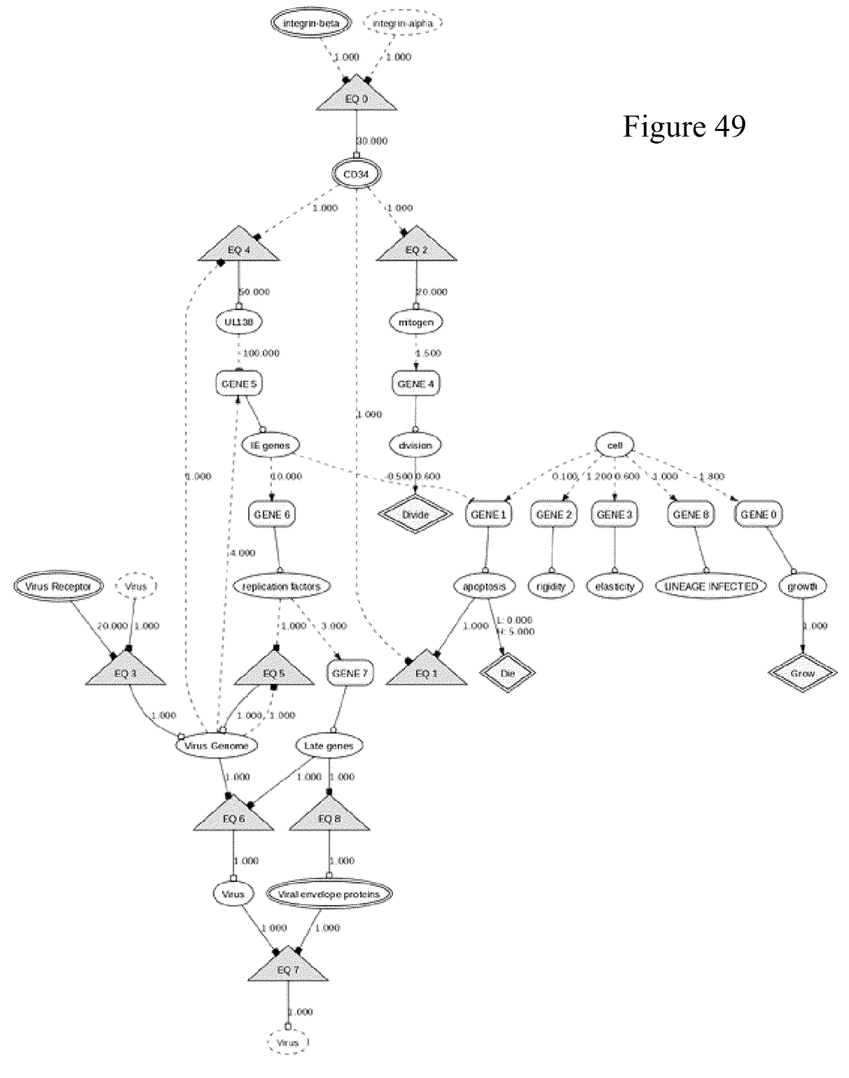

The static metabolic network for the CD34+ cells and their progeny is shown in FIG. 49. The difference between the CD34+ latently-infected cells and CD34+ uninfected cells is a lineage marker (“lineage infected” and “lineage uninfected,” respectively) and an initial pool of “virus genome.” None of the cells have an initial concentration of virus, because viral concentration arises as a result of replication derived from the viral genome within the latently infected cells.

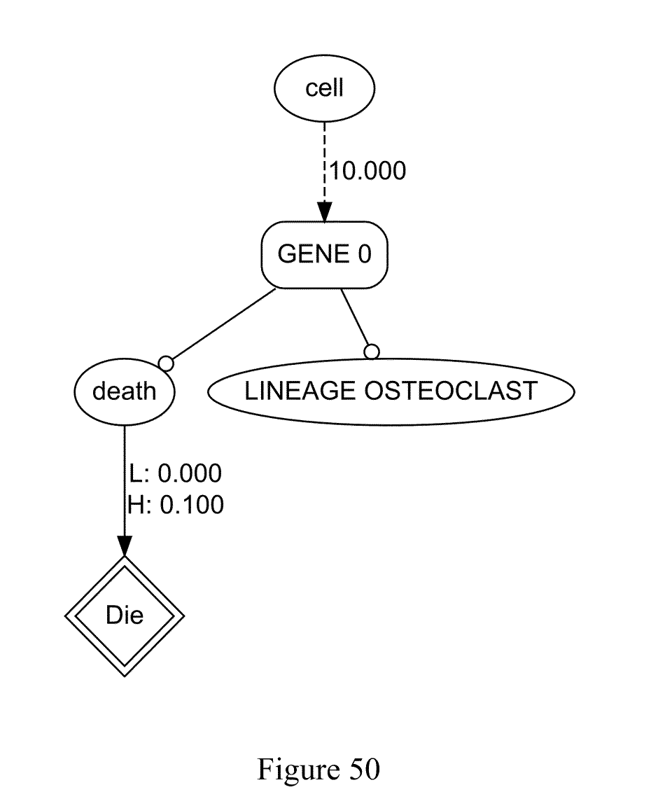

Stem cells in the bone marrow generally require a cell-cell interaction with another cell type (osteoclast) to maintain their stem cell fate. For simplicity, an active osteoclast interaction was not required to maintain the stem cell properties, but an osteoclast cell type that interacts with the initial stem cells (integrin interactions) was defined to induce CD34 expression. The CD34+ is not dispersed within the stem cell resulting in a polarized cell. This ensures that every cell division results in one CD34+ and one CD34− cell. Thus, in the current example, no more than one CD34+ cell for any lineage exists within the simulation. This is not a necessity of the model. In other embodiments, accumulation of stem cell populations may be built in. For simplicity, the osteoclast cells are not visible during the simulation and disappear after 2 steps. The osteoclast simple static metabolic network is shown in FIG. 50.

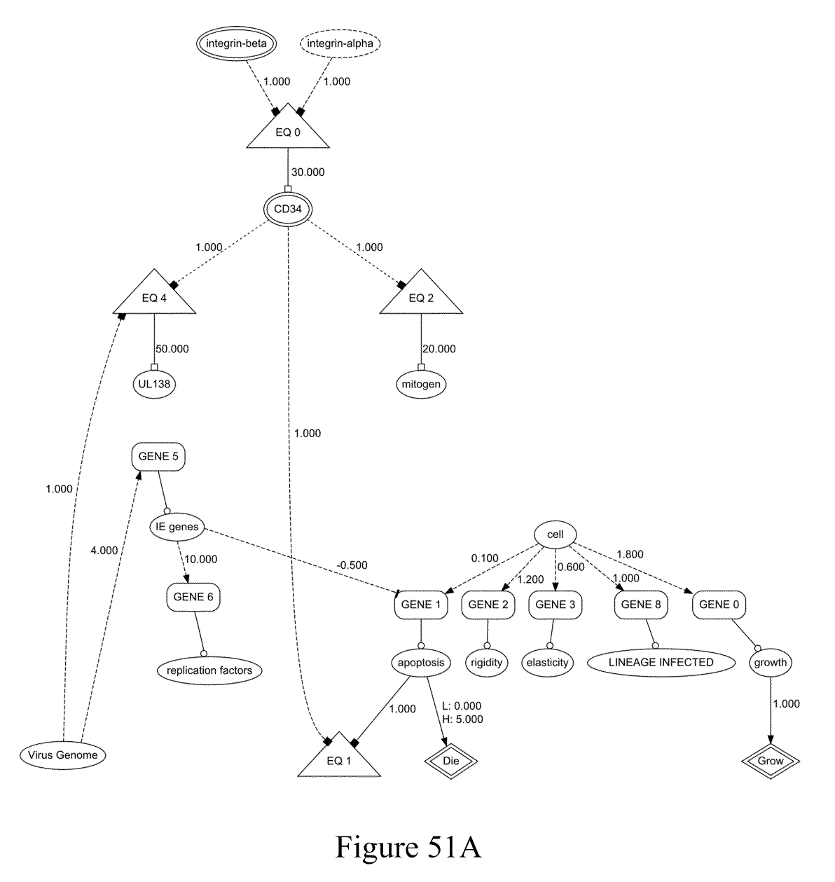

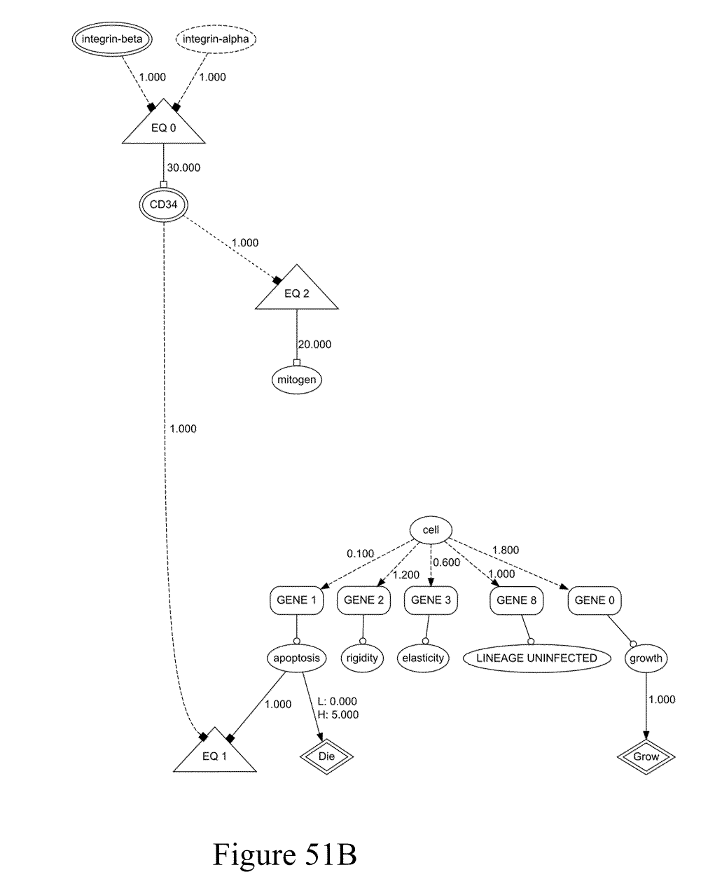

To show the details of viral spread and replication in this model, the simulations include a stem cell lineage that harbors a latent viral genome (“viral genome” concentration of 5) along with a separate lineage that has not been infected (“viral genome” concentration of zero). The active metabolic network for a latently infected cell and an uninfected cell are shown in FIGS. 51A and 51B, respectively.

As shown in FIG. 51A, when a cell is latently infected there is no viral replication occurring. When both CD34 and UL138 are present, transcription of the immediate early genes from the viral genome is inhibited to prevent viral replication and to maintain latency.

When the CD34+ cells divide they produce a CD34+ and a CD34− daughter cell. Because the CD34− daughter cell lacks CD34 and UL138 it will not maintain a state of latency. Rather, it will begin expressing sufficient levels of immediately early genes leading to virus replication, but only in CD34− daughter cells. Cell division is dependent upon a mitogen factor that requires CD34 (FIG. 49), which ensures that only the stem cells have replicative potential. In this model, the rate of division and apoptosis were configured such that the rate of cell death within the CD34− population of uninfected cells was equal to the rate of division of the CD34+ progenitors, resulting in a stable population of cells (17-19 cells) in the absence of viral infection. One function of the HCMV IE genes is to inhibit apoptosis in order to allow cells undergoing viral replication time to produce new infectious particles before destruction of the host cell. As shown in FIG. 49, IE genes interfere with apoptosis by having an inhibitory effect on “gene 1,” which is responsible for producing apoptosis in this model.

Although only one population of cells in the simulations contains an initial concentration of virus genome, they all express “virus receptor”, which makes them susceptible to infection if presented with external infectious virus. Thus, the virus produced by CD34− cells that derive from the latently infected progenitor can infect nearby cells and lead to viral spread within the local population.

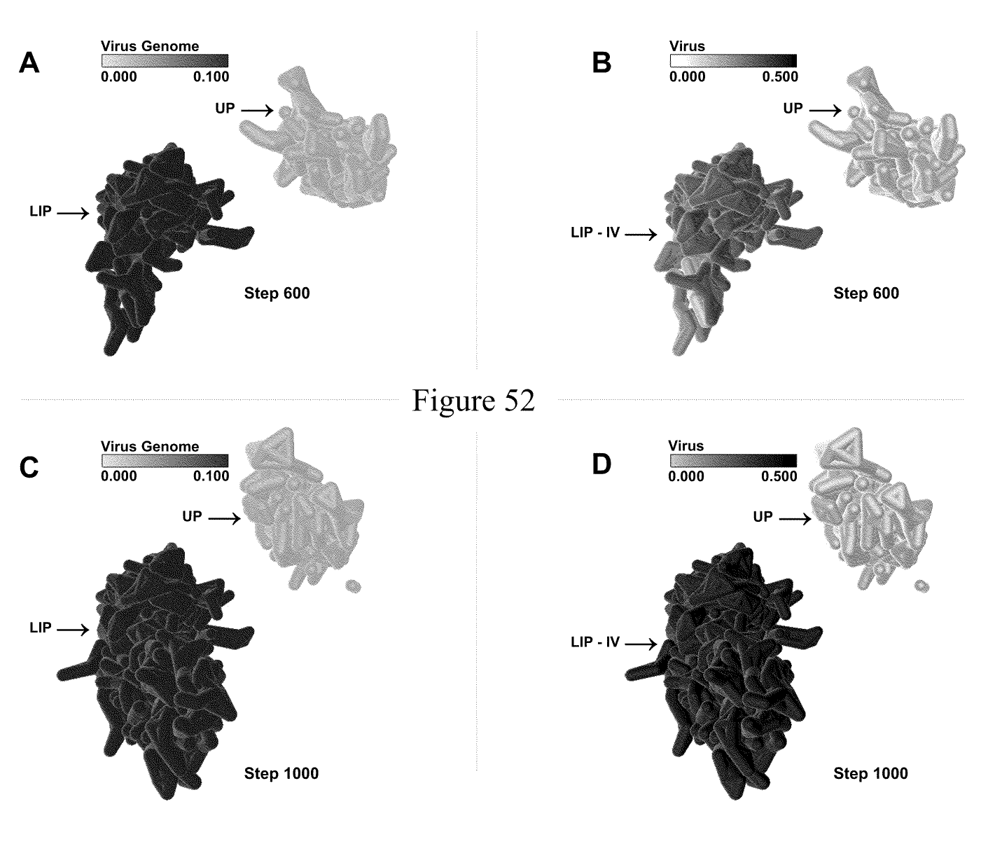

A few simulations of the model were analyzed to highlight some of its interesting features. In the first case, the simulation was initiated with two CD34+ cells that were located 20 units away from each other. This distance prevented the infection of uninfected CD34 cells by virus secreted from the infected CD34− cell lineage. A simulation recording was generated (A—HCMV initial replication but no viral spread 1000.csr) and analyzed. As shown FIG. 52A, all cells originating from the CD34− latently infected progenitor (dark cells, “LIP,” bottom left) contain viral genome, but none of the cells originating from the uninfected progenitor (light cells, “UP,” top right) have viral genome. The presence of viral genome translates into production of infectious virus (medium shaded cells, “LIP-IV,” bottom left) as shown in FIG. 52B.

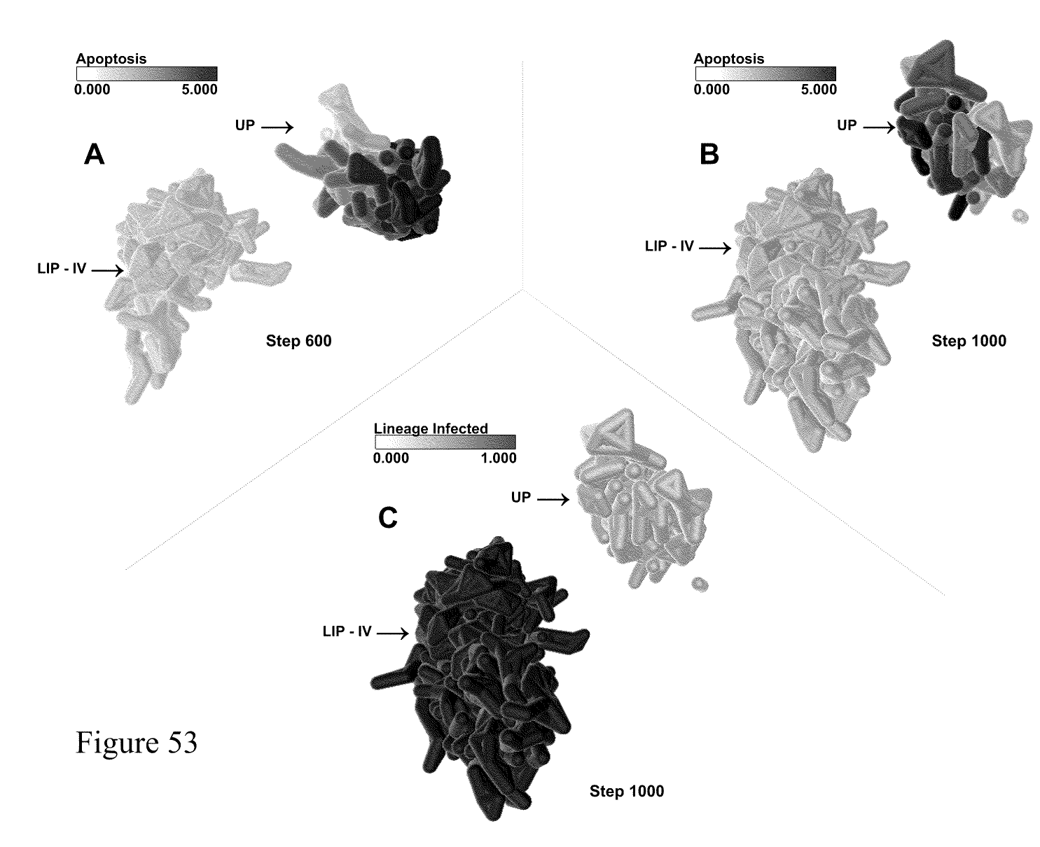

Notably, there are more cells in the cluster of infected cells (LIP and LIP-IV) than in the uninfected cells shown in FIGS. 52(A-D). As shown in FIGS. 53A and 53B, an increase in the number of cells correlates with reduced apoptosis accumulation (apoptosis shown by dark cells) in the population of infected cells (LIP-IV), which allows them to survive longer. The separate lineages (UP and LIP-IV) are highlighted in FIG. 53C.

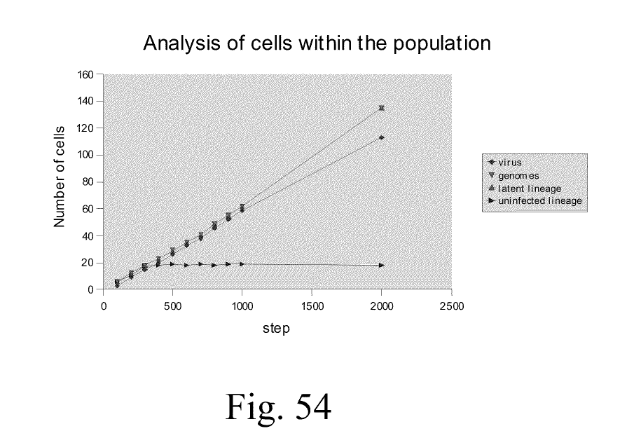

An analysis of the number of cells contained within each population illustrates the life span advantage provided to the infected cells by IE genes limiting apoptosis (FIG. 54). Whereas the uninfected cell population derived from a single progenitor cell stabilizes at 17-19 cells (“uninfected lineage,” FIG. 54), there is a steady increase in cell number within the population derived from the latently infected progenitor (“latent lineage,” FIG. 54). There is a one to one relationship between the number of cells containing virus genomes (“genomes,” FIG. 54) and those of derived from the latently infected lineage. However, there is a lag in the number of virus producing cells (“virus,” FIG. 54) as new daughter cells build up resources.

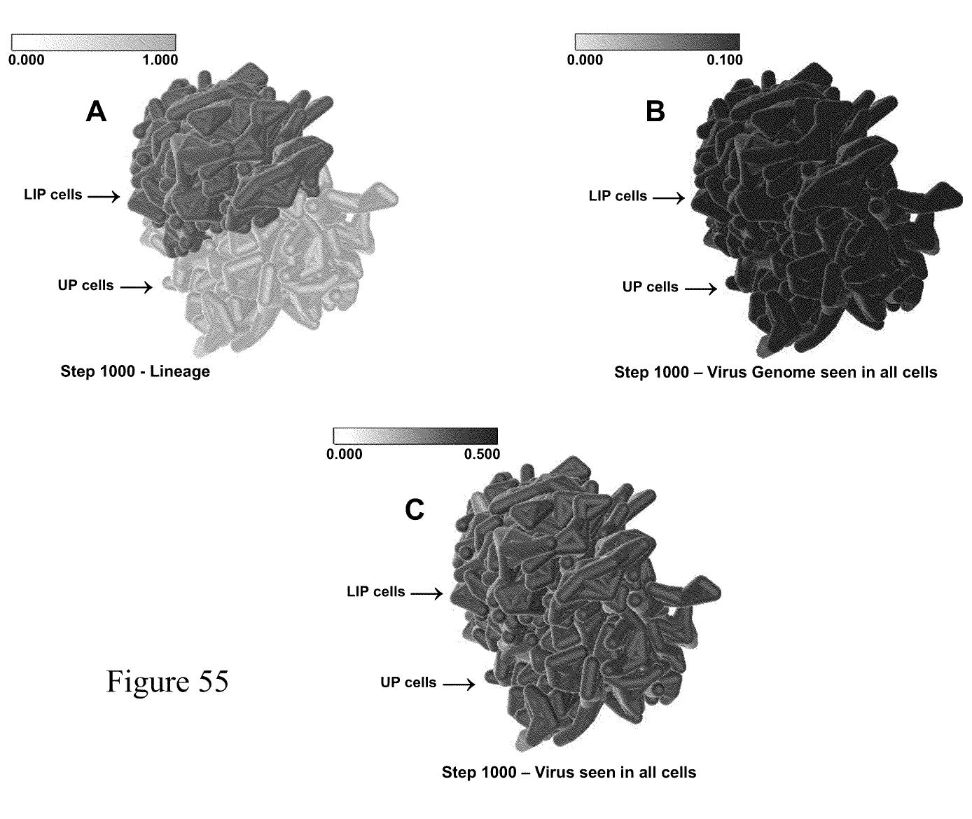

A second simulation was run with the starting populations physically close enough to allow infectious virus generated from the latent lineage to spread to cells from the uninfected lineage. The two lineages are illustrated in FIG. 55A (latently infected progenitors, “LIP,” medium shaded cells; uninfected progenitors, “UP,” light cells) whereas viral spread is indicated by the presence of virus genome in the entire population (all are dark cells, FIG. 55B). As shown in FIG. 55C, the cells derived from the uninfected lineage can not only be infected by external virus, but can replicate the viral genome in response to infection, as all cells are infected, shown by all medium shaded cells.

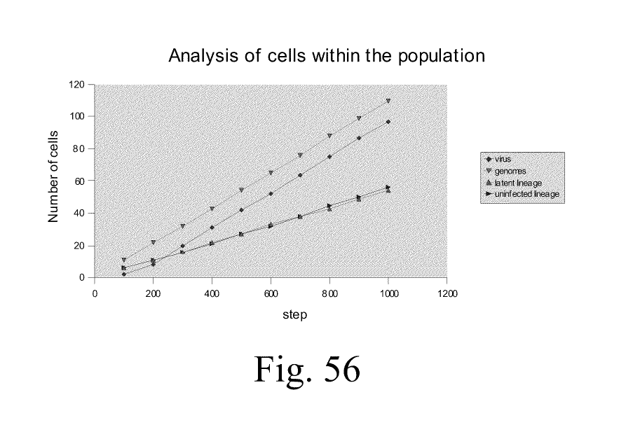

As shown in FIG. 56, the spread of the virus to all cells in the population eliminates the disparity between cell numbers associated with the separate lineages. Both lineages increase in cell count due to the introduction of virus and the associated inhibition of apoptosis.

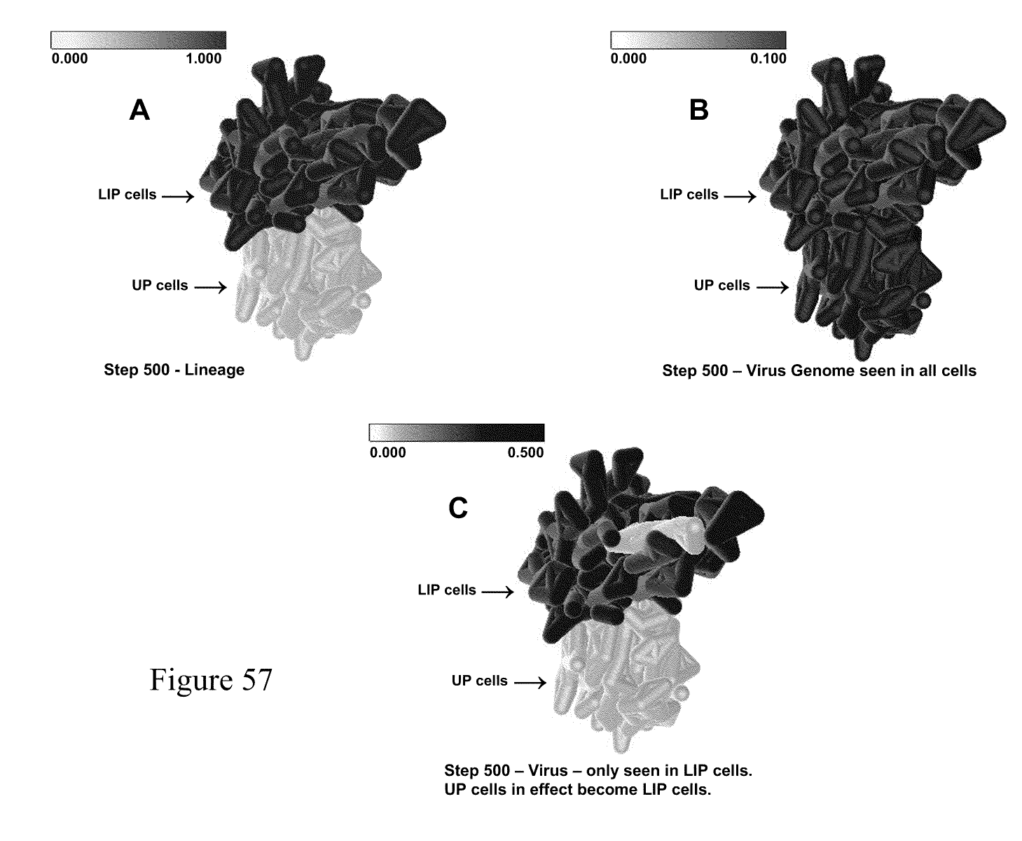

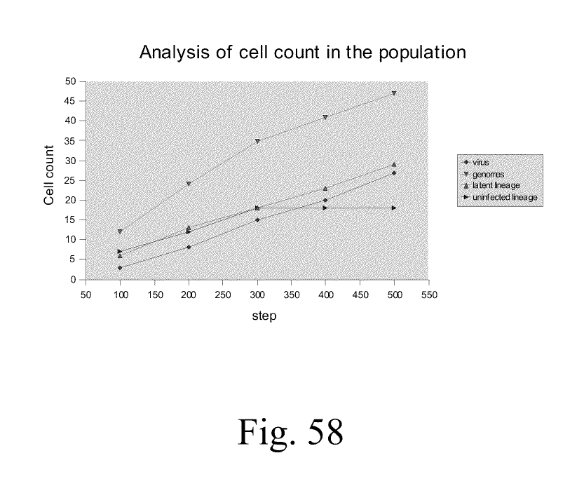

A third simulation (FIG. 57A-C, FIG. 58) shows that when the amount of virus receptor available on the cell is limiting, there is still a spread of infectious virus in the population (all cells show the presence of viral genome noted as dark cells, FIG. 57B), but the amount of viral genome is insufficient to support virus replication in the uninfected progenitor cells (bottom, light cells). This results in the spread and establishment of more latently infected populations.

In sum, a model was designed that simulates aspects of the HCMV replication cycle within the CD34+ derived cells in the bone marrow. These cells can sustain a latent viral infection without any sign of replication until division leads to physiological changes that cause the virus to undergo a latent to lytic switch. Once this happens, the IE genes act to change the cell's physiology by interfering with the apoptosis pathway. The number of infected and replicating cells in the simulation continues to slowly increase relative to the uninfected (or non-replicating) cells. The accumulation of cells is solely due to increased survival time and not to cell divisions as only CD34+ cells have the capacity to divide in this simulation. Thus, the effect of HCMV on apoptosis in our model would not itself transform cells into tumorigenic cells, whereas an increase in the number of cell divisions would increase the frequency of mutations and increase the potential for cancer formation, particularly in a cell targeting apoptosis. In further embodiments, models may incorporate additional complexities of virus-host interactions.

### I. Additional Embodiments of Simulation Systems and Methods

As another example, the cell-centric simulator may be implemented as a computational component for use in directing one or more computing devices to model one or more biological events. Referring to FIG. 29, the computational component may comprise encoded computing device instructions 2922, emanating from a tangible computer readable medium, such as a memory 2920 at a server 2908. The encoded computing device instructions 2922 are electronically accessible to at least one of the computing devices 2902 and 2908 for execution. The computational component may be received at the memory 3002 (FIG. 30) of the computing device 2902 from the server 2908 coupled to the memory 3002 via the network 2906, for example.

The execution of the encoded computing device instructions 2922 may cause the one or more computing devices 2902 and 2908 to receive configurable simulation information. In one embodiment, the configurable simulation information may include user-configurable simulation information received via user interface. In another embodiment, the configurable simulation information can be extracted from a selected configuration file generated during a previous simulation session and stored, for example, in the memory 2920 and/or database 2910.

The execution of the encoded computing device instructions 2922 may further cause the one or more computing devices 2902 and 2908 to initialize an ontogeny engine to an initial step boundary in accordance with the configurable simulation information. The execution of the encoded computing device instructions 2922 may further cause the one or more computing devices 2902 and 2908 to advance the ontogeny engine from a current step boundary to a next step boundary in accordance with the configurable simulation information and the current step boundary. The advancing can include performing a stepCells function. The execution of the encoded computing device instructions 2922 may further cause the one or more computing devices 2902 and 2908 to continue the advancing until a halting condition is encountered. In other embodiments, the advancing can include performing one or more of a killCells function, a stepECM function and stepPhysics function.

Referring to FIG. 30, an operating system (not shown) runs on the processor 3001 and coordinates and provides control of various components within the computing device system 2902. The operating system may be a commonly available operating system such as Microsoft® Windows® XP (Microsoft and Windows are trademarks of Microsoft Corporation in the United States, other countries, or both). A programming system or program interpreter may run in conjunction with the operating system and provide calls to the operating system from these programs or applications executing on computing system 2902.

Instructions for the operating system, the programming system, and applications or programs are located on storage devices, such as a hard disk drive, and may be loaded into the memory 3002 for execution by the processor 3001. The processes of the disclosed illustrative embodiments may be performed by the processor 3001 using computer implemented instructions, which may be located in a memory such as, for example, the memory 3002 or in one or more peripheral devices.

The hardware in computing system 2900 may vary depending on the implementation. Other internal hardware or peripheral devices, such as flash memory, equivalent non-volatile memory, or optical disk drives and the like, may be used in addition to or in place of the hardware depicted in FIG. 29. Also, the processes of the disclosed illustrative embodiments may be applied to a multiprocessor data processing system.

In some illustrative examples, portions of the computing system 2900 may be implemented in a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A processing unit may include one or more processors or CPUs. The depicted examples in FIGS. 29 and 30 and above-described examples are not meant to imply architectural limitations. For example, portions of the computing system 2900 also may be implemented in a tablet computer, laptop computer, or telephone device in addition to taking the form of a PDA.

Particular embodiments of the computing system 700 can take the form of an entirely hardware embodiment, an entirely software embodiment or an embodiment containing both hardware and software elements. In a particular embodiment, the disclosed methods are implemented in software, which includes but is not limited to firmware, resident software, microcode, etc.

Further, embodiments of the present disclosure, such as the one or more embodiments in FIGS. 1-27 can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital versatile disk (DVD).

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the data processing system either directly or through intervening I/O controllers.

Network adapters may also be coupled to the data processing system to enable the data processing system to become coupled to other data processing systems or remote printers or storage devices through intervening private or public networks. Modems, cable modems, and Ethernet cards are just a few of the currently available types of network adapters.

### J. Conclusion

Various embodiments of the technology are described above. It will be appreciated that details set forth above are provided to describe the embodiments in a manner sufficient to enable a person skilled in the relevant art to make and use the disclosed embodiments. Several of the details and advantages, however, may not be necessary to practice some embodiments. Additionally, some well-known structures or functions may not be shown or described in detail, so as to avoid unnecessarily obscuring the relevant description of the various embodiments. Although some embodiments may be within the scope of the claims, they may not be described in detail with respect to the Figures. Furthermore, features, structures, or characteristics of various embodiments may be combined in any suitable manner.

Moreover, one skilled in the art will recognize that there are a number of other technologies that could be used to perform functions similar to those described above and so the claims should not be limited to the devices or routines described herein. While processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. The headings provided herein are for convenience only and do not interpret the scope or meaning of the claims.

The terminology used in the description is intended to be interpreted in its broadest reasonable manner, even though it is being used in conjunction with a detailed description of identified embodiments.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. When the claims use the word “or” in reference to a list of two or more items, that word covers all of the following interpretations of the word: any of the items in the list, all of the items in the list, and any combination of the items in the list.

Any patents, applications and other references, including any that may be listed in accompanying filing papers, are incorporated herein by reference. Aspects of the described technology can be modified, if necessary, to employ the systems, functions, and concepts of the various references described above to provide yet further embodiments.

These and other changes can be made in light of the above detailed description. While the above description details certain embodiments and describes the best mode contemplated, no matter how detailed, various changes can be made. Implementation details may vary considerably, while still being encompassed by the technology disclosed herein. For example, it will be appreciated how one can simulate biological events, modify the configurable simulation information, and perform additional and/or subsequent simulations, such as those detailed above, using the cell-centric simulation system. Further, it will be recognized that a user can generate user-configurable simulation information to computationally simulate biological events such as development of cellular tissues having a desired phenotype, shape, cell composition, and/or other properties.

As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the claims to the specific embodiments disclosed in the specification, unless the above detailed description section explicitly defines such terms. Accordingly, the actual scope of the claims encompasses not only the disclosed embodiments, but also all equivalents.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and features as defined by the following claims.

### REFERENCES

The references cited within the disclosure, and all references listed below are hereby incorporated by reference in their entirety as if fully set forth herein.
Alberts, B., A. Johnson, J. Lewis, M. Raff, K. Roberts, and P. Walter (2002). Molecular Biology of the Cell, Fourth Edition, pp 1027-1125. Garland Science, New York.
Berg, J. et al. (2002) Biochemistry. 5^{th} Ed. Michelle Julet, New York.
Carlson, M., Mucha, P. J., and Turk, G., “Rigid fluid: Animating the interplay between rigid bodies and fluid,” ACM Transactions on Graphics, vol. 23, pp. 377-384, August 2004.
Carlson, M., “Rigid, Melting, and Flowing Fluid,” PhD thesis, Georgia Institute of Technology. http://www-static.cc.gatech.edu/˜carlson/papers/carlson-thesis.pdf 2004.
Desbrun, M. and Gascuel, M.-P., “Smoothed particles: A new paradigm for animating highly deformable bodies,” Proceedings of the Eurographics workshop on computer animation and simulation '96, pp. 61-76, December 1996.
Ellis, R. J. (2001) Macromolecular crowding: obvious but underappreciated. Trends. Biochem. Sci. 26:597-604.
Goodrum, F. et al., (2007) Human cytomegalovirus sequences expressed in latently infected individuals promote a latent infection in vitro. Blood, 110:937-945
Hales, T. C. (2005); A proof of the Kepler conjecture. Annals of Mathematics, 162, 1063-1183.
Miller, G. and Pearce, A., “Globular dynamics: A connected particle system for animating viscous fluids,” Computers and Graphics, vol. 13, no. 3, pp. 305-309, 1989.
Muller, M., Charypar, D., and Gross, M., “Particle-based fluid simulation for interactive applications,” in Proceedings of the 2003 ACM SIGGRAPH/Eurographics Symposium on Computer Animation (SCA-03) (Breen, D. and Lin, M., eds.), (Aire-la-Ville), pp. 154-159, Eurographics Association, Jul. 26-27, 2003.
Morowitz, H [2002]. The Emergence of Everything. Oxford Univ. Press, Oxford UK. 209 pp.
Premoze, S., Tasdizen, T., Bigler, J., Lefohn, A., and Whitaker, R. T., “Particle-based simulation of fluids,” Computer Graphics Forum, vol. 22, pp. 401-411, September 2003
Reigada, D. and Mitchell, C. H. (2005) Release of ATP from retinal pigment epithelial cells involves both CFTR and vesicular transport. Am J Cell 288:C132-C140
Steels, L. [1994] The artificial life roots of artificial intelligence. Artificial Life I, [no. 1,2]:75-110.
Terzopoulos, D., Platt, J., and Fleischer, K., “Heating and melting deformable models (from goop to glop),” in Graphics Interface '89, pp. 219-226, June 1989.

We claim:

1. A computer-implemented method of modeling an extracellular matrix (ECM) comprising:
receiving configurable simulation information, the configurable simulation information comprising one or more ECM definition rules, wherein at least one ECM unit type is defined, and wherein a plurality of ECM units assemble to form an ECM component,
initializing an ontogeny engine to an initial state,
advancing the ontogeny engine from a current step boundary to a next step boundary in accordance with the configurable simulation information and the current step boundary, wherein advancing the ontogeny engine creates a dynamic virtual environment comprising at least one ECM component, and
continuing the advancing until a halting condition is encountered.

2. The method of claim 1, wherein the dynamic virtual environment defines at least one ECM unit type and no cells.

3. The method of claim 1, wherein the ECM component is a virtual elastic fiber.

4. The method of claim 1, wherein the ECM component is a virtual rigid fiber.

5. The method of claim 1, wherein the ECM component is a virtual ground substance.

6. The method of claim 1, wherein the ECM component is a virtual membrane.

7. The method of claim 6, wherein the ECM component is a virtual basement membrane.

8. The method of claim 1, wherein the ECM units are sphere shaped.

9. The method of claim 1, wherein the ECM units are rod shaped.

10. The method of claim 1, wherein an ECM unit has 0 attachment points.

11. The method of claim 1, wherein an ECM unit is configured to have one or more attachment points.

12. The method of claim 11, wherein the ECM unit is one of a plurality of ECM units for modeling a ground substance.

13. The method of claim 1, wherein the ECM unit is one of a plurality of ECM units for modeling one or more ECM fibers.

14. The method of claim 13, wherein the ECM unit is one of a plurality of ECM units for modeling one or more rigid ECM fibers.

15. The method of claim 14, wherein the ECM unit has 2 attachment points.

16. The method of claim 11, wherein an alignment strength between two or more attached ECM units is configured to be proportional to the rigidity between the ECM units.

17. The method of claim 12, wherein the ECM unit has a number of attachment points configured for modeling the organization of ground substance.

18. The method of claim 13, wherein the ECM unit has a number of attachment points configured for modeling the organization of one or more ECM fibers.

19. The method of claim 12, wherein the strength of adhesions between ECM units is attenuated to contribute to a tensile strength for modeling ground substance.

20. The method of claim 13, wherein the strength of adhesions between ECM units is attenuated to contribute to a tensile strength for modeling one or more ECM fibers.

21. The method of claim 12, wherein the ground substance is made more elastic by decreasing a breaking distance between ECM unit attachments.

22. The method of claim 13, wherein the ECM fiber is made more elastic by decreasing a breaking distance of ECM unit attachments.

23. The method of claim 18, wherein an ECM unit has 2 or more attachment points for modeling an elastic ECM fiber network.

24. The method of claim 18, wherein an ECM unit has 4 or more attachment points for modeling a membrane.

25. The method of claim 24, wherein the membrane may comprise 3 or more attached ECM units.

26. The method of claim 1 wherein the dynamic virtual environment further defines at least one virtual cell, and wherein the virtual cell comprises a plurality of cellular subunits.

27. The method of claim 26, wherein the virtual cell interacts with the ECM units.

28. The method of claim 26, where the configurable simulation information also comprises one or more ECM production rule.

29. The method of claim 26, wherein the virtual cell may be configured to produce one or more types of ECM units according to one or more ECM production rules.

30. The method of claim 26, wherein the virtual cell may be configured to destroy one or more types of ECM units according to one or more ECM destruction rules.

31. The method of claim 26, wherein an ECM component produces an external influence to direct an oriented response by the virtual cell.

32. The method of claim 31, wherein the external influence determines placement and arrangement of ECM units produced by a virtual cell.

33. A computer-implemented method of modeling extracellular resource distribution and transport in a virtual environment comprising:
receiving configurable simulation information, the configurable simulation information comprising:
initializing an ontogeny engine to an initial state, wherein the initial state defines at least one virtual cell and one fluid in a virtual environment, wherein the virtual cell comprises a plurality of cellular subunits and the fluid comprises a plurality of fluid units, and wherein each fluid unit nay contain one or more extracellular resources to be distributed or transported,
advancing the ontogeny engine from a current step boundary to a next step boundary in accordance with the configurable simulation information and the current step boundary,
continuing the advancing until a halting condition is encountered.

34. The method of claim 33, wherein the environmental point source is an emitter.

35. The method of claim 33, wherein the configurable simulation information includes a collector.

36. The method of claim 33, wherein fluid comprises a plurality of droplets.

37. The method of claim 33, wherein fluid comprises a plurality of environment nodes.

38. The method of claim 33, further comprising a test for tissue barrier function.

39. The method of claim 33, wherein the fluid flows in accordance with a pressure gradient.

40. The method of claim 33, wherein the extracellular resources are stored within the fluid units.

41. The method of 40, wherein the extracellular resources are conditionally exchanged upon collisions between fluid units.

42. A computer-implemented method of modeling metabolism within a virtual cell comprising:
receiving configurable simulation information, the configurable simulation information comprising:
one or more metabolic equations, and
a resource catalog having one or more metabolic resources,
initializing an ontogeny engine to an initial state, wherein the initial state defines at least one virtual cell in a virtual environment, wherein the virtual cell comprises a plurality of cellular subunits,
advancing the ontogeny engine from a current step boundary to a next step boundary in accordance with the configurable simulation information and the current step boundary, the advancing comprising performing a metabolizeCell function, wherein the metabolizeCell function is a metabolic step comprising the steps of:
calculating one or more metabolic equations;
producing an extracellular matrix;
monitoring one or more resources for a fatal condition; and
monitoring one or more action capacity resources for actions comprising growth, redistribution of internal resources and division;
continuing the advancing until a halting condition is encountered.

43. The method of claim 42, wherein the the configuration simulation information also comprises one or more template resources and wherein the metabolizeCell function is a metabolic step also comprising the step of calculating the promotion of a virtual gene and transcribing an associated template resource.

44. The method of claim 42, wherein a reaction multiplier is applied to the metabolic equation.

45. The method of claim 42, wherein the metabolic equations are calculated by each cellular subunit.

46. The method of claim 45, wherein the calculation by each cellular subunit creates a non-uniform distribution of resources within the virtual cell.

47. The method of claim 42, wherein the metabolic equations further comprise one or more translation equations.

48. The method of claim 47, wherein a template resource is used in the translation equation.
